(19) United States
(12) Patent Application Publication
(10) Pub. No.: US 2007/0174009 A1
(43) Pub. Date: Jul. 26, 2007

(54) Methods and systems for analyzing a network of biological functions

(75) Inventors: Masato Miyake, Amagasaki-shi (JP); Tomohiro Yoshikawa, Amagasaki-shi (JP); Takanori Ueda, Amagasaki-shi (JP); Jun Miyake, Amagaski-shi (JP)

Correspondence Address: SEED INTELLECTUAL PROPERTY LAW GROUP PLLC, 701 FIFTH AVE, SUITE 5400, SEATTLE, WA, 98104, US

(73) Assignee: National Institute Of Advanced Industrial Science And Technology, Chiyoda-ku (JP)

(21) Appl. No.: 11/262,554

(22) Filed: Oct. 28, 2005

Related U.S. Application Data
(60) Provisional application No. 60/623,311, filed on Oct. 29, 2004.

(51) Int. Cl. G06F 19/00

(52) U.S. Cl. 702/20

(57) ABSTRACT

The present invention provides a method and system for analyzing a network of biological functions, such as transcriptional factors, structural genes, cellular markers, cell surface markers, cell shapes, organelle shapes, cell mobility, enzyme activities, metabolite concentrations, and localization of cellular components, in a biological entity such as a cell. Particularly, an object of the present invention is to provide a system and method for presenting biological information in a global manner without modification where the cell is considered a complex system.

### BACKGROUND OF THE INVENTION

1. Field of the Invention

The present invention relates to the field of analysis of biology. More specifically, the present invention relates to the logical analysis of a biological entity such as a cell.

2. Description of the Related Art

The survival of organisms depends on their ability to perceive and respond to perturbation factors such as extracellular signals. At the molecular level, perturbation factors such as signals are perceived and transmitted through networks of interacting agents present is in a biological entity such as proteins, metabolites or the like, that act cooperatively to maintain biological homeostasis and regulate activities like growth, division, differentiation, drug response, and the like. Information transmission through networks of a biological entity is mediated largely by interactions between agents having a variety of functions that may assemble and disassemble dynamically in response to signals, creating transient circuits that link external events to specific internal outputs, such as changes in gene expression, cell shapes, organelle shapes, cell mobility, enzyme activities, metabolite concentrations, and localization of cellular components. Numerous strategies have been developed to map the interactions that underlie these networks. These studies have collectively provided a wealth of data delineating genome-wide, protein-protein interactions for Escherichia coli, Saccharomyces cervisiae and other organisms. While powerful, these approaches have provided only partial pictures and are likely to overlook many interactions that are context dependent, forming only in the presence of their appropriate signals.

The change in interactions by perturbation factors such as siRNA, antibodies, ligands, hormones, drugs, proteins, mutation or small-molecules can create biological fulcrums that enable small perturbations of a network of biological functions, such as those presented in transcriptional factors, structural genes, cellular markers, cell surface markers, cell shapes, organelle shapes, cell mobility, enzyme activities, metabolite concentrations, and localization of cellular components to elicit large changes in biological phenotype, such as cellular phenotype. However not all interactions in a given signaling pathway are likely to possess this power. As such, complementary strategies Which aim to identify global interactions by artificially introducing foreign factors or peptides into cells which compete with and titrate-out the endogenous regulatory interactions, thereby disrupting the normal circuits that connect external signals to cellular responses, are of interest. By combining this strategy with functional assays, such as the activation of a gene in response to a signal, screens for functional interference can be used to identify peptides that perturb regulatory protein-protein interactions. This strategy, often referred to as dominant-interfering or dominant-negative genetics, has been successfully employed in several model organisms where high-throughput screening methods are easily applied but to a lesser extent in mammals, which traditionally have been less amenable to these types of screens. One advantage of dominant-negative strategies to that such strategies can pinpoint the functionally relevant protein-protein interactions “fulcrum points” and thereby expose the small number of nodes within the larger web of a protein network that are susceptible to functional modulation by external agents. As such, their results can provide vital information about the regulatory components that define a particular pathway and can allow the elucidation of key interactions suitable for targeting by drug screening programs.

Rosetta Inpharmatics has proposed cellular information as a profile in some patent applications (WO01/006013, WO01/005935, WO00/39339, WO00/39338. WO00/39337, WO00/24936, WO00/17402, WO99/66067, WO99/66024, WO99/58720, and WO99/59037). In such a profile, information from separate cells is processed as a group of is separate pieces of information but not continuous information. Therefore, this technique is limited in that information analysis is not conducted on a single (the same) cell. Particularly, in this technique, analysis is conducted only at one specific time point before and after a certain change, and a series of temporal changes in a point (gene) are not analyzed.

Recent advances in the profiling technique have led to accurate measurement of cellular components, and thus, profiling of cellular information (e.g., Schena et al., 1995, “Quantitative monitoring of gene expression patterns with a complementary DNA microarray”, Science 270:467-470; Lockhart et al., 1996, “Expression monitoring by hybridization to high-density oligonucleotide arrays”, Nature Biotechnology 14:1675-1680; Blanchard et al., 1996, “Sequence to array: Probing the genome's secrets”, Nature Biotechnology 14:1649: and WO01/006013). For organisms whose genome has been entirely elucidated, it is possible to analyze the transcripts of all genes in a cell. In the case of other organisms where knowledge of genomic information is increasing, a number of genes in a cell can be simultaneously monitored.

As array technology advances, arrays also have been utilized in the field of drug search (e.g., Marton et al., “Drug target validation and identification of secondary drug target effects using Microarrays”, Nat. Med., 1998 Nov., 4(11):1293-301; and Gray et al., 1998, “Exploiting chemical libraries, structure, and genomics in the search for kinase inhibitors”, Science, 281:533-538). Analysis using a profile (e.g., U.S. Pat. No. 5,777,888) and clustering of profiles provides information about conditions of cells, transplantation, target molecules and candidates for drugs, and/or the relevant functions, efficacy and toxicity of drugs. These techniques can be used to induce a common profile which represents ideal drug activity and disease conditions. Comparing profiles assists in detecting diseases in patients at early stages and provides prediction of improved clinical results for patients who have been diagnosed as having a disease.

However, there has been no technique which can provide actual information about networks of biological functions present in a biological entity such as a cell in a simple, efficient, and correct manner. In the above-described techniques, data is only analyzed in a binary-wise manner, in other words, only relationships between two particular networks are analyzed, and therefore are not analyzed in a global manner. Analysis and evaluations based on such data lack accuracy and sometimes allow misleading interpretations. Therefore, there is an increasing demand for a method for providing analyzing methods for networks of biological functions in a biological entity.

### DISCLOSURE OF THE INVENTION

An object of the present invention is to provide a method and system for analyzing a network of biological functions such as transcriptional factors, structural genes, cellular markers, cell surface markers, cell shapes, organelle shapes, cell mobility, enzyme activities, metabolite concentrations, and localization of cellular components, in a biological entity such as a cell. Particularly, an object of the present invention is to provide a system and method for presenting biological information in a global manner without modification where the cell is considered a complex system.

The above-described objects of the present invention were achieved by providing a method comprising the steps of: A)subjecting a biological entity to at least one perturbation agent; B) obtaining information on at least two functional reporters in said biological entity wherein the functional reporters reflect a biological function; and C) subjecting the obtained information to set theory processing to calculate a relationship between the functional reporters in order to generate a network relationship of the biological functions and to develop a system for analyzing a network of biological functions in a biological entity, comprising the steps of: A) at least one perturbation agent for a biological entity; B) means for obtaining information on at least two functional reporters in said biological entity, wherein the functional reporters reflect a biological function; and C) means for subjecting the obtained information to set theory processing to calculate a relationship between the functional reporters to generate a network relationship of the biological functions.

The present invention achieved a simple, efficient and correct method and system for analyzing a network of a biological entity such as a cell. Using the present invention, global networks can be easily and completely analyzed. Such complete and global analysis of the network of biological functions have not been provided in the prior art. Therefore, the present invention provides significant effects not expected by the conventional art.

Accordingly, .he present invention is useful for a variety of uses including identification of a biomarker, analysis of a drug target, analysis of a side effect, diagnosis of a cellular function, analysis of a cellular pathway, evaluation of a biological effect of a compound, and diagnosis of an infectious disease and the like.

Therefore the present invention provides the following:
1. A method for analyzing a network of biological functions in a biological entity, comprising the steps of:
   A) subjecting a biological entity to at least one perturbation agent;
   B) obtaining information on at least two functional reporters in said biological entity, wherein the functional reporters reflect a biological function; and
   C) subjecting the obtained information to set theory processing to calculate a relationship between the functional reporters to generate a network relationship of the biological functions.
2. The method according to Item 1, wherein the biological entity is a cell.
3. The method according to Item 1, wherein the perturbation agent is selected from the group consisting of RNA including siRNA, shRNA, miRNA, and ribozyme, chemical compound, cDNA, antibody, polypeptides, light, sound, pressure change, radiation, heat, and gas.
4. The method according to Item 1, wherein said perturbation agent comprises a siRNA capable of specifically regulating a function of said functional reporter.
5. The method according to Item 1, wherein said functional reporter is capable of transmitting a measurable signal.
6. The method according to Item 1, wherein said functional reporter is selected from the group consisting of transcriptional factors, regulatory genes, structural genes, cellular markers, cell surface markers, cell shapes, organelle shapes, cell mobility, enzyme activities, metabolite concentrations, and localization of cellular components.
7. The method according to Item 1, wherein said set theory processing comprises:
   classifying two specific functional reporters of at least two said functional reporters into a relationship selected from the group consisting of
   a) independent;
   b) inclusion; and
   c) intersection,
   wherein when it is determined to be independent, the two specific functional reporters are determined to have no relationship in the network:
   when it is determined to be inclusion, one of the two specific functional reporters is determined to be included in the other of the two specific functional reporters, and is located downstream of the other;
   when it is determined to be intersection, the two specific functional reporters are determined to be located downstream, branched from another by a common function.
8. The method according to Item 1, wherein the set theory processing comprises the step of mapping the absence or presence of a response by said perturbation agent per said functional reporter.
9. The method according to Item 1, wherein said calculation of relationship between said reporters comprises correlation between each functional reporter as classified into independent, inclusion and intersection to generate a summary of the correlation.
10. The method according to Item 1, wherein said perturbation factors are prepared with the number sufficient for equally targeting an intracellular pathway.
11. The method according to Item 1, wherein the information on at least two functional reporters is based on an effect of said perturbation agent after a desired time.
12. The method according to Item 1, wherein said effect is classified into the following three groups in terms of a threshold value: positive effect=+; no effect=0; and negative effect=−.
13. The method according to Item 1, wherein the information on at least two functional reporters is based on an effect of said perturbation agent after a desired time; wherein the set theory processing comprises:
   a) classifying the information into three categories by comparing the effect with a threshold value for the functional reporter and classifying into the following three groups t positive effect=+; no effect=0: and negative effect=−;
   b) determining if two of the functional reporters have a common perturbation agent, wherein the common perturbation agent has the same type of effect, and if there is no such common perturbation agent, then the two functions corresponding to the two functional reporters are located under different perturbation agents and if there is such a common perturbation agent, then the following step c) is conducted:
   c) determining if the perturbation agent set for one function of the two functions is completely included into the perturbation agent set for the other function of the two functions, and if this is the case, then the one function having the bigger set is located downstream of the other function having the smaller set, and if this is not the case, then the two functions are located in parallel under the same perturbation agents;
   d) determining if all combinations of the functional reporters are investigated, if this is the case, then integrate all the relationships of functions to a present global perturbation effects network, and if this is not the case then repeat the steps a) to c).
14. The method according to Item 13, wherein said three groups are classified into +1, 0 and −1.
15. The method according to Item 13, wherein said steps of a) to c) are calculated by producing M×N matrix, wherein M refers to the number of functional reporters and N refers to the number of perturbation agents.
16. The method according to Item 1, further comprising analyzing the generated network by conducting an actual biological experiment.
17. The method according to Item 16, wherein said step of analyzing comprises the use of a regulation agent specific to the function.
18. The method according to Item 17, wherein the regulation agent is an siRNA.
19. The method according to Item 1, wherein said network comprises a signal transduction pathway and a cellular pathway.
20. The method according to Item 1, wherein said network is used for a use selected from the group consisting of identification of a biomarker, analysis of a drug target, analysis of a side effect, diagnosis of a cellular function, analysis of a cellular pathway, evaluation of a biological effect of a compound, and diagnosis of an infectious disease.
21. A system for analyzing a network of biological functions in a biological entity, comprising:
   A) at least one perturbation agent for a biological entity;
   B) means for obtaining information on at least two functional reporters in said biological entity, wherein the functional reporters reflect a biological function; and
   C) means for subjecting the obtained information to set theory processing to calculate a relationship between the functional reporters to generate a network relationship of the biological functions.
22. The system according to Item 21, wherein the biological entity is a cell.
23. The system according to Item 21, wherein the perturbation agent is selected from the group consisting of siRNA, chemical compound, cDNA, antibody, polypeptides, light, sound, pressure change, radiation, heat and gas.
24. The system according to Item 21, wherein said perturbation agent comprises a siRNA capable of specifically regulating a function of said functional reporter.
25. The system according to Item 21, wherein said functional reporter is capable of transmitting a measurable signal.
26. The system according to Item 21, wherein said functional reporter is selected from the group consisting of transcriptional factors, structural genes, cellular markers, cell surface markers cell shapes, organelle shapes, cell mobility, enzyme activities, metabolite concentrations, and localization of cellular components.
27. The system according to Item 21, wherein said set theory processing comprises:
   classifying two specific functional reporters of at least two said functional reporters into a relationship selected from the group consisting of
   a) independent;
   b) inclusion; and
   c) intersection,
   wherein when it is determined to be independent, the two specific functional reporters are determined to have no relationships in the network;
   when it is determined to be inclusion, one of the two specific functional reporters is determined to be included in the other of the two specific functional reporters and is located downstream of the other;
   when it is determined to be intersection, the two specific functional reporters are determined to be located downstream, branched from another common function.
28. The system according to Item 21, wherein the set theory processing comprises the step of mapping the absence or presence of a response by said perturbation agent per said functional reporter.
29. The system according to Item 21, wherein said calculation of relationship between said reporters comprises a correlation between each functional reporter as classified into independent, inclusion and intersection to generate a summary of the correlation.
30. The system according to Item 1, wherein said perturbation factors are prepared with the number sufficient for equally targeting an intracellular pathway.
31. The system according to Item 21, wherein said means for obtaining information comprises means for obtaining the information on at least two functional reporters is based on an effect of said perturbation agent after a desired time.
32. The system according to Item 21, wherein said effect is classified into the following three groups in terms of a threshold value: positive effect=+; no effect=0; and negative effect=−.
33. The method according to Item 1, wherein the information on at least two functional reporters is based on an effect of said perturbation agent after a desired time;
   wherein the means for subjecting the obtained information to set theory processing comprises:
   a) means for classifying the information into three categories by comparing the effect with a threshold value for the functional reporter and classifying into the following three groups: positive effect=+; no effect=0; and negative effect=−;
   b) means for determining if two out of the functional reporters have a common perturbation agent, wherein the common perturbation agent has the same type of effect, and if there is no such common perturbation agent, then the two functions corresponding to the two functional reporters are located under different perturbation agents and if there is such a common perturbation agent, then the following step c) is conducted:
   c) means for determining if the perturbation agent set for one function of the two functions is completely included into the perturbation agent set for the other function of the two functions, and if this is the case, then one function having the bigger set is located downstream of the other function having the smaller set, and if this is not the case, then the two functions are located in parallel under the same perturbation agents;
   d) means for determining if all combinations of the functional reporters are investigated, if this is the case, then integrate all the relationships of functions to a present global perturbation effects network, and if this is not the case then repeat the steps conducted by the means a) to c).
34. The system according to Item 33, wherein said three groups are classified into +1, 0 and −1.
35. The system according to Item 33, wherein said means of a) to c) are conducted by producing M×N matrix, wherein M refers to the number of functional reporters and N refers to the number of perturbation agents.
36. The system according to Item 21, further comprising means for analyzing the generated network by conducting an actual biological experiment.
37. The system according to Item 36, wherein said means for analyzing comprises a regulation agent specific to the function.
38. The system according to Item 37, wherein the regulation agent is an siRNA.
39. The system according to Item 21, wherein said network comprises a signal transduction pathway.
40. The system according to Item 21, wherein said network is used for a use selected from the group consisting of identification of a biomarker, analysis of a drug target, analysis of a side effect, diagnosis of a cellular function, analysis of a cellular pathway, evaluation of a biological effect of a compound, and diagnosis of an infectious disease.
41. A computer program for implementing in a computer, a method for analyzing a network of biological functions in a biological entity, comprising the steps of:
   A) subjecting a biological entity to at least one perturbation agent;
   B) obtaining information on at least two functional reporters in said biological entity wherein the functional reporters reflect a biological function; and
   C) subjecting the obtained information to set theory processing to calculate a relationship between the functional reporters to generate a network relationship of the biological functions.
42. A storage medium comprising a computer program for implementing in a computer, a method for analyzing a network of biological functions in a biological entity, comprising the steps of:
   A) subjecting a biological entity to at least one perturbation agent;
   B) obtaining information on at least two functional reporters in said biological entity, wherein the functional reporters reflect a biological function; and
   C) subjecting the obtained information to set theory processing to calculate a relationship between the functional reporters to generate a network relationship of the biological functions.
43. A transmission medium comprising a computer program for implementing in a computer, a method for analyzing a network of biological functions in a biological entity, comprising the steps of:
   A) subjecting a biological entity to at least one perturbation agent;
   B) obtaining information on at least two functional reporters in said biological entity, wherein the functional reporters reflect a biological function; and
   C) subjecting the obtained information to set theory processing to calculate a relationship between the functional reporters to generate a network relationship of the biological functions.

Hereinafter, the present invention will be described by way of preferred embodiments. It will be understood by those skilled in the art that the embodiments of the present invention can be appropriately made or carried out based on the description of the present specification and the accompanying drawings, and commonly used techniques well known in the art. The function and effect of the present invention can be easily recognized by those skilled in the art.

### BRIEF DESCRIPTION OF THE DRAWINGS

FIG. 1 shows a schematic diagram of analysis according to one embodiment of the present invention. A and B refer to functional reporters (sets), which reflect functions of a biological entity such as a cell. Perturbation agents used are located within set A, within set B, within the intersection of set A and set B, outside of set A or set B. i) shows a case where there are no perturbation agents for function A (set A) and function B (set B). In i), function A and B are located under different perturbation agents. ii) shows a case where there are perturbation agents for functions A and B, and all the perturbation agents to be included into function B are also included in function A. In ii), function B is located downstream of function A. iii) shows a case where there are common perturbation agents, but some are included only in function A a and some are included only in function B. In iii), functions A and B are located under a common perturbation agent in parallel. iv) and v) show cases where three functions are involved. These can be explained in a similar manner as when two functions are used. In principle, integration of all combinations of two functions will produce the global network of all functions.

FIG. 2 shows an exemplary scheme of the present invention, in which a pathway analysis is presented using RNAi and functional reporters. An RNAi library (siRNA library) is used for measuring inhibitory effects on cellular functions such as change in metabolites, gene expression levels, etc. Functions A, B and C will encompass perturbation agents (siRNAs) having effects on the particular functions.

FIG. 3 shows an analyzed scheme presented in FIG. 2. By identifying common genes inhibited by an RNAi and those not being in common, genes specific to a specific function can be identified (e.g. “A” specific genes, etc.). intracellular pathway structure is calculated from such RNAi inhibitory experimental results.

FIG. 4 shows a scheme showing an embodiment of the present invention using a transfection device for analysis of cellular pathways. Upper left panel shows an overview of a chip type device typically used in the present invention. Lower left shows how RNAi and functional reporters are used and analyzed for analyzing a network such as a pathway of a biological entity.

FIG. 5 shows a graph showing the results of perturbation agents used in an example using HeLa cell as a biological entity. The y-axis shows the expression level, and the threshold value is set to 80% in this example. Arrows on the x-axis show the functions reflected on the functional reporters used such as CRE, AP1, GRE, ISRE, Myc, RARE, and actin.

FIG. 6 shows a result of HeLa cell transcriptional network analysis and confirmation thereof. The global network is shown with the transcriptional factors (genes) used for the analysis. Arrows from upwards show the genes down-regulated when CRE is inhibited by siRNA specific thereto.

FIG. 7 shows a graph showing the results of perturbation agents used in an example using HepG2 cell as a biological entity. Y-axis shows the expression level. The threshold value is set to 80% in this example. Arrows on the x-axis show the functions reflected on the functional reporters used such as CRE, ISRE, Myc, SRE and RARE.

FIG. 8 shows a result of HepG2 cell transcriptional network analysis and confirmation thereof. The global network is shown with the transcriptional factors (genes) used for the analysis. Arrows from upwards show the genes down-regulated when CRE is inhibited by siRNA specific thereto.

FIG. 9 shows a schematic flow chart for an exemplary embodiment of the present invention. This flow chart can be conducted in a computer.

FIG. 10 shows an exemplary computer system of the present invention.

FIG. 11 shows an exemplary combination matrix of functional reporters and siRNA.

FIG. 12 shows HeLa array scanned images (16-bit tiff image). Each mixture solution was printed as in the lower panel. After seeding cells, an array scanner was used for obtaining images (see upper panel).

FIG. 13 shows neuritegenesis of human neuroblastoma SHSY5Y. SH-SY5Y cell were cultured and when RA is added, they differentiated into cholinergic neuron-line cells, and when NGF is added, they differentiated into doperminergia neuron-like cells. In this experiments, 1512 spots/chip of siRNA were studied.

FIG. 14 shows graphs of total neurite length/no. nucleus vs. tyrosine kinase targeted siRNA (85 types were used).

FIG. 15 shows an overview of the rational approach to analyze functional roles of tyrosine kinases in neuritegenesis.

FIG. 15A (upper left) shows the case in which siRNAs inhibited neurite extension in the presence of retinoic acid (RA; hereinafter the RA set), and the set in which siRNAs inhibited neurite extension in the presence of NGF (hereinafter the NGF set) are separately (independently) present.

FIG. 15B (upper right) shows the case in which the RA set and the NGF set have overlapping members.

FIG. 15C (lower left) shows the case in which the NGF set is encompassed by the RA set.

FIG. 15D (lower right) the case in which the RA set is encompassed by the NGF set.

FIG. 16 depicts elucidation of a number of kinases by rational relation from the comprehensive data of the cell-based siRNA assay.

FIG. 17 shows the results of EGFR-siRNA, EPHA2-siRNA, EPHA3-siRNA, #075-siRNA, KIT-siRNA, #054-siRNA, RET-siRNA and #006-siRNA

FIG. 18 shows neurite bearing cell percentages are shown for each agent.

FIG. 19 shows the marker enzyme expression in the presence of each ligand of the receptor tyrosine kinase.

FIG. 20 shows the comparison between the rational relation and biological results.

### DESCRIPTION OF SEQUENCE LISTING

SEQ ID NO: 1 refers to a nucleotide sequence of c-Myc (Gene accession No: V00568).
SEQ ID NO: 2 refers to an amino acid sequence of c-Myc (Gene accession No: V00568).
SEQ ID NO: 3 refers to a nucleotide sequence of c-Fos (Gene accession No: K00650).
SEQ ID NO: 4 refers to an amino acid sequence of c-Fos (Gene accession No: K00650).
SEQ ID NO: 5 refers to a nucleotide sequence of c-Jun (Gene accession No: J04111).
SEQ ID NO: 6 refers to an amino acid sequence of c-Jun (Gene accession No: J04111).
SEQ ID NO: 7 refers to a nucleotide sequence of CREB (Gene accession No: M27691).
SEQ ID NO: 8 refers to an amino acid sequence of CREB (Gene accession No: M27691).
SEQ ID NO: 9 refers to a nucleotide sequence of E2F (Gene accession No: M96577).
SEQ ID NO: 10 refers to an amino acid sequence of E2F (Gene accession No: M96577).
SEQ ID NO: 11 refers to a nucleotide sequence of ER (Gene accession No: M12674).
SEQ ID NO: 12 refers to an amino acid sequence of ER (Gene accession No: M12674).
SEQ ID NO: 13 refers to a nucleotide sequence of GR (Gene accession No: M10901).
SEQ ID NO: 14 refers to an amino acid sequence of GR (Gene accession No: M10901).
SEQ ID NO: 15 refers to a nucleotide sequence of HSF-1 (Gene accession No: NM_{—}005526).
SEQ ID NO: 16 refers to an amino acid sequence of HSF-1 (Gene accession No: NM_{—}005526).
SEQ ID NO: 17 refers to a nucleotide sequence of HSF-2 (Gene accession No: M65217).
SEQ ID NO: 18 refers to an amino acid sequence of HSF-2 (Gene accession No: M65217).
SEQ ID NO: 19 refers to a nucleotide sequence of HSF-4 (Gene accession No: D87673).
SEQ ID NO: 20 refers to an amino acid sequence of HSP-4 (Gene accession No: D87673).
SEQ ID NO: 21 refers to a nucleotide sequence of IkBa (Gene accession No: M69043).
SEQ ID NO: 22 refers to an amino acid sequence of IkBa (Gene accession No: M69043).
SEQ ID NO: 23 refers to a nucleotide sequence of NFAT3 (Gene accession No: L41066).
SEQ ID NO: 24 refers to an amino acid sequence of NFAT3 (Gene accession No: L41066).
SEQ ID NO: 25 refers to a nucleotide sequence of NFkB (Gene accession No: S76638).
SEQ ID NO: 26 refers to an amino acid sequence of NFkB (Gene accession No: S76638).
SEQ ID NO: 27 refers to a nucleotide sequence of RARA (Gene accession No: NM_{—}000964).
SEQ ID NO: 28 refers to an amino acid sequence of RARA (Gene accession No: NM_{—}000964).
SEQ ID NO: 29 refers to a nucleotide sequence of RARA (Gene accession No: NM_{—}000965).
SEQ ID NO: 30 refers to an amino acid sequence of RARA (Gene accession No: NM_{—}000965).
SEQ ID NO: 31 refers to a nucleotide sequence of RARB1 (Gene accession No: NM_{—}016152).
SEQ ID NO: 32 refers to an amino acid sequence of RARB1 (Gene accession No: NM_{—}016152).
SEQ ID NO: 33 refers to a nucleotide sequence of RARB2 (Gene accession No: M57707).
SEQ ID NO: 34 refers to an amino acid sequence of RARB2 (Gene accession No: M57707).
SEQ ID NO: 35 refers to a nucleotide sequence of RARG (Gene accession No: M15400).
SEQ ID NO: 36 refers to an amino acid sequence of RARG (Gene accession No: M15400).
SEQ ID NO: 37 refers to a nucleotide sequence of Rb (Gene accession No: J03161).
SEQ ID NO: 38 refers to an amino acid sequence of Rb (Gene accession No: J03161).
SEQ ID NO: 39 refers to a nucleotide sequence of SRF (Gene accession No: M97935).
SEQ ID NO: 40 refers to an amino acid sequence of SRF (Gene accession No: M97935).
SEQ ID NO: 41 refers to a nucleotide sequence of STAT1a (Gene accession No: M97936).
SEQ ID NO: 42 refers to an amino acid sequence of STAT1a (Gene accession No: M97936).
SEQ ID NO: 43 refers to a nucleotide sequence of STAT1b (Gene accession No: M97934).
SEQ ID NO: 44 refers to an amino acid sequence of STAT1b (Gene accession No: M97934).
SEQ ID NO: 45 refers to a nucleotide sequence of STAT2 (Gene accession No: L29277).
SEQ ID NO: 46 refers to an amino acid sequence of STAT2 (Gene accession No: L29277).
SEQ ID NO: 47 refers to a nucleotide sequence of STAT3 (Gene accession No: Y00479).
SEQ ID NO: 48 refers to an amino acid sequence of STAT3 (Gene accession No: Y00479).
SEQ ID NO: 49 refers to a nucleotide sequence of P53 (Gene accession No: AF307851).
SEQ ID NO: 50 refers to an amino acid sequence of Scramble (Gene accession No: AF307851).
SEQ ID NO: 51 refers to a nucleotide sequence to fibronectin.
SEQ ID NO:52 shows an amino acid sequence to fibronectin.
SEQ ID NO: 53 refers to a nucleotide sequence of c-Fos siRNA.
SEQ ID NO: 54 refers to a nucleotide sequence of c-Jun siRNA.
SEQ ID NO: 55 refers to a nucleotide sequence of CREB siRNA.
SEQ ID NO: 56 refers to a nucleotide sequence of E2F siRNA.
SEQ ID NO: 57 refers to a nucleotide sequence of ER siRNA.
SEQ ID NO: 58 refers to a nucleotide sequence of GR siRNA.
SEQ ID NO: 59 refers to a nucleotide sequence of HSF-1 siRNA.
SEQ ID NO: 60 refers to a nucleotide sequence of HSF-2 siRNA.
SEQ ID NO: 61 refers to a nucleotide sequence of HSF-4 siRNA.
SEQ ID NO: 62 refers to a nucleotide sequence of IkBa siRNA.
SEQ ID NO: 63 refers to a nucleotide sequence of NFAT3 siRNA.
SEQ ID NO: 64 refers to a nucleotide sequence of NFkB siRNA.
SEQ ID NO: 65 refers to a nucleotide sequence of RARA siRNA.
SEQ ID NO: 66 refers to a nucleotide sequence of RARB1 siRNA.
SEQ ID NO: 67 refers to a nucleotide sequence of RARB2 siRNA.
SEQ ID NO: 68 refers to a nucleotide sequence of RARG siRNA.
SEQ ID NO: 69 refers to a nucleotide sequence of Rb siRNA.
SEQ ID NO: 70 refers to a nucleotide sequence of SRF siRNA.
SEQ ID NO: 71 refers to a nucleotide sequence of STAT1a siRNA.
SEQ ID NO: 72 refers to a nucleotide sequence of STAT1b siRNA.
SEQ ID NO: 73 refers to a nucleotide sequence of STAT2 siRNA.
SEQ ID NO: 74 refers to a nucleotide sequence of STAT3 siRNA.
SEQ ID NO: 75 refers to a nucleotide sequence of TR siRNA.
SEQ ID NO: 76 refers to a nucleotide sequence of p53 siRNA.
SEQ ID NO: 77 refers to a nucleotide sequence of scramble II Duplex (Gene accession No: AF307851).
SEQ ID NO: 78 refers to a nucleotide sequence of the kinase EGFR.
SEQ ID NO: 79 refers to an amino acid sequence of the kinase EGFR.
SEQ ID NO: 80 refers to a nucleotide sequence of the kinase EPHA2.
SEQ ID NO: 81 refers to an amino acid sequence of the kinase EPHA2.
SEQ ID NO: 82 refers to a nucleotide sequence of the kinase EPHA3.
SEQ ID NO: 83 refers to an amino acid sequence of the kinase EPHA3.
SEQ ID NO: 84 refers to a nucleotide sequence of the kinase #075.
SEQ ID NO: 85 refers to an amino acid sequence of the kinase #075.
SEQ ID NO: 86 refers to a nucleotide sequence of the kinase KIT.
SEQ ID NO: 87 refers to an amino acid sequence of the kinase KIT.
SEQ ID NO: 88 refers to a nucleotide sequence of the kinase #054.
SEQ ID NO: 89 refers to an amino acid sequence of the kinase #054.
SEQ ID NO: 90 refers to a nucleotide sequence of the kinase RET.
SEQ ID NO: 91 refers to an amino acid sequence of the kinase RET.
SEQ ID NO: 92 refers to a nucleotide sequence of the kinase #006.
SEQ ID NO: 93 refers to an amino acid sequence of the kinase #006.
   EGFR-siRNA, EPHA2-siRNA, EPHA3-siRNA, #075-siRNA, KIT-siRNA, #054-siRNA, RET-siRNA and #006-siRNA used herein are available from Amersham Biosciences Japan, as the following catalog numbers: EGFR siRNA: M-003114-01; KIT siRNA: M-003150-01; RET siRNA: M-003170-01; EPHA2 siRNA: M-003116-01; EPHA3 siRNA: M-003117-01; #006 siRNA: M-003171-01; #075 siRNA: M-003149-01; and #054 siRNA: M-003152-01. The sequences thereof are unpublished but equivalents thereof can be prepared using well known technology in the art.
   A nucleotide sequence of c-Myc siRNA used herein can be obtained from Ambion, Inc. as Silencer™ c-myc siRNA.

### BEST MODE FOR CARRYING OUT THE INVENTION

It should be understood throughout the present specification that articles for singular forms include the concept of their plurality unless otherwise mentioned. Therefore, articles or adjectives for singular forms (e.g., “a”, “an”, “the”, etc. in English, and articles, adjectives, etc. in other languages) include the concept of their plurality unless otherwise specified. As such, the terms “a” or “an”, “one or more” and “at least one” can be used interchangeably herein. It is also to be noted that the terms “comprising,” “including,” and “having” can be used interchangeably. Furthermore, a compound “selected from the group consisting of refers to one or more of the compounds in the list that follows, including mixtures (i.e. combinations) of two or more of the compounds. It should be also understood that terms as used herein have definitions ordinarily used in the art unless otherwise mentioned. Therefore, all technical and scientific terms used herein have the same meanings as commonly understood by those skilled in the art. Otherwise, the present application (including definitions) takes precedence.

Before the present compounds, compositions, system, device and/or methods are disclosed and described, it is to be understood that this invention to not limited to specific synthetic methods, specific reagents or to laboratory or manufacturing techniques, as such may, of course, vary unless it is otherwise indicated. It is also to be understood that the terminology used herein is for the purpose of describing particular embodiments only and is not intended to be limiting.

(Definition of Terms)

Hereinafter, terms specifically used herein will be defined.

(Biological Functions)

As used herein the term “network of biological functions” refers to any network of parameters of a biological entity, such as genes, transcriptional factors, structural genes, cellular markers, cell surface markers, cell shapes, organelle shapes, cell mobility, enzyme activities, metabolite concentrations, and localization of cellular components and the like. Such networks may be but are not limited to a pathway of parameters such as genes, signal transduction pathway, and the like.

As used herein a “pathway” refers to any pathway of parameters of a biological entity. Such pathways may be but are not limited to a pathway of a drug stimulation and the like.

As used herein the term “biological function” refers to any parameter which is related to and/or reflects the living state of a biological entity such as a cell. Such biological functions include but are not limited to transcriptional factors, regulatory genes, structural genes, cellular markers, cell surface markers, cell shapes, organelle shapes, cell mobility, enzyme activities, metabolite concentrations, and localization of cellular components. Such biological function may be measured by using a functional reporter which is specific to the function. As used herein the term “specific” in terms of the biological function refers to the relationship between a biological function and a functional reporter, wherein a change in the functional reporter is related to the change in the state of the biological function.

As used herein the term “perturbation agent” refers to any agent that causes perturbation in a biological entity. Such perturbation agents include but are not limited to, for example, RNA (e.g. siRNA, shRNA, miRNA, ribozyme), chemical compound, cDNA, antibody, polypeptides, light, sound, pressure change, radiation, heat, gas, and the like, particularly siRNA capable of specifically regulating a function of said functional reporter is preferred, since such siRNA specifically targets the function in a biological entity such as a cell.

As used herein the term “functional reporter” refers to an agent which changes the signal of a biological function to a measurable signal, such as light, expression of protein, production of metabolite, change in color, fluorescence, chemilunescence, and the like.

As used herein the term “set theory” refers to a theory as used and understood in the art, and the branch of pure mathematics that deals with the nature and relationships of sets. A mathematical formalization of the theory of “sets” (aggregates or collections) of objects (“elements” or “members”). Many mathematicians use set theory as the basis for all other mathematics. Such set theory includes the analysis of members into sets and classification of sets into inclusion, independent and intersection, and the like.

As used herein the term “set” is used as in the set theory in the art, and refers to a group of members or elements.

As used herein the term “member”, “cardinality” or “element” is interchangeably used to refer to a basic unit of a set. In the present invention, a functional reporter can be regarded as a set, and a perturbation agent or information/data/result derived therefrom can be regarded as a member.

As used herein the term “inclusion” refers to a relationship of two sets where all members of one set there of is included in the other set.

As used herein the term “independent” refers to a relationship of two groups where all members of one set are not included in the other set and vice versa.

As used herein the term “intersection” refers to a relationship of two sets where some members of one set are included and some are not, and vice versa, and therefore there to an overlap set between the two sets.

As used herein the term “network relationship” refers to a relationship of members of a network. Such relationship may be presented in a map of members with arrows, which shows the direction of influence of one member on the other.

As used herein the term “parallel” when used for relationship of two parameters refers to the state where the two parameters are located in different pathways in a network.

As used herein the term “downstream” when used for relationship of two parameters refers to the state where one of the two parameters is located downstream of the other in a pathway or a network.

As used herein the term “upstream” when used for relationship of two parameters refers to the state where one of the two parameters is located upstream of the other in a pathway or a network.

As used herein the term “common” refers to a state where two parameters are in the same relationship for a function or any other parameter of a biological entity.

As used herein the phrase “equally targeting” refers to a condition of distributing perturbation agents, where the perturbation agents to be introduced have substantially the same effects on the targets of interest. In the present invention, two or more perturbation agents are usually used to change the network structure of a biological entity such as a cell, it is preferable to use such equally targeting perturbation agents.

As used herein the term “threshold” refers to a specific value for evaluating whether a function is activated or suppressed. Such a threshold may be determined experimentally, empirically, or theoretically. Threshold may be arbitrarily selected for certain cases.

(Biology)

As used herein the term “biological entity” refers to any entity which is biologically living. Examples of such biological entities include living organism, organ, tissue, cell, microorganisms such as bacteria, virus, and the like.

The term “cell” is herein used in its broadest sense in the art, referring to a structural unit of tissue of a multicellular organism, which is capable of self replicating, has genetic information and a mechanism for expressing it, and is surrounded by a membrane structure which isolates the cell from the outside. Cells used herein may be either naturally-occurring cells or artificially modified cells (e.g., fusion cells, genetically modified cells, etc.). Examples of cell sources include, but are not limited to, a single-cell culture; the embryo, blood, or body tissue of normally-grown transgenic animal; a mixture of cells derived from normally-grown cell lines; and the like.

Cells used herein may be derived from any organism (e.g., any unicellular organisms (e.g., bacteria and yeast) or any multicellular organisms (e.g., animals (e.g., vertebrates and invertebrates), plants (e.g., monocotyledons and dicotyledons, etc.)). For example, cells used herein are derived from a vertebrate (e.g., Myxiniformes, Petronyzoniformes, Chondrichthyes, Osteichthyes, amphibian, reptilian, avian, mammalian, etc.), more preferably mammalian (e.g., monotremata, marsupialia, edentate, dermoptera, chiroptera, carnivore, insectivore, probosoldea, perissodactyla, artiodactyla, tubulidentata, pholidota, sirenia, cetacean, primates, rodentia, lagomorpha, etc.). In one embodiment, cells derived from Primates (e.g., chimpanzee, Japanese monkey, human) are used. The above-described cells may be either stem cells or somatic cells. Also, the cells may be adherent cells, suspended cells, tissue forming cells, and mixtures thereof. The cells may be used for transplantation.

Any organ may be targeted by the present invention. A biological entity such as a tissue or cell targeted by the present invention may be derived from any organ. As used herein, the term “organ” refers to a morphologically independent structure localized at a particular portion of an individual organism in which a certain function is performed. In multicellular organisms (e.g., animals, plants), an organ consists of several tissues spatially arranged in a particular manner, each tissue being composed of a number of cells. An example of such an organ includes an organ relating to the vascular system. In one embodiment, organs targeted by the present invention include, but are not limited to, skin, blood vessel, cornea, kidney, heart, liver, umbilical cord, intestine, nerve, lung, placenta, pancreas, brain, peripheral limbs, retina, and the like. Examples of cells differentiated from pluripotent cells include epidermic cells, pancreatic parenchymal cells, pancreatic duct cells, hepatic cells, blood cells, cardiac muscle cells, skeletal muscle cells, osteoblasts, skeletal myoblasts, neurons, vascular endothelial cells, pigment cells, smooth muscle cells, fat cells, bone cells, cartilage cells, and the like.

As used herein, the term “tissue” refers to an aggregate of cells having substantially the same function and/or form in a multicellular organism. “Tissue” is typically an aggregate of cells of the same origin, but may be an aggregate of cells of different origins as long as the cells have the same function and/or form. Therefore, tissues used herein may be composed of an aggregate of cells of two or more different origins. Typically, a tissue constitutes a part of an organ. Animal tissues are separated into epithelial tissue, connective tissue, muscular tissue, nervous tissue, and the like, on a morphological, functional, or developmental basis. Plant tissues are roughly separated into meristematic tissue and permanent tissue according to the developmental stage of the cells constituting the tissue. Alternatively, tissues may be separated into single tissues and composite tissues according to the type of cells constituting the tissue. Thus, tissues are separated into various categories.

As used herein, the term “isolated” means that naturally accompanying material is at least reduced, or preferably substantially completely eliminated, in normal circumstances. As used herein, an isolated biological entity can be targeted by the present invention. Therefore, the term “isolated cell” refers to a cell substantially free from other accompanying substances (e.g., other cells, proteins, nucleic acids, etc.) in natural circumstances. The term “isolated” in relation to nucleic acids or polypeptides means that, for example, the nucleic acids or the polypeptides are substantially free from cellular substances or culture media when they are produced by recombinant DNA techniques; or precursory chemical substances or other chemical substances when they are chemically synthesized. Isolated nucleic acids are preferably free from sequences naturally flanking the nucleic acid within an organism from which the nucleic acid i:s derived (i.e., sequences positioned at the 5′ terminus and the 3′ terminus of the nucleic acid). Preferably, an isolated cell is used for analysis of the present invention.

As used herein, the term “established” in relation to cells refers to a state of a cell in which a particular property (such as pluripotency) of the cell is maintained and the cell undergoes stable proliferation under culture conditions. In the present invention, such an established cell may be used.

As used herein, the term “state” refers to a condition concerning various parameters of a biological entity such as a cell (e.g., cell cycle, response to an external factor, signal transduction, gene expression, gene transcription, etc.). Examples of such a state include, but are not limited to, differentiated states, undifferentiated states, responses to external factors, cell cycles, growth states, and the like. As used herein, the term “gene state” refers to any state associated with a gene (e.g., an expression state, a transcription state, etc.).

As used herein, the terms “differentiation” or “cell differentiation” refers to a phenomenon where two or more types of cells having qualitative differences in form and/or function occur in a daughter cell population derived from the division of a single cell. Therefore, “differentiation” includes a process during which a population (family tree) of cells, which do not originally have a specific detectable feature, acquire a feature, such as production of a specific protein, or the like. At present, cell differentiation is generally considered to be a state of a cell in which a specific group of genes in the genome are expressed. Cell differentiation can be identified by searching for intracellular or extracellular agents or conditions which elicit the above-described state of gene expression. Differentiated cells are stable in principle. Particularly, animal cells which have been once differentiated are rarely differentiated into other types of cells.

As used herein, the term “pluripotency” refers to a nature of a cell, i.e., an ability to differentiate into one or more, preferably two or more, tissues or organs. Therefore, the terms “pluripotent” and “undifferentiated” are herein used interchangeably unless otherwise mentioned. Typically, the pluripotency of a cell is limited during development, and in an adult, cells constituting a tissue or organ rarely alter to different cells, that is, the pluripotency is usually lost. Particularly, epithelial cells resist altering to other types of epithelial cells. Such alteration typically occurs in pathological conditions, and is called metaplasia. However, mesenchymal cells tend to easily undergo metaplasia, i.e., alter to other mesenchymal cells, with relatively simple stimuli. Therefore, mesenchymal cells have a high level of pluripotency. Embryonic stem cells have pluripotency. Tissue stem cells have pluripotency. Thus, the term “pluripotency” may include the concept of totipotency. An example of an in vitro assay, for determining whether or not a cell has pluripotency, includes, but is not limited to, culturing under conditions for inducing the formation and differentiation of embryoid bodies. Examples of an in vivo assay for determining the presence or absence of pluripotency, include, but are not limited to, implantation of a cell into an immunodeficient mouse so as to form teratoma, injection of a cell into a blastocyst so as to form a chimeric embryo, implantation of a cell into a tissue of an organism (e.g., injection of a cell into ascites) so as to undergo proliferation, and the like. As used herein, one type of pluripotency is “totipotency”, which refers to an ability to be differentiated into all kinds of cells which constitute an organism. The idea of pluripotency encompasses totipotency. An example of a totipotent cell is a fertilized ovum. An ability to be differentiated into only one type of cell is called “unipotency”.

As used herein, the term “gene” refers to an element defining a genetic trait, which is a biological function of a biological entity. A gene is typically arranged in a given sequence on a chromosome or other extrachromosomal factor. A gene which defines the primary structure of a protein is called a structural gene. A gene which regulates the expression of a structural gene is called a regulatory gene (e.g., promoter). Genes herein include structural genes and regulatory genes unless otherwise specified. Therefore, for example, the term “cyclin gene” typically includes the structural gene of cyclin and the promoter of cyclin. As used herein, “gene” may refer to “polynucleotide”, “oligonucleotide”, “nucleic acid”, and “nucleic acid molecule” and/or “protein”, “polypeptide”, “oligopeptide” and “peptide”. As used herein, “gene product” includes “polynucleotide”, “oligonucleotide”, “nucleic acid” and “nucleic acid molecule” and/or “protein” “polypeptide”, “oligopeptide” and “peptide”, which are expressed by a gene. Those skilled in the art understand what a gene product is, according to the context.

As used herein, the term “homology” in relation to a sequence (e.g., a nucleic acid sequence, an amino acid sequence. etc.) refers to the proportion of identity between two or more gene sequences. Therefore, the greater the homology between two given genes, the greater the identity or similarity between their sequences. Whether or not two genes have homology is determined by comparing their sequences directly or by a hybridization method under stringent conditions. When two gene sequences are directly compared with each other, these genes have homology if the DNA sequences of the genes have representatively at least 50% identity, preferably at least 70% identity, more preferably at least 80%, 90%, 95%, 96%, 97%, 98%, or 99% identity with each other. As used herein, the term “similarity” in relation to a sequence (e.g., a nucleic acid sequence, an amino acid sequence, or the like) refers to the proportion of identity between two or more sequences when conservative substitution is regarded as positive (identical) in the above-described homology. Therefore, homology and similarity differ from each other in the presence of conservative substitutions. If no conservative substitutions are present, homology and similarity have the same value. Such homologous genes and the like may be used as the same function in a network, if applicable, and may be used as different perturbation agents and the like, if applicable.

The terms “protein”, polypeptides, “oligopeptide” and “peptide” as used herein have the same meaning and refer to an amino acid polymer of any length. This polymer may be a straight, branched or cyclic chain polymer. An amino acid may be a naturally-occurring or nonnaturally-occurring amino acid, or a variant amino acid. The term may include those assembled into a composite of a plurality of polypeptide chains. The term also includes a naturally-occurring or artificially modified amino acid polymer. Such modification includes, for example, disulfide bond formation, glycosylation, lipidation, acetylation. phosphorylation, or any other manipulation or modification (e.g., conjugation with a labeling moiety). This definition encompasses a polypeptide containing at least one amino acid analog (e.g., nonnaturally-occurring amino acid, etc.), a peptide-like compound (e.g., peptoid), and other variants known in the art, for example. Gene products, such as extracellular matrix proteins (e.g., fibronectin, etc.), are usually in the form of a polypeptide. Polypeptides used in the present invention may be produced by, for example, cultivating primary culture cells producing the peptides or cell lines thereof, followed by separation or purification of the peptides from the culture supernatant. Alternatively, genetic manipulation techniques can be used to incorporate a gene encoding a polypeptide of interest into an appropriate expression vector, transform an expression host with the vector, and collect recombinant polypeptides from the culture supernatant of the transformed cells. The above-described host cell may be any host cells conventionally used in genetic manipulation techniques as long as they can express a polypeptide of interest while maintaining the physiological activity of the peptide (e.g., E. coli, yeast, an animal cell, etc.). Polypeptides derived from the thus-obtained cells may have at least one amino acid substitution, addition, and/or deletion or at least one sugar chain substitution, addition, and/or deletion as long as they have substantially the same function as that of naturally-occurring polypeptides.

The terms “polynucleotide”, “oligonucleotide”. “nucleic acid molecule” and “nucleic acid” as used herein have the same meaning and refer to a nucleotide polymer having any length. This term also includes an “oligonucleotide derivative” or a “polynucleotide derivative”. An “oligonucleotide derivative” or a “polynucleotide derivative” includes a nucleotide derivative, or refers to an oligonucleotide or a polynucleotide having different linkages between nucleotides from typical linkages, which are interchangeably used. Examples of such an oligonucleotide specifically include 2′-O-methyl-ribonucleotide, an oligonucleotide derivative in which a phosphodiester bond in an oligonucleotide is converted to a phosphorothioate bond, an oligonucleotide derivative in which a phosphodiester bond in an oligonucleotide is converted to a N3′-P5′ phosphoroamidate bond, an oligonucleotide derivative in which a ribose and a phosphodiester bond in an oligonucleotide are converted to a peptide-nucleic acid bond, an oligonucleotide derivative in which uracil in an oligonucleotide is substituted with C-5 propynyl uracil, an oligonucleotide derivative in which uracil in an oligonucleotide is substituted with C-5 thiazole uracil, an oligonucleotide derivative in which cytosine in an oligonucleotide is substituted with C-5 propynyl cytosine, an oligonucleotide derivative in which cytosine in an oligonucleotide to substituted with phenoxazine-modified cytosine, an oligonucleotide derivative in which ribose in DNA is substituted with 2′-O-propyl ribose, and an oligonucleotide derivative in which ribose in an oligonucleotide is substituted with 2′-methoxyethoxy ribose. Unless otherwise indicated, a particular nucleic acid sequence also implicitly encompasses conservatively-modified variants thereof (e.g. degenerate codon substitutions) and complementary sequences as well as the sequence explicitly indicated. Specifically, degenerate codon substitutions may be produced by generating sequences in which the third position of one or more selected (or all) codons is substituted with mixed-base and/or deoxyinosine residues (Batzer et al., Nucleic Acid Res. 19:5081(1991); Ohtsuka et al., J. Biol. Chem. 260:2605-2608 (1985); Rossolini et al., Mol. Cell. Probes 8:91-98(1994)). A gene encoding an extracellular matrix protein (e.g., fibronectin, etc.) or the like is usually in the form of a polynucleotide. A molecule to be transfected is in the form of a polynucleotide.

As used herein, the term “corresponding”, when used for the relationship between a functional reporter and function, refers to a state where the signal derived from a functional reporter of interest reflects the state of a function. Therefore one can determine the state of such a function based on the signal of the functional reporter corresponding to the function. For example, a gene expressing a fluorescent protein operably linked under a transcriptional factor is said to be a functional reporter corresponding to the transcriptional factor, and the like.

As used herein, the term “corresponding” amino acid or nucleic acid refers to an amino acid or nucleotide in a given polypeptide or polynucleotide molecule, which has, or is anticipated to have, a function similar to that of a predetermined amino acid or nucleotide in a polypeptide or polynucleotide as a reference for comparison. Particularly, in the case of enzyme molecules, the term refers to an amino acid which is present at a similar position in an active site and similarly contributes to catalytic activity. For example, in the case of antisense molecules for a certain polynucleotide, the term refers to a similar portion in an ortholog corresponding to a particular portion of the antisense molecule.

As used herein, the term “corresponding” gene (e.g., a polypeptide or polynucleotide molecule) refers to a gene in a given species, which has, or is anticipated to have, a function similar to that of a predetermined gene in a species as a reference for comparison. When there are a plurality of genes having such a function, the term refers to a gene having the same evolutionary origin. Therefore, a gene corresponding to a given gene may be an ortholog of the given gene. Therefore, genes corresponding to mouse cyclin genes can be found in other animals. Such a corresponding gene can be identified by techniques well known in the art. Therefore, for example, a corresponding gene in a given animal can be found by searching a sequence database of the animal (e.g., human, rat) using the sequence of a reference gene (e.g., mouse oyolin gene, etc.) as a query sequence.

As used herein, the term “fragment” with respect to a polypeptide or polynucleotide refer to a polypeptide or polynucleotide having a sequence length ranging from 1 to n−1 with respect to the full length of the reference polypeptide or polynucleotide (of length n). The length of the fragment can be appropriately changed depending on the purpose. For example, in the case of polypeptides, the lower limit of the length of the fragment includes 3, 4, 5, 6, 7, 8, 9, 10, 15, 20, 25, 30, 40, 50 or more nucleotides. Lengths represented by integers which are not herein specified (e.g., 11 and the like) may be appropriate as a lower limit. For example, in the case of polynucleotides, the lower limit of the length of the fragment includes 5, 6, 7, 8, 9, 10, 15, 20, 25, 30, 40, 50, 75, 100 or more nucleotides. Lengths represented by integers which are not herein specified (e.g., 11 and the like) may be appropriate as a lower limit. As used herein, the length of polypeptides or polynucleotides can be represented by the number of amino acids or nucleic acids, respectively. However, the above-described numbers are not absolute. The above-described numbers as the upper or lower limit are intended to include some greater or smaller numbers (e.g., ±10%), as long as the same function is maintained. For this purpose, “about” may be herein put ahead of the numbers. However, it should be understood that the interpretation of numbers is not affected by the presence or absence of “about” in the present specification.

As used herein, the term “biological activity” refers to activity possessed by an agent (e.g., a polynucleotide, a protein, etc.) within an organism, including activities exhibiting various functions (e.g., transcription promoting activity, etc.). For example, when a certain factor is an enzyme, the biological activity thereof includes its enzyme activity. In another example, when a certain factor is a ligand, the biological activity thereof includes the binding of the ligand to a receptor corresponding thereto. The above-described biological activity can be measured by techniques well-known in the art.

As used herein, the term “search” indicates that a given nucleic acid sequence is utilized to find other nucleic acid base sequences having a specific function and/or property either electronically or biologically, or using other methods. Examples of an electronic search include, but are not limited to, BLAST (Altschul et al., J. Mol. Biol. 215:403-410 (1990)), FASTA (Pearson & Lipman, Proc. Natl. Acad. Sci., USA 85:2444-2448 (1988)), Smith and Waterman method (Smith and Waterman, J. Mol. Biol. 147:195-197 (1981)), and Needleman and Wunsch method (Needleman and Wunsch, J. Mol. Biol. 48:443-453 (1970)), and the like. Examples of a biological search include, but are not limited to, a macroarray in which genomic DNA is attached to a nylon membrane or the like or a microarray (microassay) in which genomic DNA to attached to a glass plate under stringent hybridization conditions, PCR and in situ hybridization, and the like. Such a search may be conducted by using a method or system of the present invention.

As used herein, the term “probe” refers to a substance for use in searching, which is used in a biological experiment, such as in vitro and/or in vivo screening or the like, including, but not being limited to, for example, a nucleic acid molecule having a specific base sequence or a peptide containing a specific amino acid sequence.

Examples of a nucleic acid molecule as a common probe include one having a nucleic acid sequence having a length of at least 8 contiguous nucleotides, which is homologous or complementary to the nucleic acid sequence of a gene of interest. Such a nucleic acid sequence may be preferably a nucleic acid sequence having a length of at least 9 contiguous nucleotides, more preferably a length of at least 10 contiguous nucleotides, and even more preferably a length of at least 11 contiguous nucleotides, a length of at least 12 contiguous nucleotides, a length of at least 13 contiguous nucleotides, a length of at least 14 contiguous nucleotides, a length of at least 15 contiguous nucleotides, a length of at least 20 contiguous nucleotides, a length of at least 25 contiguous nucleotides, a length of at least 30 contiguous nucleotides, a length of at least 40 contiguous nucleotides, or a length of at least 50 contiguous nucleotides. A nucleic acid sequence used as a probe includes a nucleic acid sequence having at least 70% homology to the above-described sequence, more preferably at least 80%, and even more preferably at least 90% or at least 95%.

As used herein, the term “primer” refers to a substance required for initiation of a reaction of a macromolecule compound to be synthesized, in a macromolecule synthesis enzymatic reaction. In a reaction for synthesizing a nucleic acid molecule, a nucleic acid molecule (e.g., DNA, RNA, or the like) which is complementary to part of a macromolecule compound to be synthesized may be used.

A nucleic acid molecule which is ordinarily used as a primer includes one that has a nucleic acid sequence having a length of at least 8 contiguous nucleotides, which is complementary to the nucleic acid sequence of a gene of interest. Such a nucleic acid sequence preferably has a length of at least 9 contiguous nucleotides, more preferably a length of at least 10 contiguous nucleotides, even more preferably a length of at least 11 contiguous nucleotides, a length of at least 12 contiguous nucleotides, a length of at least 13 contiguous nucleotides, a length of at least 14 contiguous nucleotides, a length of at least 15 contiguous nucleotides, a length of at least 16 contiguous nucleotides, a length of at least 17 contiguous nucleotides, a length of at least 18 contiguous nucleotides, a length of at least 19 contiguous nucleotides, a length of at least 20 contiguous nucleotides, a length of at least 25 contiguous nucleotides, a length of at least 30 contiguous nucleotides, a length of at least 40 contiguous nucleotides, and a length of at least 50 contiguous nucleotides. A nucleic acid sequence used as a primer includes a nucleic acid sequence having at least 70% homology to the above-described sequence, more preferably at least 80%, even more preferably at least 90%, and most preferably at least 95%. An appropriate sequence as a primer may vary depending on the property of the sequence to be synthesized (amplified). Those skilled in the art can design an appropriate primer depending on the sequence of interest. Such primer design is well known in the art and may be performed manually or using a computer program (e.g., LASERGENE, Primer Select, DNAStar).

As used herein, the term “epitope” refers to an antigenic determinant. Therefore, the term “epitope” includes a set of amino acid residues which is involved in recognition by a particular immunoglobulin, or in the context of T cells, those residues necessary for recognition by the T cell receptor proteins and/or Major Histocompatibility Complex (MHC) receptors. This term is also used interchangeably with “antigenic determinant” or “antigenic determinant site”. In the field of immunology, in vivo or in vitro, an epitope is a feature of a molecule (e.g., primary, secondary and tertiary peptide structure, and charge) that forms a site recognized by an immunoglobulin, T cell receptor or HLA molecule. An epitope including a peptide comprises 3 or more amino acids in a spatial conformation which is unique to the epitope. Generally, an epitope consists of at least 5 such amino acids, and more ordinarily, consists of at least 6, 7, 8, 9 or 10 such amino acids. The greater the length of an epitope, the more the similarity of the epitope to the original peptide, i.e., longer epitopes are generally preferable. This is not necessarily the case when the conformation is taken into account. Methods of determining the spatial conformation of amino acids are known in the art, and include, for example, X-ray crystallography and 2-dimensional nuclear magnetic resonance spectroscopy. Furthermore, the identification of epitopes in a given protein is readily accomplished using techniques well known in the art. See, also, Geysen et al., Proc. Natl. Acad. Sci. USA (1984) 81: 3998 (general method of rapidly synthesizing peptides to determine the location of immunogenic epitopes in a given antigen); U.S. Pat. No: 4,708,871 (procedures for identifying and chemically synthesizing epitopes of antigens); and Geysen et al., Molecular immunology (1986) 23: 709 (technique for identifying peptides with high affinity for a given antibody). Antibodies that recognize the same epitope can be identified in a simple immunoassay. Thus, methods for determining epitopes including a peptide are well known in the art. Such an epitope can be determined using a well-known, common technique by those skilled in the art if the primary nucleic acid or amino acid sequence of the epitope is provided.

Therefore, an epitope including a peptide requires a sequence having a length of at least 3 amino acids, preferably at least 4 amino acids, more preferably at least 5 amino acids, at least 6 amino acids, at least 7 amino acids, at least 8 amino acids, at least 9 amino acids, at least 10 amino acids, at least 15 amino acids, at least 20 amino acids, and 25 amino acids. Epitopes may be linear or conformational.

As used herein, the term “biological molecule” refers to molecules or aggregates of molecules relating to an organism and aggregates of organisms. As used herein, the term “biological” or “organism” refers to a biological organism, including, but being not limited to, an animal, a plant, a fungus, a virus, and the like. Biological molecules include molecules extracted from an organism and aggregations thereof, though the present invention is not limited to this. Any molecules or aggregates of molecules relating to an organism and aggregates of organisms fall within the definition of a biological molecule. Therefore, low molecular weight molecules (e.g., low molecular weight molecule ligands, etc.) capable of being used as medicaments fall within the definition of a biological molecule as long as an effect on an organism is intended. Examples of such a biological molecule include, but are not limited to, proteins, polypeptides, oligopeptides, peptides, polynucleotides, oligonucleotide, nucleotides, nucleic acids (e.g., DNA such as cDNA and genomic DNA; RNA such as mRNA), polysaccharides, oligosaccharides, lipids, low molecular weight molecules (e.g., hormones, ligands, information transmitting substances, low molecular weight organic molecules, etc.), and composite molecules thereof and aggregations thereof (e.g., glycolipids, glycoproteins, lipoproteins, etc.), and the like. A biological molecule may include a cell itself or a portion of tissue as long as it is intended to be introduced into a cell. Typically, a biological molecule may be a nucleic acid, a protein, a lipid, a sugar, a proteolipid, a lipoprotein, a glycoprotein, a proteoglycan, or the like. Preferably, a biological molecule may include a nucleic acid (DNA or RNA) or a protein. In an embodiment, a biological molecule is a nucleic acid (e.g., genomic DNA or cDNA, or DNA synthesized by PCR or the like). In another embodiment, a biological molecule may be a protein. Such a biological molecule may be a hormone or a cytokine.

The term “cytokine” is used herein in the broadest sense in the art and refers to a physiologically active substance which is produced by a cell and acts on the same or a different cell. Cytokines are generally proteins or polypeptides having a function of controlling an immune response, regulating the endocrine system, regulating the nervous system, acting against a tumor, acting against a virus, regulating cell growth, regulating cell differentiation, or the like. Cytokines are used herein in the form of a protein or a nucleic acid or in other forms, in actual practice, cytokines are typically proteins. The term “growth factor” refers to a substance which promotes or controls cell growth. Growth factors are also called “proliferation factors” or “development factor”. Growth factors may be added to cell or tissue culture medium, substituting for serum macromolecules. It has been revealed that a number of growth factors have a function of controlling differentiation in addition to a function of promoting cell growth. Examples of cytokines representatively include, but are not limited to, interleukins, chemokines, hematopoietic factors (e.g., colony stimulating factors), tumor necrosis factor, and interferons. Representative examples of growth factors include, but are not limited to, platelet-derived growth factor (PDGF), epidermal growth factor (EGF), fibroblast growth factor (FGF), hepatocyte growth factor (HGF), endothelial cell growth factor (VEGF), cardiotrophin, and the like, which have proliferative activity.

The term “hormone” is herein used in its broadest sense in the art, referring to a physiological organic compound which is produced in a particular organ or cell of an animal or plant, and has a physiological effect on an organ apart from the site producing the compound. Examples of such a hormone include, but are not limited to, growth hormones, sex hormones, thyroid hormones, and the like. The scope of hormones may intersect partially with that of cytokines.

As used herein, the terms “Cell adhesion agent”, “cell adhesion molecule”, “adhesion agent” and “adhesion molecule” are used interchangeably to refer to a molecule capable of mediating the joining of two or more cells (cell adhesion) or adhesion between a substrate and a cell. Cell adhesion molecules such as fibronectin may be used for transfection array used in the present invention. In general, cell adhesion molecules are divided into two groups: molecules involved in cell-cell adhesion (intercellular adhesion) (cell-cell adhesion molecules) and molecules involved in cell-extracellular matrix adhesion (cell-substrate adhesion) (cell-substrate adhesion molecules). For a method of the present invention, either type of molecule is useful and can be effectively used. Therefore, cell adhesion molecules herein include a substrate protein and a cellular protein (e.g., integrin, etc.) involved in cell-substrate adhesion. A molecule other than a protein can fall within the concept of cell adhesion molecule as long as it can mediate cell adhesion.

For cell-cell adhesion, cadherin, a number of molecules belonging in an immunoglobulin superfamily (NCAM, L1, ICAM, fasciclin II, III, etc.), selectin, and the like are known, each of which is known to connect to cell membranes via a specific molecular reaction.

On the other hand, major cell adhesion molecules functioning for cell-substrate adhesion are integrins, which recognize and bind to various proteins contained in extracellular matrices. These cell adhesion molecules are all located on cell membranes and can be regarded as a type of receptor (cell adhesion receptor). Therefore, receptors present on cell membranes can also be used in a method of the present invention. Examples of such a receptor include, but are not limited to, α-integrin, β-integrin. CD44, syndecan, aggrecan, and the like. Techniques for cell adhesion are well known as described above and as described in, for example, “Saibogaimatorikkusu -Rineho heno Oyo-[Extracellular matrix -Clinical Applications-], Medical Review.

It can be determined whether or not a certain molecule is a cell adhesion molecule, by an assay, such as biochemical quantification (an SDS-PAGE method, a labeled-collagen method, etc.), immunological quantification (an enzyme antibody method, a fluorescent antibody method, an immunohistological study, etc.), a PDR method, a hybridization method, or the like, in which a positive reaction is detected. Examples of such a cell adhesion molecule include, but are not limited to, collagen, integrin, fibronectin, laminin, vitronectin, fibrinogen, immunoglobulin superfamily members (e.g., CD2, CD4, CD8, ICAM1, ICAM2, VCAM1), selectin, cadherin, and the like. Most of these cell adhesion molecules transmit an auxiliary signal for cell activation into a cell due to intercellular interaction as well as cell adhesion. It can be determined whether or not such an auxiliary signal can be transmitted into a cell, by an assay, such as biochemical quantification (an SDS-PAGE method, a labeled-collagen method, etc.), immunological quantification (an enzyme antibody method, a fluorescent antibody method, an immunohistological study, etc.), a PCR method, a hybridization method, or the like, in which a positive reaction is detected.

Examples of cell adhesion molecules include, but are not limited to, immunoglobulin superfamily molecules (LFA-3, ICAM-1, CD2, CD4, CD8, ICAM1, ICAM2, VCAM1, etc.); integrin family molecules (LFA-1, Mac-1, gpIIbIIIa, p150, p95, VLA1, VLA2, VLA3, VLA4, VLA5, VLA6, etc.); selectin family molecules (L-selectin, E-selectin, P-selectin, etc.), and the like.

As used herein, the term “extracellular matrix protein” refers to a protein constituting an “extracellular matrix”. As used herein, the term “extracellular matrix” (ECM) is also called “extracellular substrate” and has the same meaning as commonly used in the art, and refers to a substance existing between somatic cells no matter whether the cells are epithelial cells or non-epithelial cells. Extracellular matrices are involved in supporting tissue as well as in internal environmental structures essential for survival of all somatic cells. Extracellular matrices are generally produced from connective tissue cells. Some extracellular matrices are secreted from cells possessing basal membrane, such as epithelial cells or endothelial cells. Extracellular matrices are roughly divided into fibrous components and matrices filling therebetween. Fibrous components include collagen fibers and elastic fibers. A basic component of matrices is glycosaminoglycan (acidic mucopolysaccharide), most of which is bound to non-collagenous protein to form a polymer of a proteoglycan (acidic mucopolysaccharide-protein complex). In addition, matrices include glycoproteins, such as laminin of basal membrane, microfibrils around elastic fibers, fibers, fibronectins on cell surfaces, and the like. Particularly differentiated tissue has the same basic structure. For example, in hyaline cartilage, chondroblasts characteristically produce a large amount of cartilage matrices including proteoglycans. In bones, osteoblasts produce bone matrices which cause calcification. Examples of extracellular matrices for use in the present invention include, but are not limited to, collagen, elastin, proteoglycan, glycosaminoglycan, fibronectin, laminin, elastic fiber, collagen fiber, and the like.

As used herein, the term “receptor” refers to a molecule which is present on cells, within nuclei, or the like, and is capable of binding to an extracellular or intracellular agent where the binding mediates signal transduction. Receptors are typically in the form of proteins. The binding partner of a receptor is usually referred to as a ligand.

As used herein, the term “agonist” refers to an agent which binds to the receptor of a certain biologically acting substance (e.g., ligand, etc.), and has the same or similar function as the function of the substance.

As used herein, the term “antagonist” refers to a factor which competitively binds to the receptor of a certain biologically acting substance (ligand), and does not produce physiological action via the receptor. Antagonists include antagonist drugs, blockers, inhibitors, and the like.

As used herein, the term “agent” may be any substance or other entity (e.g., energy, such as light, radiation, heat, electricity, or the like) as long as the intended purpose can be achieved. Examples of such a substance include, but are not limited to, proteins, polypeptides, oligopeptides, peptides, polynucleotides, oligonucleotides, nucleotides, nucleic acids (e.g., DNA such as cDNA, genomic DNA, or the like, and RNA such as mRNA), polysaccharides, oligosaccharides, lipids, low molecular weight organic molecules (e.g., hormones, ligands, information transfer substances, molecules synthesized by combinatorial chemistry, low molecular weight molecules (e.g., pharmaceutically acceptable low molecular weight ligands and the like), and the like), and combinations of these molecules. Examples of an agent specific to a polynucleotide include, but are not limited to, representatively, a polynucleotide having complementarity to the sequence of the polynucleotide with a predetermined sequence homology (e.g., 70% or more sequence identity), a polypeptide such as a transcriptional agent binding to a promoter region, and the like. Examples of an agent specific to a polypeptide include, but are not limited to, representatively, an antibody specifically directed to the polypeptide or derivatives or analogs thereof (e.g., single chain antibody), a specific ligand or receptor when the polypeptide is a receptor or ligand, a substrate when the polypeptide is an enzyme, and the like.

As used herein, the term “agent binding specifically to” a certain agent such as a nucleic acid molecule or polypeptide refers to an agent which has a level of binding to the nucleic acid molecule or polypeptide equal to or higher than a level of binding to other nucleic acid molecules or polypeptides. Examples of such an agent include, but are not limited to, when a target is a nucleic acid molecule, a nucleic acid molecule having a complementary sequence of a nucleic acid molecule of interest, a polypeptide capable of binding to a nucleic acid sequence of interest (e.g., a transcription agent, etc.), and the like, and when a target is a polypeptide, an antibody, a single chain antibody, either of a pair of a receptor and a ligand, either of a pair of an enzyme and a substrate, and the like.

As used herein, the term “compound” refers to any identifiable chemical substance or molecule, including, but not limited to, a low molecular weight molecule, a peptide, a protein, a sugar, nucleotide, or a nucleic acid. Such a compound may be a naturally-occurring product or a synthetic product.

As used herein, the term “low molecular weight organic molecule” refers to an organic molecule having a relatively small molecular weight. Usually, the low molecular weight organic molecule refers to a molecular weight of about 1,000 or less, or may refer to a molecular weight of more than 1,000. Low molecular weight organic molecules can be ordinarily synthesized by methods known in the art or combinations thereof. These low molecular weight organic molecules may be produced by organisms. Examples of the low molecular weight organic molecules include, but are not limited to, hormones, ligands, information transfer substances, synthesized by combinatorial chemistry, pharmaceutically acceptable low molecular weight molecules (e.g., low molecular weight ligands and the like), and the like.

As used herein, the term “contact” refers to direct or indirect placement of a compound physically close to the polypeptide or polynucleotide of the present invention. Polypeptides or polynucleotides may be present in a number of buffers, salts, solutions, and the like. The term “contact” includes placement of a compound in a beaker, a microliter plate, a cell culture flask, a microarray (e.g., a gene chip) or the like containing a polypeptide encoded by a nucleic acid or a fragment thereof.

As used herein, the term “antibody” encompasses polyclonal antibodies, monoclonal antibodies, human antibodies, humanized antibodies, polyfunctional antibodies, chimeric antibodies, and anti-idiotype antibodies, and fragments thereof (e.g., F(ab′)2 and Fab fragments), and other recombinant conjugates. These antibodies may be fused with an enzyme (e.g., alkaline phosphatase, horseradish peroxidase, α-galactosidase, and the like) via a covalent bond or by recombination. Antibodies can be used as a perturbation agent in the present invention.

As used herein, the term “antigen” refers to any substrate to which an antibody molecule may specifically bind. As used herein, the term “immunogen” refers to an antigen capable of initiating activation of the antigen-specific immune response of a lymphocyte. Antigens can be used as a perturbation agent in the present invention.

In a given protein molecule, a given amino acid may be substituted with another amino acid in a structurally important region, such as a cationic region or a substrate molecule binding site, without a clear reduction or loss of interactive binding ability. A given biological function of a protein is defined by the interactive ability or other property of the protein. Therefore, a particular amino acid substitution may be performed in an amino acid sequence, or at the DNA sequence level, to produce a protein which maintains the original property after the substitution. Therefore, various modifications of paptices as disclosed herein and DNA encoding such peptides may be performed without clear losses of biological activity.

When the above-described modifications are designed, the hydrophobicity indices of amino acids may be taken into consideration. The hydrophobic amino acid indices play an important role in providing a protein with an interactive biological function, which is generally recognized in the art (Kyte, J. and Doolittle, R. F., J. Mol. Biol. 157(1):105-132, 1982). The hydrophobic property of an amino acid contributes to the secondary structure of a protein and then regulates interactions between the protein and other molecules (e.g., enzymes, substrates. receptors, DNA, antibodies, antigens, etc.). Each amino acid is given a hydrophobicity index based on the hydrophobicity and charge properties thereof as follows: isoleucine (+4.5); valine (+4.2); leucine (+3.8); phenylalanine (+2.8); oysteine/cystine (+2.5); methionine (+1.9); alanine (+1.8); glycine (−0.4): threonine (−0.7); serine (−0.8); tryptophan (−0.9); tyrosine (−1.3); proline (−1.6); histidine (−3.2); glutamic acid (−3.5); glutamine (−3.5); aspartic acid (−3.5); asparagine (−3.5); lysine (−3.9); and arginine (−4.5).

It is well known that if a given amino acid is substituted with another amino acid having a similar hydrophobicity index, the resultant protein may still have a biological function similar to that of the original protein (e.g., a protein having an equivalent enzymatic activity). For such an amino acid substitution, the hydrophobicity index is preferably within ±2, more preferably within ±1, and even more preferably within ±0.5. It is understood in the art that such an amino acid substitution based on hydrophobicity is efficient. As described in U.S. Pat. No. 4,554,101, amino acid residues are given the following hydrophilicity indices: arginine (+3.0); lysine (+3.0); aspartic acid (+3.0±1); glutamic acid (+3.0±1); serine (+0.3): asparagine (+0.2); glutamine (+0.2); glycine (0); threonine (−0.4); proline (−0.5±1); alanine (−0.5); histidine (−0.5); cysteine (−1.0); methionine (−1.3); valine (−1.5); leucine (−1.8); isoleucine (−1.8); tyrosine (−2.3); phenylalanine (−2.5); and tryptophan(−3.4). It is understood that an amino acid may be substituted with another amino acid which has a similar hydrophilicity index and can still provide a biological equivalent. For such an amino aced substitution, the hydrophilicity index is preferably within ±2, more preferably ±1, and even more preferably ±0.5.

(Devices and Solid Phase Supports)

As used herein, the term “device” refers to a part which can constitute the whole or a portion of an apparatus, and comprises a support (preferably, a solid phase support) and a target substance carried thereon. Examples of such a device include, but are not limited to, chips, arrays, microliter plates, cell culture plates, Petri dishes, films, beads, and the like. Such a device may constitute a system of the present invention. In particular, such a device may be used as means for obtaining information on at least two functional reporters in said biological entity, wherein the functional reporters reflect a biological function

As used herein, the term “support” refers to a material which can fix a substance, such as a biological molecule. Such a support may be made from any fixing material which has a capability of binding to a biological molecule as used herein via covalent or noncovalent bonds, or which may be induced to have such a capability.

Examples of materials used for supports include any material capable of forming a solid surface, such as, without limitation, glass, silica, silicon, ceramics, silicon dioxide, plastics, metals (including alloys), naturally-occurring and synthetic polymers (e.g., polystyrene, cellulose, chitosan, dextran, and nylon), and the like. A support may be formed of layers made of a plurality of materials. For example, a support may be made of an inorganic insulating material, such as glass, quartz glass, alumina, sapphire, forsterite, silicon oxide, silicon carbide, silicon nitride, or the like. A support may be made of an organic material, such as polyethylene, ethylene, polypropylene, polylsobutylene, polyethylene terephthalate, unsaturated polyester, fluorine-containing resin, polyvinyl chloride, polyvinylidene chloride, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrile-butadiene-styrene copolymer, silicone resin, polyphenylene oxide, polysulfone, and the like. Also in the present invention, nitrocellulose film, nylon film, PVDF film, or the like, which are used in blotting, may be used as a material for a support. When a material constituting a support is in the solid phase, such as a support is herein particularly referred to as a “solid phase support”. A solid phase support may be herein in the form of a plate, a microwell plate, a chip, a glass slide, a film, beads, a metal (surface), or the like. A support may not be coated or may be coated.

As used herein, the term “liquid phase” has the same meaning as commonly understood by those skilled in the art, typically referring a state in solution.

As used herein, the term “solid phase” has the same meaning as commonly understood by those skilled in the art, typically referring to a solid state. As used herein, liquid and solid may be collectively referred to as a “fluid”.

As used herein, the term “substrate” refers to a material (preferably, solid) which is used to construct a chip or array according to the present invention. Therefore, substrates are included in the concept of plates. Such a substrate may be made from any solid material which has a capability of binding to a biological molecule as used herein via covalent or noncovalent bonds, or which may be induced to have such a capability.

Exaples of materials used for plates and substrates include any material capable of forming a solid surf ace, such as, without limitation, glass, silica, silicon, ceramics, silicon dioxide, plastics, metals (including alloys), naturally-occurring and synthetic polymers (e.g., polystyrene, cellulose, chitosan, dextran, and nylon), and the like. A support may be formed of layers made of a plurality of materials. For example, a support may be made of an inorganic insulating material, such as glass, quartz glass, alumina, sapphire, forsterite, silicon oxide, silicon carbide, silicon nitride, or the like. A support may be made of an organic material, such as polyethylene, ethylene, polypropylene, polyisobutylene, polyethylene terephthalate, unsaturated polyester, fluorine-containing resin, polyvinyl chloride, polyvinylidene chloride, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrile-butadiene-styrene copolymer, silicone resin, polyphenylene oxide, polysulfone, and the like. A material preferable as a substrate varies depending on various parameters such as a measuring device, and can be selected from the above-described various materials as appropriate by those skilled in the art. For transfection arrays, glass slides are preferable. Preferably, such a substrate may have a coating.

As used herein, the term “coating” in relation to a solid phase support or substrate refers to an act of forming a film of a material on a surface of the solid phase support or substrate, and also refers to a film itself. Coating is performed for various purposes, such as, for example, improvement in the quality of a solid phase support and substrate (e.g., elongation of life span, improvement in resistance to hostile environment, such as resistance to acids, etc.), an improvement in affinity to a substance integrated with a solid phase support or substrate, and the like. Various materials may be used for such coating, including, without limitation, biological substances (e.g., DNA, RNA, protein, lipid, etc.), polymers (e.g., poly-L-lysine, MAS (available from Matsunami Glass, Kishiwada, Japan), and hydrophobia fluorine resin), silane (APS (e.g., γ-aminopropyl silane, etc.)), metals (e.g., gold, etc.), in addition to the above-described solid phase support and substrate. The selection of such materials is within the technical scope of those skilled in the art and thus can be performed using techniques well known in the art. In one preferred embodiment, such a coating may be advantageously made of poly-L-lysine, silane (e.g., epoxy silane or mercaptosilane, APS (γ-aminopropyl silane), etc.), MAS, hydrophobic fluorine resin, a metal (e.g., gold, etc.). Such a material may be preferably a substance suitable for cells or objects containing cells (e.g., organisms, organs, etc.).

As used herein, the terms “chip” or “microchip” are used interchangeably to refer to a micro integrated circuit which has versatile functions and constitutes a portion of a system. Examples of a chip include, but are not limited to, DNA chips, protein chips, and the like.

As used herein, the term “array” refers to a substrate (e.g., a chip, etc.) which has a pattern of a composition containing at least one (e.g., 1000 or more, etc.) target substances (e.g., DNA, proteins, transfection mixtures, etc.), which are arrayed. Among arrays, patterned substrates having a small size (e.g., 10×10 mm, etc.) are particularly referred to as microarrays. The terms “microarray” and “array” are used interchangeably. Therefore, a patterned substrate having a larger size than that which is described above may be referred to as a microarray. For example, an array comprises a set of desired transfection mixtures fixed to a solid phase surface or a film thereof. An array preferably comprises at least 10² antibodies of the same or different types, more preferably at least 10³, even more preferably at least 10⁴, and still even more preferably at least 10⁵. These antibodies are placed on a surface of up to 125×80 mm, more preferably 10×10 mm. An array includes, but is not limited to, a 96-well microtiter plate, a 384-well microtiter plate, a microtiter plate the size of a glass slide, and the like. A composition to be fixed may contain one or a plurality of types of target substances. Such a number of target substance types may be in the range of from one to the number of spots, including, without limitation, about 10, about 100, about 500, and about 1,000.

As used herein, the term “transfection array” refers to an array which embodies transfection on each of the spots or addresses on the array. Such transfection may be conducted using the technology described herein and exemplified in the Examples.

As described above, any number of target substances (e.g., proteins, such as antibodies) may be provided on a solid phase surface or film, typically including no more than 10⁸ biological molecules per substrate, in another embodiment no more than 10⁷ biological molecules, no more than 10⁶ biological molecules, no more than 10⁵ biological molecules, no more than 10⁴ biological molecules, no more than 10³ biological molecules, or no more than 10² biological molecules. A composition containing more than 10⁸ biological molecule target substances may be provided on a substrate. In these cases, the size of a substrate is preferably small. Particularly, the size of a spot of a composition containing target substances (e.g., proteins such as antibodies) may be as small as the size of a single biological molecule (e.g., 1 to 2 nm order). In some cases, the minimum area of a substrate may be determined based on the number of biological molecules on a substrate. A composition containing target substances, which are intended to be introduced into cells, are herein typically arrayed on and fixed via covalent bonds or physical interaction to a substrate in the form of spots having a size of 0.01 mm to 10 mm.

“Spots” of biological molecules may be provided on an array. As used herein, the term “spot” refers to a certain set of compositions containing target substances. As used herein, the term spotting refers to an act of preparing a spot of a composition containing a certain target substance on a substrate or plate. Spotting may be performed by any method, for example, pipetting or the like, or alternatively, using an automatic device. These methods are well known in the art.

As used herein, the term “address” refers to a unique position on a substrate, which may be distinguished from other unique positions. Addresses are appropriately associated with spots. Addresses can have any distinguishable shape such that substances at each address may be distinguished from substances at other addresses (e.g., optically). A shape defining an address may be, for example, without limitation, a circle, an ellipse, a square, a rectangle, or an irregular shape. Therefore, the term “address” is used to indicate an abstract concept, while the term “spot” is used to indicate a specific concept. Unless it is necessary to distinguish them from each other, the terms “address” and “spot” may be herein used interchangeably.

The size of each address particularly depends on the size of the substrate, the number of addresses on the substrate, the amount of a composition containing target substances and/or available reagents, the size of microparticles, and the level of resolution required for any method used for the array. The size of each address may be, for example, in the range of from 1-2 nm to several centimeters, though the address may have any size suited to an array.

The spatial arrangement and shape which define an address are designed so that the microarray is suited to a particular application. Addresses may be densely arranged or sparsely distributed, or subgrouped into a desired pattern appropriate for a particular type of material to be analyzed.

Microarrays are widely reviewed in, for example, “Genomu Kino Kenkyu Purotokoru [Genomic Function Research Protocol] (Jikken Igaku Bessatsu [Special Issue of Experimental Medicine], Posuto Genomu Jidai no Jikken Koza 1 [Lecture 1 on Experimentation in Post-genome Era), “Genomu Ikagaku to korekarano Genomu Iryo [Genome Medical Science and Future Genome Therapy (Jikken Igaku Zokan [Special Issue of Experimental Medicine]), and the like.

A vast amount of data can be obtained from a microarray. Therefore, data analysis software is important for administration of correspondence between clones and spots, data analysis, and the like. Such software may be attached to various detection systems (e.g., Ermolaeva O. et al., (1998) Nat. Genet., 20: 19-23). The format of database includes, for example, GATC (genetic analysis technology consortium) proposed by Affymetrix.

Micromachining for arrays is described in, for example, Campbell, S. A. (1996). “The Science and Engineering of Microeleotronic Fabrication”, Oxford University Press; Zaut, P. V. (1996). “Microarray Fabrication: a Practical Guide to Semiconductor Processing”, Semiconductor Services; Madou, M. J. (1997), “Fundamentals of Microfabrication”, CRC15 Press; Rai-Choudhury, P. (1997), “Handbook of Microlithography, Micromachining, & Microfabrication: Microlithography”; and the like, portions related thereto of which are herein incorporated by reference.

(Detection)

In cell analysis or determination in the present invention, various detection methods and means can be used as long as they can be used to detect information attributed to a cell or a substance interacting therewith. Examples of such detection methods and means include, but are not limited to, visual inspection, optical microscopes, confocal microscopes, reading devices using a laser light source, surface plasmon resonance (SPR) imaging, electric signals, chemical or biochemical markers, which may be used singly or in combination. Examples of such a detecting device include, but are not limited to, fluorescence analyzing devices, spectrophotometers, scintillation counters, CCD, luminometers, and the like. Any means capable of detecting a biological molecule may be used.

As used herein, the term “marker” or “biomarker” is interchangeably used to refer to a biological agent for indicating a level or frequency of a substance or state of interest. Examples of such markers include, but are not limited to, nucleic acids encoding a gene, gene products, metabolic products, receptors, ligands, antibodies, and the like.

Therefore, as used herein, the term “marker” in relation to a state of a cell refers to an agent (e.g., ligands, antibodies, complementary nucleic acids, etc.) interacting with intracellular factors indicating the state of the cell (e.g., nucleic acids encoding a gene, gene products (e.g., mRNA, proteins, posttranscriptionally modified proteins, etc.), metabolic products, receptors, etc.) in addition to transcription control factors. In the present invention, such a marker may be used to produce information which is in turn analyzed. Such a marker may preferably interact with a factor of interest. As used herein, the term “specificity” in relation to a marker refers to a property of the marker which interacts with a molecule of interest to a significantly higher extent than it does with other similar molecules. Such a marker is herein preferably present within cells or may be present outside cells.

As used herein, the term “label” refers to a factor which distinguishes a molecule or substance of interest from others (e.g., substances, energy, electromagnetic waves, etc.). Examples of labeling methods include, but are not limited to, RI (radioisotope) methods, fluorescence methods, biotinylation methods, chemoluminance methods, and the like. When the above-described nucleic acid fragments and complementary oligonucleotides are labeled by fluorescence methods, fluorescent substances having different fluorescence emission maximum wavelengths are used for labeling. The difference between each fluorescence emission maximum wavelength may be preferably 10 nm or more. Any fluorescent substance which can bind to a base portion of a nucleic acid may be used, preferably including a cyanine dye (e.g., Cy3 and Cy5 in the Cy Dye™ series, etc. ), a rhodamine 6G reagent, N-acetoxy-N2-acetyl amino fluorene (AAF), AAIF (iodine derivative of AAF), and the like. Examples of fluorescent substances having a difference in fluorescence emission maximum wavelength of 10 nm or more include a combination of Cy5 and a rhodamine 6G reagent, a combination of Cy3 and fluorescein, a combination of a rhodamine 6G reagent and fluorescein, and the like. In the present invention, such a label can be used to alter a sample of interest so that the sample can be detected by detecting means. Such alteration is known in the art. Those skilled in the art can perform such alteration using a method appropriate for a label and a sample of interest.

As used herein, the term “interaction” refers to, without limitation, hydrophobic interactions, hydrophilic interactions, hydrogen bonds, Van der Waals forces, ionic interactions, nonionic interactions, electrostatic interactions, and the like.

As used herein, the term “interaction level” in relation to the interaction between two substances (e.g., cells, etc.) refers to the extent or frequency of interaction between the two substances. Such an interaction level can be measured by methods well known in the art. For example, the number of cells which are fixed and actually perform an interaction is counted directly or indirectly (e.g., the intensity of reflected light) for example, without limitation, by using an optical microscope, a fluorescence microscope, a phase-contrast microscope, or the like, or alternatively by staining cells with a marker, an antibody, a fluorescent label or the like, specific thereto and measuring the intensity thereof. Such a level can be displayed directly from a marker or indirectly via a label. Based on the measured value of such a level, the number or frequency of genes, which are actually transcribed or expressed in a certain spot, can be calculated.

(Presentation and Display)

As used herein, the terms “display” and “presentation” are used interchangeably to refer to an act of providing information obtained by a method of the present invention or information derived therefrom directly or indirectly, or in an information-processed form. Examples of such displayed forms include, but are not limited to, various methods, such as graphs, photographs, tables, animations, and the like. Such techniques are described in, for example. METHODS IN CELL BIOLOGY, VOL. 56, ed. 1998, pp: 185-215, A High-Resolution Multimode Digital Microscope System (Sluder & Wolf, Salmon), which discusses application software for automating a microscope and controlling a camera and the design of a hardware device comprising an automated optical microscope, a camera, and a Z-axis focusing device, which can be used herein. Image acquisition by a camera is described in detail in, for example, Inoue and Spring, Video Microscopy, 2d. Edition, 1997, which is herein incorporated by reference. Real time display can also be performed using techniques well known in the art. For example, after all images are obtained and stored in a semi-permanent memory, or substantially at the same time as when an image to obtained, the image can be processed with appropriate application software to obtain processed data. For example, data may be processed by a method for playing back a sequence of images without interruption, a method for displaying images in real time, or a method for displaying images as a “movie” showing irradiating light as changes or continuation on a focal plane.

In another embodiment, application software for measurement and presentation typically includes software for setting conditions for applying stimuli or conditions for recording detected signals. With such a measurement and presentation application, a computer can have a means for applying a stimulus to cells and a means for processing signals detected from cells, and in addition, can control an optical observing means (a SIT camera and an image filing device) and/or a cell culturing means.

By inputting conditions for stimulation on a parameter setting screen using a keyboard, a touch panel, a mouse, or the like, it is possible to set desired complicated conditions for stimulation. In addition, various conditions, such as a temperature for cell culture, pH, and the like, can be set using a keyboard, a mouse, or the like. A display screen displays information on a network detected from a cell or information derived therefrom in real time or after recording. In addition, another recorded information or information derived therefrom of a cell can be displayed while being superimposed with a microscopic image of the cell. In addition to recorded information, measurement parameters in recording (stimulation conditions, recording conditions, display conditions, process conditions, various conditions for cells, temperature, pH, etc.) can be displayed in real time. The present invention may be equipped with a function of issuing an alarm when a temperature or pH departs from the tolerable range.

On a data analysis screen, in addition to the set theory as used in the present invention, it is possible to set conditions for various mathematical analyses, such as Fourier transformation, cluster analysis, FFT analysis, coherence analysis, correlation analysis, and the like. The present invention may be equipped with a function of temporarily displaying information on a network, a function of displaying topography, or the like. The results of these analyses can be displayed while being superimposed with microscopic images stored in a recording medium.

(Gene introduction)

Any technique may be used herein for introduction of a nucleic acid molecule into cells, including, for example, transformation, transduction, transfection, and the like. In the present invention, transfection is preferable.

As used herein, the term “transfection” refers to an act of performing gene introduction or transfection by culturing cells with gene DNA, plasmid DNA, viral DNA, viral RNA or the like in a substantially naked form (excluding viral particles), or adding such a genetic material into cell suspension to allow the cells to take in the genetic material. A gene introduced by transfection is typically expressed within cells in a temporary manner or may be incorporated into cells in a permanent manner.

Such a nucleic acid molecule introduction technique is well known in the art and commonly used, and is described in, for example, Ausubel F. A. et al., editors, (1988), Current Protocols in Molecular Biology, Wiley, New York, N.Y.; Sambrook J. et al. (1987) Molecular Cloning: A Laboratory Manual, 2nd Ed. and its 3rd Ed., Cold Spring Harbor Laboratory Press, Cold Spring Harbor, N.Y.; Special issue, Jikken Igaku [Experimental Medicine] “Experimental Methods for Gene introduction & Expression Analysis”, Yodo-sha, 1997; and the like. Gene introduction can be confirmed by methods as described herein, such as Northern blotting analysis and Western blotting analysis, or other is well-known, common techniques.

When a gene is mentioned herein, the term “vector” or “recombinant vector” refers to a vector transferring a polynucleotide sequence of interest to a target cell. Such a vector is capable of self-replication or incorporation into a chromosome in a host cell (e.g., a prokaryotic cell, yeast, an animal cell, a plant cell, an insect cell, an individual animal, and an individual plant, etc.), and contains a promoter at a site suitable for transcription of a polynucleotide of the present invention. A vector suitable for performing cloning is referred to as a “cloning vector”. Such a cloning vector ordinarily contains a multiple cloning site containing a plurality of restriction sites. Restriction enzyme sites and multiple cloning sites as described above are well known in the art and can be used as appropriate by those skilled in the art depending on the purpose in accordance with publications described herein (e.g., Sambrook et al., supra).

As used herein, the term “expression vector” refers to a nucleic acid sequence comprising a structural gene and a promoter for regulating expression thereof, and in addition, various regulatory elements in a state that allows them to operate within host cells. The regulatory element may include, preferably, terminators, selectable markers such as drug-resistance genes, and enhancers.

Examples of “recombinant vectors” for prokaryotic cells include, but are not limited to, pcDNA3 (+), pBluescript-SK(+/−), pGEM-T, pEF-BOS, pEGFP, pHAT, pUC18, pFT-DEST™42GATEWAY (Invitrogen), and the like.

Examples of “recombinant vectors” for animal cells include, but are not limited to, pcDNAI/Amp, pcDNAI, pCDM8 (all commercially available from Funakoshi), pAGE107 [Japanese Laid-Open Publication No: 3-229 (Invitrogen), pAGE103 [J. Biochem., 101, 1307(1987)], pAMo, pAMoA [J. Biol. Chem., 268, 22782-22787(1993)], a retrovirus expression vector based on a murine stem cell virus (MSCV), pEF-BOS, pEGFP, and the like.

Examples of recombinant vectors for plant cells include, but are not limited to, pPCVICEn4HPT, pCGN1548, pCGN1549, pBI221, pBI121, and the like.

Any of the above-described methods for introducing DNA into cells can be used as a vector introduction method, including, for example, transfection, transduction, transformation, and the like (e.g., a calcium phosphate method, a liposome method, a DEAE dextran method, an electroporation method, a particle gun (gene gun) method, and the like), a lipofaction method, a spheroplast method (Proc. Natl. Acad. Sci. USA, 84, 1929(1978)), a lithium acetate method (J. Bacteriol., 153, 163(1983); and Proc. Natl. Acad. Sci. USA, 75, 1929(1978)), and the like.

As used herein, the term “gene introduction reagent” refers to a reagent which is used in a gene introduction method so as to enhance introduction efficiency. Examples of such a gene introduction reagent include, but are not limited to, cationic polymers, cationic lipids, polyamine-based reagents, polyimine-based reagents, calcium phosphate, and the like. Specific examples of a reagent used in transfection include reagents available from various sources, such as, without limitations Effectene Transfection Reagent (cat. no. 301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA). LipofectAMINE 2000 Reagent (11668-019, Invitrogen corporation, CA), JetPEI (×4) conc. (101-30, Polyplus-transfection, France) and ExGen 500 (R0511, Fermentas Inc., MD), and the like.

Gene expression (e.g., mRNA expression, polypeptide expression) may be “detected” or “quantified” by an appropriate method, including mRNA measurement and immunological measurement methods. Examples of molecular biological measurement methods include Northern blotting methods, dot blotting methods, PCR methods, and the like. Examples of immunological measurement methods include ELISA methods, RIA methods, fluorescent antibody methods, Western blotting methods, immunohistological staining methods, and the like, where a microtiter plate may be used. Examples of quantification methods include ELISA methods, RIA methods, and the like. A gene analysis method using an array (e.g., a DNA array, a protein array, etc.) may be used. The DNA array is widely reviewed in Saibo-Kogaku [Cell Engineering], special issue, “DNA Microarray and up-to-date PCR Method”, edited by Shujun-sha. The protein array is described in detail in Nat Genet. 2002 December; 32 Suppl:526-32. Examples of methods for analyzing gene expression include, but are not limited to, RT-PCR methods, RACE methods, SSCP methods, immunoprecipitation methods, two-hybrid systems, in vitro translation methods, and the like in addition to the above-described techniques. Other analysis methods are described in, for example, “Genome Analysis Experimental Method, Yusuke Nakamura's Lab-Manual, edited by Yusuke Nakamura, Yodo-sha (2002), and the like. All of the above-described publications are herein incorporated by reference.

As used herein, the term “expression level” refers to the amount of a polypeptide or mRNA expressed in a subject cell. The term “expression level” includes the level of protein expression of a polypeptide evaluated by any appropriate method using an antibody, including immunological measurement methods (e.g., an ELISA method, an RIA method, a fluorescent antibody method, a Western blotting method, an immunohistological staining method, and the like, or the mRNA level of expression of a polypeptide evaluated by any appropriate method, including molecular biological measurement methods (e.g., a Northern blotting method, a dot blotting method, a PCR method, and the like). The term “change in expression level” indicates that an increase or decrease in the protein or mRNA level of expression of a polypeptide evaluated by an appropriate method including the above-described immunological measurement method or molecular biological measurement method.

(Screening)

As used herein, the term “screening” refers to selection of a target, such as an organism, a substance, or the like, a given specific property of interest from a population containing a number of elements using a specific operation/evaluation method. For screening, an agent (e.g., an antibody), a polypeptide or a nucleic acid molecule of the present invention can be used.

As used herein, screening by utilizing an immunological reaction is also referred to as “immunophenotyping”. In this case, an antibody or a single chain antibody may be used for immunophenotyping a cell line and a biological sample. A transcription or translation product of a gene may be useful as a cell specific marker, or more particularly, a cell marker which is distinctively expressed in various stages in differentiation and/or maturation of a specific cell type. A monoclonal antibody directed to a specific epitope, or a combination of epitopes allows for screening of a cell population expressing a marker. Various techniques employ monoclonal antibodies to screen for a cell population expressing a marker. Examples of such techniques include, but are not limited to, magnetic separation using magnetic beads coated with antibodies, “panning” using antibodies attached to a solid matrix (i.e., a plate), flow cytometry, and the like (e.g., U.S. Pat. No. 5,985,660; and Morrison et al., Cell, 96:737-49(1999)).

These techniques may be used to screen cell populations containing undifferentiated cells, which can grow and/or differentiate as seen in human umbilical cord blood or which are treated and modified into an undifferentiated state (e.g., embryonic stem cells, tissue stem cells, etc.).

(Diagnosis)

As used herein, the term “diagnosis” refers to an act of identifying various parameters associated with a disease, a disorder, a condition, or the like of a subject and determining a current state of the disease, the disorder, the condition, or the like. A method, device, or system of the present invention can be used to analyze cellular networks, a drug resistance level, identification of a biomarker, analysis of a drug target, analysis of a side effect, diagnosis of a cellular function, analysis of a cellular pathway, evaluation of a biological effect of a compound, and diagnosis of an infectious disease and the like. Such information can be used to select parameters, such as a disease, a disorder, a condition, and a prescription or method for treatment or prevention of a subject.

A diagnosis method of the present invention can use, in principle, a sample which is derived from the body of a subject. Therefore, it is possible for someone which is not a medical practitioner, such as a medical doctor, to deal with such a sample. The present invention is industrially useful.

(Therapy)

As used herein, the term “therapy” refers to an act of preventing progression of a disease or a disorder, preferably maintaining the current state of a disease or a disorder, more preferably alleviating a disease or a disorder, and more preferably extinguishing a disease or a disorder.

As used herein, the term “subject” refers to an organism which is subjected to the treatment of the present invention. A subject is also referred to as a “patient”. A patient or subject may preferably be a human.

As used herein, the term “cause” or “pathogen” in relation to a disease, a disorder or a condition of a subject refers to an agent associated with the disease, the disorder or the condition (also collectively referred to as a “lesion”, or “disease damage” in plants), including, without limitation, a causative or pathogenic substance (pathogenic agent), a disease agent, a diseased cell, a pathogenic virus, and the like.

A disease targeted by the present invention may be any disease associated with a pathogenic gene. Examples of such a disease include, but are not limited to, cancer, infectious diseases due to viruses or bacteria, allergy, hypertension, hyperlipemia, diabetes, cardiac diseases, cerebral infarction, dementia, obesity, arteriosclerosis, infertility, mental and nervous diseases, cataract, progeria, hypersensitivity to ultraviolet radiation, and the like.

A disorder targeted by the present invention may be any disorder associated with a pathogenic gene.

Examples of such a disease, disorder or condition include, but are not limited to, circulatory diseases (anemia (e.g., aplastic anemia (particularly, severe aplastic anemia), renal anemia, cancerous anemia, secondary anemia, refractory anemia, etc.), cancer or tumors (e.g., leukemia, multiple myeloma), etc.); neurological diseases (dementia, cerebral stroke and sequela thereof, cerebral tumor, spinal injury, etc.); immunological diseases (T-cell deficiency syndrome, leukemia, etc.); motor organ and the skeletal system diseases (fracture, osteoporosis, luxation of joints, subluxation, sprain, ligament injury, osteoarthritis, osteosarcoma, Ewing's sarcoma, osteogenesis imperfecta, osteochondrodysplasia, etc.); dermatologic diseases (atrichia, malanoma, cutis malignant lympoma, hemangiosarcoma, histiocytosis, hydroa, pustulosis, dermatitis, eczema, etc.); endocrinologic diseases (hypothalamus/hypophysis diseases, thyroid gland diseases, accessory thyroid gland (parathyroid) diseases, adrenal cortex/medulla diseases, saccharometabolism abnormality, lipid metabolism abnormality, protein metabolism abnormality, nucleic acid metabolism abnormality, inborn error of metabolism (phenylketonuria, galactosemia, homocystinuria, maple syrup urine disease), analbuminemia, lack of ascorbic acid synthetic ability, hyperbilirubinemia, hyperbilirubinuria, kallikrein deficiency, mast cell deficiency, diabetes insipidus, vaeopressin secretion abnormality, dwarfism, Wolman's disease (acid lipase deficiency)), mucopolysaccharidosis VI, etc.); respiratory diseases (pulmonary diseases (e.g., pneumonia, lung cancer. etc.), bronchial diseases, lung cancer. bronchial cancer, etc.); alimentary diseases (esophagial diseases (e.g., esophagial cancer, etc.), stomach/duodenum diseases (e.g., stomach cancer, duodenum cancer, etc.), small intestine diseases/large intestine diseases (e.g., polyps of the colon, colon cancer, rectal cancer, etc.), bile duct diseases, liver diseases (e.g., liver cirrhosis, hepatitis (A, B, C, D, E, etc.), fulminant hepatitis, chronic hepatitis. primary liver cancer, alcoholic liver disorders, drug induced liver disorders, etc.), pancreatic diseases (acute pancreatitis, chronic pancreatitis, pancreas cancer, cystic pancreas diseases, etc.), peritoneum/abdominal wall/diaphragm diseases (hernia, etc.), Hirschsprung's disease, etc.); urinary diseases (kidney diseases (e.g., renal failure, primary glomerulus diseases, renovascular disorders, tubular function abnormality, interstitial kidney diseases, kidney disorders due to systemic diseases, kidney cancer, etc.), bladder diseases (e.g., cystitis, bladder cancer, etc.); genital diseases (male genital organ diseases (e.g., male sterility, prostatomegaly, prostate cancer, testicular cancer, etc.), female genital organ diseases (e.g., female sterility, ovary function disorders, hysteromyoma, adenomyosis uteri, uterine cancer, endometriosis, ovarian cancer, villosity diseases, etc.), etc); circulatory diseases (heart failure, angina pectoris, myocardial infarct, arrhythmia, valvulitis, cardiac musale/pericardium diseases, congenital heart diseases (e.g., atrial septal defeat, arterial canal patenoy, tetralogy of Fallot, etc.), artery diseases (e.g., arteriosclerosis, aneurysm), vein diseases (e.g., phlebeurysm, etc.), lymphoduct diseases (e.g., lymphedema, etc.), etc.); and the like.

As used herein, the term “pharmaceutically acceptable carrier” refers to a material for use in production of a medicament, an animal drug or an agricultural chemical, which does not have an adverse effect on an effective component. Examples of such a pharmaceutically acceptable carrier include, but are not limited to, antioxidants, preservatives, colorants, flavoring agents, diluents, emulsifiers, suspending agents, solvents, fillers, bulking agents, buffers, delivery vehicles, excipients, agricultural or pharmaceutical adjuvants, and the like.

The type and amount of a pharmaceutical agent used in a treatment method of the present invention can be easily determined by those skilled in the art based on information obtained by a method of the present invention (e.g., information about the level of drug resistance, etc.) and with reference to the purpose of use, a target disease (type, severity, and the like), the patient's age, weight, sex, and case history, the form or type of the cell, and the like. The frequency of the treatment method of the present invention applied to a subject (or patient) is also determined by those skilled in the art with respect to the purpose of use, target disease (type, severity, and the like), the patient's age, weight, sex, and case history, the progression of the therapy, and the like. Examples of the frequency include once per day to several months (e.g., once per week to once per month). Preferably, administration is performed once per week to month with reference to the progression.

As used herein, the term “instructions” refers to a description of a tailor made therapy of the present invention for a person who performs administration, such as a medical doctor, a patient, or the like. Instructions state when to administer a medicament of the present invention, such as immediately after or before radiation therapy (e.g., within 24 hours, etc.). The instructions are prepared in accordance with a format defined by an authority of a country in which the present invention is practiced (e.g., Health, Labor and Welfare Ministry in Japan, Food and Drug Administration (FDA) in the U.S., and the like), explicitly describing that the instructions are approved by the authority. The instructions are so-called a package insert and are typically provided as paper media. The instructions are not so limited and may be provided in the form of electronic media (e.g., web sites, electronic mails, and the like provided on the internet).

In a therapy of the present invention, two or more pharmaceutical agents may be used as required. When two or more pharmaceutical agents are used, these agents may have similar properties or may be derived from similar origins, or alternatively, may have different properties or may be derived from different origins. A method of the present invention can be used to obtain information about the drug resistance level of a method of administering two or more pharmaceutical agents.

Also, in the present invention, a gene therapy can be performed based on the resultant information about drug resistance. As used herein, the term “gene therapy” refers to a therapy in which a nucleic acid, which has been expressed or can be expressed, is administered into a subject in such an embodiment of the present invention, a protein encoded by a nucleic acid is produced to mediate a therapeutic effect.

In the present invention, it will be understood by those skilled in the art that if the result of analysis of a certain specific information is once correlated with a state of a biological entity such as a cell in a similar organism (e.g., mouse with respect to human, etc.), the result of analysis of the corresponding information can be correlated with a state of a biological entity such as a cell. This feature is supported by, for example, Dobutsu Baiyo Saibo Manuaru [Animal Culture Cell Manual], Seno, ed., Kyoritsu Shuppan, 1993, which is herein incorporated by reference.

The present invention may be applied to gene therapies based on such a certain specific information of the result of network analysts.

Any methods for gene therapy available in the art may be used in accordance with the present invention. Illustrative methods will be described below.

Methods for gene therapy are generally reviewed in, for example, Goldspiel et al., Clinical Pharmacy 12: 488-505(1993); Wu and Wu, Biotherapy 3: 87-95(1991); Tolstoshev, Ann. Rev. Pharmacol. Toxicol., 32: 573-596(1993); Mulligan, Science 260: 926-932(1993); Morgan and Anderson, Ann. Rev. Biochem., 62: 191-217(1993); and May, TIBTECH 11(5): 155-215(1993). Commonly known recombinant DNA techniques used in gene therapy are described in, for example, Ausubel et al. (ed.), Current Protocols in Molecular Biology, John Wiley & Sons, NY(1993); and Kriegler, Gene Transfer and Expression, A Laboratory Manual, Stockton Press, NY (1990).

(Basic techniques)

Techniques used herein are within the technical scope of the present invention unless otherwise specified. These techniques are commonly used in the fields of fluidics, micromachining, organic chemistry, biochemistry, genetic engineering, molecular biology, microbiology, genetics, and their relevant fields. The techniques are well described in documents described below and the documents mentioned herein elsewhere.

Micromachining is described in, for example, Campbell, S. A. (1996), “The Science and Engineering of Microelectronic Fabrication”, Oxford University Press; Zaut, P. V. (1996), “Microarray Fabrication: a Practical Guide to Semiconductor Processing”. Semiconductor Services; Madou, M. J. (1997), “Fundamentals of Microfabrication”, CRC15 Press; Rai-Choudhury, P. (1997), “Handbook of Microlithography, Micromachining, & Microfabrication: Microlithography”. Relevant portions (or possibly the entirety) of each of these publications are herein incorporated by reference.

Molecular biology techniques, biochemistry techniques, and microbiology techniques used herein are well known and commonly used in the art, and are described in, for example, Sambrook J. et al. (1989), “Molecular Cloning: A Laboratory Manual”, Cold Spring Harbor and its 3rd Ed. (2001); Ausubel, F. M. (1987), “Current Protocols in Molecular Biology”, Greene Pub. Associates and Wiley-Interscience; Ausubel, F. M. (1989), “Short Protocols in Molecular Biology: A Compendium of Methods from Current Protocols in Molecular Biology”, Greene Pub. Associates and Wiley-Interscience; Innis. M. A. (1990), “PCR Protocols: A Guide to Methods and Applications”, Academic Press; Ausubel, F. M. (1992), “Short Protocols in Molecular Biology: A Compendium of Methods from Current Protocols in Molecular Biology”, Greene Pub. Associates; Ausubel, F. M. (1995), “Short Protocols in Molecular Biology: A Compendium of Methods from Current Protocols in Molecular Biology”, Greene Pub. Associates: Innis, M. A. et al. (1995), “PCR Strategies”, Academic Press; Ausubel, F. M. (1999), “Short Protocols in Molecular Biology: A Compendium of Methods from Current Protocols in Molecular Biology”, Wiley, and annual updates; Sninsky, J. J. et al. (1999), “PCR Applications: Protocols for Functional Genomics”, Academic Press; Special issue, Jikken Igaku [Experimental Medicine] “Idenshi Donyu & Hatsugenkaiseki Jikkenho [Experimental Method for Gene introduction & Expression Analysis]”, Yodo-sha, 1997; and the like. Relevant portions (or possibly the entirety) of each of these publications are herein incorporated by reference.

DNA synthesis techniques and nucleic acid chemistry for producing artificially synthesized genes are described in, for example, Gait, M. J. (1985), “Oligonucleotide Synthesis: A Practical Approach”, IRL Press; Gait, M. J. (1990), “Oligonucleotide Synthesis: A Practical Approach”, IRL Press; Eckstein, F. (1991), “Oligonucleotides and Analogues: A Practical Approach”, IRL Press; Adams, R. L. et al. (1992), “The Biochemistry of the Nucleic Acids”, Chapman & Hall; Shabarova, Z. et al. (1994), “Advanced Organic Chemistry of Nucleic Acids”, Weinheim; Blackburn, G. M. et al. (1996), “Nucleic Acids in Chemistry and Biology”, Oxford University Press; Hermanson, G. T. (1996), “Bioconjugate Techniques”, Academic Press; and the like. Relevant portions (or possibly the entirety) of each of these publications are herein incorporated by reference.

(RNAi)

As used herein, the term “RNAi” is an abbreviation of RNA interference and refers to a phenomenon where an agent for causing RNAi, such as double-stranded RNA (also called dsRNA), is introduced into cells and mRNA homologous thereto is specifically degraded, so that synthesis of gene products are suppressed, and a technique using the phenomenon. As used herein, RNAi may have the same meaning as that of an agent which causes RNAi.

As used herein, the term “an agent causing RNAi” refers to any agent capable of causing RNAi. As used herein, “an agent causing RNAi of a gene” indicates that the agent causes RNAi relating to the gene and the effect of RNAi is achieved (e.g., suppression of expression of the gene, and the like). Examples of such an agent causing RNAi include, but are not limited to, a sequence having at least about 70% homology to the nucleic acid sequence of a target gene or a sequence hybridizable under stringent conditions, RNA containing a double-stranded portion having a length of at least 10 nucleotides or variants thereof. Here, this agent may be preferably DNA containing a 3′ protruding end, and more preferably the 3′ protruding end has a length of 2 or more nucleotides (e.g., 2-4 nucleotides in length).

Though not wishing to be bound by any theory, a mechanism which causes RNAi is considered to be as follows. When a molecule which causes RNAi, such as dsRNA, is introduced into a cell, an RNaseIII-like nuclease having a helicase domain (called dicer) cleaves the molecule on about a 20 base pair basis from the 3′ terminus in the presence of ATP in the case where the RNA is relatively long (e.g., 40 or more base pairs). As used herein, the term “siRNA” is an abbreviation of short interfering RNA and refers to short double-stranded RNA of 10 or more base pairs which are artificially chemically synthesized or biochemically synthesized, synthesized in the organism body, or produced by double-stranded RNA of about 40 or more base pairs being degraded within the organism. siRNA typically has a structure having 5′-phosphate and 3′-OH, where the 3′ terminus projects by about 2 bases. A specific protein is bound to siRNA to form RISC (RNA-induced-silencing-complex). This complex recognizes and binds to mRNA having the same sequence as that of siRNA and cleaves mRNA at the middle of siRNA due to RNaseIII-like enzymatic activity. It is preferable that the relationship between the sequence of siRNA and the sequence of mRNA to be cleaved as a target is a 100% match. However, base mutations at a site away from the middle of siRNA do not completely remove the cleavage activity by RNAi, leaving partial activity, while base mutations in the middle of siRNA have a large influence and the mRNA cleavage activity by RNAi is considerably lowered. By utilizing such a nature, only mRNA having a mutation can be specifically degraded. Specifically, siRNA in which the mutation is provided in the middle thereof is synthesized and is introduced into a cell. Therefore, in the present invention, siRNA per se as well as an agent capable of producing siRNA (e.g., representatively dsRNA of about 40 or more base pairs) can be used as an agent capable of eliciting RNAi.

Also, though not wishing to be bound by any theory, apart from the above-described pathway, the antisense strand of siRNA binds to mRNA such that the siRNA functions as a primer for RNA-dependent RNA polymerase (RdRP), so that dsRNA is synthesized. This dsRNA is a substrate for a dicer, leading to production of new siRNA. It is intended that such an action is amplified. Therefore, in the present invention, siRNA per se and an agent capable of producing siRNA are useful. In fact, in insects and the like, for example, 35 dsRNA molecules can completely degrade 1,000 or more copies of intracellular mRNA, and therefore, it will be understood that siRNA per se as well as an agent capable of producing siRNA are useful.

In the present invention, double-stranded RNA having a length of about 20 bases (e.g., representatively about 21 to 23 bases) or less than about 20 bases, which is called siRNA, can be used. Expression of siRNA in cells can suppress expression of a pathogenic gene targeted by the siRNA. Therefore, siRNA can be used for treatment, prophylaxis, prognosis, and the like of diseases.

The siRNA of the present invention may be in any form as long as it can elicit RNAi.

In another embodiment, an agent capable of causing RNAi may have a short hairpin structure having a sticky portion at the 3′ terminus (shRNA; short hairpin RNA). As used herein, the term “shRNA” refers to a molecule of about 20 or more base pairs in which a single-stranded RNA partially contains a palindromic base sequence and forms a double-strand structure therein (i.e., a hairpin structure). shRNA can be artificially chemically synthesized. Alternatively, shRNA can be produced by linking sense and antisense strands of a DNA sequence in reverse directions and synthesizing RNA in vitro with T7 RNA polymerase using the DNA as a template. Though not wishing to be bound by any theory, it should be understood that after shRNA is introduced into a cell, the shRNA is degraded in the cell into a length of about 20 bases (e.g., representatively 21, 22, 23 bases) and causes RNAi in the same manner as siRNA, leading to the treatment effect of the present invention. It should be understood that such an effect is exhibited in a wide range of organisms, such as insects, plants, animals (including mammals), and the like. Thus, shRNA elicits RNAi in the same manner as siRNA and therefore can be used as an effective component of the present invention. shRNA may preferably have a 3′ protruding end. The length of the double-stranded portion is not particularly limited, but is preferably about 10 or more nucleotides, and more preferably about 20 or more nucleotides. Here, the 3′ protruding end may be preferably DNA, more preferably DNA of at least 2 nucleotides in length, and even more preferably DNA of 2-4 nucleotides in length.

An agent capable of causing RNAi used in the present invention may be artificially synthesized (chemically or biochemically) or naturally occurring. There is substantially no difference therebetween in terms of the effect of the present invention. A chemically synthesized agent is preferably purified by liquid chromatography or the like.

An agent capable of causing RNAi used in the present invention can be produced in vitro. In this synthesis system, T7 RNA polymerase and T7 promoter are used to synthesize antisense and sense RNAs from template DNA. These RNAs are annealed and thereafter are introduced into a cell. In this case, RNAi is caused via the above-described mechanism, thereby achieving the effect of the present invention. Here, for example, the introduction of RNA into cell can be carried out by a calcium phosphate method.

Another example of an agent capable of causing RNAi according to the present invention is a single-stranded nucleic acid hybridizable to mRNA or all nucleic acid analogs thereof. Such agents are useful for the method and composition of the present invention.

(Set Theory)

As mentioned above, the term “set theory” refers to a theory as used and understood in the art and the branch of pure mathematics, that deals with the nature and relationships of sets. Many mathematicians use set theory as the basis for all other mathematics. Such set theory includes the analysis of objects (“elements or “members”) into sets (aggregates or collections) and classifying these sets into inclusion, independent and intersection, and the like. Set theory is well known in the art and one skilled in the art can refer to Cantor, G., 1932, Gesammelte Abhandlungen, Berlin: Springer-Verlag; Ulam, S., 1930, ‘Zur Masstheorie in der allgemeinen Mengenlehre’, Fund. Math., 16, 140-150; Gödel, K., 1940, ‘The consistency of the axiom of choice and the generalized continuum hypothesis’, Ann. Math. Studies, 3; Scott, D., 1961, ‘Measurable cardinals and constructible sets’. Bull. Acad. Pol. Sci., 9, 521-524; Cohen, P., 1966, Set theory and the continuum hypothesis, New York: Benjamin; Jensen, R., 1972, ‘The fine structure of the constructible hierarchy’, Ann. Math. Logic, 4, 229-308; Martin, D. and Steel, J., 1989, ‘A proof of projective determinacy’, J. Amer. Math. Soc., 2, 71-125; Hrbacek, K. and Jech, T., 1999, Introduction to Set Theory, New York: Marcel Dekker, Inc. http://plato.stanford.edu/entries/set-theory/primer.html and the like.

The language of set theory is based on a single fundamental relation, called membership. We say that A is a member of B (in symbols A∈B), or that the set B contains A as its element. The understanding is that a set is determined by its elements. In other words, two sets are deemed equal if they have exactly the same elements. In practice, one considers sets of numbers, sets of points, sets of functions, sets of other sets and so on. In theory, it is not necessary to distinguish between objects. One only need to consider sets.

Using the membership relation, one can derive other concepts usually associated with sets, such as unions and intersections of sets. For example, a set C is the union of two sets A and B if its members are exactly those objects that are either members of A or members of B. The set C to uniquely determined, because we have specified what its elements are. There are more complicated operations on sets that can be defined in the language of set theory (i.e. using only the relation ∈), and we shall not concern ourselves with those. Let us mention another operation: the (unordered) pair {A, B} has as its elements exactly the sets A and B. (If it happens that A=B, then the “pair” has exactly one member, and is called a singleton {A}.) By combining the operations of union and pairing, one can produce from any finite list of sets the set that contains these sets as members: {A,B,C,D, . . . ,K,L,M}. It should also be mentioned that the empty set, the set that has no elements. (The empty set is uniquely determined by this property, as it is the only set that has no elements—this is a consequence of the understanding that sets are determined by their elements.). When dealing with sets informally, such operations on sets are self-evident; with the axiomatic approach, it is postulated that such operations can be applied: for instance, one postulates that for any sets A and B, the set {A,B} exists. In order to endow set theory with sufficient expressive power one needs to postulate more general construction principles than those alluded to above. The guiding principle is that any objects that can be singled out can be collected into a set.

If a and b are sets, then the unordered pair {a, b} is a set whose elements are exactly a and b. The “order” in which a and b are put together plays no role; {a, b}={b, a}. For many applications, it is necessary to pair a and b in such a way that one can “read off” which set comes “first” and which comes “second.” It is denoted that this ordered pair of a and b by (a, b); a is the first coordinate of the pair (a, b), b is the second coordinate.

As any object of our study, the ordered pair has to be a set. It should be defined in such a way that two ordered pairs are equal if and only if their first coordinates are equal and their second coordinates are equal. This guarantees in particular that (a, b)≠(b,a) if a≠b.

Definition. (a, b)=({{a}, {a, b}}.

If a≠b, (a, b) has two elements, a singleton {a} and an unordered pair {a, b}. The first coordinate can be found by looking at the element of {a}. The second coordinate is then the other element of {a, b}. If a=b, then (a, a)={{a}, {a,a}}={{a}} has only one element. In any case, it seems obvious that both coordinates can be uniquely “read off” from the set (a, b). This statement is made precise in the following theorem.

Theorem. (a, b)=(a′, b′) if and only if a=a′ and b=b′.

Proof. If a=a′ and b=b′, then, of course, (a, b)={{a}, {a, b}}={{a′}, {a′, b′}}=(a′,b′). The other implication is more intricate. Let us assume that {{a}, {a, b}}={{a′}, {a′, b′}}. If a≠b, {a}={a′} and {a, b}={a′, b′}. So, first, a=a′ and then {a, b}={a, b′} implies b=b′. If a=b, {{a}, {a, a}}={{a}}. So {a}={a′}, {a}={a′,b′}, and we get a=a′=b′, so a=a′ and b=b′ holds in this case, too.

With ordered pairs at our disposal, ordered triples can be defined:
(a, b, c)=((a, b), c),
ordered quadruples
(a, b, c, d)=((a, b, c), d),

and so on. Also, ordered “one-tuples” can be defined.
(a)=a.

A binary relation is determined by specifying all ordered pairs of objects in that relation; it does not matter by what property the set of these ordered pairs is described. We are led to the following definition.

Definition. A set R is a binary relation if all elements of R are ordered pairs, i.e., if for any z∈R there exist x and y such that z=(x, y).

It is customary to write xRy instead of (x, y)∈R. We say that x is in relation R with y if xRy holds.

The set of all x which are in relation R with some y is called the domain of R and denoted by “dom R.” So dom R={x| there exists y such that xRy}. dom R is the set of all first coordinates of ordered pairs in R.

The set of all y such that, for some x, x is in relation R with y is called the range of R, denoted by “ran R.” So ran R={y| there exists x such that xRy}.

Function, as understood in mathematics, is a procedure or a rule, assigning to any object a from the domain of the function a unique object, b, the value of the function at a. A function, therefore, represents a special type of relation, a relation where every object, a, from the domain is related to precisely one object in the range, namely, to the value of the function at a.

Definition. A binary relation F is called a function (or mapping, correspondence) if aFb1 and aFb2 imply b1=b2 for any a, b1, and b2. In other words, a binary relation F is a function if and only if for every a from dom F there is exactly one b such that aFb. This unique b is called the value of F at a and is denoted F(a) or Fa. [F(a) is not defined if a dom F.] If F is a function with dom F=A and ran F⊂B, it is customary to use the notations F: A B, <F(a)|a∈A>, <Fa|a∈A>, <Fa>a∈A for the function F. The range of the function F can then be denoted {F(a)|a∈A} or {Fa}a∈A.

The Axiom of Extensionality can be applied to functions as follows.

Lemma. Let F and G be functions. F=G if and only if dom F=dom G and F(x)=G(x) for all x∈dom F.

A function f is called one-to-one or injective if a1∈dom f, a2∈C dom f, and a1≠a2 implies f(a1≠f(a2). In other words if a1∈dom f, a 2∈dom f, and f(a1)=f(a2), then a1=a2.

In order to develop mathematics within the framework of the axiomatic set theory, it is necessary to define natural numbers. Natural numbers are known intuitively: 0, 1, 2, 3, . . . , 15, . . . , 515, etc., and examples of sets having zero, one, two, or three elements can be easily given.

To define number 0, a representative of all sets having no elements is chosen. However, this is easy, since there is only one such set. 0=Ø is defined. Let us proceed to sets having one element (singletons): {Ø}, {{Ø}}, {{Ø, {Ø}}}; in general, {x}. A representative can be chosen as follows: Since we already defined one particular object, namely 0, a natural choice is {0}. So It to defined:
1{0}={Ø}.

Next sets with two elements are considered: {Ø, {Ø}}, {{Ø}, {Ø, {Ø}}}, {{Ø}, {{Ø}}}, etc. By now, defined 0 and 1 have been defined, and 0≠1. A particular two-element set is singled out, the set whose elements are the previously defined numbers 0 and 1:
2={0,1}={Ø, {Ø}}.

It should begin to be obvious how the process continues:
3={0, 1, 2}={Ø, {Ø}, {Ø,{Ø}}}
4={0, 1, 2, 3}={Ø,{Ø}, {Ø,{Ø}}, {Ø, {Ø}, {Ø, {Ø}}}}
5={0, 1, 2, 3, 4}etc.

The idea is simply to define a natural number n as the set of all smaller natural numbers: {0, 1, . . . , n−1}. In this way, n is a particular set of n elements.

This idea still has a fundamental deficiency. 0, 1, 2, 3, 4, and 5 have been defined and could easily define 15 and not so easily 515. But no list of such definitions tells us what a natural number is in general. A statement of the form is necessary: A set n is a natural number if . . . . We cannot just say that a set n is a natural number if its elements are all the smaller natural numbers, because such a “definition” would involve the very concept being defined.

The construction of the first few numbers is observed again. We defined 2={0, 1}. To get 3, we had to adjoin a third element to 2, namely, 2 itself:
3=2∪{2}={0, 1}∪{2}.

Similarly,
4=3∪{3}={0, 1, 2}∪{3},
5=4∪{4},etc.

Given a natural number n, we get the “next” number by adjoining one more element to n, namely, n itself. The procedure works even for 1 and 2: 1=0∪{0}, 2=1∪{1}, but, of course, not for 0, the least natural number.

These considerations suggest the following.

Definition. The successor of a set x is the set S(x)=x∪{x}.

Intuitively, the successor S(n) of a natural number n is the “one bigger” number n+1. We use the more suggestive notation n+1 for S(n) in what follows. We later define addition of natural numbers (using the notion of successor) in such a way that n+1 indeed equals the sum of n and 1. Until then, it is just a notation, and no properties of addition are assumed or implied by it.

It can now be summarized the intuitive understanding of natural numbers as follows:
1. 0 is a natural number.
2. If n is a natural number, then its successor n+1 is also a natural number.
3. All natural numbers are obtained by application of (a) and (b), i.e., by starting with 0 and repeatedly applying the successor operation: 0, 0+1=1, 1+1=2, 2+1=3, 3+1=4, 4+1=5, . . . etc.

Definition. A set I is called inductive if
1. 0∈I.
2. If n∈I, then (n+1)∈I.

An inductive set contains 0 and, with each element, also its successor. According to (c), an inductive set should contain all natural numbers. The precise meaning of (c) is that the set of natural numbers is an inductive set which contains no other elements but natural numbers, i.e., it is the smallest inductive set. This leads to the following definition.

Definition. The set of all natural numbers is the set
={x|x∈I for every inductive set I}.

The elements of the set are called natural numbers. Thus a set x is a natural number if and only if it belongs to every inductive set.

From the point of view of pure set theory, the most basic question about a set is: How many elements does it have? It is a fundamental observation that we can define the statement “sets A and B have the same number of elements” without knowing anything about numbers.

Definition. Sets A and B have the same cardinality if there is a one-to-one function f with domain A and range B. We denote this by |A|=|B|.

Definition. The cardinality of A is less than or equal to the oardinality of B (notation: |A|=|B|) if there is a one-to-one mapping of A onto B.

Notice that |A|=|B| means that |A|=|C| for some subset C of B. We also write |A|<|B| to mean that |A|=|B| and not |A|=|B|, i.e., that there is a one-to-one mapping of A onto a subset of B, but there is no one-to-one mapping of A onto B.

Lemma.
1. If |A|=|B| and |A|=|C|, then |C|=|B|.
2. If |A|=|B| and |B|=|C|, then |A|=|C|.
3. |A|=|A|.
4. If |A|=|B | and |B|=|C|, then |A|=|C|.

Cantor-Bernstein Theorem. If |X|=|Y| and |Y|=|X|, then |X|=|Y|.

Finite sets can be defined as those sets whose size is a natural number.

Definition. A set, S, is finite if it has the same cardinality as some natural number, n. We then define |S|=n and say that S has n elements. A set is infinite if it is not finite.

As described above, set theory can be applied to an analysis of the present invention.

For example, a test result can be summarized in an Excel(trademark)-format file, in which functional reporters such as transcriptional factor reporters, and perturbation agents such as siRNA's are plotted in an x-y format, and the value corresponding to each combination thereof is filled therein. The actual value may be compared to a standard value, or a threshold of interest such as a result obtained by using a scrambled siRNA. The values may be normalized into three values such as +, 0 and −. The values are evaluated, for example, when 80% or less of the threshold, it is normalized to “−1”, and when between 80% and 120% of the threshold, it is normalized to “0”, and when 120% or more of the threshold, it is normalized to “+1”. The normalized or degenerated matrix may be used to analyze the effects of perturbation agents (such as siRNA's) on reporters in a simpler manner, and to obtain a set of perturbation agents giving effects on each of the reporters. An exemplary table is shown below.

before normalization

| | Function 1 | Function 2 | Function 3 | Function 4 |
|---|---|---|---|---|
| siRNA 1 | 70% | 120% | 80% | 75% |
| siRNA 2 | 115% | 100% | 65% | 130% |
| siRNA 3 | 150% | 90% | 105% | 115% |

after normalization

| | Function 1 | Function 2 | Function 3 | Function 4 |
|---|---|---|---|---|
| siRNA 1 | −1 | +1 | −1 | −1 |
| siRNA 2 | 0 | 0 | −1 | +1 |
| siRNA 3 | +1 | 0 | 0 | 0 |

### DESCRIPTION OF PREFERRED EMBODIMENTS

Hereinafter, the present invention will be described by way of embodiments. Embodiments described below are provided only for illustrative purposes. Accordingly, the scope of the present invention is not limited by the embodiments except as by the appended claims.

In one aspect, the present invention provides a method for analyzing a network of biological functions in a biological entity. The present method comprises the steps of: A) subjecting a biological entity to at least one perturbation agent; B) obtaining information on at least two functional reporters in said biological entity, wherein the functional reporters reflect a biological function; and C) subjecting the obtained information to set theory processing to calculate a relationship between the functional reporters to generate a network relationship of the biological functions.

The step of subjecting a biological entity to at least one perturbation agent, may be conducted in any manner as long as the perturbation agent is conducted to the entity and attains the effects of interest, and is dependent on the type of perturbation used.

The step of obtaining information on at least two functional reporters may be conducted in any manner as long as signals of such reporters can be measured. Preferably, reporters emit measurable signals such as light, fluorescence, protein expression and the like, when a perturbation agent has an effect. Therefore, preferably, the functional reporter is capable of transmitting a measurable signal.

So long set theory can be conducted, the step of subjecting the data to set theory can be conducted.

Preferably, a biological entity used in the present invention is a cell.

Perturbation agents used in the present invention may be any agents which give a perturbation or a change to a biological entity or a system such as RNA including siRNA, shRNA, miRNA, and ribozyme, chemical compound, cDNA, antibody, polypeptides, light, sound, pressure change, radiation, heat, gas, and the like, preferably a siRNA capable of specifically regulating a function of said functional reporter.

Functional reporters used in the present invention include but are not limited to transcriptional factors, regulatory genes, structural genes, cellular markers, cell surface markers, cell shapes, organelle shapes, cell mobility, enzyme activities, metabolite concentrations, and localization of cellular components.

In a specific embodiment, the set theory processing used in the present invention may be conducted by classifying two specific functional reporters of at least two said functional reporters into a relationship selected from the group consisting of a) independent, b) inclusion, and c) intersection, wherein when it is determined to be independent, the two specific functional reporters are determined to have no relationships in the network; when it is determined to be inclusion, one of the two specific functional reporters is determined to be included in the other of the two specific functional reporters and located downstream of the other; when it is determined to be intersection, the two specific functional reporters are determined to be located downstream branched from another common function.

In the present invention, any mathematical process of set theory can be used as long as sets can be analyzed according to set theory. In a specific embodiment of the present invention, the set theory processing comprises the step of mapping the absence or presence of a response by said perturbation agent per said functional reporter.

In a specific embodiment of the present invention, the set theory processing can comprise a calculation of a relationship between the reporters is comprising correlation between each functional reporter as classified into independent, inclusion and intersection to generate a summary of the correlation. This calculation can be conducted by using a matrix.

In a preferable embodiment of the present invention, the perturbation factors used in the present invention are advantageously prepared such that the number of perturbation factors sufficient for equally targeting an intracellular pathway. In the present invention, two or more perturbation agents are usually used to change the network structure of a biological entity such as a cell. It is preferable to use equally targeting perturbation agents. Basic elements constituting biological functions are changes in networks such as a molecular network in response to the circumstantial stimulation. In other words, although not wishing bound to any particular theory, it is considered that the existence of diversity in biological functions show that such networks in a biological entity such as a cell have also diversity, therefore, in order to investigate M changes in a state of a biological entity such as a cell, N perturbation agents can be given to the biological entity to allow network analysis such as molecular network analysis, or an analysis of the number of the states, which have diversity. Furthermore, when analysis is conducted with respect to a fixed M, sufficient number of perturbation agents, N, is used so that the number of cases (or the number of combinations) is preferably sufficient analysis for network analysis, such as an intracellular network analysis. Moreover, equally targeting perturbation agents are considered to cause changes in network structure without causing biased effects on the network. Therefore, such equally targeting perturbation agents are preferably used, and more preferably the number of such perturbation agents is used. Such a number will be readily understood by those skilled in the art from the disclosure of the present specification.

The information on at least two functional reporters as analyzed in the present invention may be based on an effect of said perturbation agent after a desired time. As used herein such a desired time may be selected depending on the circumstances, purposes and the like of the analysis to be conducted. For example, when effects of agents on a cell are observed, tens of minutes to a couple of hours, or up to several days may usually be used.

In a specific embodiment, the effect obtained by the perturbation agents used can be classified into the following three groups in terms of a threshold value: positive effect=+ (preferably +1); no effect=0; and negative effect=− (preferably −1).

In a preferable embodiment of the present invention, the information on at least two functional reporters is based on an effect of the perturbation agent after a desired time; wherein the set theory processing comprises: a) classifying the information into three categories by comparing the effect with a threshold value for the functional reporter and classifying them into the following three groups: positive effect=+ (preferably +1); no effect=0; and negative effect=− (preferably −1); b) determining if two out of the functional reporters have a common perturbation agent, wherein the common perturbation agent has the same type of effect, and if there is no such common perturbation agent, then the two functions corresponding to the two functional reporters are located under different perturbation agents and if there is such a common perturbation agent, then the following step c) is conducted: c) determining if the perturbation agent set for one function of the two functions is completely included into the perturbation agent set for the other function of the two functions, and if this is the case, then one function having the bigger set is located downstream of the other function having the smaller set, and if this is not the case, then the two functions are located in parallel under the same perturbation agents; d) determining if all combinations of the functional reporters are investigated, if this is the case, then integrate all the relationships of functions to present a global perturbation effects network, and if this is not the case then repeat the steps a) to c). These steps can be conducted on a computer equipped with a computer program implementing the process and steps of interest.

In a preferable embodiment of the present invention, said steps of a) to c) are calculated by producing M×N matrix, wherein M refers to the number of functional reporters and N refers to the number of perturbation agents. By using such a matrix, the set theory can be easily processed by a normal matrix calculation process.

In a further embodiment of the present invention, the present invention may further comprise analyzing the generated network by conducting an actual biological experiment. Preferably, such an analysis comprises the use of a regulation agent such as siRNA, antibody, antisense oligonucleotide, inhibitor, activator, ligand, receptors and the like, specific to the function. Preferably, siRNA is used.

The present invention can be used for analyzing networks such as a signal transduction pathway, a cellular pathway and the like.

The present invention is useful for identification of a biomarker, analysis of a drug target, analysis of a side effect, diagnosis of a cellular function, analysis of a cellular pathway, evaluation of a biological effect of a compound, and diagnosis of an infectious disease and the like.

In another aspect of the present invention, the present invention provides a system for analyzing a network of biological functions in a biological entity, comprising: A) at least one perturbation agent for a biological entity; B) means for obtaining information on at least two functional reporters in said biological entity, wherein the functional reporters reflect a biological function; and C) means for subjecting the obtained information to set theory processing to calculate a relationship between the functional reporters to generate a network relationship of the biological functions. In a system of the present invention, perturbation agents may be supplied separately. Therefore, in an embodiment, the present invention merely comprises B) means for obtaining information on at least two functional reporters in said biological entity, wherein the functional reporters reflect a biological function; and C) means for subjecting the obtained information to set theory processing to calculate a relationship between the functional reporters to generate a network relationship of the biological functions.

Means for obtaining information on at least two functional reporters in said biological entity, wherein the functional reporters reflect a biological function, may be provided as a transfection array, but the present invention is not limited to this. Such a transfection array is extensively described elsewhere herein and exemplified in the following Examples.

Means for subjecting the obtained information to set theory processing to calculate a relationship between the functional reporters to generate a network relationship of the biological functions, may be provided as a computer program but the present invention is not limited to this. As set theory is known in the art, it is understood that any computer program implementing such a calculation based on set theory can be used in the present invention.

It should be noted that those skilled in the art will understand that any other specific embodiments of the method as described hereinabove may be employed and are applicable to a system of the present:invention if necessary.

In a further aspect of the present invention, the present invention provides a computer program for implementing in a computer, a method for analyzing a network of biological functions in a biological entity, comprising the steps of: A) subjecting a biological entity to at least one perturbation agent; B) obtaining information on at least two functional reporters in said biological entity, wherein the functional reporters reflect a biological function; and C) subjecting the obtained information to set theory processing to calculate a relationship between the is functional reporters to generate a network relationship of the biological functions.

It should be noted that those skilled in the art will understand that any other specific embodiments of the method and system as described hereinabove may be employed and are applicable to a computer program of the present invention if necessary.

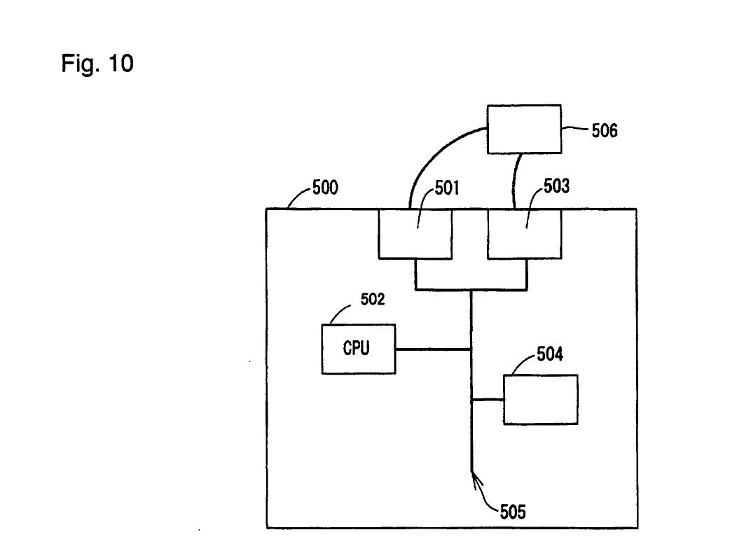

A configuration of a computer or system for implementing a method of the present invention for analyzing a network of biological functions in a biological entity is shown in FIG. 10. FIG. 10 shows an exemplary configuration of a computer 500 for executing the cellular state presenting method of the present invention.

The computer 500 comprises an input section 501, a CPU 502, an output section 503, a memory 504, and a bus 505. The input section 501, the CPU 502, the output section 503, and the memory 504 are connected via a bus 505. The input section 501 and the output section 503 are connected to an I/O device 506.

An outline of a process for presenting a state of a cell, which is executed by the computer 500, will be described below.

A program for executing a method for analyzing a network of biological functions in a biological entity is stored in, for example, the memory 502. Alternatively, information necessary for the method may be stored in any type of recording medium, such as a floppy disk, MO, CD-ROM, CD-R, DVD-ROM, or the like separately or together. Alternatively, the program may be stored in an application server. The information or data stored in such a recording medium is loaded via the I/O device 506 (e.g., a disk drive, a network (e.g., the Internet)) to the memory 504 of the computer 500. The CPU 502 executes the cellular state presenting program, so that the computer 500 functions as a device for performing a method of the present invention for analyzing a network of biological functions in a biological entity.

Information about a cell or the like is input via the input section 501 as well as data obtained. Known information may be input as appropriate.

The CPU 502 generates display data based on the information about data and cells through the input section 501, and stored the display data into the memory 504. Thereafter, the CPU 502 may store the information in the memory 504. Thereafter, the output section 503 outputs a network analyzed by the CPU 502 as display data. The output data is output through the I/O device 506.

In still different aspect of the present invention, the present invention provides that a storage medium comprising a computer program for implementing in a computer, a method for analyzing a network of biological functions in a biological entity, comprising the steps of: A) subjecting a biological entity to at least one perturbation agent; B) obtaining information on at least two functional reporters in said biological entity, wherein the functional reporters reflect a biological function; and C) subjecting the obtained information to set theory processing to calculate a relationship between the functional reporters to generate a network relationship of the biological functions.

It should be noted that those skilled in the art will understand that any other specific embodiments of the method, system and computer program as described hereinabove may be employed and are applicable to a storage medium of the present invention if necessary. Such a storage medium may be any type of recording medium, such as CD-ROMs, flexible disks. CD-Rs, CD-RWs, MOs, mini disks, DVD-ROMs, DVD-Rs, memory sticks, hard disks, and the like.

In yet still further aspect of the present invention, the present invention provides a transmission medium comprising a computer program for implementing in a computer, a method for analyzing a network of biological functions in a biological entity, comprising the steps of: A) subjecting a biological entity to at least one perturbation agent; B) obtaining information on at least two functional reporters in said biological entity, wherein the functional reporters reflect a biological function; and C) subjecting the obtained information to set theory processing to calculate a relationship between the functional reporters to generate a network relationship of the biological functions.

It should be noted that those skilled in the art will understand that any other specific embodiments of the method, system, computer program and storage medium as described hereinabove may be employed and are applicable to a transmission medium of the present invention if necessary. Examples of such a transmission medium include, but are not limited to, networks, such as intranets, the Internet, and the like.

The preferred embodiments of the present invention have been heretofore described for a better understanding of the present invention. Hereinafter, the present invention will be described by way of examples. Examples described below are provided only for illustrative purposes. Accordingly, the scope of the present invention is not limited except as by the appended claims. According to the examples below, it will be understood that those skilled in the art can select cells, supports, biological factors, salts, positively charged substances, negatively charged substances, actin acting substances, and the like, as appropriate, and can make or carry out the present invention.

### EXAMPLES

Hereinafter, the present invention will be described in greater detail by way of examples, though the present invention is not limited to the examples below. Reagents, supports, and the like were commercially available from Sigma (St. Louis, USA), Wako Pure Chemical Industries (Osaka, Japan), Matsunami Glass (Kishiwada, Japan) unless otherwise specified.

### Example 1

### Reagents

Formulations below were prepared in Example 1. Fibronectin and the like were commercially available. Fragments and variants were obtained by genetic engineering is techniques:
1) fibronectin (SEQ ID NO: 52);
2) ProNectin F (Sanyo Chemical Industries, Kyoto, Japan);
3) ProNectin L (Sanyo Chemical Industries);
4) ProNectin Plus (Sanyo Chemical Industries);
5) gelatin.

Plasmids were prepared as DNA for transfection, Plasmids, pEGFP-N1, pDsRed2-N1 and other transcriptional factors and kinase encoding gene-containing plasmids (available from BD Biosciences, Clontech, CA, USA) were used. In these plasmids, gene expression was under the control of cytomegalovirus (CMV). The plasmid DNA was amplified in E. coli (XL1 blue, Stratagene, TX, USA) and the amplified plasmid DNA was used as a complex partner. The DNA was dissolved in distilled water free from DNase and RNase.

shRNA and/or siRNA were also prepared according to the known technology.

The following transfection reagents were used: Effectene Transfection Reagent (cat. no. 301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA). LipofectAMINE 2000 Reagent (11668-019, Invitrogen corporation, CA), JetPEI (×4) conc. (101-30, Polyplus-transfection, France), and ExGen 500 (R0511, Fermentas Inc., MD). These transfection reagents were added to the above-described DNA and actin acting substance in advance or complexes thereof with the DNA were produced in advance.

The thus-obtained solution was used in assays using transfection arrays described below.

### Example 2

### Transfection Array—Demonstration Using Mesenchymal Stem Cells

In Example 2, the transfection efficiency of the solid phase was observed. The protocol used in Example 2 will be described below.

(Protocol)

The final concentration of DNA was adjusted to 1 μg/μL. An actin acting substance was preserved as a stock having a concentration of 10 μg/μL in ddH₂O. All dilutions were made using PBS. ddH₂O, or Dulbecco's MEM. A series of dilutions, for example, 0.2 μg/μL, 0.27 μg/μL, 0.4 μg/μL, 0.53 μg/μL, 0.6 μg/μL, 0.8 μg/μL, 1.0 μg/μL, 1.07 μg/μL , 1.33 μg/μL, and the like, were formulated.

Transfection reagents were used in accordance with instructions provided by each manufacturer.

Plasmid DNA was removed from a glycerol stock and amplified in 100 mL L-amp overnight. Qiaprep Miniprep or Qiagen Plasmid Purification Maxi was used to purify DNA in accordance with a standard protocol provided by the manufacturer.

In Example 2, the following 5 cells were used to confirm an effect: human mesenchymal stem cell (hMSCs, PT-2501, Cambrex BioScience Walkersville, Inc., MD): human embryonic renal cell (HEK293, RCB1637, RIKEN Cell Bank, JPN); NIH3T3-3 cell (RCB0150, RIKEN Cell Bank, JPN): HeLa cell (RC0007, RIKEN Cell Bank, JPN); and HepG2(RCB1648, RIKEN Cell Bank, JPN). These cells were cultured in DMEM/10% IFS containing L-glut and pen/strep.

(Dilution and DNA Spots)

Transfection reagents and DNA were mixed to form a DNA-transfection reagent complex. The complex formation requires a certain period of time. Therefore, the mixture was spotted onto a solid phase support (e.g., a poly-L-lysine slide) using an arrayer. In Example 2, as a solid phase support, an APS slide, a MAS slide, and an uncoated slide were used as well as a poly-L-lysine slide. These slides are available from Matsunami Glass (Kishiwada, Japan) or the like.

For complex formation and spot fixation, the slides were dried overnight in a vacuum dryer. Drying was performed in the range of 2 hours to 1 week.

Although the fibronectin and the like might be used during the complex formation, it was also used immediately before spotting in Example 2.

(Formulation of Mixed Solution and Application to Solid Phase Supports)

300 μL of DNA concentrated buffer (EC buffer) +16 μL of an enhancer were mixed in an Eppendorf tube. The mixture was mixed with a Vortex, followed by incubation for 5 minutes. 50 μL of a transfection reagent (Effectene, etc.) was added to the mixture, followed by mixing by pipetting. To apply a transfection reagent, an annular wax barrier was formed around the spots on the slide. 366 μL of the mixture was added to the spot region surrounded by the wax, followed by incubation at room temperature for 10 to 20 minutes. Thereby, the fixation to the support was manually achieved.

(Distribution of Cells)

Next, a protocol for adding cells will be described. Cells were distributed for transfection. The distribution was typically performed by reduced-pressure suction in a hood. A slide was placed on a dish, and a solution containing cells was added to the dish for transfection. The cells were distributed as follows.

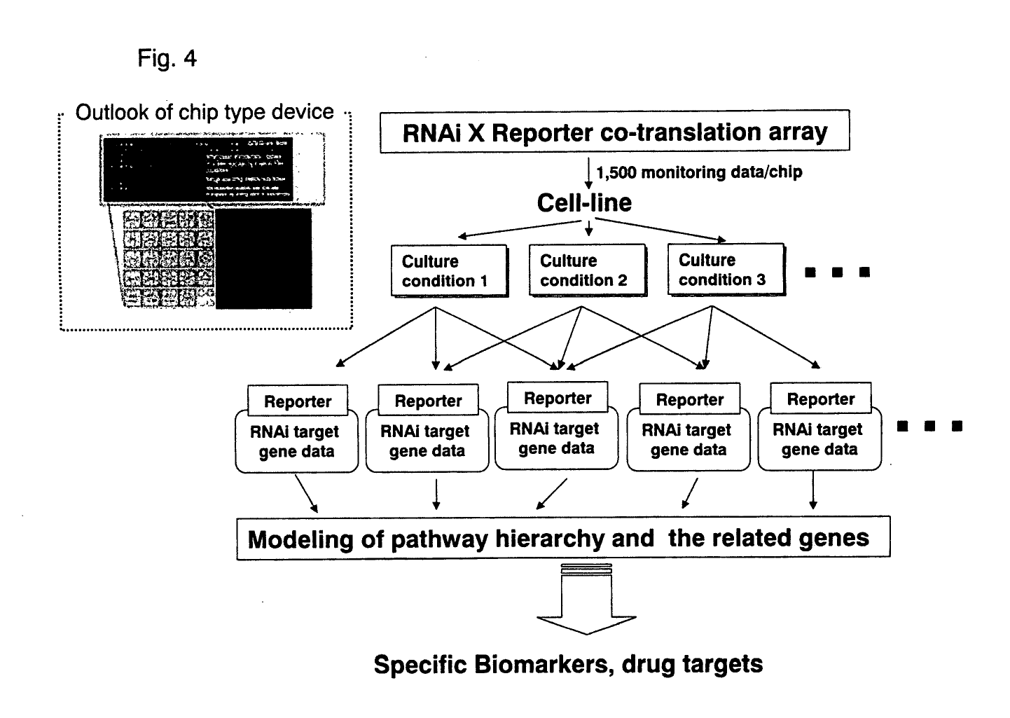

The growing cells were distributed to a concentration of 10⁷ cells/25 mL. The cells were plated on the slide in a 100×100×15 mm squared Petri dish or a 100 mm (radius)×15 mm circular dish. Transfection was conducted for about 40 hours. This period of time corresponded to about 2 cell cycles. The slide was treated for immunofluorescence. See FIG. 4, upper left panel for an example of an array.

(Evaluation of Gene Introduction)

Gene introduction was evaluated by detection using, for example, immunofluorescence, fluorescence microscope examination, laser scanning, radioactive labels, and sensitive films, or emulsion.

When an expressed protein to be visualized is a fluorescent protein, such a protein can be observed with a fluorescence microscope and a photograph thereof can be taken. For large-sized expression arrays, slides may be scanned using a laser scanner for storage of data. If an expressed protein can be detected using fluorescence antibodies, an immunofluorescence protocol can be successively performed. If detection is based on radioactivity, the slide may be adhered as described above, and autoradiography using film or emulsion can be performed to detect radioactivity.

(Laser Scanning and Quantification of Fluorescence Intensity)

To quantify transfection efficiency, the present inventors use a DNA microarray scanner (GeneTAC UC4×4, Genomic Solutions Inc., MI). Total fluorescence intensity (arbitrary unit) was measured, and thereafter, fluorescence intensity per unit surface area was calculated.

(Cross-sectional Observation by Confocal Scanning Microscope)

Cells were seeded on tissue culture dishes at a final concentration of 1×10⁵ cells/well and cultured in appropriate medium (Human Mesenchymal Cell Basal Medium (MSCGM BulletKit PT-3001, Cambrex BioScience Walkersville, Inc., MD). After fixation of the cell layer with 4% paraformaldehyde solution, SYTO and Texas Red-X phalloidin (Molecular Probes Inc., OR, USA) was added to the cell layer for observation of nuclei and F-actin. The samples emitting light due to gene products and the stained samples were observed with a confocal laser microscope (LSM510: Carl Zeiss Co., Ltd., pinhole size-Ch1=123 μm, Ch2=108 μm, image Interval=0.4) to obtain cross sectional views.

(Experimental Protocols)

(Cell Sources, Culture Media, and Culture Conditions)

In this example, five different cell lines were used: human mesenchymal stem cells (hMSCs, PT-2501, Cambrex BioScience Walkersville, Inc., MD), human embryonic kidney cell HEK293 (RCB1637, RIKEN Cell Bank, JPN), NIH3T3-3 (RCB0150, RIKEN Cell Bank, JPN), HeLa (RCB0007, RIKEN Cell Bank, JPN), and HepG2 (RCB1648, RIKEN Cell Bank, JPN). In the case of human MSCs, cells were maintained in commercially available Human Mesenchymal Cell Basal Medium (MSCGM BulletKit PT-3001, Cambrex BioScience Walkersville, Inc., MD). In case of HEK293, NIH3T3-3, HeLa and HepG2, cells were maintained in Dulbeoco's Modified Eagle's Medium (DMEM, high glucose 4.5 g/L with L-Glutamine and sodium pyruvate; 14246-25, Nakalai Tesque, JPN) with 10% fetal bovine serum (FBS, 29-167-54, Lot No. 2025F, Dainippon Pharmaceutical CO., LTD., JPN). All cells were cultivated in a controlled incubator at 37° C. in 5% CO₂. In experiments involving hMSCs, we used hMSCs of less than five passages, in order to avoid phenotypic changes.

(Plasmids and Transfection Reagents)

To evaluate the efficiency of transfection, the pEGFP-N1 and pDsRed2-N1 vectors (cat. no. 6085-1, 6973-1, BD Biosciences Clontech, CA) were used. Both genes' expressions were under the control of cytomegalovirus (CMV) promoter. Transfected cells continuously expressed EGFP or DsRed2, respectively. Plasmid DNAs were amplified using Escherichia coli, XL1-blue strain (200249, Stratagene, TX), and purified by EndoFree Plasmid Kit (EndoFree Plasmid Maxi Kit 12362, QIAGEN, CA). In all cases, plasmid DNA was dissolved in DNase and RNase free water. Transfection reagents were obtained as below: Effectene Transfection Reagent (cat. no.301425, Qiagen, CA), TransFast™ Transfection Reagent (E2431, Promega, WI), Tfx™-20 Reagent (E2391, Promega, WI), SuperFect Transfection Reagent (301305, Qiagen, CA), PolyFect Transfection Reagent (301105, Qiagen, CA), LipofectAMINE 2000 Reagent (11668-019, Invitrogen corporation, CA), JetPEI (×4) conc. (101-30, Polyplus-transfection, France), and ExGen 500 (R0511, Fermentas Inc., MD).

(Solid-Phase Transfection Array (SPTA) Production)

The detail of protocols for ‘reverse transfection’ was described in the web site, ‘Reverse Transfection Homepage’ (http://staffa.wi.mit.edu/sabatini_public/reverse_transfection.htm) or J. Ziauddin, D. M. Sabatini, Nature, 411, 2001, 107; and R. W. Zu, S. N. Bailey, D. M. Sabatini, Trends in Cell Biology, Vol. 12, No. 10, 485. In our solid phase transfection (SPTA method), three types of glass slides were studied (silanized glass slides; APS slides, and poly-L-lysine coated glass slides; PLL slides, and MAS coated slides; Matsunami Glass, JPN) with a 48 square pattern (3 mm×3 mm) separated by a hydrophobia fluoride resin coating.

(Plasmid DNA Printing Solution Preparation)

Two different ways to produce a SPTA were developed. The main differences reside in the preparation of the plasmid DNA printing solution.

(Method A)

In the case of using Effectene Transfection Reagent, the printing solution contained plasmid DNA and cell adhesion molecules (bovine plasma fibronectin (cat. no. 16042-41, Nakalai Tesque, JPN), dissolved in ultra-pure water at a concentration of 4 mg/mL). The above solution was applied on the surface of the slide using an inkjet printer (synQUAD™, Cartesian Technologies, Inc., CA) or manually, using a 0.5 to 10 μL tip. This printed slide was dried up over 15 minutes at room temperature in a safety-cabinet. Before transfection, total Effectene reagent was gently poured on the DNA-printed glass slide and incubated for 15 minutes at room temperature. The excess Effectene solution was removed from the glass slide using a vacuum aspirator and dried at room temperature for 15 minutes in a safety-cabinet. The DNA-printed glass slide obtained was set in the bottom of a 100-mm culture dish and approximately 25 mL of cell suspension (2 to 4×10⁴ cells/mL) was gently poured into the dish. Then, the dish was transferred to the incubator at 37° C. in 5% CO₂ and incubated for 2 or 3 days.

(Method B)

In case of other transfection reagents (TransFast™, Tfx™-20, SuperFect, PolyFect, LipofectAMINE 2000, JetPEI (×4) conc., or Exgen), plasmid DNA, fibronectin, and the transfection reagent, were mixed homogeneously in a 1.5-mL micro-tube according to the ratios indicated in the manufacturer's instructions and incubated at room temperature for 15 minutes before printing on a chip. The printing solution was applied to the surface of the glass-slide using an inkjet printer or a 0.5- to 10-μL tip. The printed glass-slide was completely dried at room temperature over 10 minutes in a safety-cabinet. The printed glass-slide was placed in the bottom of a 100-mm culture dish and approximately 3 mL of cell suspension (2 to 4×10⁴ cells/mL) was added and incubated at room temperature over 15 minutes in a safety-cabinet. After is incubation, fresh medium was poured gently into the dish. Then, the dish was transferred to an incubator at 37° C. in 5% CO₂ and incubated for 2 to 3 days. After incubation, using fluorescence microscopy (IX-71, Olympus PROMARKETING, INC., JPN), we observed the transfectants, based on their expression of enhanced fluorescent proteins (EFP, EGFP and DsRed2). Phase contrast images were taken with the same microscope. In both protocols, cells were fixed by using a paraformaldehyde (PFA) fixation method (4% PFA in PBS, treatment time was 10 minutes at room temperature).

(Laser Scanning and Fluorescence Intensity Quantification)

In order to quantify the transfection efficiency, we used a DNA micro-array scanner (GeneTAC UC4×4, Genomic Solutions Inc., MI). The total fluorescence intensity (arbitrary units) was measured, and thereafter, the fluorescence intensity per surface area was calculated.

(Solid-phase Transfection Array of Human Mesenchymal Stem Cells)

The capacity of human Mesenchymal Stem Cells (hMSC) to differentiate into various kinds of cells is particularly intriguing in studies which target tissue regeneration and renewal. In particular, the genetic analysis of transformation of these cells has attracted attention with the expectation of understanding of a factor that controls the pluripotency of hMSC. In conventional hMSC studies, it is not possible to perform transfection with desired genetic materials.

It was demonstrated that solid phase transfection can be used to achieve a “transfection patch” is capable of being used for in vivo gene delivery and a solid phase transfection array (SPTA) for high-throughput genetic function research on hMSC.

Although a number of standard techniques are available for transfecting mammalian cells, it is known that it is inconvenient and difficult to introduce genetic material into hMSC as compared with cell lines, such as HEK293, HeLa, and the like. Conventional viral vector delivery and electroporation techniques are each important. However, these techniques have the following inconveniences: potential toxicity (for the virus technique); difficulty in high-throughput analysis at the genomic scale; and limited applications in in vivo studies (for electroporation).

The present inventors developed solid phase support fixed system which can be easily fixed to a solid phase support and has sustained-release capability and cell affinity, whereby most of the above-described drawbacks could be overcome and attained analysis a network of a biological entity such as a cell with set theory.

As a result of this example, several important effects were achieved: high transfection efficiency (thereby making it possible to study a group of cells having a statistically significant scale); low cross contamination between regions having different DNA molecules (thereby making it possible to study the effects of different genes separately); the extended survival of transfected cells; high-throughput, compatible and simple detecting procedure. SPTA having these features serve as an appropriate basis for further studies.

A coating agent used is crucial for the achievement of high transfection efficiency on chips. It was found that when a glass chip is used, PLL provided the best results both for transfection efficiency and cross contamination (described below). When fibronectin coating was not used, few transfectants were observed (all the other experimental conditions were retained unchanged). Although not completely established, fibronectin probably plays a role in accelerating the cell adhesion process (data not shown), and thus, limiting the time which permits the diffusion of DNA released from the surface.

### Example 3

### RNAi Transfection Microarray

Arrays were produced as described in Example 2. As genetic material, mixtures of plasmid DNA (pDNA) and shRNA were used. The compositions of the mixtures are shown in Table 2.

TABLE 2

| | pDNA vs. shRNA ratio | | | | |
|---|---|---|---|---|---|
| | [μL/μL] | | | | |
| | 9:1 | 7:3 | 1:1 | 3:7 | 1:9 |
| plasmid DNA (1 mg/mL) | 1.8 | 1.4 | 1.0 | 0.6 | 0.2 |
| shRNA (1 mg/mL) | 0.2 | 0.6 | 1.0 | 1.4 | 1.8 |
| Lipofectamine2000 | 4.0 | 4.0 | 4.0 | 4.0 | 4.0 |
| Fibronectin (4 mg/mL) | 5.0 | 5.0 | 5.0 | 5.0 | 5.0 |

Thus, it was revealed that the method of the present invention is applicable to any cells for analysis using shRNA.

### Example 4

### Use of RNAi Microarray Using siRNA

Next, siRNA was used instead of shRNA to construct RNAi transfection microarrays in accordance with the protocol as described in Example 2.

Functional reporters for transcriptional factors and fibronectin described in Table 2 were used to synthesize siRNAs for the transcriptional factors including SRE, TRE, E2F, p53, Rb, Actin, NFAT, NFkB, STAT3, RARE, PMA, ISRA, HSE, Myc, AP1, GAS, ERE, GRE and CRE. siRNA for EGFP was used as a control. Each siRNA was evaluated as to whether or not it knocks out a target transcription factor. Scrambled RNAs were used as negative controls, and their ratios were evaluated.

The following table shows the transcriptional factors to be targeted by the siRNA used in the present Example.

TABLE 3

| Symbol | | | | |
|---|---|---|---|---|
| (SEQ ID | | | Target Gene | |
| NO: of | | SEQUENCE | ID (SEQ ID | |
| siRNA) | MANUFACTURER | ANALYSIS | NOs) | Annotation |
| Scramble | Dharmacon | Dharmacon | | Non-targeting |
| (SEQ ID | | | | (scramble II Duplex) |
| NO: 77) | | | | |
| available as | | | | |
| Scramble II | | | | |
| Duplex | | | | |
| c-Myc | Ambion | Ambion | V00568 (SEQ | Human mRNA |
| available | | | ID NOs: 1-2) | encoding the |
| as | | | | c-myc oncogene |
| Silencer ™ | | | | |
| c-myc | | | | |
| siRNA | | | | |
| c-Fos (SEQ | Dharmacon | B-Bridge | K00650 (SEQ | Human fos |
| ID NO: 53) | | | ID NOs: 3-4) | proto-oncogene |
| | | | | (c-fos), complete |
| | | | | ods |
| c-Jun (SEQ | Dharmacon | B-Bridge | J04111 (SEQ | Human c-jun proto |
| ID NO: 54) | | | ID NOs 5-6 | oncogene (JUN), |
| | | | | complete cds, clone |
| | | | | hCJ-1 |
| CREB (SEQ | Dharmacon | B-Bridge | M27691 (SEQ | Human |
| ID NO: 55) | | | ID NOs 7-8) | transactivator |
| | | | | protein (CREB) |
| | | | | mRNA, complete |
| | | | | cds |
| E2F (SEQ | Dharmacon | B-Bridge | M96577 (SEQ | Homo sapiens |
| ID NO: 56) | | | ID NOs 9-10) | (E2F-1) |
| | | | | pRB-binding |
| | | | | protein mRNA, |
| | | | | complete cds |
| ER (SEQ ID | Dharmacon | B-Bridge | M12674 (SEQ | Human estrogen |
| NO: 57) | | | ID NOs | receptor mRNA, |
| | | | 11-12) | complete ods |
| GR (SEQ | Dharmacon | B-Bridge | M10901 (SEQ | Human |
| ID NO: 58) | | | ID NOs | glucocorticoid |
| | | | 13-14) | receptor alpha |
| | | | | mRNA, complete |
| | | | | ods |
| HSF-1 | Dharmacon | B-Bridge | NM_005526 | Homo sapiens heat |
| (SEQ ID | | | (SEQ ID NOs | shock-transcription |
| NO: 59) | | | 15-16) | factor 1 (HSF1), |
| | | | | mRNA |
| HSF-2 | Dharmacon | B-Bridge | M65217 (SEQ | Human heat shock |
| (SEQ ID | | | ID NOs | factor 2 (HSF2) |
| NO: 60) | | | 17-18) | mRNA, complete |
| | | | | cds |
| HSF-4 | Dharmacon | B-Bridge | D87673 (SEQ | Homo sapiens |
| (SEQ ID | | | ID NOs | mRNA for heat |
| NO: 61) | | | 19-20) | shock-transcription |
| | | | | factor 4, complete |
| | | | | cds |
| IkBa (SEQ | Dharmacon | B-Bridge | M69043 (SEQ | Homo sapiens |
| ID NO: 62) | | | ID NOs | MAD-3 mRNA |
| | | | 21-22) | encoding IkB-like |
| | | | | activity, complete |
| | | | | ods |
| NFAT3 | Dharmacon | B-Bridge | L41066 (SEQ | Homo sapiens |
| (SEQ ID | | | ID NOs | NF-AT3 mRNA, |
| NO: 63) | | | 23-24) | complete cds |
| NFkB (SEQ | Dharmacon | B-Bridge | S76638 (SEQ | p50-NF-kappa B |
| ID NO: 64) | | | ID NOs | homolog [human, |
| | | | 25-26) | peripheral blood T |
| | | | | cells, mRNA, 3113 |
| | | | | nt] |
| RARA | Dharmacon | B-Bridge | NM_000964 | Homo sapiens |
| (SEQ ID | | | (SEQ ID NOs | retinoic acid |
| NO: 65) | | | 27-28) | receptor, alpha |
| | | | | (RARA), mRNA |
| RARB1 | Dharmacon | B-Bridge | NM_000965 | Homo sapiens |
| (SEQ ID | | | (SEQ ID NOs | retinoic acid |
| NO: 66) | | | 29-30) | receptor, beta |
| | | | | (RARB), transcript |
| | | | | variant 1, mRNA |
| RARB2 | Dharmacon | B-Bridge | NM_016152 | Homo sapiens |
| (SEQ ID | | | (SEQ ID NOs | retinoic acid |
| NO: 67) | | | 31-32) | receptor, beta |
| | | | | (RARB), transcript |
| | | | | variant 2, mRNA |
| RARG | Dharmacon | B-Bridge | M57707 (SEQ | Human retinoic acid |
| (SEQ ID | | | ID NOs | receptor gamma |
| NO: 68) | | | 33-34) | mRNA, complete |
| | | | | cds |
| Rb (SEQ ID | Dharmacon | B-Bridge | M15400 (SEQ | Human |
| NO: 69) | | | ID NOs: | retinoblastoma |
| | | | 35-36) | susoeptibility |
| | | | | mRNA, complete |
| | | | | cds |
| SRF (SEQ | Dharmacon | B-Bridge | J03161 (SEQ | Human serum |
| ID NO: 70) | | | ID NOs: | response factor |
| | | | 37-38 | (SRF) mRNA, |
| | | | | complete cds |
| STAT1a | Dharmacon | B-Bridge | M97935 (SEQ | Homo sapiens |
| (SEQ ID | | | ID NOs | transcription factor |
| NO: 71) | | | 39-40) | ISGF-3 mRNA, |
| | | | | complete cds |
| STAT1b | Dharmacon | B-Bridge | M97936 (SEQ | Human |
| (SEQ ID | | | ID NOs | transcription factor |
| NO: 72) | | | 41-42) | ISGF-3 mRNA |
| | | | | sequence |
| STAT2 | Dharmacon | B-Bridge | M97934 (SEQ | Homo sapiens |
| (SEQ ID | | | (ID NOs | interferon alpha |
| NO: 73) | | | 43-44) | induced |
| | | | | transcriptional |
| | | | | activator (ISGF-3) |
| | | | | mRNA sequence |
| STAT3 | Dharmacon | B-Bridge | L29277 (SEQ | Homo sapiens |
| (SEQ ID | | | ID NOs | DNA-binding |
| NO: 74) | | | 45-46) | protein (APRF) |
| | | | | mRNA, complete |
| | | | | ods |
| TR (SEQ ID | Dharmacon | B-Bridge | Y00479 (SEQ | H. sapiens mRNA |
| NO: 75) | | | ID NOs | for thyroid hormone |
| | | | 47-48) | receptor |
| p53 (SEQ | Dharmacon | B-Bridge | AF307851 | Homo sapiens p53 |
| ID NO: 76) | | | (SEQ ID NOs | protein mRNA, |
| | | | 49-50) | complete cds |

The functional reporters used in the present Example are as follows:

TABLE 4
FUNTIONAL REPORTER LISTS

| Mercury | | | | | | | |
|---|---|---|---|---|---|---|---|
| signaling | Detection | Induction | Binding | Not | | | |
| pathway | Targets | elements | TFs | active | Active | Localization | Re-location |
| pAP1(PMA)- | PKC and | Phorbol | c-jun, | low | increase | cytosol | No |
| EGFP | Related | esters | c-fos | intensity | intensity | | |
| | Pathways | (PMA) | | | | | |
| | such as | | | | | | |
| | MAPK/JNK | | | | | | |
| pAP1-EGFP | AP1 | serum, | c-jun, | low | increase | cytosol | No |
| | induction | growth | c-fos | intensity | intensity | | |
| | and | factors | | | | | |
| | SAPK/JNK | | | | | | |
| | pathway | | | | | | |
| pCRE-EGFP | CREB | cAPM, | CREB, | low | increase | cytosol | No |
| | activation | forskolin | ATF | intensity | intensity | | |
| | and | | | | | | |
| | JNK, p38 | | | | | | |
| | MAPK, | | | | | | |
| | PKA | | | | | | |
| pERE-EGFP | activation | estrogen | ER | low | increase | cytosol | No |
| | of | | homodimer | intensity | intensity | | |
| | Estrogen | | | | | | |
| | response | | | | | | |
| | element | | | | | | |
| pE2F-EGFP | E2F-mediated | Rb | E2F | low | increase | cytosol | No |
| | pathwats | degradation | | intensity | intensity | | |
| | (early | | | | | | |
| | S-phase) | | | | | | |
| pGAS-EGFP | induction | Cytokines | STAT1/ | low | increase | cytosol | No |
| | of | (STAT1/ | STAT1 | intensity | intensity | | |
| | STAT1(JAK/ | STAT1) | | | | | |
| | STAT | | | | | | |
| | path) | | | | | | |
| pGRE-EGFP | activation | glucocorticoids | GR | low | increase | cytosol | No |
| | of | | | intensity | intensity | | |
| | Glucocorticoid | | | | | | |
| | response | | | | | | |
| | element | | | | | | |
| pHSE-EGFP | activation | Heat | HSFs | low | increase | cytosol | No |
| | of HSF | shook | | intensity | intensity | | |
| | and heat | | | | | | |
| | shock-mediated | | | | | | |
| | Path | | | | | | |
| pISRE-EGFP | IFN-triggered | INF α, β | IRFs, | low | increase | cytosol | No |
| | path, | (Type I) | STAT2/ | intensity | intensity | | |
| | antiviral, | γ(Type | STAT1 | | | | |
| | growth | II) | | | | | |
| | inhibitory, | | | | | | |
| | immunoregulatory | | | | | | |
| | activities, | | | | | | |
| | JAK/STAT | | | | | | |
| pMyc-EGFP | activation | serum, | Myc/Max | low | increase | cytosol | No |
| | cMyc | growth | hetero | intensity | intensity | | |
| | and | factors | dimer | | | | |
| | cMyc-mediated | | | | | | |
| | path load | | | | | | |
| | to cell | | | | | | |
| | growth | | | | | | |
| pNFAT-EGFP | activation | PMA | NFAT | low | increase | cytosol | No |
| | NFAT | | | intensity | intensity | | |
| | and | | | | | | |
| | NFAT-mediated | | | | | | |
| | path, | | | | | | |
| | carcineurin, | | | | | | |
| | PKC | | | | | | |
| pNFkB-EGFP | activation | TNF, | NFkB | low | increase | cytosol | No |
| | of | IL-1, | | intensity | intensity | | |
| | NFkB | lymphokine | | | | | |
| | signal | receptors | | | | | |
| | transduction | | | | | | |
| p53-EGFP | p53-mediated | | p53 | low | increase | cytosol | No |
| | path | | | intensity | intensity | | |
| pRARE-EGFP | induction | RA | RAR, | low | increase | cytosol | No |
| | of | | RXR | intensity | intensity | | |
| | retinoic | | | | | | |
| | acid (RA) | | | | | | |
| pRb-EGFP | activity | | Rb | increase | decrease | cytosol | No |
| | of | | | intensity | intensity | | |
| | Rb-mediated | | | | | | |
| | path, | | | | | | |
| | repression | | | | | | |
| | cell | | | | | | |
| | cycle | | | | | | |
| | progression | | | | | | |
| pSRE-EGFP | induction | serum, | SRF, | low | increase | cytosol | No |
| | of SRE, | growth | Elk-1/ | intensity | intensity | | |
| | MAPK/JNK | factors | STAT | | | | |
| pSTAT3-EGFP | JAK/STAT- | Cytokines, | STAT3/ | low | increase | cytosol | No |
| | mediated | | STAT3 | intensity | intensity | | |
| | path | | | | | | |
| pTRE-EGFP | induction | | | low | increase | cytosol | No |
| | of thyroid | | | intensity | intensity | | |
| | response | | | | | | |
| | element | | | | | | |

Each cell was subjected to solid phase transfection, followed by culture for two days. Images were taken using a fluorescence image scanner, and the fluorescence level was quantified. In detail, the assay was conducted as follows:

The following reagents were mixed for “printing” DNA onto a transfection array as follows.

TMA printing Mix

| | |
|---|---|
| Plasmid DNA [1 ug/uL] | 2.0 uL |
| siRNA [20 pmol] | 7.0 uL |
| DMEM | 7.0 uL |
| Fibronectin [4 mg/mL] | 5.0 uL |
| LipofectAMINE2000 | 4.0 uL |
| Final Vol. [uL] | 25.0 uL |

Bubble Jet (trademark) DNA printer (manufactured by Cartesian Dispensing Systems, Ann Arbor, Mich., USA) was used for printing the DNA mixtures as prepared above onto glass slides. All combinations of nineteen reporters, and twenty six siRNA's were prepared for the present assay, and four spots per each combination were spotted onto the transfection array to make the transfection array for the present Example.

HeLa cells (human cervical cancer cell line) and HepG2 (human hepatoma cell line) were each seeded at 2×10⁶ cells/mL and cultured in CO₂ incubators for forty-eight hours.

After culturing the cells, a scanner for DNA microarrays (ArrayWoRx (trade name), Applied Precision, LLC, Issaquah, Wash., USA) was used for obtaining fluorescent images of EGFP expression. These images were analyzed with image analyzing software (ImaGene; BioDiscovery; El Segundo, Calif. USA) to obtain intensity integral value of the EGFP fluorescence.

Relative intensity ratio against the intensity in the case where Scramble II Duplex, which is a negative control, was used was calculated. Results with 120% or more in terms of the negative control were deemed as up-regulation, results with 80% or less in terms of the negative control was deemed as down-regulation. Results therebetween (i.e., 80%<results<120%) were considered to be no change.

The results for HeLa cells and HepG2 cells are shown below.

TABLE 5-1
(HeLa cells)

| Hela-K | AP1 | PMA | CRE | E2F | ERE | GAS |
|---|---|---|---|---|---|---|
| Scramble | 100.0% | 100.0% | 100.0% | 100.0% | 100.0% | 100.0% |
| c-Myc | 63.1% | 63.4% | 67.7% | 136.7% | 103.5% | 89.0% |
| c-Fos | 72.9% | 89.6% | 67.0% | 112.5% | 116.6% | 86.4% |
| c-Jun | 63.1% | 78.4% | 60.9% | 93.4% | 119.4% | 84.1% |
| CREB | 71.9% | 102.1% | 56.7% | 128.3% | 98.1% | 90.7% |
| E2F | 57.9% | 104.5% | 58.0% | 99.2% | 103.6% | 81.8% |
| ER | 44.2% | 85.4% | 44.3% | 110.9% | 97.3% | 89.8% |
| GR | 70.5% | 119.9% | 33.9% | 124.6% | 100.9% | 88.9% |
| HSF-1 | 84.5% | 123.2% | 37.4% | 109.2% | 98.1% | 91.3% |
| HSF-2 | 72.6% | 124.5% | 25.7% | 144.2% | 95.0% | 81.6% |
| HSF-4 | 55.3% | 112.9% | 28.2% | 104.2% | 94.4% | 100.0% |
| IkBa | 68.4% | 109.3% | 27.6% | 123.8% | 97.5% | 94.0% |
| NFAT3 | 79.7% | 104.2% | 22.7% | 140.4% | 95.6% | 84.5% |
| NFkB | 93.2% | 89.8% | 21.3% | 125.2% | 92.9% | 100.1% |
| RARA | 81.1% | 95.4% | 24.6% | 183.9% | 94.9% | 86.1% |
| RARB1 | 87.1% | 67.0% | 24.8% | 139.2% | 95.2% | 81.5% |
| RARB2 | 89.1% | 65.0% | 79.7% | 129.6% | 96.1% | 86.3% |
| RARG | 70.2% | 60.3% | 63.7% | 110.5% | 97.3% | 93.8% |
| Rb | 41.7% | 59.4% | 45.0% | 142.8% | 107.3% | 83.7% |
| SRF | 35.7% | 56.2% | 55.6% | 140.0% | 112.8% | 81.9% |
| STAT1a | 32.7% | 56.3% | 88.4% | 93.6% | 109.1% | 84.9% |
| STAT1b | 34.9% | 48.8% | 52.8% | 140.2% | 109.6% | 85.2% |
| STAT2 | 32.3% | 49.5% | 44.2% | 141.1% | 105.9% | 84.8% |
| STAT3 | 30.0% | 59.1% | 40.1% | 133.3% | 106.8% | 81.8% |
| TR | 29.4% | 55.2% | 39.2% | 131.1% | 101.0% | 80.2% |
| p53 | 36.7% | 149.7% | 26.9% | 174.8% | 98.0% | 79.9% |
| Anti-GFP | | | | | | |

TABLE 5-2
HeLa cells

| Hela-K | GRE | HSE | ISRE | Myc | NFAT | NFKB |
|---|---|---|---|---|---|---|
| Scramble | 100.0% | 100.0% | 100.0% | 100.0% | 100.0% | 100.0% |
| c-Myc | 69.7% | 89.5% | 126.7% | 79.2% | 99.7% | 61.6% |
| c-Fos | 70.1% | 98.1% | 68.8% | 63.8% | 98.3% | 87.6% |
| c-Jun | 55.5% | 77.4% | 108.0% | 57.9% | 104.4% | 80.9% |
| CREB | 66.2% | 82.1% | 74.7% | 47.7% | 109.7% | 138.3% |
| E2F | 76.5% | 84.5% | 67.7% | 46.9% | 139.3% | 99.7% |
| ER | 79.6% | 87.4% | 70.3% | 48.9% | 158.7% | 80.0% |
| GR | 115.2% | 92.9% | 76.1% | 56.8% | 215.8% | 144.2% |
| HSF-1 | 51.0% | 117.3% | 84.0% | 69.5% | 253.2% | 143.2% |
| HSF-2 | 51.6% | 122.0% | 65.2% | 99.7% | 177.4% | 172.8% |
| HSF-4 | 77.1% | 111.4% | 79.5% | 99.4% | 141.7% | 111.0% |
| IkBa | 81.0% | 89.5% | 110.9% | 91.6% | 195.7% | 62.2% |
| NFAT3 | 71.0% | 80.2% | 88.4% | 59.7% | 162.1% | 109.4% |
| NFkB | 69.1% | 103.6% | 86.0% | 72.9% | 113.9% | 96.4% |
| RARA | 58.7% | 122.9% | 119.1% | 122.4% | 119.3% | 98.9% |
| RARB1 | 60.6% | 102.0% | 96.9% | 79.4% | 106.6% | 93.4% |
| RARB2 | 114.5% | 73.3% | 77.9% | 70.9% | 133.6% | 132.6% |
| RARG | 73.8% | 88.1% | 77.1% | 74.4% | 124.9% | 79.5% |
| Rb | 70.3% | 84.6% | 107.0% | 81.2% | 124.3% | 146.0% |
| SRF | 63.3% | 97.3% | 79.3% | 75.3% | 101.9% | 74.3% |
| STAT1a | 82.2% | 94.8% | 67.5% | 58.7% | 89.2% | 197.0% |
| STAT1b | 85.8% | 74.9% | 65.9% | 63.3% | 86.8% | 168.7% |
| STAT2 | 58.5% | 84.1% | 83.3% | 68.7% | 83.4% | 17.2% |
| STAT3 | 97.8% | 104.3% | 89.7% | 85.6% | 99.0% | 68.7% |
| TR | 54.3% | 80.6% | 137.7% | 87.6% | 95.3% | 177.5% |
| p53 | 60.6% | 82.1% | 72.8% | 103.5% | 177.8% | 125.8% |
| Anti-GFP | | | | | | |

TABLE 5-3
HeLa cells

| Hela-K | RARE | Rb | STAT3 | SRE | TRE | P53 | Actin |
|---|---|---|---|---|---|---|---|
| Scramble | 100.0% | 100.0% | 100.0% | 100.0% | 100.0% | 100.0% | 100.0% |
| c-Myc | 68.6% | 97.2% | 85.4% | 108.2% | 75.4% | 61.8% | 64.3% |
| c-Fos | 62.9% | 99.7% | 85.3% | 148.1% | 108.5% | 148.1% | 67.7% |
| c-Jun | 76.0% | 148.9% | 75.8% | 128.1% | 127.7% | 100.2% | 106.0% |
| CREB | 39.3% | 259.6% | 116.5% | 8030.8% | 134.2% | 87.5% | 73.8% |
| E2F | 51.1% | 151.7% | 180.1% | 15876.5% | 125.0% | 109.3% | 69.3% |
| ER | 100.5% | 102.2% | 114.4% | 63797.3% | 118.0% | 82.5% | 123.6% |
| GR | 64.8% | 133.4% | 139.7% | 44143.6% | 150.1% | 63.0% | 134.6% |
| HSF-1 | 136.9% | 252.8% | 162.5% | 11434.8% | 223.5% | 75.2% | 75.1% |
| HSF-2 | 127.3% | 227.3% | 237.7% | 32416.7% | 764.1% | 41.2% | 41.6% |
| HSF-4 | 87.4% | 128.3% | 127.5% | 17739.5% | 179.4% | 103.3% | 252.6% |
| IkBa | 130.4% | 142.0% | 177.4% | 16354.2% | 149.7% | 136.5% | 181.9% |
| NFAT3 | 88.7% | 118.6% | 129.4% | 18955.4% | 87.9% | 135.4% | 164.5% |
| NFkB | 68.6% | 106.5% | 299.0% | 17733.0% | 170.2% | 111.2% | 242.1% |
| RARA | 70.4% | 147.4% | 149.7% | 42654.8% | 94.5% | 56.7% | 72.9% |
| RARB1 | 69.0% | 113.7% | 84.0% | 12200.8% | 69.2% | 104.5% | 190.6% |
| RARB2 | 100.9% | 126.6% | 87.7% | 30989.4% | 101.4% | 195.0% | 195.2% |
| RARG | 45.1% | 125.5% | 65.9% | 107.6% | 110.2% | 172.5% | 95.1% |
| Rb | 43.6% | 159.6% | 86.6% | 104.0% | 112.3% | 410.8% | 62.1% |
| SRF | 133.6% | 116.0% | 65.3% | 14027.5% | 234.7% | 181.5% | 33.2% |
| STAT1a | 50.5% | 85.2% | 52.8% | 15856.3% | 148.3% | 58.2% | 121.2% |
| STAT1b | 59.0% | 126.3% | 82.3% | 11458.8% | 119.5% | 132.0% | 217.9% |
| STAT2 | 52.0% | 110.7% | 93.0% | 12913.7% | 98.6% | 278.9% | 28.0% |
| STAT3 | 74.2% | 94.9% | 79.5% | 13046.1% | 154.1% | 110.2% | 129.5% |
| TR | 108.0% | 206.0% | 56.7% | 13107.4% | 157.1% | 105.4% | 122.7% |
| p53 | 98.9% | 84.2% | 51.6% | 12588.8% | 152.5% | 26.4% | 167.7% |
| Anti-GFP | | | | | | | 53.9% |

Normalized matrix of the network of HeLa cells are provided as follows:

TABLE 5-4

| Hela-K | AP1 | PMA | CRE | E2F | ERE | GAS | GRE | HSE | ISRE | Myc | NFAT |
|---|---|---|---|---|---|---|---|---|---|---|---|
| Scramble | | | | | | | | | | | |
| c-Myc | −1 | −1 | −1 | 1 | 0 | 0 | −1 | 0 | 1 | −1 | 0 |
| c-Fos | −1 | 0 | −1 | 0 | 0 | 0 | −1 | 0 | −1 | −1 | 0 |
| c-Jun | −1 | −1 | −1 | 0 | 0 | 0 | −1 | −1 | 0 | −1 | 0 |
| CREB | −1 | 0 | −1 | 1 | 0 | 0 | −1 | 0 | −1 | −1 | 0 |
| E2F | −1 | 0 | −1 | 0 | 0 | 0 | −1 | 0 | −1 | −1 | 1 |
| ER | −1 | 0 | −1 | 0 | 0 | 0 | −1 | 0 | −1 | −1 | 1 |
| GR | −1 | 0 | −1 | 1 | 0 | 0 | 0 | 0 | −1 | −1 | 1 |
| HSF-1 | 0 | 1 | −1 | 0 | 0 | 0 | −1 | 0 | 0 | −1 | 1 |
| HSF-2 | −1 | 1 | −1 | 1 | 0 | 0 | −1 | 1 | −1 | 0 | 1 |
| HSF-4 | −1 | 0 | −1 | 0 | 0 | 0 | −1 | 0 | −1 | 0 | 1 |
| IkBa | −1 | 0 | −1 | 1 | 0 | 0 | 0 | 0 | 0 | 0 | 1 |
| NFAT3 | −1 | 0 | −1 | 1 | 0 | 0 | −1 | 0 | 0 | −1 | 1 |
| NFkB | 0 | 0 | −1 | 1 | 0 | 0 | −1 | 0 | 0 | −1 | 0 |
| RARA | 0 | 0 | −1 | 1 | 0 | 0 | −1 | 1 | 0 | 1 | 0 |
| RARB1 | 0 | −1 | −1 | 1 | 0 | 0 | −1 | 0 | 0 | −1 | 0 |
| RARB2 | 0 | −1 | −1 | 1 | 0 | 0 | 0 | −1 | −1 | −1 | 1 |
| RARG | −1 | −1 | −1 | 0 | 0 | 0 | −1 | 0 | −1 | −1 | 1 |
| Rb | −1 | −1 | −1 | 1 | 0 | 0 | −1 | 0 | 0 | 0 | 1 |
| SRF | −1 | −1 | −1 | 1 | 0 | 0 | −1 | 0 | −1 | −1 | 0 |
| STAT1a | −1 | −1 | 0 | 0 | 0 | 0 | 0 | 0 | −1 | −1 | 0 |
| STAT1b | −1 | −1 | −1 | 1 | 0 | 0 | 0 | −1 | −1 | −1 | 0 |
| STAT2 | −1 | −1 | −1 | 1 | 0 | 0 | −1 | 0 | 0 | −1 | 0 |
| STAT3 | −1 | −1 | −1 | 1 | 0 | 0 | 0 | 0 | 0 | 0 | 0 |
| TR | −1 | −1 | −1 | 1 | 0 | 0 | −1 | 0 | 1 | 0 | 0 |
| P53 | −1 | 1 | −1 | 1 | 0 | −1 | −1 | 0 | −1 | 0 | 1 |
| Anti-GFP | | | | | | | | | | | |

| Hela-K | NFKB | RARE | Rb | STAT3 | SRE | TRE | P53 | Actin |
|---|---|---|---|---|---|---|---|---|
| Scramble | | | | | | | | |
| c-Myc | −1 | −1 | 0 | 0 | 0 | −1 | −1 | −1 |
| c-Fos | 0 | −1 | 0 | 0 | 1 | 0 | 1 | −1 |
| c-Jun | 0 | −1 | 1 | −1 | 1 | 1 | 0 | 0 |
| CREB | 1 | −1 | 1 | 0 | 1 | 1 | 0 | −1 |
| E2F | 0 | −1 | 1 | 1 | 1 | 1 | 0 | −1 |
| ER | −1 | 0 | 0 | 0 | 1 | 0 | 0 | 1 |
| GR | 1 | −1 | 1 | 1 | 1 | 1 | −1 | 1 |
| HSF-1 | 1 | 1 | 1 | 1 | 1 | 1 | −1 | −1 |
| HSF-2 | 1 | 1 | 1 | 1 | 1 | 1 | −1 | −1 |
| HSF-4 | 0 | 0 | 1 | 1 | 1 | 1 | 0 | 1 |
| IkBa | −1 | 1 | 1 | 1 | 1 | 1 | 1 | 1 |
| NFAT3 | 0 | 0 | 0 | 1 | 1 | 0 | 1 | 1 |
| NFkB | 0 | −1 | 0 | 1 | 1 | 1 | 0 | 1 |
| RARA | 0 | −1 | 1 | 1 | 1 | 0 | −1 | −1 |
| RARB1 | 0 | −1 | 0 | 0 | 1 | −1 | 0 | 1 |
| RARB2 | 1 | 0 | 1 | 0 | 1 | 0 | 1 | 1 |
| RARG | −1 | −1 | 1 | −1 | 0 | 0 | 1 | 0 |
| Rb | 1 | −1 | 1 | 0 | 0 | 0 | 1 | −1 |
| SRF | −1 | 1 | 0 | −1 | 1 | 1 | 1 | −1 |
| STAT1a | 1 | −1 | 0 | −1 | 1 | 1 | −1 | 1 |
| STAT1b | 1 | −1 | 1 | 0 | 1 | 0 | 1 | 1 |
| STAT2 | −1 | −1 | 0 | 0 | 1 | 0 | 1 | −1 |
| STAT3 | −1 | −1 | 0 | −1 | 1 | 1 | 0 | 1 |
| TR | 1 | 0 | 1 | −1 | 1 | 1 | 0 | 1 |
| P53 | 1 | 0 | 0 | −1 | 1 | 1 | −1 | 1 |
| Anti-GFP | | | | | | | | −1 |

TABLE 6-1
HepG2 cells

| HepG2 | AP1 | PMA | CRE | E2F | ERE | GAS |
|---|---|---|---|---|---|---|
| Scramble | 100.0% | 100.0% | 100.0% | 100.0% | 100.0% | 100.0% |
| c-Myc | 72.4% | 74.8% | 53.6% | 113.9% | 97.8% | 87.4% |
| c-Fos | 89.0% | 113.3% | 67.5% | 114.3% | 95.8% | 91.1% |
| c-Jun | 97.2% | 92.6% | 65.1% | 117.1% | 106.8% | 88.4% |
| CREB | 125.7% | 128.3% | 48.5% | 163.4% | 93.4% | 94.3% |
| E2F | 107.6% | 96.9% | 56.7% | 122.4% | 92.3% | 98.4% |
| ER | 115.7% | 78.6% | 54.5% | 136.9% | 97.0% | 98.9% |
| GR | 108.1% | 103.2% | 48.6% | 148.7% | 93.7% | 103.0% |
| HSF-1 | 115.7% | 82.6% | 54.7% | 114.0% | 93.2% | 114.6% |
| HSF-2 | 101.9% | 86.8% | 64.3% | 123.2% | 96.5% | 93.6% |
| HSF-4 | 98.5% | 81.3% | 66.7% | 141.7% | 103.6% | 108.0% |
| IkBa | 96.6% | 61.1% | 56.0% | 154.0% | 101.0% | 101.8% |
| NFAT3 | 97.6% | 143.1% | 54.3% | 160.8% | 101.0% | 93.7% |
| NFkB | 85.1% | 82.8% | 38.2% | 129.2% | 113.9% | 102.2% |
| RARA | 114.0% | 104.8% | 35.0% | 194.0% | 104.7% | 91.4% |
| RARB1 | 90.7% | 70.1% | 32.6% | 142.4% | 109.9% | 87.4% |
| RARB2 | 101.3% | 61.5% | 72.0% | 129.3% | 111.0% | 89.3% |
| RARG | 90.9% | 76.4% | 69.2% | 127.9% | 107.2% | 94.7% |
| Rb | 108.6% | 71.9% | 45.4% | 145.7% | 101.0% | 85.0% |
| SRF | 77.1% | 77.1% | 53.8% | 127.7% | 106.3% | 88.6% |
| STAT1a | 85.5% | 56.7% | 86.4% | 134.6% | 110.1% | 89.6% |
| STAT1b | 100.9% | 64.6% | 70.2% | 166.6% | 100.2% | 86.8% |
| STAT2 | 79.1% | 40.6% | 42.8% | 163.0% | 97.8% | 89.9% |
| STAT3 | 167.3% | 51.3% | 54.4% | 132.0% | 96.6% | 94.0% |
| TR | 67.6% | 61.1% | 51.8% | 134.0% | 94.6% | 90.9% |
| p53 | 94.0% | 85.7% | 53.1% | 170.0% | 91.8% | 89.3% |
| Anti-GFP | | | | | | |

TABLE 6-2
HepG2 cells

| HepG2 | GRE | HSE | ISRE | Myc | NFAT | NFKB |
|---|---|---|---|---|---|---|
| Scramble | 100.0% | 100.0% | 100.0% | 100.0% | 100.0% | 100.0% |
| c-Myc | 75.7% | 98.4% | 109.0% | 102.1% | 82.3% | 55.6% |
| c-Fos | 83.0% | 108.7% | 72.3% | 95.9% | 86.0% | 94.8% |
| c-Jun | 70.5% | 107.1% | 111.4% | 94.7% | 81.2% | 71.3% |
| CREB | 91.4% | 125.9% | 73.4% | 76.4% | 81.8% | 100.8% |
| E2F | 78.1% | 128.2% | 77.0% | 69.2% | 111.8% | 91.9% |
| ER | 76.8% | 106.7% | 97.4% | 66.2% | 96.1% | 62.3% |
| GR | 111.5% | 110.1% | 75.0% | 60.3% | 89.8% | 86.6% |
| HSF-1 | 71.0% | 118.5% | 94.8% | 57.0% | 89.4% | 95.0% |
| HSF-2 | 73.3% | 108.9% | 68.3% | 62.0% | 120.0% | 77.2% |
| HSF-4 | 77.4% | 104.3% | 82.1% | 57.3% | 119.6% | 67.4% |
| IkBa | 106.2% | 102.3% | 76.0% | 61.9% | 102.1% | 64.5% |
| NFAT3 | 84.7% | 94.2% | 97.0% | 55.4% | 100.0% | 109.9% |
| NFkB | 89.1% | 95.0% | 99.7% | 57.6% | 94.9% | 54.6% |
| RARA | 77.3% | 108.5% | 104.2% | 56.9% | 100.8% | 62.5% |
| RARB1 | 68.6% | 96.4% | 75.6% | 46.3% | 91.3% | 60.8% |
| RARB2 | 112.6% | 89.3% | 70.7% | 48.0% | 99.0% | 67.9% |
| RARG | 76.8% | 94.3% | 91.9% | 96.2% | 104.2% | 84.4% |
| Rb | 84.7% | 100.5% | 91.6% | 102.3% | 149.8% | 131.6% |
| SRF | 63.1% | 102.6% | 89.4% | 119.5% | 174.7% | 63.2% |
| STAT1a | 79.9% | 97.8% | 77.7% | 122.0% | 162.6% | 93.7% |
| STAT1b | 72.1% | 93.9% | 66.9% | 116.4% | 187.8% | 47.3% |
| STAT2 | 77.6% | 89.5% | 69.2% | 140.5% | 161.2% | 83.7% |
| STAT3 | 89.2% | 119.3% | 82.9% | 105.1% | 118.2% | 50.2% |
| TR | 62.8% | 92.3% | 90.4% | 87.2% | 89.0% | 87.9% |
| p53 | 66.1% | 95.2% | 63.6% | 69.1% | 92.8% | 86.1% |
| Anti-GFP | | | | | | |

TABLE 6-3
HepG2 cells

| HepG2 | RARE | Rb | STAT3 | SRE | TRE | P53 | Actin |
|---|---|---|---|---|---|---|---|
| Scramble | 100.0% | 100.0% | 100.0% | 100.0% | 100.0% | 100.0% | 100.0% |
| c-Myc | 96.9% | 110.4% | 83.8% | 96.3% | 103.5% | 81.7% | 87.4% |
| c-Fos | 66.8% | 525.5% | 80.2% | 88.4% | 127.0% | 503.7% | 81.3% |
| c-Jun | 59.1% | 516.4% | 81.6% | 74.4% | 98.6% | 228.0% | 108.1% |
| CREB | 46.1% | 686.6% | 105.6% | 63.3% | 82.1% | 107.9% | 132.2% |
| E2F | 59.7% | 296.1% | 187.0% | 54.0% | 89.3% | 317.2% | 75.4% |
| ER | 67.4% | 87.7% | 105.1% | 57.9% | 86.7% | 192.2% | 60.8% |
| GR | 51.4% | 169.1% | 133.8% | 55.7% | 85.4% | 142.9% | 93.9% |
| HSF-1 | 59.5% | 376.9% | 136.0% | 47.9% | 1198.2% | 68.8% | 50.0% |
| HSF-2 | 77.6% | 320.1% | 174.8% | 48.6% | 183.5% | 54.9% | 33.2% |
| HSF-4 | 47.7% | 195.9% | 120.3% | 41.0% | 233.3% | 95.2% | 54.1% |
| IkBa | 65.2% | 139.7% | 116.1% | 39.7% | 139.8% | 301.1% | 48.6% |
| NFAT3 | 57.6% | 195.5% | 136.6% | 53.1% | 120.8% | 310.6% | 51.1% |
| NFkB | 53.5% | 138.8% | 119.9% | 44.4% | 143.3% | 129.4% | 53.5% |
| RARA | 60.9% | 246.0% | 105.4% | 61.5% | 112.5% | 89.1% | 73.1% |
| RARB1 | 71.6% | 273.6% | 57.7% | 38.4% | 120.2% | 135.3% | 202.0% |
| RARB2 | 50.0% | 137.0% | 69.0% | 55.8% | 142.7% | 74.2% | 149.0% |
| RARG | 107.9% | 258.3% | 53.0% | 83.2% | 103.5% | 132.3% | 94.5% |
| Rb | 80.3% | 395.2% | 92.4% | 70.0% | 98.8% | 649.6% | 127.7% |
| SRF | 79.4% | 220.9% | 63.2% | 55.1% | 128.0% | 126.2% | 66.3% |
| STAT1a | 72.3% | 136.5% | 39.0% | 45.8% | 108.7% | 173.3% | 100.2% |
| STAT1b | 71.6% | 150.9% | 40.8% | 38.1% | 111.2% | 156.6% | 363.0% |
| STAT2 | 59.6% | 104.2% | 68.3% | 39.8% | 90.6% | 116.5% | 82.3% |
| STAT3 | 120.4% | 144.1% | 63.8% | 32.6% | 106.9% | 86.6% | 143.9% |
| TR | 81.7% | 113.6% | 53.6% | 26.5% | 86.8% | 94.3% | 199.6% |
| p53 | 99.2% | 181.7% | 52.2% | 33.2% | 294.4% | 26.5% | 191.9% |
| Anti-GFP | | | | | | | 45.7% |

Normalized matrix of the network of HepG2 cells are provided as follows:

TABLE 6-4

| HepG2 | AP1 | PMA | CRE | E2F | ERE | GAS | GRE | HSE | ISRE | Myc | NFAT |
|---|---|---|---|---|---|---|---|---|---|---|---|
| Scramble | | | | | | | | | | | |
| c-Myc | −1 | −1 | −1 | 0 | 0 | 0 | −1 | 0 | 0 | 0 | 0 |
| c-Fos | 0 | 0 | −1 | 0 | 0 | 0 | 0 | 0 | −1 | 0 | 0 |
| c-Jun | 0 | 0 | −1 | 0 | 0 | 0 | −1 | 0 | 0 | 0 | 0 |
| CREB | 1 | 1 | −1 | 1 | 0 | 0 | 0 | 1 | −1 | −1 | 0 |
| E2F | 0 | 0 | −1 | 1 | 0 | 0 | −1 | 1 | −1 | −1 | 0 |
| ER | 0 | −1 | −1 | 1 | 0 | 0 | −1 | 0 | 0 | −1 | 0 |
| GR | 0 | 0 | −1 | 1 | 0 | 0 | 0 | 0 | −1 | −1 | 0 |
| HSF-1 | 0 | 0 | −1 | 0 | 0 | 0 | −1 | 0 | 0 | −1 | 0 |
| HSF-2 | 0 | 0 | −1 | 1 | 0 | 0 | −1 | 0 | −1 | −1 | 1 |
| HSF-4 | 0 | 0 | −1 | 1 | 0 | 0 | −1 | 0 | 0 | −1 | 0 |
| IkBa | 0 | −1 | −1 | 1 | 0 | 0 | 0 | 0 | −1 | −1 | 0 |
| NFAT3 | 0 | 1 | −1 | 1 | 0 | 0 | 0 | 0 | 0 | −1 | 0 |
| NFkB | 0 | 0 | −1 | 1 | 0 | 0 | 0 | 0 | 0 | −1 | 0 |
| RARA | 0 | 0 | −1 | 1 | 0 | 0 | −1 | 0 | 0 | −1 | 0 |
| RARB1 | 0 | −1 | −1 | 1 | 0 | 0 | −1 | 0 | −1 | −1 | 0 |
| RARB2 | 0 | −1 | −1 | 1 | 0 | 0 | 0 | 0 | −1 | −1 | 0 |
| RARG | 0 | −1 | −1 | 1 | 0 | 0 | −1 | 0 | 0 | 0 | 0 |
| Rb | 0 | −1 | −1 | 1 | 0 | 0 | 0 | 0 | 0 | 0 | 1 |
| SRF | −1 | −1 | −1 | 1 | 0 | 0 | −1 | 0 | 0 | 0 | 1 |
| STAT1a | −1 | −1 | 0 | 1 | 0 | 0 | −1 | 0 | −1 | 1 | 1 |
| STAT1b | 0 | −1 | −1 | 1 | 0 | 0 | −1 | 0 | −1 | 0 | 1 |
| STAT2 | −1 | −1 | −1 | 1 | 0 | 0 | −1 | 0 | −1 | 1 | 1 |
| STAT3 | 1 | −1 | −1 | 1 | 0 | 0 | 0 | 0 | 0 | 0 | 0 |
| TR | −1 | −1 | −1 | 1 | 0 | 0 | −1 | 0 | 0 | 0 | 0 |
| P53 | 0 | 0 | −1 | 1 | 0 | 0 | −1 | 0 | −1 | −1 | 0 |
| Anti-GFP | | | | | | | | | | | |

| HepG2 | NFKB | RARE | Rb | STAT3 | SRE | TRE | P53 | Actin |
|---|---|---|---|---|---|---|---|---|
| Scramble | | | | | | | | |
| c-Myc | −1 | 0 | 0 | 0 | 0 | 0 | 0 | 0 |
| c-Fos | 0 | −1 | 1 | 0 | 0 | 1 | 1 | 0 |
| c-Jun | −1 | −1 | 1 | 0 | −1 | 0 | 1 | 0 |
| CREB | 0 | −1 | 1 | 0 | −1 | 0 | 0 | 1 |
| E2F | 0 | −1 | 1 | 1 | −1 | 0 | 1 | −1 |
| ER | −1 | −1 | 0 | 0 | −1 | 0 | 1 | −1 |
| GR | 0 | −1 | 1 | 1 | −1 | 0 | 1 | 0 |
| HSF-1 | 0 | −1 | 1 | 1 | −1 | 1 | −1 | −1 |
| HSF-2 | −1 | −1 | 1 | 1 | −1 | 1 | −1 | −1 |
| HSF-4 | −1 | −1 | 1 | 1 | −1 | 1 | 0 | −1 |
| IkBa | −1 | −1 | 1 | 0 | −1 | 1 | 1 | −1 |
| NFAT3 | 0 | −1 | 1 | 1 | −1 | 1 | 1 | −1 |
| NFkB | −1 | −1 | 1 | 0 | −1 | 1 | 1 | −1 |
| RARA | −1 | −1 | 1 | 0 | −1 | 0 | 0 | −1 |
| RARB1 | −1 | −1 | 1 | −1 | −1 | 1 | 1 | 1 |
| RARB2 | 0 | −1 | 1 | −1 | −1 | 1 | −1 | 1 |
| RARG | 0 | 0 | 1 | −1 | 0 | 0 | 1 | 0 |
| Rb | 1 | 0 | 1 | 0 | −1 | 0 | 1 | 1 |
| SRF | −1 | −1 | 1 | −1 | −1 | 1 | 1 | −1 |
| STAT1a | 0 | −1 | 1 | −1 | −1 | 0 | 1 | 0 |
| STAT1b | −1 | −1 | 1 | −1 | −1 | 0 | 1 | 1 |
| STAT2 | 0 | −1 | 0 | −1 | −1 | 0 | 0 | 0 |
| STAT3 | −1 | 1 | 1 | −1 | −1 | 0 | 0 | 1 |
| TR | 0 | 0 | 0 | −1 | −1 | 0 | 0 | 1 |
| P53 | 0 | 0 | 1 | −1 | −1 | 1 | −1 | 1 |
| Anti-GFP | | | | | | | | −1 |

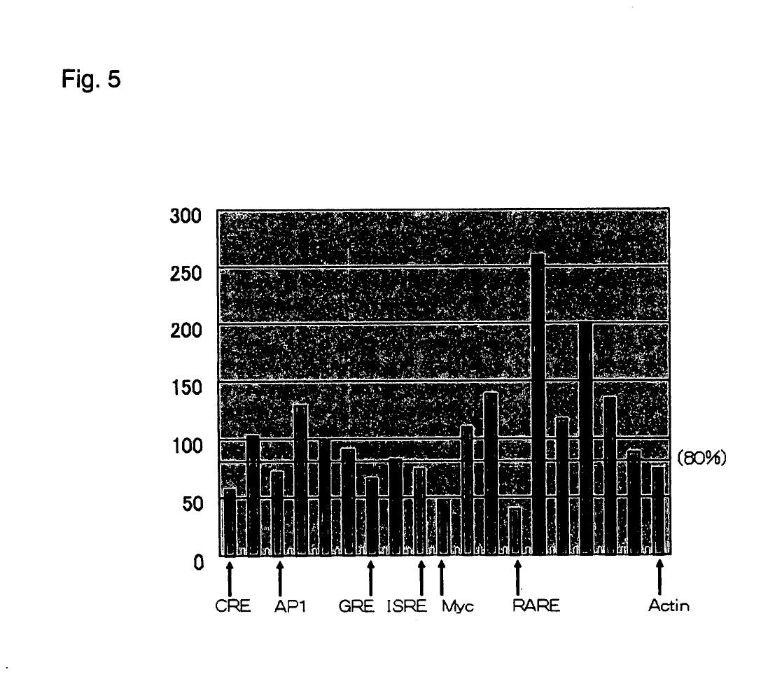

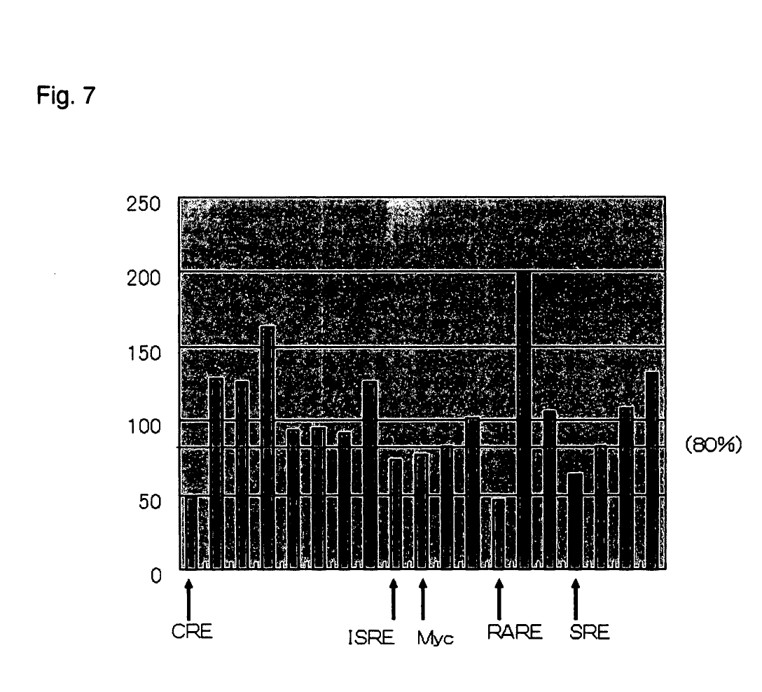

Exemplary results were summarized in FIGS. 5 and 7.

As shown in FIGS. 5 and 7, when RNAi was used, the expression of each gene was specifically suppressed in a variety of manners. Thus, it was demonstrated that an array having a plurality of genetic material, which are applicable to RNAi, can be realized and analysis using set theory can be performed for the effect of RNAi on cells.

### Example 5

### Mathematical Analysis Using Set Theory

Next, analysis using set theory was produced based on data obtained using the techniques described in Examples 2-4. Here, HeLa cells and HepG2 cell were used for analysis. For HeLa and HepG2 cells, transcriptional factors SRE, TRE, E2F, p53, Rb, Actin, NFAT, NFkB, STAT3, RARE, PMA, ISRA, HSE, Myc, AP1, GAS, ERE, GRE and CRE were used.

(Mathematical Analysis Technique)

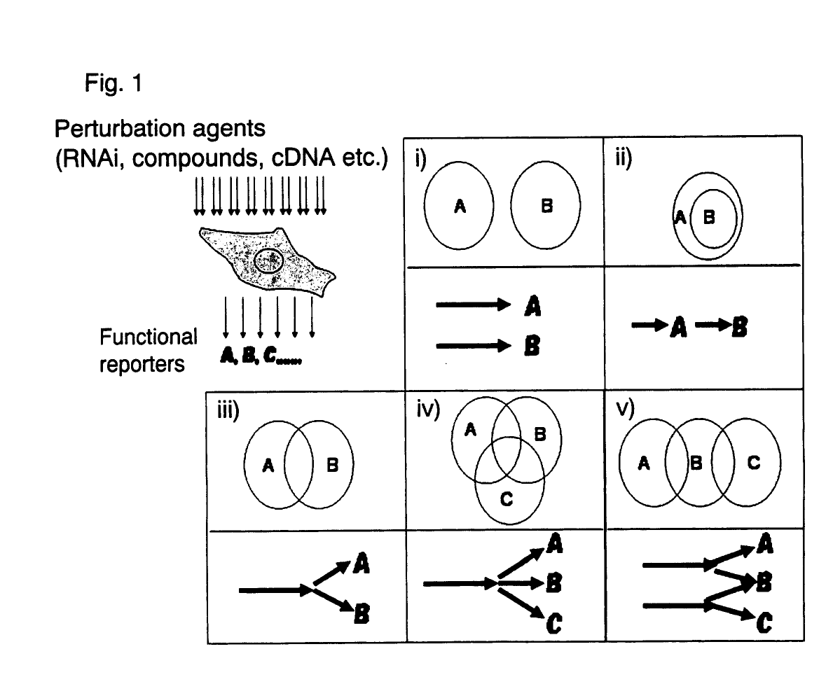

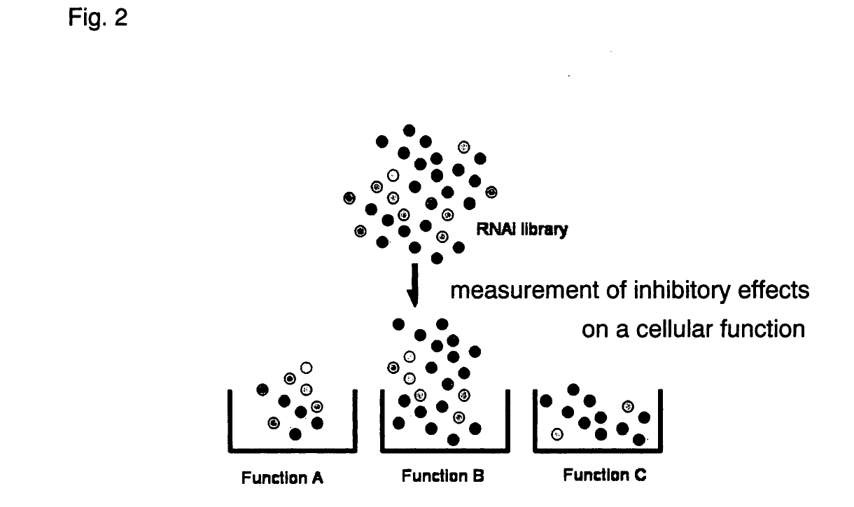

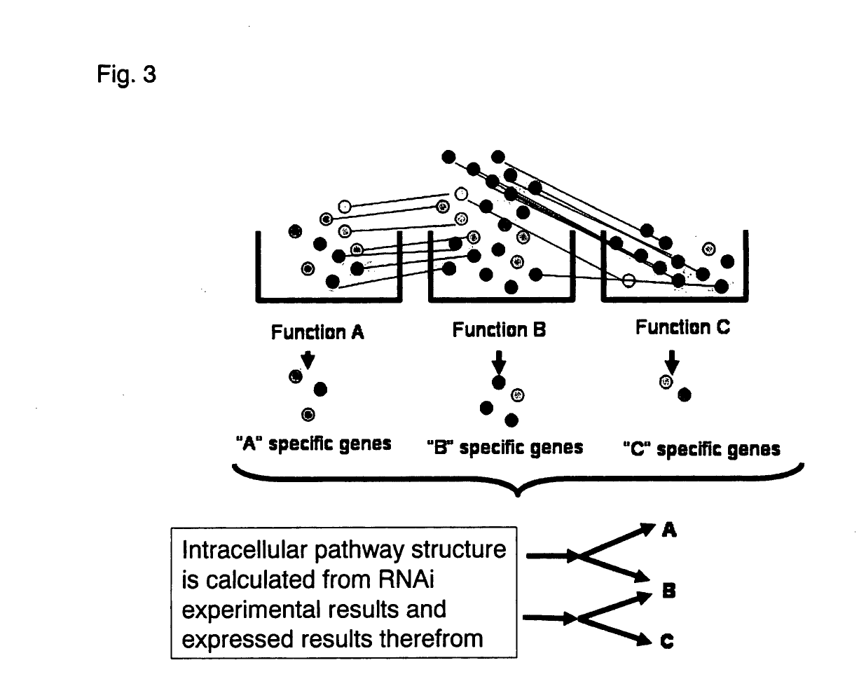

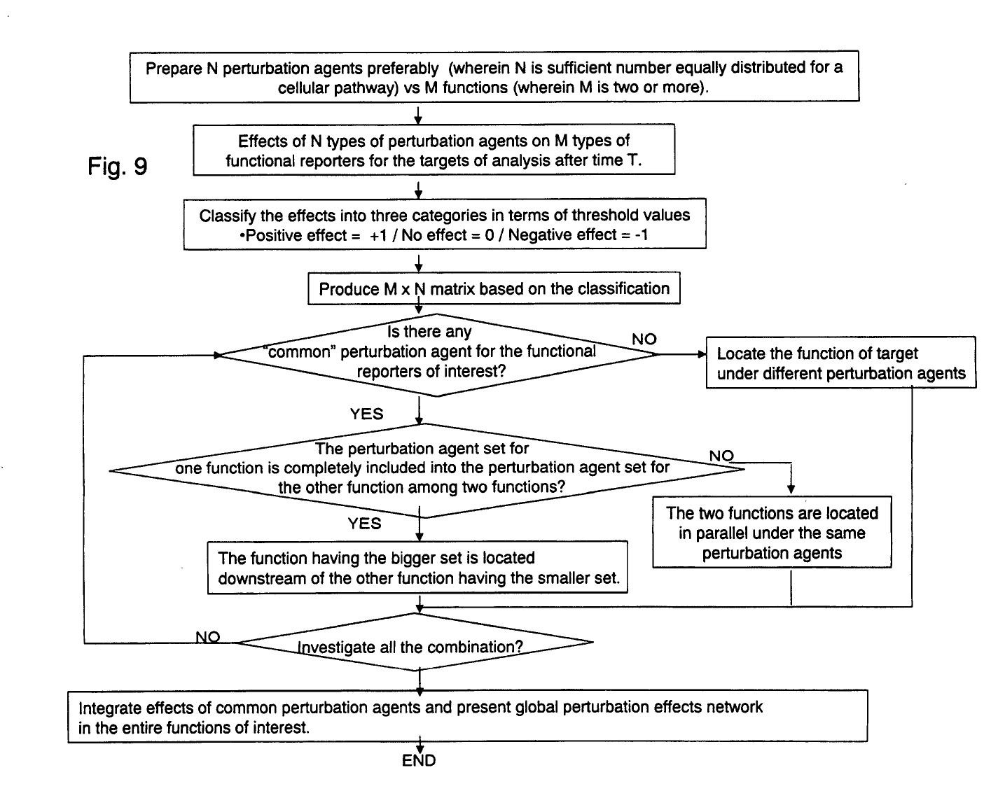

A mathematical analysis technique used herein is shown in FIGS. 1 and 9. FIG. 1 shows a schematic diagram of analysis according to one embodiment of the present invention. A and B refer to functional reporters, which can be regarded as sets, reflecting functions of a biological entity such as a cell. Perturbation agents used are located within set A, within set B, within the intersection of set A and set B, outside of set A or set B. i) shows a case where there are no perturbation agents for function A (set A) and function B (set B). In i), function A and B are located under different perturbation agents. ii) shows a case where there are perturbation agents for functions A and B, and all the perturbation agents to be included into function B are also included in function A. In ii), function B is located downstream of function A. iii) shows a case where there are common perturbation agents, but some are included only in function A and some are included only in function B. In iii), functions A and B are located under a common perturbation agent in parallel. iv) and v) show cases where three functions are involved. These can be explained in a similar manner as when two functions are used. In principle, integration of all combination of two functions will produce the global network of all functions. FIG. 9 shows a schematic flow chart for an exemplary embodiment of the present invention. This flow chart can be conducted in a computer.

An assay was conducted using the reporters for the siRNA under control conditions (cells, supplement factors, culture conditions, etc.). For the following analysis, conditions as described in Example 4 were used.

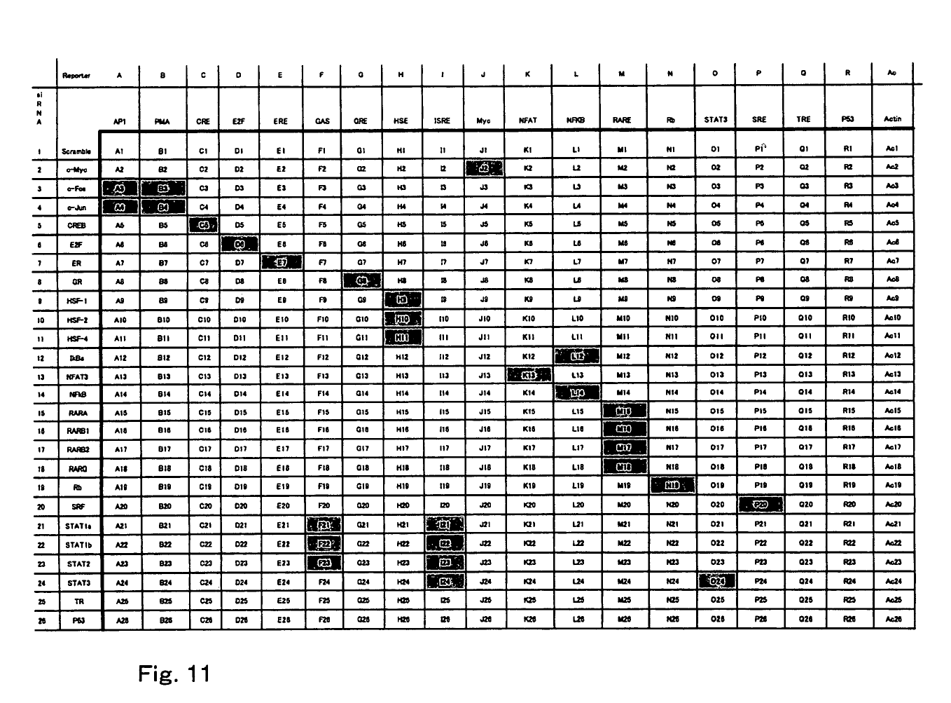

The matrix used for calculation of a combination matrix of functional reporters and siRNA shown in FIG. 11. Each column represents a column and row corresponding to an Excel(trademark) sheet.

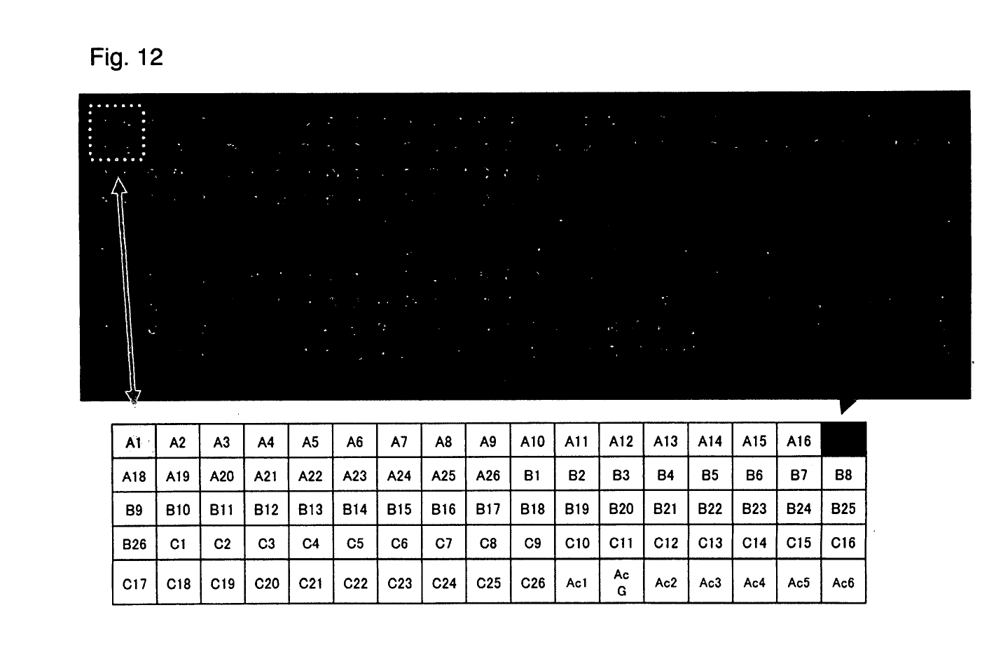

The actually used transfection array is shown in FIG. 12. FIG. 12 shows HeLa array scanned images (16-bit tiff image). Each mixture solution was printed as in the lower panel. After seeding cells, an array scanner was used for obtaining images (see upper panel).

Exemplary results are summarized in FIG. 5 and 7. It was demonstrated that when compared only to DNA in this manner, most of the transcription factors were induced when inducing agents were added.

Next, the activity of the siRNAs was classified into three groups including +, 0 and −. The results can be expressed using a matrix. The effects were analyzed in accordance with the set theory using scheme as shown in FIG. 1. In this case, effect of siRNA on parameters such as cellular formation, neurite growth, gene expression, and the like were compared. The measurement can be conducted at any time after a certain period of time sufficient for observing the effect of interest. For example, in this example, 1 hour and 6 hours were selected.

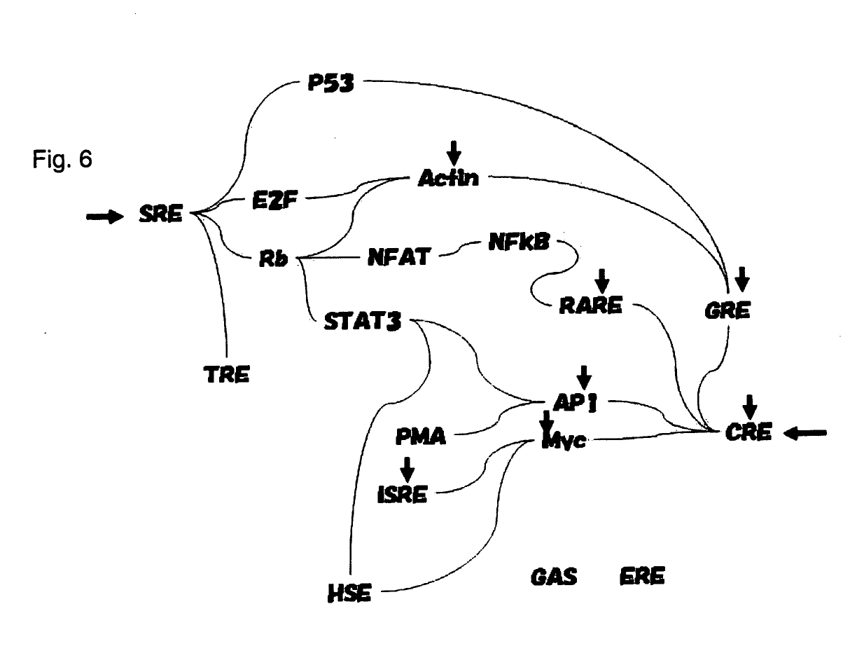

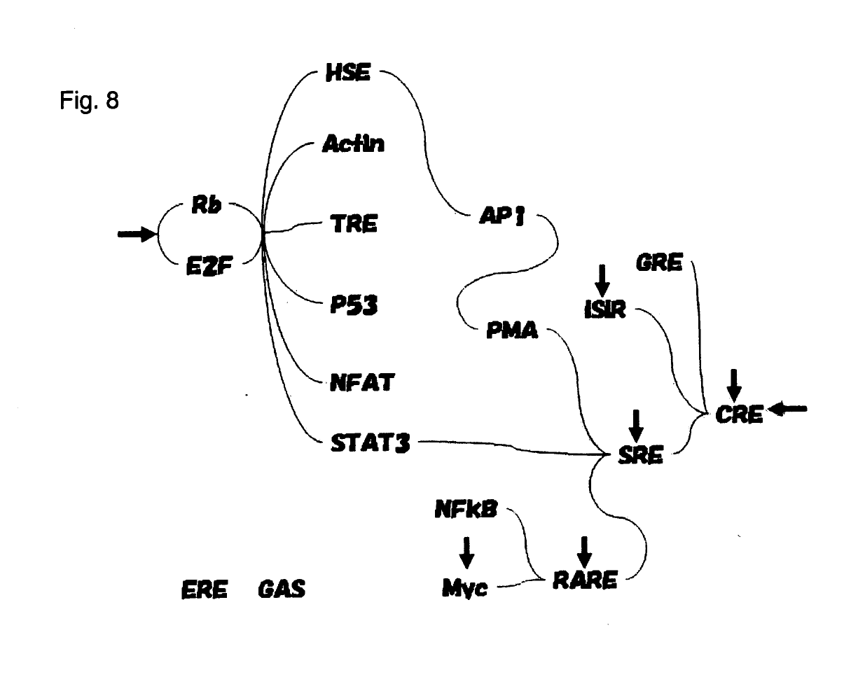

The results are shown in FIGS. 6 and 8. As shown in FIG. 6, in HeLa cells, SRE is located most downstream of the network. Above SRE, p53, E2F, Rb and TRE are located. Actin is located above E2F and Rb, and Rb has actin, NFAT and STAT3 thereabove. NFkB is upstream of NFAT, and has RARE thereabove. STAT3 has AP1 and HSE thereabove. AP1 is located upstream of PMA and ISRE. CRE is located most upstream of the network of the parameters used, and has GRE, RARE, AP1 and Myc thereunder. GAS and ERE have no related parameter and therefore are independent in the network analyzed.

As shown in FIG. 8, in HepG2 cells, CRE is located most upstream of the network analyzed, and has GRE, ISIR and SRE thereunder. SRE has PMA, STAT3 and RARE thereunder, Rb and E2F are located downstream of HSE, actin, TRE, p53, NFAT and STAT3. STAT3 is located downstream of SRE. PMA is located upstream of AP1, which is located upstream of HSE. NFkB and Myc are located downstream of RARE. ERE and GAS have no related parameter and therefore independent in the network analyzed.

For confirmatory experiments, effects of siRNA for CRE for HeLa and HepG2 cells were analyzed. The results are shown by arrows. Arrows show the transcriptional factors which had inhibitory effects by the addition of siRNA for CRE, therefore suggest that these factors are located very close to the CRE in the network.

In conclusion, the present invention in which a network of a biological entity such as a cell, can be correctly analyzed by applying set theory. Set theory has never been used to analyze biological functions, in particular, a network thereof. Therefore, it is a significant result to find that set theory can be used for correctly construct network relationships of parameters of a biological entity.

### Example 6

### MicroRNA

Next, nucleic acid molecules encoding microRNA (miRNA) were used to produce cellular networks. As miRNA, miRNA-23 was used. A protocol as used in the above-described examples was used.

MicroRNA is a non-coding RNA of 18 to 25 bases (not translated into protein), which was first found in nematodes and then revealed to be preserved widely in animals and plants. It has been reported that miRNA is involved in the development and differentiation of nematodes and plants. It has been suggested that animals have a similar process. To date 200 or more miRNAs have been reported.

H. Kawasaki, K. Taira, Nature 423, 838-842(2003) reported that the target of miRNA-23 is the Hes1 gene (Hes1 is a repressor transcription factor which suppress the differentiation of stem cells into neurons). miRNA-23 is present in the vicinity of the translation terminating codon for this gene, and forms incomplete complementary base pairing (77%). Such incomplete complementary base pairing is important for the function of miRNA. Indeed, it has already been found that synthetic miRNA-23, which is introduced into NT2 human embryonic tumor cells, can suppress the expression of Hes1. This activity can be knocked out by using siRNA or the like.

According to the above-described principle, miRNA is produced.

It can be demonstrated that such a system can be used to analyze by set theory in a similar manner as described above for miRMA.

### Example 7

### Biological System-ribozyme

Next, a ribozyme was used to produce cellular networks. A ribozyme as described in 305 YAKUGAKU ZASSHI [Journal of Pharmacology] 123(5) 305-313 (2003) was herein used. A protocol as described in the above mentioned Examples was used.

Ribozymes were discovered by observing that the group I intron of tetrahymena catalyzes site specific cleavage and binding reactions of RNA chains. A ribozyme refers to RNA having such an enzymatic activity. Examples of ribozymes include hammerhead ribozymes, hairpin ribozymes, and the like.

It can be demonstrated that such a system can be used to analyze by set theory in a similar manner as described above for ribozymes.

### Example 8

### Drug Screening

Next, a compound library is used for screening a drug. A cell, which is a model of a disease such as a cancer cell, normal cell, and stem cell, is used for screening. A compound library containing 1,000 compounds is used as perturbation agents. Parameters such as transcriptional factors, regulatory genes, structural genes, cellular markers, cell surface markers, cell shapes, organelle shapes, cell mobility, enzyme activities, metabolite is concentrations, and localization of cellular components are selected. Exemplary parameters are: cancer drugs, drugs for diabetes, and the like.

These parameters are measured in an appropriate manner for each parameter, and information collected thereon. Collected information is analyzed based on set theory as described above.

Analyzing the results to allow elucidating which compounds are likely to be a leading candidate for the drug, thereby used for drug screening.

Accordingly, the present invention is useful for identifying a novel drug.

### Example 9

### Identification of Biomarkers

The present invention can be used for identification of biomarkers. Biomarkers are generally indicators for quantifying or digitizing biological information. Such biomarkers include blood glucose level as a biomarker for diabetes, adiponectin. TNF-alpha, PAI-1 and the like, which are gradually used in clinic. Digitization of biological information can be interpreted to specification of effects of perturbation agents on a cell, and characteristic network structure in a variety of cells (cancers, normal cells, stem cells and the like).

In this regard, siRNA can be used as a target for drug discovery, and the identified siRNA may used for developing drugs.

Therefore, the present Example uses a variety of is biomarkers as functional reporters of perturbation agents such as siRNA and the like. Specific functional reporters identified in the present Example may be used as biomarkers for the specific cell of interest.

### Example 10

### Analysts of Adverse Effect and Diagnosis of Cellular Functions

The present invention may also be used for analyzing an adverse effect of a drug, and/or diagnosing a cell or other biological entity including diagnosis of infectious diseases. The present invention can also be used for analyzing cellular pathways.

In this example, changes in network structures by perturbation agents are sorted in a catalog format to provide an evaluation standard for distinguishing normal and abnormal cells. Further, by obtaining network structures characterizing a cellular function, a method of evaluating a cellular function can be conducted.

For example, when administering a drug to a variety of normal cells from a variety of organs, comparing with a normal network structure (without administering the drug) allows evaluation of effects including adverse effects of the drug on a biological entity such as a cell. Further, network database including catalogs of network structures, information of known databases such as KEGG signaling gateways and the like, can be used for characterizing cellular functions. Mapping of perturbation agents having effects on cellular functions on a map created by the database allow analysis of pathway characterizing cellular functions.

### Example 11

### Biological Evaluation of Compounds

Perturbation agents are not only those having a single target, but also those having a number of targets, and therefore compounds used in drug screening and/or siRNAs can be combined for evaluating biological effects. When using these compounds and/or siRNAs, it should be considered that these agents have a plurality of targets and therefor have effects on a plurality of functions constituting a network. Effects on such a network structure obtained by the present example, are also useful for analyzing effects of compounds on a biological entity.

### Example 12

### Rational Approach to Analyze Functional Roles of Tyrosine Kinases in Neuritegenesis

In the present example, human neuroblastoma, SHSY5Y was used for observing the differentiation to neuron like cells based on the information obtained from the method of the present invention.

In the presence of retinoic acid, SHSY5Y cells express choline acetyltransferase and extend the neurites thereof. In the presence of NGF, the cells express tyrosine hydroxylase and extend the neurite thereof.

Therefore, tyrosine kinases play an important role as a valve in the signaling pathway for cellular events.

In the present Example, it is studies which tyrosine kinase amongst a huge number of tyrosine kinases is responsible for choline acetyltransferase induction, tyrosine hydroxylase expression and neurite extention events.

### EXPERIMENTAL

### Materials and Methods

Cell used: SH-SY5Y (available from ATCC No: CRL-2266)

Reagents used:

Retinoic acid (all-trans available from Sigma-Aldrich, Prod. No. R 2625)

NGF (available from Sigma 2.5 S #N-6009)

Eagle's minimum essential medium, foetal bovine serum, glatamine, and pencillin/streptomycin were purchased from BioWhittaker, Walkersville, Md.

(Cell Culture)

Human neuroblastoma (SHSY5Y) cells were maintained in Eagle's minimum essential medium (EMEM) supplemented with 10% (v/v) foetal bovine serum (FBS), 2% (v/v) glutamine and 1% (v/v) penicillin/streptomycin (10% medium), hereafter referred to as growth medium. Cells were incubated at 37° C. in a humidified atmosphere of 5% carbon dioxide.

(Differentiation)

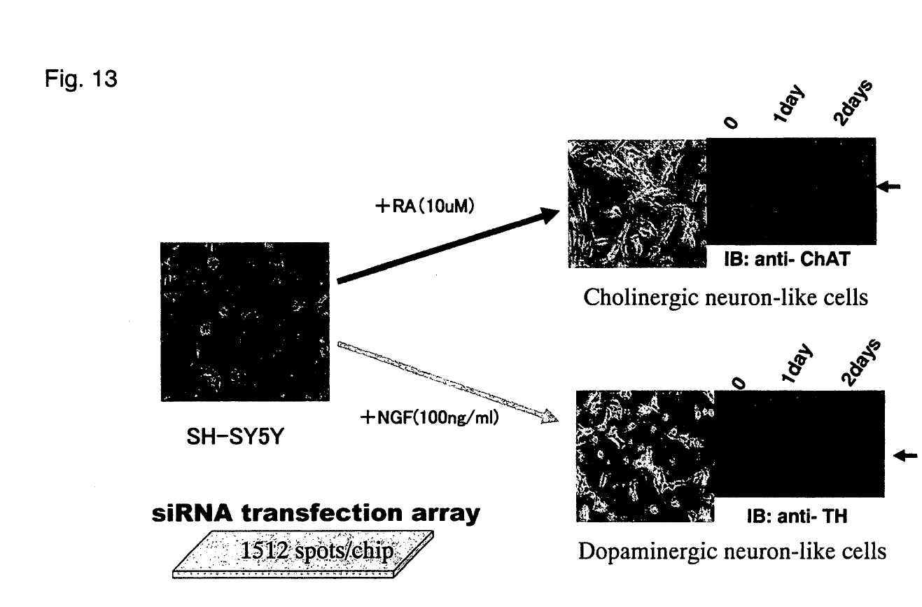

Differentiation has been performed according to Yamada Y. et al., Neurosci Lett. 2004 Jun. 24; 364(1):11-15. Briefly, 100 ng/ml of NGF or 10 ug of retinoic acid was added to the culture medium differentiate the SHSY5Y cells. Usually, when retinoic acid is added, the cell differentiates into cholinergic neuron-like cell as exemplified in FIG. 13. When NGF is added, the cell differentiates into dopaminergic neuron-like cells as exemplified in FIG. 13.

(Transfection Microarray)

Transfection microarray experiments were performed according to the Examples described hereinabove.

(On-chip Image-based Quantification of Neurite Outgrowth Inhibition by the siRNAs Targeted Tyrosine Kinases)

In order to analyze various types of kinases, siRNA specific to the tyrosine kinases have been used, siRNA were prepared according to the Examples described hereinabove.

Neurite growth was measured by means of image-based quantification frequency of neurite outgrowth according to Neurosci Lett. 2005 Apr. 11; 378(1):40-3. Epub 2005 Jan. 7. In Brief, the protocols are as follows.

Rat pheochromocytoma (PC12) cells (Tischler, A. S., and L. A. Greene. 1975. Nerve growth factor-induced process formation by cultured rat pheochromrocytoma cells. Nature (Lond.). 258: 341-342.) were grown in monolayer culture in DME with 4.5 g/l glucose supplemented with 10% heat-inactivated horse serum. 5% newborn calf serum, glutamine (2 mM), and penicillin/streptomycin (100 U/ml) and were carried for no more than 10 passages. PC12 cells were “primed” with NGF as described (Greene. L. A. 1977. A quantitative bioassay for nerve growth factor (NGF) activity employing a clonal pheochromocytoma cell line. Brain Res. 133: 350-353; Greene. L. A., D. S. Burstein, and M. M. Black. 1982. The role of transcription-dependent priming in nerve growth factor promoted neurite outgrowth. Dev. Biol. 91:305-316). For studies on process outgrowth, NGF-primed PC12 cells were passaged and mechanically divested of their neurites by trituration through a narrow bore 9-inch pasteur pipet. After washing three times in growth medium, cells were resuspended at a concentration of 10⁵ cells/ml in growth medium with or without 50 ng/ml NGF, and 100 ul of this cell suspension were added per welt (0.28 cm² surface area).

Fixation and staining with fluorescein labeled antibody to neurofilament 100 protein or DM1A antibody to tubulin (4 hr) have been conducted. Image acquisition using IN Cell Analyzer 1000 (Amersham Bioscicences); 3 min/plate was conducted.

(Acquisition)

Images were acquired at 1392×1040 pixels, 12 bit precision, 400 msec exposure. Total acquisition time (move/focus/acquire) was about 3 mm for an entire 96 well plate. Both epifluorescence (4× and 10× objectives) and D|C (10×) optics were used.

(Manual Scoring)

Two skilled technicians traced nourites and cell bodies using MCID™ Elite image analysts software. A minimum length parameter was combined with visual evaluation to distinguish neurites from other structures.

(Automated Scoring).

The machine was given a set of scoring parameters (minimum and maximum neurite width, minimum neurite length, mean cell size per condition), defined prior to the analysis. The measurements required for the predefinition process took about an hour to obtain.

(Results)

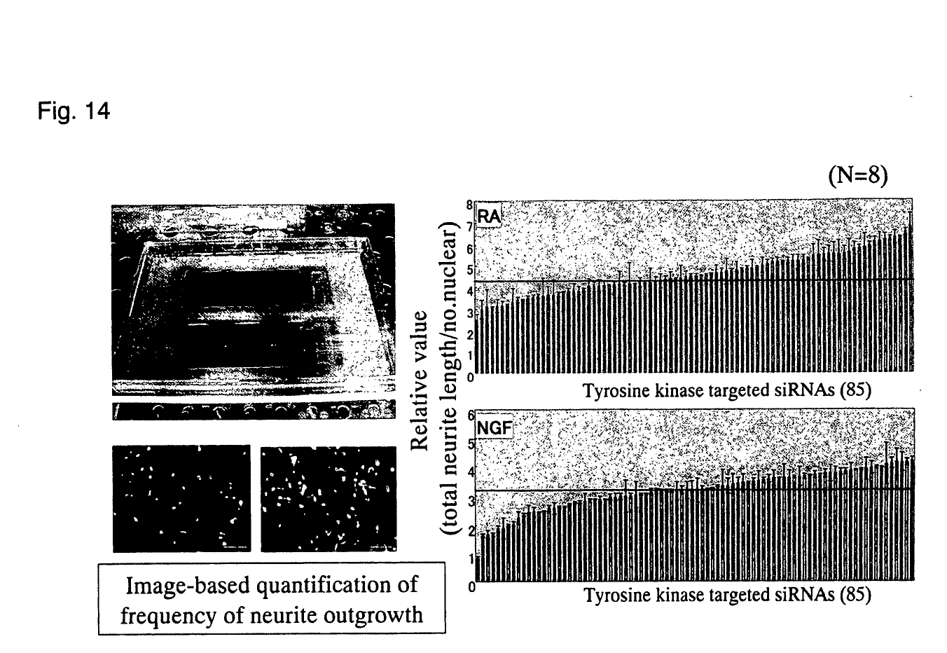

The results are shown in FIG. 14. FIG. 14 shows graphs of total neurite length/no. nucleus vs. tyrosine kinase targeted siRNA (85 types were used).

(Rational Approach to Analyze the Functional Roles of Tyrosine Kinases in Neuritegenesis)

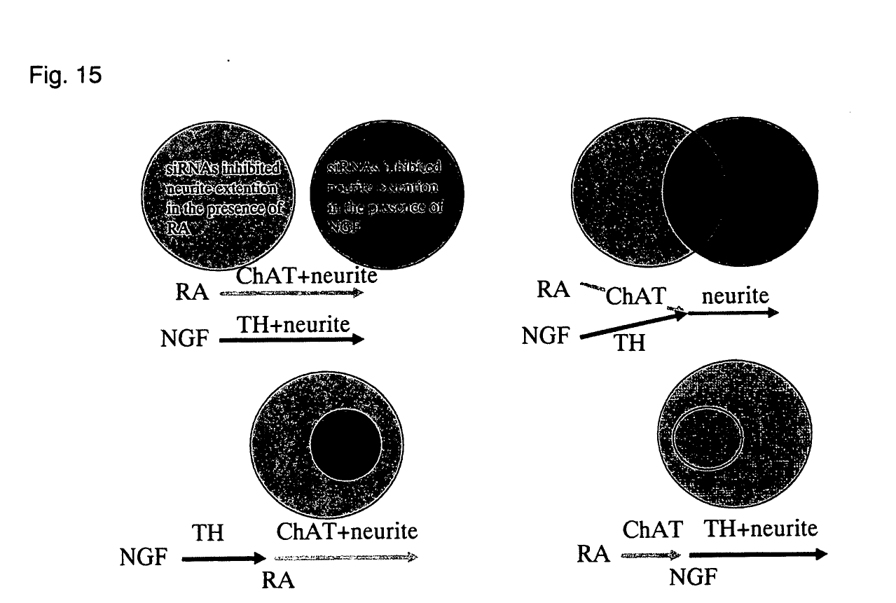

Overview of the rational approach to analyze the functional roles of tyrosine kinases in neuritegenesis to shown in FIG. 15. As in FIG. 15A (upper left), the set in which siRNAs inhibited neurite extension in the presence of retinoic acid (RA; hereinafter the RA set), and the set in which siRNAs inhibited neurite extension in the presence of NGF (hereinafter the NGF set) are separately (independently) present, then the two pathways triggered by choline acetyltransferase (differentiation into cholinergic neuron-like cell) and by tyrosine hydroxylase (differentiation into dopaminergic neuron-like cell) are independent. Cholinergic neuron-like cells were identified by using anti-choline acetyltransferase antibody, and dopaminergic neuron-like cells were identified by using anti-tyrosine hydroxylase antibody, both of which are available from Clontech.

If the RA set and the NGF set have overlapping members, then the pathway is interpreted to be as shown in FIG. 15B. As shown, RA signal and NGF signal are integrated into the same pathway into the neurite direction.

If the NGF set is encompassed by the RA set as shown in FIG. 15C, then the pathway is interpreted such that the NGF signaling (tyrosine hydrophosphate) is located upstream of the RA signaling (choline acetyltransferase) and eventually results in neurite growth.

If the RA set is encompassed by the NGF set as shown in FIG. 15D, then the pathway is interpreted such that the RA signaling (choline acetyltransferase) is located upstream of the NGF signaling (tyrosine hydrophosphate) and eventually results in neurite growth.

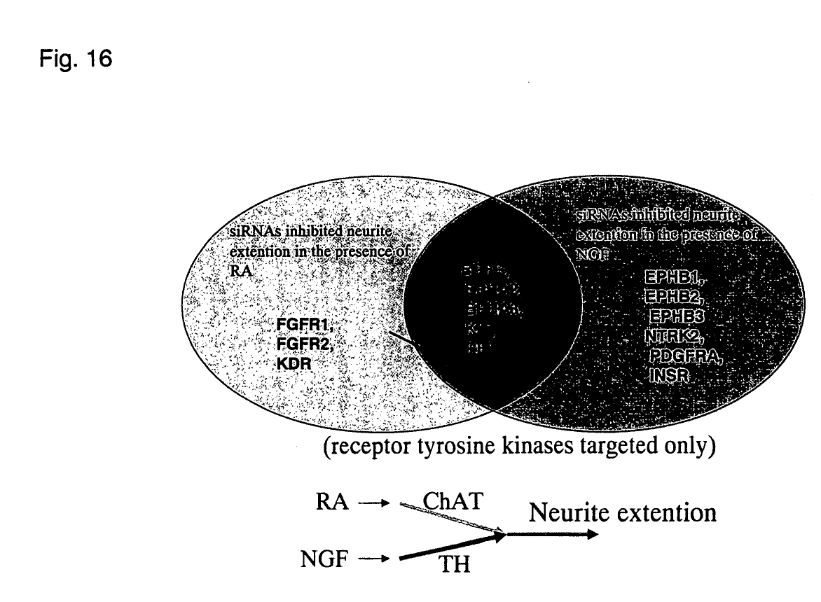

By conducting above-mentioned analysis, we have elucidated a number of kinases by rational relation from the comprehensive data of the cell-based siRNA assay (FIG. 16). FIG. 16 shows that siRNAs against FGFR1, FGFR2 and KDR inhibited neurite extension in the presence of RA, but not in the presence of NGF. EPHB1, EPHB2, EPHB3, NTRK2, PDGFRA, and INSR inhibited neurite extension in the presence of NGF but not in the presence of RA. Furthermore, siRNAs against EGFR, EPHA2, EPHA2, KIT and RET inhibited neurite extension in the present of both RA and NGF.

(Knockdown of RTK Proteins)

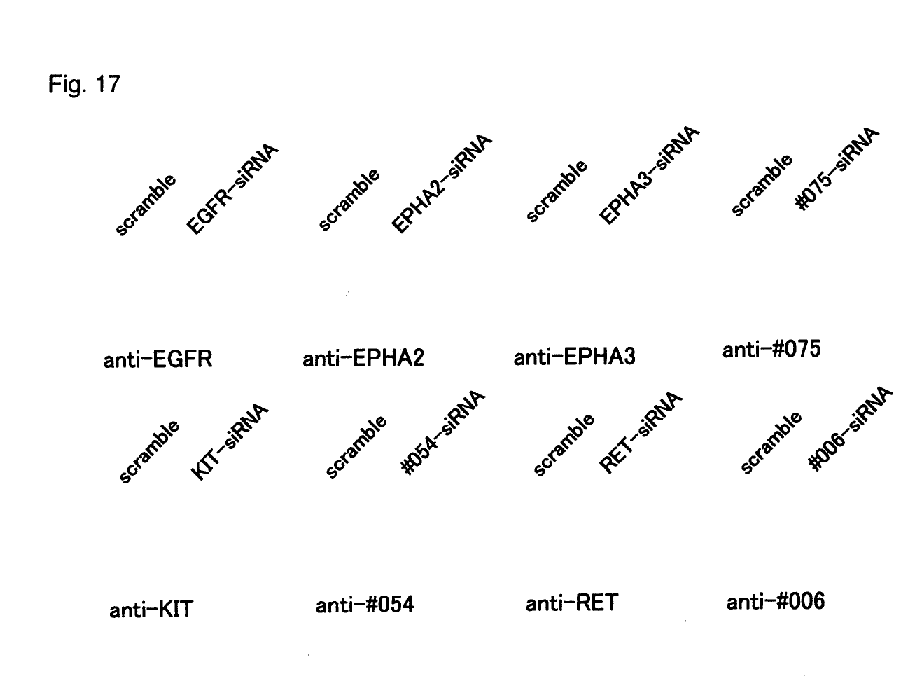

In order to further analyze the functions of tyrosine kinases, we further conducted knockdown experiments using a variety of siRNA against tyrosine kinases. siRNA's were designed according to the protocols as described hereinabove or according to the common general knowledge of the art. FIG. 17 shows the results of EGFR-siRNA, EPHA2-siRNA, EPHA3-siRNA, #075-siRNA, KIT-siRNA, #054-siRNA, RET-siRNA and #006-siRNA. The entire nucleotide sequences of EGFR, EPHA2, EPHA3, #075, KIT, #054, RET and #006 are shown in the Sequence Listings (SEQ ID NOs: 78, 80, 82, 84, 86, 88, 90 and 92, respectively). The entire amino acid sequences of EGFR, EPHA2, EPHA3, #075, KIT, #054, RET and #006 are shown in the Sequence Listings (SEQ ID NOs: 79. 81, 83, 85, 87, 89, 91 and 93, respectively)

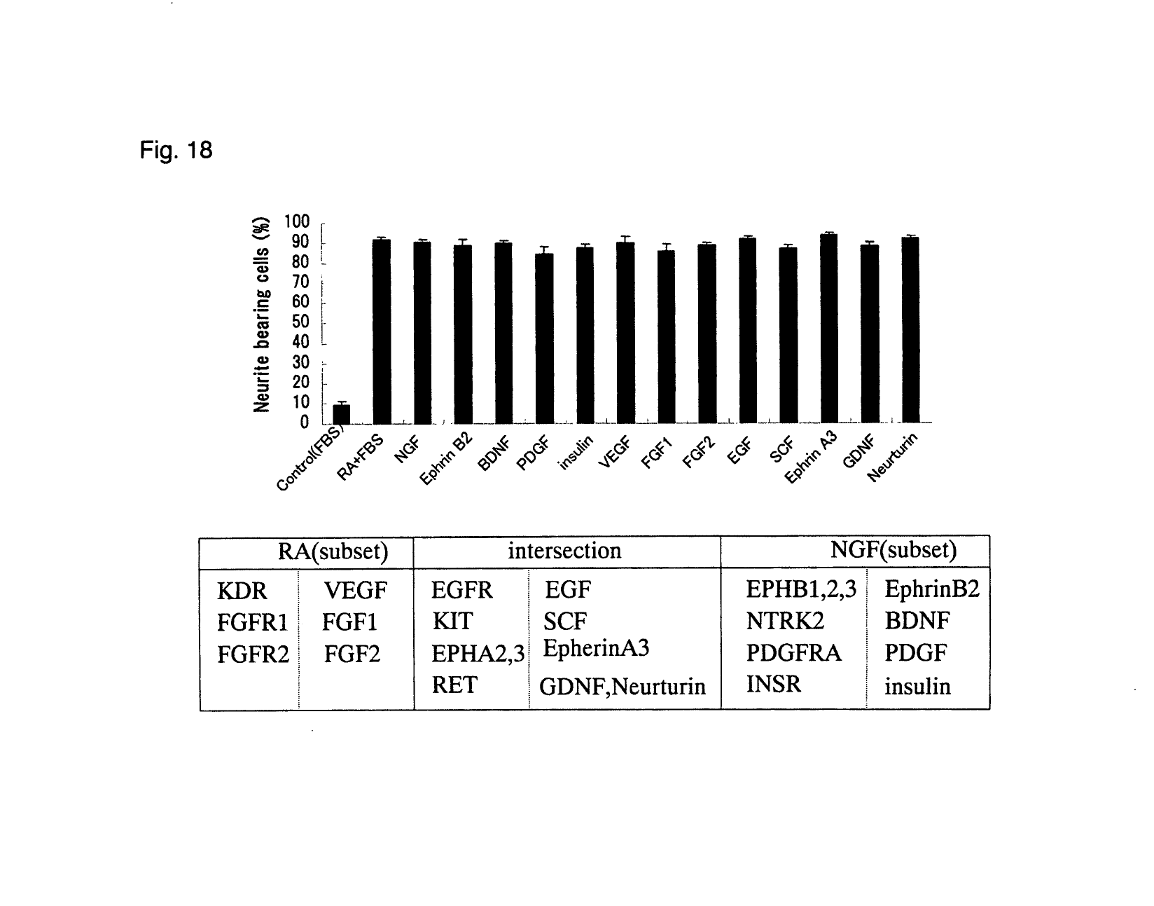

Neurite extension in the presence of the specific ligands of the receptor tyrosine kinases was also examined. FBS without specific agents was used as a control. RA-FBS, NGF, Ephrin B2, BDNF, PDGF, Insulin, VEGF, FGF1, FGF2, EGF, SCF, EphrinA3, GDNF and Neurturin were examined. FIG. 18 shows neurite bearing cell percentages are shown for each agent. RA subset include KDR, FGFR1 and FGFR2, which receptors correspond to ligands VEGF, FGF1 and FGF2, respectively. NGF subset include EPHB1, EPHB2, EPHB3, NTRK2, PDFGRA and INSR, which receptors correspond to ligands EphrinB2, EphrinB2, EphrinB2, BDNF, PDGF and insulin. The intersection subset of RA and NGF subsets encompasses EGFR, KIT, EPHA2, EPHA3 and RET, which receptors correspond to ligands EGF, SCF, EpherinA3, EPhrinA3 and GFNF/Neurturin.

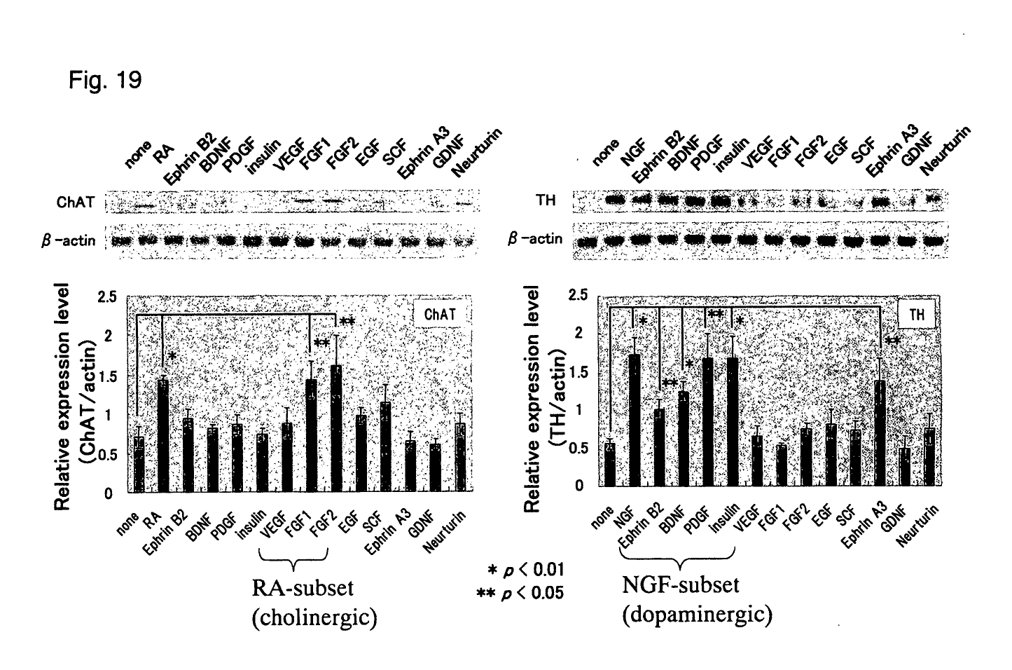

Next, the marker enzyme expression in the presence of each ligand of the receptor tyrosine kinase has been studied. First, expression of each ligand enhanced by ChAT, TH and beta-actin (control) was analyzed for the ligands described above. The intensity of expression of each ligand is shown above (wet data; FIG. 19, upper panels), and in relative expression level (FIG. 19, lower panels). As shown, RA is strongly correlated with VEGF, FGF1 and FGF2, which indicates that these ligands are cholinergic, whereas NGF is strongly correlated with NGF, Ephrin B2, BDNF, PDGF, insulin and Pehrin A3, which indicates that these ligands are dopaminergic.

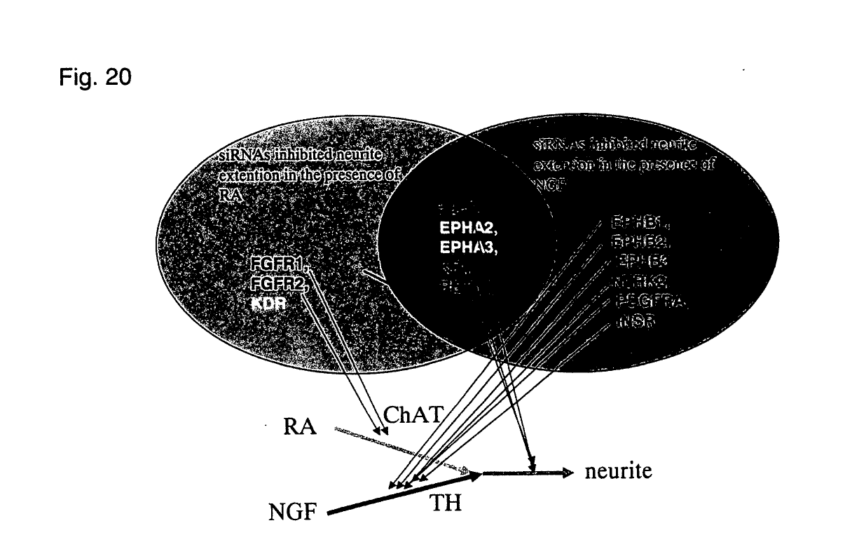

In summary, as shown in FIG. 20, which shows comparison of the rational relation and biological results, a variety of kinases are classified into subsets of biological significance based on the set theory analysis of the present invention. Specifically, FGFR1 and FGFR2 are classified into ones located upstream of RA signaling pathway before integration. EPHB1, EPHB2, EPHB3, NTRK2, PDGFRA, and INSR are classified into ones located upstream of NGF signaling pathway. EGFR, KIT and RET are classified into ones located downstream of the pathways after integration before proceeding to the neurite extension.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

### INDUSTRIAL APPLICABILITY

According to the present invention, it is possible to determine the state of cells by observing a surprisingly small number of factors. Therefore, the present invention is applicable to diagnosis, prevention, and treatment. The present invention is also applicable to the fields of food, cosmetics, agriculture, environmental engineering, and the like.

What is claimed is:

1. A method for analyzing a network of biological functions in a biological entity, comprising the steps of:
A) subjecting a biological entity to at least one perturbation agent;
B) obtaining information on at least two functional reporters in said biological entity, wherein the functional reporters reflect a biological function; and
C) subjecting the obtained information to set theory processing to calculate a relationship between the functional reporters to generate a network relationship of the biological functions.

2. The method according to claim 1, wherein the biological entity is a cell.

3. The method according to claim 1, wherein the perturbation agent is selected from the group consisting of RNA including siRNA, shRNA, miRNA, and ribozyme, chemical compound, cDNA, antibody, polypeptides, light, sound, pressure change, radiation, heat, and gas.

4. The method according to claim 1, wherein said perturbation agent comprises a siRNA capable of specifically regulating a function of said functional reporter.

5. The method according to claim 1, wherein said functional reporter is capable of transmitting a measurable signal.

6. The method according to claim 1, wherein said functional reporter is selected from the group consisting of transcriptional factors, regulatory genes, structural genes, cellular markers, cell surface markers, cell shapes, organelle shapes, cell mobility, enzyme activities, metabolite concentrations, and localization of cellular components.

7. The method according to claim 1, wherein said set theory processing comprises:
classifying two specific functional reporters of said at least two functional reporters into a relationship selected from the group consisting of
a) independent;
b) inclusion; and
c) intersection,
wherein when it is determined to be independent, the two specific functional reporters are determined to have no relationship in the network; when it is determined to be inclusion, one of the two specific functional reporters is determined to be included in the other of the two specific functional reporters and is located downstream of the other;
when it is determined to be intersection, the two specific functional reporters are determined to be located downstream, branched from another common function.

8. The method according to claim 1, wherein the set theory processing comprises the step of mapping the absence or presence of a response by said perturbation agent per said functional reporter.

9. The method according to claim 1, wherein said calculation of relationship between said reporters comprises a correlation between each functional reporter as classified into independent, inclusion and intersection to generate a summary of the correlation.

10. The method according to claim 1, wherein said perturbation factors are prepared with the number sufficient for equally targeting an intracellular pathway.

11. The method according to claim 1, wherein the information on at least two functional reporters is based on an effect of said perturbation agent after a desired time.

12. The method according to claim 1, wherein said effect is classified into the following three groups in terms of a threshold value: positive effect=+; no effect=0; and negative effect=−.

13. The method according to claim 1, wherein the information on at least two functional reporters is based on an effect of said perturbation agent after a desired time; wherein the set theory processing comprises:
a) classifying the information into three categories by comparing the effect with a threshold value for the functional reporter and classifying into the following three groups: positive effect=+, no effect=0; and negative affect=−;
b) determining if two out of the functional reporters have a common perturbation agent, wherein the common perturbation agent has the same type of effect, and if there is no such a common perturbation agent, then the two functions corresponding to the two functional reporters are located under different perturbation agents and if there is such a common perturbation agent, then the following step c) is conducted:
c) determining if the perturbation agent set for one function of the two functions is completely included into the perturbation agent set for the other function of the two functions, and if this is the case, then one function having the bigger set to located downstream of the other function having the smaller set, and if this is not the case, then the two functions are located in parallel under the same perturbation agents;
d) determining if all combinations of the functional reporters are investigated, if this is the case, then integrate all the relationships of functions to a present global perturbation effects network, and if this is not the case then repeat the steps a) to c).

14. The method according to claim 13, wherein said three groups are classified into+1, 0 and −1.

15. The method according to claim 13, wherein said steps of a) to c) are calculated by producing M×N matrix, wherein M refers to the number of functional reporters and N refers to the number of perturbation agents.

16. The method according to claim 1, further comprising analyzing the generated network by conducting an actual biological experiment.

17. The method according to claim 16, wherein said step of analyzing comprises the use of a regulation agent specific to the function.

18. The method according to claim 17, wherein the regulation agent is an siRNA.

19. The method according to claim 1, wherein said network comprises a signal transduction pathway and a cellular pathway.

20. The method according to claim 1, wherein said network is used for a use selected from the group consisting of identification of a biomarker, analysis of a drug target, analysis of a side effect, diagnosis of a cellular function, analysis of a cellular pathway, evaluation of a biological effect of a compound, and diagnosis of an infectious disease.

21. A system for analyzing a network of biological functions in a biological entity, comprising:
A) at least one perturbation agent for a biological entity;
B) means for obtaining information on at least two functional reporters in said biological entity, wherein the functional reporters reflect a biological function; and
C) means for subjecting the obtained information to set theory processing to calculate a relationship between the functional reporters to generate a network relationship of the biological functions.

22. The system according to claim 21, wherein the biological entity is a cell.

23. The system according to claim 21, wherein the perturbation agent is selected from the group consisting of siRNA, chemical compound, cDNA, antibody, polypeptides, light, sound, pressure change, radiation, heat, and gas.

24. The system according to claim 21, wherein said perturbation agent comprises an siRNA capable of specifically regulating a function of said functional reporter.

25. The System according to claim 21, wherein said functional reporter is capable of transmitting a measurable signal.

26. The system according to claim 21, wherein said functional reporter is selected from the group consisting of transcriptional factors, structural genes, cellular markers, cell surface markers cell shapes, organelle shapes, cell mobility, enzyme activities, metabolite concentrations, and localization of cellular components.

27. The system according to claim 21, wherein said set theory processing comprises:
classifying two specific functional reporters of said at least two functional reporters into a relationship selected from the group consisting of
a) independent;
b) inclusion; and
c) intersection,
wherein when it is determined to be independent, the two specific functional reporters are determined to have no relationships in the network;
when it is determined to be inclusion, one of the two specific functional reporters is determined to be included in the other of the two specific functional reporters and is located downstream of the other;
when it is determined to be intersection, the two specific functional reporters are determined that to be located downstream, branched from another common function.

28. The system according to claim 21, wherein the set theory processing comprises the step of mapping the absence or presence of a response by said perturbation agent per said functional reporter.

29. The system according to claim 21, wherein said calculation of relationship between said reporters comprises correlation between each functional reporter as classified into independent, inclusion and intersection to generate a summary of the correlation.

30. The system according to claim 1, wherein said perturbation factors are prepared with the number sufficient for equally targeting an intracellular pathway.

31. The system according to claim 21, wherein said means for obtaining information comprises means for obtaining the information on at least two functional reporters is based on an effect of said perturbation agent after a desired time.

32. The system according to claim 21, wherein said effect is classified into the following three groups in terms of a threshold values positive effect=+: no effect=0; and negative effect=−.

33. The method according to claim 1, wherein the information on at least two functional reporters is based on an effect of said perturbation agent after a desired time;
wherein the means for subjecting the obtained information to set theory processing comprises:
a) means for classifying the information into three categories by comparing the effect with a threshold value for the functional reporter and classifying into the following three groups: positive effect=+; no effect=0; and negative effect=−;
b) means for determining if two out of the functional reporters have common perturbation agent, wherein the common perturbation agent has the same type of effect, and if there is no such common perturbation agent, then the two functions corresponding to the two functional reporters are located under different perturbation agents and if there is such a common perturbation agent, then the following step c) is conducted:
c) means for determining if the perturbation agent set for one function of the two functions is completely included into the perturbation agent set for the other function of the two functions, and if this is the case, then one function having the bigger set is located downstream of the other function having the smaller set, and if this is not the case, then the two functions are located in parallel under the same perturbation agents;
d) means for determining if all combinations of the functional reporters are investigated, if this is the case, then integrate all the relationships of functions to a present global perturbation effects network, and if this is not the case then repeat the steps conducted by the means a) to c).

34. The system according to claim 33, wherein said three groups are classified into+1, 0 and −1.

35. The system according to claim 33, wherein said means of a) to c) are conducted by producing M×N matrix, wherein M refers to the number of functional reporters and N refers to the number of perturbation agents.

36. The system according to claim 21, further comprising means for analyzing the generated network by conducting an actual biological experiment.

37. The system according to claim 36, wherein said means for analyzing comprises a regulation agent specific to the function.

38. The system according to claim 37, wherein the regulation agent is an siRNA.

39. The system according to claim 21, wherein said network comprises a signal transduction pathway.

40. The system according to claim 21, wherein said network is used for a use selected from the group consisting of identification of a biomarker, analysis of a drug target, analysis of a side effect, diagnosis of a cellular function, analysis of a cellular pathway, evaluation of a biological effect of a compound, and diagnosis of an infectious disease.

41. A computer program for implementing in a computer, a method for analyzing a network of biological functions in a biological entity, comprising the steps of:
A) subjecting a biological entity to at least one perturbation agent;
B) obtaining information on at least two functional reporters in said biological entity, wherein the functional reporters reflect a biological function; and
C) subjecting the obtained information to set theory processing to calculate a relationship between the functional reporters to generate a network relationship of the biological functions.

42. A storage medium comprising a computer program for implementing in a computer, a method for analyzing a network of biological functions in a biological entity, comprising the steps of:
A) subjecting a biological entity to at least one perturbation agent;
B) obtaining information on at least two functional reporters in said biological entity, wherein the functional reporters reflect a biological function; and
C) subjecting the obtained information to set theory processing to calculate a relationship between the functional reporters to generate a network relationship of the biological functions.

43. A transmission medium comprising a computer program for implementing in a computer, a method for analyzing a network of biological functions in a biological entity, comprising the steps of:
A) subjecting a biological entity to at least one perturbation agent;
B) obtaining information on at least two functional reporters in said biological entity, wherein the functional reporters reflect a biological function; and
C) subjecting the obtained information to set theory processing to calculate a relationship between the functional reporters to generate a network relationship of the biological functions.


SEQUENCE LISTING (93 sequences)

SEQ ID NO: 1 - DNA, 2121 bp, Homo sapiens
  CDS (559)..(1878)
ctgctcgcggccgccaccgccgggccccggccgtccctggctcccctcctgcctcgagaagggcagggcttctcagaggcttggcgggaaaaaagaacggagggagggatcgcgctgagtataaaagccggttttcggggctttatctaactcgctgtagtaattccagcgagaggcagagggagcgagcgggcggccggctagggtggaagagccgggcgagcagagctgcgctgcgggcgtcctgggaagggagatccggagcgaatagggggcttcgcctctggcccagccctcccgcttgatcccccaggccagcggtccgcaacccttgccgcatccacgaaactttgcccatagcagcgggcgggcactttgcactggaacttacaacacccgagcaaggacgcgactctcccgacgcggggaggctattctgcccatttggggacacttccccgccgctgccaggacccgcttctctgaaaggctctccttgcagctgcttagacgctggatttttttcgggtagtggaaaaccagcagcctcccgcgacgatgcccctcaacgttagcttcaccaacaggaactatgacctcgactacgactcggtgcagccgtatttctactgcgacgaggaggagaacttctaccagcagcagcagcagagcgagctgcagcccccggcgcccagcgaggatatctggaagaaattcgagctgctgcccaccccgcccctgtcccctagccgccgctccgggctctgctcgccctcctacgttgcggtcacacccttctcccttcggggagacaacgacggcggtggcgggagcttctccacggccgaccagctggagatggtgaccgagctgctgggaggagacatggtgaaccagagtttcatctgcgacccggacgacgagaccttcatcaaaaacatcatcatccaggactgtatgtggagcggcttctcggccgccgccaagctcgtctcagagaagctggcctcctaccaggctgcgcgcaaagacagcggcagcccgaaccccgcccgcggccacagcgtctgctccacctccagcttgtacctgcaggatctgagcgccgccgcctcagagtgcatcgacccctcggtggtcttcccctaccctctcaacgacagcagctcgcccaagtcctgcgcctcgcaagactccagcgccttctctccgtcctcggattctctgctctcctcgacggagtcctccccgcagggcagccccgagcccctggtgctccatgaggagacaccgcccaccaccagcagcgactctgaggaggaacaagaagatgaggaagaaatcgatgttgtttctgtggaaaagaggcaggctcctggcaaaaggtcagagtctggatcaccttctgctggaggccacagcaaacctcctcacagcccactggtcctcaagaggtgccacgtctccacacatcagcacaactacgcagcgcctccctccactcggaaggactatcctgctgccaagagggtcaagttggacagtgtcagagtcctgagacagatcagcaacaaccgaaaatgcaccagccccaggtcctcggacaccgaggagaatgtcaagaggcgaacacacaacgtcttggagcgccagaggaggaacgagctaaaacggagcttttttgccctgcgtgaccagatcccggagttggaaaacaatgaaaaggcccccaaggtagttatccttaaaaaagccacagcatacatcctgtccgtccaagcagaggagcaaaagctcatttctgaagaggacttgttgcggaaacgacgagaacagttgaaacacaaacttgaacagctacggaactcttgtgcgtaaggaaaagtaaggaaaacgattccttctaacagaaatgtcctgagcaatcacctatgaacttgtttcaaatgcatgatcaaatgcaacctcacaaccttggctgagtcttgagactgaaagatttagccataatgtaaactgcctcaaattggactttgggcataaaagaacttttttatgcttaccatcttttttttttctttaacagatttgtatttaagaattgtttttaaaaaattttaa

SEQ ID NO: 2 - protein, 439 aa, Homo sapiens
MPLNVSFTNRNYDLDYDSVQPYFYCDEEENFYQQQQQSELQPPAPSEDIWKKFELLPTPPLSPSRRSGLCSPSYVAVTPFSLRGDNDGGGGSFSTADQLEMVTELLGGDMVNQSFICDPDDETFIKNIIIQDCMWSGFSAAAKLVSEKLASYQAARKDSGSPNPARGHSVCSTSSLYLQDLSAAASECIDPSVVFPYPLNDSSSPKSCASQDSSAFSPSSDSLLSSTESSPQGSPEPLVLHEETPPTTSSDSEEEQEDEEEIDVVSVEKRQAPGKRSESGSPSAGGHSKPPHSPLVLKRCHVSTHQHNYAAPPSTRKDYPAAKRVKLDSVRVLRQISNNRKCTSPRSSDTEENVKRRTHNVLERQRRNELKRSFFALRDQIPELENNEKAPKVVILKKATAYILSVQAEEQKLISEEDLLRKRREQLKHKLEQLRNSCA

SEQ ID NO: 3 - DNA, 6210 bp, Homo sapiens
  CDS (889)..(1029)
  CDS (1783)..(2034)
  CDS (2466)..(2573)
  CDS (2688)..(3326)
gcaggaacagtgctagtattgctcgagcccgagggctggaggttaggggatgaaggtctgcttccacgctttgcactgaattagggctagaattggggatgggggtaggggcgcattccttcgggagccgaggcttaagtcctcggggtcctgtactcgatgccgtttctcctatctctgagcctcagaactgtcttcagtttccgtacaagggtaaaaaggcgctctctgccccatcccccccgacctcgggaacaagggtccgcattgaaccaggtgcgaatgttctctctcattctgcgccgttcccgcctcccctcccccagccgcggcccccgcctccccccgcactgcaccctcggtgttggctgcagcccgcgagcagttcccgtcaatccctccccccttacacaggatgtccatattaggacatctgcgtcagcaggtttccacggcctttccctgtagccctggggggagccatccccgaaacccctcatcttggggggcccacgagacctctgagacaggaactgcgaaatgctcacgagattaggacacgcgccaaggcgggggcagggagctgcgagcgctggggacgcagccgggcggccgcagaagcgcccaggcccgcgcgccacccctctggcgccaccgtggttgagcccgtgacgtttacactcattcataaaacgcttgttataaaagcagtggctgcggcgcctcgtactccaaccgcatctgcagcgagcaactgagaagccaagactgagccggcggccgcggcgcagcgaacgagcagtgaccgtgctcctacccagctctgcttcacagcgcccacctgtctccgcccctcggcccctcgcccggctttgcctaaccgccacgatgatgttctcgggcttcaacgcagactacgaggcgtcatcctcccgctgcagcagcgcgtccccggccggggatagcctctcttactaccactcacccgcagactccttctccagcatgggctcgcctgtcaacgcgcaggtaaggctggcttcccgtcgccgcggggccgggggcttggggtcgcggaggaggagacaccgggcgggacgctccagtagatgagtagggggctcccttgtgcctggagggaggctgccgtggccggagcggtgccggctcgggggctcgggacttgctctgagcgcacgcacgcttgccatagtaagaattggttcccccttcgggaggcaggttcgttctgagcaacctctggtctgcactccaggacggatctctgacattagctggagcagacgtgtcccaagcacaaactcgctaactagagcctggcttcttcggggaggtggcagaaagcggcaatcccccctcccccggcagcctggagcacggaggagggatgagggaggagggtgcagcgggcgggtgtgtaaggcagtttcattgataaaaagcgagttcattctggagactccggagcggcgcctgcgtcagcgcagacgtcagggatatttataacaaaccccctttcaagcaagtgatgctgaagggataacgggaacgcagcggcaggatggaagagacaggcactgcgctgcggaatgcctgggaggaaaagggggagacctttcatccaggatgagggacatttaagatgaaatgtccgtggcaggatcgtttctcttcactgctgcatgcggcactgggaactcgccccacctgtgtccggaacctgctcgctcacgtcggctttccccttctgttttgttctaggacttctgcacggacctggccgtctccagtgccaacttcattcccacggtcactgccatctcgaccagtccggacctgcagtggctggtgcagcccgccctcgtctcctctgtggccccatcgcagaccagagcccctcaccctttcggagtccccgccccctccgctggggcttactccagggctggcgttgtgaagaccatgacaggaggccgagcgcagagcattggcaggaggggcaaggtggaacaggtgaggaactctagcgtactcttcctgggaatgtgggggctgggtgggaagcagccccggagatgcaggagcccagtacagaggatgaagccactgatggggctggctgcacatccgtaactgggagccctggctccaagcccattccatcccaactcagactctgagtctcaccctaagaagtactctcatagtttcttccctaagtttcttaccgcatgctttcagactgggctcttctttgttctcttgctgaggatcttattttaaatgcaagtcacacctattctgcaactgcaggtcagaaatggtttcacagtggggtgccaggaagcagggaagctgcaggagccagttctactggggtgggtgaatggaggtgatggcagacacttttactgaatgtcggtctttttttgtgattattctagttatctccagaagaagaagagaaaaggagaatccgaagggaaaggaataagatggctgcagccaaatgccgcaaccggaggagggagctgactgatacactccaagcggtaggtactctgtgggttgctcctttttaaaacttaagggaaagttggagattgagcataagggcccttgagtaagactgtgtcttatgctttcctttatccctctgtatacaggagacagaccaactagaagatgagaagtctgctttgcagaccgagattgccaacctgctgaaggagaaggaaaaactagagttcatcctggcagctcaccgacctgcctgcaagatccctgatgacctgggcttcccagaagagatgtctgtggcttcccttgatctgactgggggcctgccagaggttgccaccccggagtctgaggaggccttcaccctgcctctcctcaatgaccctgagcccaagccctcagtggaacctgtcaagagcatcagcagcatggagctgaagaccgagccctttgatgacttcctgttcccagcatcatccaggcccagtggctctgagacagcccgctccgtgccagacatggacctatctgggtccttctatgcagcagactgggagcctctgcacagtggctccctggggatggggcccatggccacagagctggagcccctgtgcactccggtggtcacctgtactcccagctgcactgcttacacgtcttccttcgtcttcacctaccccgaggctgactccttccccagctgtgcagctgcccaccgcaagggcagcagcagcaatgagccttcctctgactcgctcagctcacccacgctgctggccctgtgagggggcagggaaggggaggcagccggcacccacaagtgccactgcccgagctggtgcattacagagaggagaaacacatcttccctagagggttcctgtagacctagggaggaccttatctgtgcgtgaaacacaccaggctgtgggcctcaaggacttgaaagcatccatgtgtggactcaagtccttacctcttccggagatgtagcaaaacgcatggagtgtgtattgttcccagtgacacttcagagagctggtagttagtagcatgttgagccaggcctgggtctgtgtctcttttctctttctccttagtcttctcatagcattaactaatctattgggttcattattggaattaacctggtgctggatattttcaaattgtatctagtgcagctgattttaacaataactactgtgttcctggcaatagtgtgttctgattagaaatgaccaatattatactaagaaaagatacgactttattttctggtagatagaaataaatagctatatccatgtactgtagtttttcttcaacatcaatgttcattgtaatgttactgatcatgcattgttgaggtggtctgaatgttctgacattaacagttttccatgaaaacgttttattgtgtttttaatttatttattaagatggattctcagatatttatatttttattttatttttttctaccttgaggtcttttgacatgtggaaagtgaatttgaatgaaaaatttaagcattgtttgcttattgttccaagacattgtcaataaaagcatttaagttgaatgcgaccaaccttgtgctcttttcattctggaagtcttgtaagtttctgaaaggtattattggagaccagtttgtcaagaagggtagctgctggagggggacacaccctctgtctgatcccttatcaaagaggacaaggaaactatagagctgattttagaatattttacaaatacatgccttccattggaatgctaagattttctactgcttctggggacgggaaaccgctgtgtaacagcttttgtgggaatacattttttctgtttcagtactcgcagggggaaatatttaaattttgttgtgctaatattaaattcagatgttttgatcttaaaggaaccctttaagcaaacagaacctagctttgtacagactattttaactttttattctcacaaaatcacgtggagggttattctacttcaaagatgagcaaattgaagaatggttagaataaacaactttcttgatattccgttatcggcattagaatcttcctgctcgttatcgtatccagcaggctgaactgcctcttgatacttggttaaaaaaaattttcaggccgggcgcggtggcccatgcctgtaatcctagcactttgggaggccgaggcaggcggatcacctgaggtcgggagttcgagaccagcctgaccaacatggagaaaccccgtctttactaaaaatacaaaattagcctggtgtggtggtgcatgcctgtaatcctagctacttgagaggctgagacaggaaaatcacttgaactcgggaggcggatgttgcagcgaactgagattgcgccattgcactccagcctgggcaacaagattgaaactctgtttaaaaaaaaaagttttcactaatgtgtacatttttttgtactcttttattctcgaaagggaaggagggctattgccctatcccttattaataaatgcattgtggtttctggtttctctaataccatatgcccttcattcagtttatagtgggcggaagtgggggagaaaaagttgctcagaaatcaaaagatatctcaaacagcacaaataatggctgatcgttctgcaaacaaaaagttacataatagctcaagaaggagaagtcaacatgactctgaacaagctttaacttagaaactttatcatcttaaggaagaacgtgacctttgtccaggacgtctctggtaatggggcacttacacacacatgcacacgtacaaaccacagggaaaggagaccgcccttctgcctctgctcgcgagtatcacgcaggcaccatgcactatgttttcacacacactgggtggaagaagagcttcagcgccagtcttctaatgctttggtgataatgaaaatcactgggtgcttatggggtgtcatattcaatcgagttaaaagttttaattcaaaatgacagttttactgaggttgatgttctcgtctatgatatctctgcccctcccataaaaatggacatttaaaagcaacttaccgctctttagatcactcctatatcacacaccacttggggtgctgtttctgctagacttgtgatgacagtggccttaggatccctgtttgctgttcaaagggcaaatattttatagcctttaaatatacctaaactaaatacagaattaatataactaacaaacacctggtctgaaataacaaggtgatctaccctggaaggaacccagctggtgggccaggagcggtggctcacacctgtaattccagcactttgggaggctgagacaggaggatcactggagtccaggagtttgagaccagcctgggcaacatggcaaaacccagtgtgcttctgttgtcccagctacactactcaggaggctgaggcaggagtatgacttgagcctgggagggggaggttgcagagaactgatattgcaccaccactgcactccagcctgggtgacacagcaaaaccctatctcaaaaaaaaaaaaaaaaaaaaggaacccagctggttcctgtaggtgtgcaataataacaaccagaggaagaaaaggaagacgatttcccagatgaagaagggcagctggaccttcggac

SEQ ID NO: 4 - protein, 380 aa, Homo sapiens
MMFSGFNADYEASSSRCSSASPAGDSLSYYHSPADSFSSMGSPVNAQDFCTDLAVSSANFIPTVTAISTSPDLQWLVQPALVSSVAPSQTRAPHPFGVPAPSAGAYSRAGVVKTMTGGRAQSIGRRGKVEQLSPEEEEKRRIRRERNKMAAAKCRNRRRELTDTLQAETDQLEDEKSALQTEIANLLKEKEKLEFILAAHRPACKIPDDLGFPEEMSVASLDLTGGLPEVATPESEEAFTLPLLNDPEPKPSVEPVKSISSMELKTEPFDDFLFPASSRPSGSETARSVPDMDLSGSFYAADWEPLHSGSLGMGPMATELEPLCTPVVTCTPSCTAYTSSFVFTYPEADSFPSCAAAHRKGSSSNEPSSDSLSSPTLLAL

SEQ ID NO: 5 - DNA, 3622 bp, Homo sapiens
  CDS (1261)..(2256)
cccggggaggggaccggggaacagagggccgagaggcgtgcggcaggggggagggtaggagaaagaagggcccgactgtaggagggcagcggagcattacctcatcccgtgagcctccgcgggcccagagaagaatcttctagggtggagtctccatggtgacgggcgggcccgcccccctgagagcgacgcgagccaatgggaaggccttggggtgacatcatgggctatttttaggggttgactggtagcagataagtgttgagctcgggctggataagggctcagagttgcactgagtgtggctgaagcagcgaggcgggagtggaggtgcgcggagtcaggcagacagacagacacagccagccagccaggtcggcagtatagtccgaactgcaaatcttattttcttttcaccttctctctaactgcccagagctagcgcctgtggctcccgggctggtggttcgggagtgtccagagagccttgtctccagccggccccgggaggagagccctgctgcccaggcgctgttgacagcggcggaaagcagcggtaccccacgcgcccgccgggggacgtcggcgagcggctgcagcagcaaagaactttcccggcggggaggaccggagacaagtggcagagtcccggagcgaacttttgcaagcctttcctgcgtcttaggcttctccacggcggtaaagaccagaaggcggcggagagccacgcaagagaagaaggacgtgcgctcagcttcgctcgcaccggttgttgaacttgggcgagcgcgagccgcggctgccgggcgccccctccccctagcagcggaggaggggacaagtcgtcggagtccgggcggccaagacccgccgccggccggccactgcagggtccgcactgatccgctccgcggggagagccgctgctctgggaagtgagttcgcctgcggactccgaggaaccgctgcgcccgaagagcgctcagtgagtgaccgcgacttttcaaagccgggtagcgcgcgcgagtcgacaagtaagagtgcgggaggcatcttaattaaccctgcgctccctggagcgagctggtgaggagggcgcagcggggacgacagccagcgggtgcgtgcgctcttagagaaactttccctgtcaaaggctccggggggcgcgggtgtcccccgcttgccagagccctgttgcggccccgaaacttgtgcgcgcacgccaaactaacctcacgtgaagtgacggactgttctatgactgcaaagatggaaacgaccttctatgacgatgccctcaacgcctcgttcctcccgtccgagagcggaccttatggctacagtaaccccaagatcctgaaacagagcatgaccctgaacctggccgacccagtggggagcctgaagccgcacctccgcgccaagaactcggacctcctcacctcgcccgacgtggggctgctcaagctggcgtcgcccgagctggagcgcctgataatccagtccagcaacgggcacatcaccaccacgccgacccccacccagttcctgtgccccaagaacgtgacagatgagcaggaggggttcgccgagggcttcgtgcgcgccctggccgaactgcacagccagaacacgctgcccagcgtcacgtcggcggcgcagccggtcaacggggcaggcatggtggctcccgcggtagcctcggtggcagggggcagcggcagcggcggcttcagcgccagcctgcacagcgagccgccggtctacgcaaacctcagcaacttcaacccaggcgcgctgagcagcggcggcggggcgccctcctacggcgcggccggcctggcctttcccgcgcaaccccagcagcagcagcagccgccgcaccacctgccccagcagatgcccgtgcagcacccgcggctgcaggccctgaaggaggagcctcagacagtgcccgagatgcccggcgagacaccgcccctgtcccccatcgacatggagtcccaggagcggatcaaggcggagaggaagcgcatgaggaaccgcatcgctgcctccaagtgccgaaaaaggaagctggagagaatcgcccggctggaggaaaaagtgaaaaccttgaaagctcagaactcggagctggcgtccacggccaacatgctcagggaacaggtggcacagcttaaacagaaagtcatgaaccacgttaacagtgggtgccaactcatgctaacgcagcagttgcaaacattttgaagagagaccgtcgggggctgaggggcaacgaagaaaaaaaataacacagagagacagacttgagaacttgacaagttgcgacggagagaaaaaagaagtgtccgagaactaaagccaagggtatccaagttggactgggttcggtctgacggcgcccccagtgtgcacgagtgggaaggacttggtcgcgccctcccttggcgtggagccagggagcggccgcctgcgggctgccccgctttgcggacgggctgtccccgcgcgaacggaacgttggactttcgttaacattgaccaagaactgcatggacctaacattcgatctcattcagtattaaaggggggagggggagggggttacaaactgcaatagagactgtagattgcttctgtagtactccttaagaacacaaagcggggggagggttggggaggggcggcaggagggaggtttgtgagagcgaggctgagcctacagatgaactctttctggcctgctttcgttaactgtgtatgtacatatatatattttttaatttgattaaagctgattactgtcaataaacagcttcatgcctttgtaagttatttcttgtttgtttgtttgggtatcctgcccagtgttgtttgtaaataagagatttggagcactctgagtttaccatttgtaataaagtatataatttttttatgttttgtttctgaaaattccagaaaggatatttaagaaaatacaataaactattggaaagtactcccctaacctcttttctgcatcatctgtagatcctagtctatctaggtggagttgaaagagttaagaatgctcgataaaatcactctcagtgcttcttactattaagcagtaaaaactgttctctattagacttagaaataaatgtacctgatgtacctgatgctatgtcaggcttcatactccacgctcccccagcgtatctatatggaattgcttaccaaaggctagtgcgatgtttcaggaggctggaggaaggggggttgcagtggagagggacagcccactgagaagtcaaacatttcaaagtttggattgcatcaagtggcatgtgctgtgaccatttataatgttagaaattttacaataggtgcttattctcaaagcaggaattggtggcagattttacaaaagatgtatccttccaatttggaatcttctctttgacaattcctagataaaaagatggcctttgtcttatgaatatttataacagcattctgtcacaataaatgtattcaaataccaataacagatcttgaattgcttccctttactacttttttgttcccaagttatatactgaagtttttatttttagttgctgaggtt

SEQ ID NO: 6 - protein, 331 aa, Homo sapiens
MTAKMETTFYDDALNASFLPSESGPYGYSNPKILKQSMTLNLADPVGSLKPHLRAKNSDLLTSPDVGLLKLASPELERLIIQSSNGHITTTPTPTQFLCPKNVTDEQEGFAEGFVRALAELHSQNTLPSVTSAAQPVNGAGMVAPAVASVAGGSGSGGFSASLHSEPPVYANLSNFNPGALSSGGGAPSYGAAGLAFPAQPQQQQQPPHHLPQQMPVQHPRLQALKEEPQTVPEMPGETPPLSPIDMESQERIKAERKRMRNRIAASKCRKRKLERIARLEEKVKTLKAQNSELASTANMLREQVAQLKQKVMNHVNSGCQLMLTQQLQTF

SEQ ID NO: 7 - DNA, 2454 bp, Homo sapiens
  CDS (117)..(1100)
cgcggcggaggtgtagtttgacgcggtgtgttacgtgggggagagaataaaactccagcgagatccgggccgtgaacgaaagcagtgacggaggagcttgtaccaccggtaactaaatgaccatggaatctggagccgagaaccagcagagtggagatgcagctgtaacagaagctgaaaaccaacaaatgacagttcaagcccagccacagattgccacattagcccaggtatctatgccagcagctcatgcaacatcatctgctcccaccgtaactctagtacagctgcccaatgggcagacagttcaagtccatggagtcattcaggcggcccagccatcagttattcagtctccacaagtccaaacagttcagatttcaactattgcagaaagtgaagattcacaggagtcagtggatagtgtaactgattcccaaaagcgaagggaaattctttcaaggaggccttcctacaggaaaattttgaatgacttatcttctgatgcaccaggagtgccaaggattgaagaagagaagtctgaagaggagacttcagcacctgccatcaccactgtaacggtgccaactccaatttaccaaactagcagtggacagtatattgccattacccagggaggagcaatacagctggctaacaatggtaccgatggggtacagggcctgcaaacattaaccatgaccaatgcagcagccactcagccgggtactaccattctacagtatgcacagaccactgatggacagcagatcttagtgcccagcaaccaagttgttgttcaagctgcctctggagacgtacaaacataccagattcgcacagcacccactagcactattgcccctggagttgttatggcatcctccccagcacttcctacacagcctgctgaagaagcagcacgaaagagagaggtccgtctaatgaagaacagggaagcagctcgagagtgtcgtagaaagaagaaagaatatgtgaaatgtttagaaaacagagtggcagtgcttgaaaatcaaaacaagacattgattgaggagctaaaagcacttaaggacctttactgccacaaatcagattaatttgggatttaaattttcacctgttaaggtggaaaatggactggcttggccacaacctgaaagacaaaataaacattttattttctaaacatttctttttttctatgcgcaaaactgcctgaaagcaactacagaatttcattcatttgtgcttttgcattaaactgtgaatgttccaacacctgcctccacttctcccctcaagaaattttcaacgccaggaatcatgaagagacttctgcttttcaacccccaccctcctcaagaagtaataatttgtttacttgtaaattgatgggagaaatgaggaaaagaaaatctttttaaaaatgatttcaaggtttgtgctgagctccttgattgccttagggacagaattaccccagcctcttgagctgaagtaatgtgtgggccgcatgcataaagtaagtaaggtgcaatgaagaagtgttgattgccaaattgacatgttgtcacattctcattgtgaattatgtaaagttgttaagagacataccctctaaaaaagaactttagcatggtattgaaggaattagaaatgaatttggagtgctttttatgtatgttgtcttcttcaatactgaaaatttgtccttggttcttaaaagcattctgtactaatacagctcttccatagggcagttgttgcttcttaattcagttctgtatgtgttcaacatttttgaatacattaaaagaagtaaccaactgaacgacaaagcatggtatttgaattttaaattaaagcaaagtaaataaaagtacaaagcatattttagttagtactaaattcttagtaaaatgctgatcagtaaaccaatcccttgagttatataacaagatttttaaataaatgttattgtcctcaccttcaaaaatatttatattgtcactcatttacgtaaaaagatatttctaatttactgttgcccattgcacttacataccaccaccaagaaagccttcaagatgtcaaataaagcaaagtgatatatatttgtttatgaaatgttacatgtagaaaaatactgattttaaatattttccatattaacaatttaacagagaatctctagtgaattttttaaatgaaagaagttgtaaggatataaaaagtacagtgttagatgtgcacaaggaaagttattttcagacatatttgaatgactgctgtactgcaatatttggattgtcattcttacaaaacatttttttgttctcttgtaaaaagagtagttattagttctgctttagctttccaatatgctgtatagcctttgtcattttataattttaattcctgattaaaacagtctgtatttgtgtatatcat

SEQ ID NO: 8 - protein, 327 aa, Homo sapiens
MTMESGAENQQSGDAAVTEAENQQMTVQAQPQIATLAQVSMPAAHATSSAPTVTLVQLPNGQTVQVHGVIQAAQPSVIQSPQVQTVQISTIAESEDSQESVDSVTDSQKRREILSRRPSYRKILNDLSSDAPGVPRIEEEKSEEETSAPAITTVTVPTPIYQTSSGQYIAITQGGAIQLANNGTDGVQGLQTLTMTNAAATQPGTTILQYAQTTDGQQILVPSNQVVVQAASGDVQTYQIRTAPTSTIAPGVVMASSPALPTQPAEEAARKREVRLMKNREAARECRRKKKEYVKCLENRVAVLENQNKTLIEELKALKDLYCHKSD

SEQ ID NO: 9 - DNA, 2517 bp, Homo sapiens
  CDS (136)..(1449)
ggaattccgtggccgggactttgcaggcagcggcggccgggggcggagcgggatcgagccctcgccgaggcctgccgccatgggcccgcgccgccgccgccgcctgtcacccgggccgcgcgggccgtgagcgtcatggccttggccggggcccctgcgggcggcccatgcgcgccggcgctggaggccctgctcggggccggcgcgctgcggctgctcgactcctcgcagatcgtcatcatctccgccgcgcaggacgccagcgccccgccggctcccaccggccccgcggcgcccgccgccggcccctgcgaccctgacctgctgctcttcgccacaccgcaggcgccccggcccacacccagtgcgccgcggcccgcgctcggccgcccgccggtgaagcggaggctggacctggaaactgaccatcagtacctggccgagagcagtgggccagctcggggcagaggccgccatccaggaaaaggtgtgaaatccccgggggagaagtcacgctatgagacctcactgaatctgaccaccaagcgcttcctggagctgctgagccactcggctgacggtgtcgtcgacctgaactgggctgccgaggtgctgaaggtgcagaagcggcgcatctatgacatcaccaacgtccttgagggcatccagctcattgccaagaagtccaagaaccacatccagtggctgggcagccacaccacagtgggcgtcggcggacggcttgaggggttgacccaggacctccgacagctgcaggagagcgagcagcagctggaccacctgatgaatatctgtactacgcagctgcgcctgctctccgaggacactgacagccagcgcctggcctacgtgacgtgtcaggaccttcgtagcattgcagaccctgcagagcagatggttatggtgatcaaagcccctcctgagacccagctccaagccgtggactcttcggagaactttcagatctcccttaagagcaaacaaggcccgatcgatgttttcctgtgccctgaggagaccgtaggtgggatcagccctgggaagaccccatcccaggaggtcacttctgaggaggagaacagggccactgactctgccaccatagtgtcaccaccaccatcatctcccccctcatccctcaccacagatcccagccagtctctactcagcctggagcaagaaccgctgttgtcccggatgggcagcctgcgggctcccgtggacgaggaccgcctgtccccgctggtggcggccgactcgctcctggagcatgtgcgggaggacttctccggcctcctccctgaggagttcatcagcctttccccaccccacgaggccctcgactaccacttcggcctcgaggagggcgagggcatcagagacctcttcgactgtgactttggggacctcacccccctggatttctgacagggcttggagggaccagggtttccagagtagctcaccttgtctctgcagccctggagccccctgtccctggccgtcctcccagcctgtttggaaacatttaatttatacccctctcctctgtctccagaagcttctagctctggggtctggctaccgctaggaggctgagcaagccaggaagggaaggagtctgtgtggtgtgtatgtgcatgcagcctacacccacacgtgtgtaccgggggtgaatgtgtgtgagcatgtgtgtgtgcatgtaccggggaatgaaggtgaacatacacctctgtgtgtgcactgcagacacgccccagtgtgtccacatgtgtgtgcatgagtccatctctgcgcgtgggggggctctaactgcactttcggcccttttgctcgtggggtcccacaaggcccagggcagtgcctgctcccagaatctggtgctctgaccaggccaggtggggaggctttggctggctgggcgtgtaggacggtgagagcacttctgtcttaaaggttttttctgattgaagctttaatggagcgttatttatttatcgaggcctctttggtgagcctggggaatcagcaaaaggggaggaggggtgtggggttgataccccaactccctctacccttgagcaagggcaggggtccctgagctgttcttctgccccatactgaaggaactgaggcctgggtgatttatttattgggaaagtgagggagggagacagactgactgacagccatgggtggtcagatggtggggtgggccctctccagggggccagttcagggcccagctgccccccaggatggatatgagatgggagaggtgagtgggggaccttcactgatgtgggcaggaggggtggtgaaggcctcccccagcccagaccctgtggtccctcctgcagtgtctgaagcgcctgcctccccactgctctgccccaccctccaatctgcactttgatttgcttcctaacagctctgttccctcctgctttggttttaataaatattttgatgacgttaaaaaaaggaattcgatat

SEQ ID NO: 10 - protein, 437 aa, Homo sapiens
MALAGAPAGGPCAPALEALLGAGALRLLDSSQIVIISAAQDASAPPAPTGPAAPAAGPCDPDLLLFATPQAPRPTPSAPRPALGRPPVKRRLDLETDHQYLAESSGPARGRGRHPGKGVKSPGEKSRYETSLNLTTKRFLELLSHSADGVVDLNWAAEVLKVQKRRIYDITNVLEGIQLIAKKSKNHIQWLGSHTTVGVGGRLEGLTQDLRQLQESEQQLDHLMNICTTQLRLLSEDTDSQRLAYVTCQDLRSIADPAEQMVMVIKAPPETQLQAVDSSENFQISLKSKQGPIDVFLCPEETVGGISPGKTPSQEVTSEEENRATDSATIVSPPPSSPPSSLTTDPSQSLLSLEQEPLLSRMGSLRAPVDEDRLSPLVAADSLLEHVREDFSGLLPEEFISLSPPHEALDYHFGLEEGEGIRDLFDCDFGDLTPLDF

SEQ ID NO: 11 - DNA, 2092 bp, Homo sapiens
  CDS (293)..(2080)
gaattccaaaattgtgatgtttcttgtatttttgatgaaggagaaatactgtaatgatcactgtttacactatgtacactttaggccagccctttgtagcgttatacaaactgaaagcacaccggacccgcaggctcccggggcagggccggggccagagctcgcgtgtcggcgggacatgcgctgcgtcgcctctaacctcgggctgtgctctttttccaggtggcccgccggtttctgagccttctgccctgcggggacacggtctgcaccctgcccgcggccacggaccatgaccatgaccctccacaccaaagcatctgggatggccctactgcatcagatccaagggaacgagctggagcccctgaaccgtccgcagctcaagatccccctggagcggcccctgggcgaggtgtacctggacagcagcaagcccgccgtgtacaactaccccgagggcgccgcctacgagttcaacgccgcggccgccgccaacgcgcaggtctacggtcagaccggcctcccctacggccccgggtctgaggctgcggcgttcggctccaacggcctggggggtttccccccactcaacagcgtgtctccgagcccgctgatgctactgcacccgccgccgcagctgtcgcctttcctgcagccccacggccagcaggtgccctactacctggagaacgagcccagcggctacacggtgcgcgaggccggcccgccggcattctacaggccaaattcagataatcgacgccagggtggcagagaaagattggccagtaccaatgacaagggaagtatggctatggaatctgccaaggagactcgctactgtgcagtgtgcaatgactatgcttcaggctaccattatggagtctggtcctgtgagggctgcaaggccttcttcaagagaagtattcaaggacataacgactatatgtgtccagccaccaaccagtgcaccattgataaaaacaggaggaagagctgccaggcctgccggctccgcaaatgctacgaagtgggaatgatgaaaggtgggatacgaaaagaccgaagaggagggagaatgttgaaacacaagcgccagagagatgatggggagggcaggggtgaagtggggtctgctggagacatgagagctgccaacctttggccaagcccgctcatgatcaaacgctctaagaagaacagcctggccttgtccctgacggccgaccagatggtcagtgccttgttggatgctgagccccccatactctattccgagtatgatcctaccagacccttcagtgaagcttcgatgatgggcttactgaccaacctggcagacagggagctggttcacatgatcaactgggcgaagagggtgccaggctttgtggatttgaccctccatgatcaggtccaccttctagaatgtgcctggctagagatcctgatgattggtctcgtctggcgctccatggagcacccagtgaagctactgtttgctcctaacttgctcttggacaggaaccagggaaaatgtgtagagggcatggtggagatcttcgacatgctgctggctacatcatctcggttccgcatgatgaatctgcagggagaggagtttgtgtgcctcaaatctattattttgcttaattctggagtgtacacatttctgtccagcaccctgaagtctctggaagagaaggaccatatccaccgagtcctggacaagatcacagacactttgatccacctgatggccaaggcaggcctgaccctgcagcagcagcaccagcggctggcccagctcctcctcatcctctcccacatcaggcacatgagtaacaaaggcatggagcatctgtacagcatgaagtgcaagaacgtggtgcccctctatgacctgctgctggagatgctggacgcccaccgcctacatgcgcccactagccgtggaggggcatccgtggaggagacggaccaaagccacttggccactgcgggctctacttcatcgcattccttgcaaaagtattacatcacgggggaggcagagggtttccctgccacagtctgagagctccctggc

SEQ ID NO: 12 - protein, 595 aa, Homo sapiens
MTMTLHTKASGMALLHQIQGNELEPLNRPQLKIPLERPLGEVYLDSSKPAVYNYPEGAAYEFNAAAAANAQVYGQTGLPYGPGSEAAAFGSNGLGGFPPLNSVSPSPLMLLHPPPQLSPFLQPHGQQVPYYLENEPSGYTVREAGPPAFYRPNSDNRRQGGRERLASTNDKGSMAMESAKETRYCAVCNDYASGYHYGVWSCEGCKAFFKRSIQGHNDYMCPATNQCTIDKNRRKSCQACRLRKCYEVGMMKGGIRKDRRGGRMLKHKRQRDDGEGRGEVGSAGDMRAANLWPSPLMIKRSKKNSLALSLTADQMVSALLDAEPPILYSEYDPTRPFSEASMMGLLTNLADRELVHMINWAKRVPGFVDLTLHDQVHLLECAWLEILMIGLVWRSMEHPVKLLFAPNLLLDRNQGKCVEGMVEIFDMLLATSSRFRMMNLQGEEFVCLKSIILLNSGVYTFLSSTLKSLEEKDHIHRVLDKITDTLIHLMAKAGLTLQQQHQRLAQLLLILSHIRHMSNKGMEHLYSMKCKNVVPLYDLLLEMLDAHRLHAPTSRGGASVEETDQSHLATAGSTSSHSLQKYYITGEAEGFPATV

SEQ ID NO: 13 - DNA, 4788 bp, Homo sapiens
  CDS (133)..(2466)
tttttagaaaaaaaaaatatatttccctcctgctccttctgcgttcacaagctaagttgtttatctcggctgcggcgggaactgcggacggtggcgggcgagcggctcctctgccagagttgatattcactgatggactccaaagaatcattaactcctggtagagaagaaaaccccagcagtgtgcttgctcaggagaggggagatgtgatggacttctataaaaccctaagaggaggagctactgtgaaggtttctgcgtcttcaccctcactggctgtcgcttctcaatcagactccaagcagcgaagacttttggttgattttccaaaaggctcagtaagcaatgcgcagcagccagatctgtccaaagcagtttcactctcaatgggactgtatatgggagagacagaaacaaaagtgatgggaaatgacctgggattcccacagcagggccaaatcagcctttcctcgggggaaacagacttaaagcttttggaagaaagcattgcaaacctcaataggtcgaccagtgttccagagaaccccaagagttcagcatccactgctgtgtctgctgcccccacagagaaggagtttccaaaaactcactctgatgtatcttcagaacagcaacatttgaagggccagactggcaccaacggtggcaatgtgaaattgtataccacagaccaaagcacctttgacattttgcaggatttggagttttcttctgggtccccaggtaaagagacgaatgagagtccttggagatcagacctgttgatagatgaaaactgtttgctttctcctctggcgggagaagacgattcattccttttggaaggaaactcgaatgaggactgcaagcctctcattttaccggacactaaacccaaaattaaggataatggagatctggttttgtcaagccccagtaatgtaacactgccccaagtgaaaacagaaaaagaagatttcatcgaactctgcacccctggggtaattaagcaagagaaactgggcacagtttactgtcaggcaagctttcctggagcaaatataattggtaataaaatgtctgccatttctgttcatggtgtgagtacctctggaggacagatgtaccactatgacatgaatacagcatccctttctcaacagcaggatcagaagcctatttttaatgtcattccaccaattcccgttggttccgaaaattggaataggtgccaaggatctggagatgacaacttgacttctctggggactctgaacttccctggtcgaacagttttttctaatggctattcaagccccagcatgagaccagatgtaagctctcctccatccagctcctcaacagcaacaacaggaccacctcccaaactctgcctggtgtgctctgatgaagcttcaggatgtcattatggagtcttaacttgtggaagctgtaaagttttcttcaaaagagcagtggaaggacagcacaattacctatgtgctggaaggaatgattgcatcatcgataaaattcgaagaaaaaactgcccagcatgccgctatcgaaaatgtcttcaggctggaatgaacctggaagctcgaaaaacaaagaaaaaaataaaaggaattcagcaggccactacaggagtctcacaagaaacctctgaaaatcctggtaacaaaacaatagttcctgcaacgttaccacaactcacccctaccctggtgtcactgttggaggttattgaacctgaagtgttatatgcaggatatgatagctctgttccagactcaacttggaggatcatgactacgctcaacatgttaggagggcggcaagtgattgcagcagtgaaatgggcaaaggcaataccaggtttcaggaacttacacctggatgaccaaatgaccctactgcagtactcctggatgtttcttatggcatttgctctggggtggagatcatatagacaatcaagtgcaaacctgctgtgttttgctcctgatctgattattaatgagcagagaatgactctaccctgcatgtacgaccaatgtaaacacatgctgtatgtttcctctgagttacacaggcttcaggtatcttatgaagagtatctctgtatgaaaaccttactgcttctctcttcagttcctaaggacggtctgaagagccaagagctatttgatgaaattagaatgacctacatcaaagagctaggaaaagccattgtcaagagggaaggaaactccagccagaactggcagcggttttatcaactgacaaaactcttggattctatgcatgaagtggttgaaaatctccttaactattgcttccaaacatttttggataagaccatgagtattgaattccccgagatgttagctgaaatcatcaccaatcagataccaaaatattcaaatggaaatatcaaaaaacttctgtttcatcaaaagtgactgccttaataagaatggttgccttaaagaaagtcgaattaatagcttttattgtataaactatcagtttgtcctgtagaggttttgttgttttattttttattgttttcatctgttgttttgttttaaatacgcactacatgtggtttatagagggccaagacttggcaacagaagcagttgagtcgtcatcacttttcagtgatgggagagtagatggtgaaatttattagttaatatatcccagaaattagaaaccttaatatgtggacgtaatctccacagtcaaagaaggatggcacctaaaccaccagtgcccaaagtctgtgtgatgaactttctcttcatactttttttcacagttggctggatgaaattttctagactttctgttggtgtatcccccccctgtatagttaggatagcatttttgatttatgcatggaaacctgaaaaaaagtttacaagtgtatatcagaaaagggaagttgtgccttttatagctattactgtctggttttaacaatttcctttatatttagtgaactacgcttgctcattttttcttacataattttttattcaagttattgtacagctgtttaagatgggcagctagttcgtagctttcccaaataaactctaaacattaatcaatcatctgtgtgaaaatgggttggtgcttctaacctgatggcacttagctatcagaagaccacaaaaattgactcaaatctccagtattcttgtcaaaaaaaaaaaaaaaaaagctcatattttgtatatatctgcttcagtggagaattatataggttgtgcaaattaacagtcctaactggtatagagcacctagtccagtgacctgctgggtaaactgtggatgatggttgcaaaagactaatttaaaaaataactaccaagaggccctgtctgtacctaacgccctatttttgcaatggctatatggcaagaaagctggtaaactatttgtctttcaggaccttttgaagtagtttgtataacttcttaaaagttgtgattccagataaccagctgtaacacagctgagagacttttaatcagacaaagtaattcctctcactaaactttacccaaaaactaaatctctaatatggcaaaaatggctagacacccattttcacattcccatctgtcaccaattggttaatctttcctgatggtacaggaaagctcagctactgatttttgtgatttagaactgtatgtcagacatccatgtttgtaaaactacacatccctaatgtgtgccatagagtttaacacaagtcctgtgaatttcttcactgttgaaaattattttaaacaaaatagaagctgtagtagccctttctgtgtgcaccttaccaactttctgtaaactcaaaacttaacatatttactaagccacaagaaatttgatttctattcaaggtggccaaattatttgtgtaatagaaaactgaaaatctaatattaaaaatatggaacttctaatatatttttatatttagttatagtttcagatatatatcatattggtattcactaatctgggaagggaagggctactgcagctttacatgcaatttattaaaatgattgtaaaatagcttgtatagtgtaaaataagaatgatttttagatgagattgttttatcatgacatgttatatattttttgtaggggtcaaagaaatgctgatggataacctatatgatttatagtttgtacatgcattcatacaggcagcgatggtctcagaaaccaaacagtttgctctaggggaagagggagatggagactggtcctgtgtgcagtgaaggttgctgaggctctgacccagtgagattacagaggaagttatcctctgcctcccattctgaccacccttctcattccaacagtgagtctgtcagcgcaggtttagtttactcaatctccccttgcactaaagtatgtaaagtatgtaaacaggagacaggaaggtggtgcttacatccttaaaggcaccatctaatagcgggttactttcacatacagccctcccccagcagttgaatgacaacagaagcttcagaagtttggcaatagtttgcatagaggtaccagcaatatgtaaatagtgcagaatctcataggttgccaataatacactaattcctttctatcctacaacaagagtttatttccaaataaaatgaggacatgtttttgttttctttgaatgctttttgaatgttatttgttattttcagtattttggagaaattatttaataaaaaaacaatcatttgctttttg

SEQ ID NO: 14 - protein, 777 aa, Homo sapiens
MDSKESLTPGREENPSSVLAQERGDVMDFYKTLRGGATVKVSASSPSLAVASQSDSKQRRLLVDFPKGSVSNAQQPDLSKAVSLSMGLYMGETETKVMGNDLGFPQQGQISLSSGETDLKLLEESIANLNRSTSVPENPKSSASTAVSAAPTEKEFPKTHSDVSSEQQHLKGQTGTNGGNVKLYTTDQSTFDILQDLEFSSGSPGKETNESPWRSDLLIDENCLLSPLAGEDDSFLLEGNSNEDCKPLILPDTKPKIKDNGDLVLSSPSNVTLPQVKTEKEDFIELCTPGVIKQEKLGTVYCQASFPGANIIGNKMSAISVHGVSTSGGQMYHYDMNTASLSQQQDQKPIFNVIPPIPVGSENWNRCQGSGDDNLTSLGTLNFPGRTVFSNGYSSPSMRPDVSSPPSSSSTATTGPPPKLCLVCSDEASGCHYGVLTCGSCKVFFKRAVEGQHNYLCAGRNDCIIDKIRRKNCPACRYRKCLQAGMNLEARKTKKKIKGIQQATTGVSQETSENPGNKTIVPATLPQLTPTLVSLLEVIEPEVLYAGYDSSVPDSTWRIMTTLNMLGGRQVIAAVKWAKAIPGFRNLHLDDQMTLLQYSWMFLMAFALGWRSYRQSSANLLCFAPDLIINEQRMTLPCMYDQCKHMLYVSSELHRLQVSYEEYLCMKTLLLLSSVPKDGLKSQELFDEIRMTYIKELGKAIVKREGNSSQNWQRFYQLTKLLDSMHEVVENLLNYCFQTFLDKTMSIEFPEMLAEIITNQIPKYSNGNIKKLLFHQK

SEQ ID NO: 15 - DNA, 2156 bp, Homo sapiens
  CDS (161)..(1750)
cgggcccgttgcaagatggcggcggccatgctgggccccggggctgtgtgtgcgcagcgggcggcggcgcggcccggaaggctggcgcggcgacggcgttagcccggccctcggcccctctttgcggccgctccctccgcctattccctccttgctcgagatggatctgcccgtgggccccggcgcggcggggcccagcaacgtcccggccttcctgaccaagctgtggaccctcgtgagcgacccggacaccgacgcgctcatctgctggagcccgagcgggaacagcttccacgtgttcgaccagggccagtttgccaaggaggtgctgcccaagtacttcaagcacaacaacatggccagcttcgtgcggcagctcaacatgtatggcttccggaaagtggtccacatcgagcagggcggcctggtcaagccagagagagacgacacggagttccagcacccatgcttcctgcgtggccaggagcagctccttgagaacatcaagaggaaagtgaccagtgtgtccaccctgaagagtgaagacataaagatccgccaggacagcgtcaccaagctgctgacggacgtgcagctgatgaaggggaagcaggagtgcatggactccaagctcctggccatgaagcatgagaatgaggctctgtggcgggaggtggccagccttcggcagaagcatgcccagcaacagaaagtcgtcaacaagctcattcagttcctgatctcactggtgcagtcaaaccggatcctgggggtgaagagaaagatccccctgatgctgaacgacagtggctcagcacattccatgcccaagtatagccggcagttctccctggagcacgtccacggctcgggcccctactcggccccctccccagcctacagcagctccagcctctacgcccctgatgctgtggccagctctggacccatcatctccgacatcaccgagctggctcctgccagccccatggcctcccccggcgggagcatagacgagaggcccctatccagcagccccctggtgcgtgtcaaggaggagccccccagcccgcctcagagcccccgggtagaggaggcgagtcccgggcgcccatcttccgtggacaccctcttgtccccgaccgccctcattgactccatcctgcgggagagtgaacctgcccccgcctccgtcacagccctcacggacgccaggggccacacggacaccgagggccggcctccctcccccccgcccacctccacccctgaaaagtgcctcagcgtagcctgcctggacaagaatgagctcagtgaccacttggatgctatggactccaacctggataacctgcagaccatgctgagcagccacggcttcagcgtggacaccagtgccctgctggacctgttcagcccctcggtgaccgtgcccgacatgagcctgcctgaccttgacagcagcctggccagtatccaagagctcctgtctccccaggagccccccaggcctcccgaggcagagaacagcagcccggattcagggaagcagctggtgcactacacagcgcagccgctgttcctgctggaccccggctccgtggacaccgggagcaacgacctgccggtgctgtttgagctgggagagggctcctacttctccgaaggggacggcttcgccgaggaccccaccatctccctgctgacaggctcggagcctcccaaagccaaggaccccactgtctcctagaggccccggaggagctgggccagccgcccacccccacccccagtgcagggctggtcttggggaggcagggcagcctcgcggtcttgggcactggtgggtcggccgccatagccccagtaggacaaacgggctcgggtctgggcagcacctctggtcaggagggtcaccctggcctgccagtctgccttcccccaaccccgtgtcctgtggtttggttggggcttcacagccacacctggactgaccctgcaggttgttcatagtcagaattgtattttggatttttacacaactgtcccgttccccgctccacagagatacacagatatatacacacagtggatggacggacaagacaggcagagatctataaacagacaggctctaaaaaaaaaaaaaaaaaaaa

SEQ ID NO: 16 - protein, 529 aa, Homo sapiens
MDLPVGPGAAGPSNVPAFLTKLWTLVSDPDTDALICWSPSGNSFHVFDQGQFAKEVLPKYFKHNNMASFVRQLNMYGFRKVVHIEQGGLVKPERDDTEFQHPCFLRGQEQLLENIKRKVTSVSTLKSEDIKIRQDSVTKLLTDVQLMKGKQECMDSKLLAMKHENEALWREVASLRQKHAQQQKVVNKLIQFLISLVQSNRILGVKRKIPLMLNDSGSAHSMPKYSRQFSLEHVHGSGPYSAPSPAYSSSSLYAPDAVASSGPIISDITELAPASPMASPGGSIDERPLSSSPLVRVKEEPPSPPQSPRVEEASPGRPSSVDTLLSPTALIDSILRESEPAPASVTALTDARGHTDTEGRPPSPPPTSTPEKCLSVACLDKNELSDHLDAMDSNLDNLQTMLSSHGFSVDTSALLDLFSPSVTVPDMSLPDLDSSLASIQELLSPQEPPRPPEAENSSPDSGKQLVHYTAQPLFLLDPGSVDTGSNDLPVLFELGEGSYFSEGDGFAEDPTISLLTGSEPPKAKDPTVS

SEQ ID NO: 17 - DNA, 2411 bp, Homo sapiens
  CDS (89)..(1699)
gcgttctcgggaagctgctgccgtagctgccgccgccgctaccaccgcgttcgggtgtagaatttggaatccctgcgccgcgttaacaatgaagcagagttcgaacgtgccggctttcctcagcaagctgtggacgcttgtggaggaaacccacactaacgagttcatcacctggagccagaatggccaaagttttctggtcttggatgagcaacgatttgcaaaagaaattcttcccaaatatttcaagcacaataatatggcaagctttgtgaggcaactgaatatgtatggtttccgtaaagtagtacatatcgactctggaattgtaaagcaagaaagagatggtcctgtagaatttcagcatccttacttcaaacaaggacaggatgacttgttggagaacattaaaaggaaggtttcatcttcaaaaccagaagaaaataaaattcgtcaggaagatttaacaaaaattataagtagtgctcagaaggttcagataaaacaggaaactattgagtccaggctttctgaattaaaaagtgagaatgagtccctttggaaggaggtgtcagaattacgagcaaagcatgcacaacagcaacaagttattcgaaagattgtccagtttattgttacattggttcaaaataaccaacttgtgagtttaaaacgtaaaaggcctctacttctaaacactaatggagcccaaaagaagaacctgtttcagcacatagtcaaagaaccaactgataatcatcatcataaagttccacacagtaggactgaaggtttaaagccaagggagaggatttcagatgacatcattatttatgatgttactgatgataatgcagatgaagaaaatatcccagttattccagaaactaatgaggatgttatatctgatccctccaactgtagccagtaccctgatattgtcatcgttgaagatgacaatgaagatgagtatgcacctgtcattcagagtggagagcagaatgaaccagccagagaatccctaagttcaggcagtgatggcagcagccctctcatgtctagtgctgtccagctaaatggctcatccagtctgacctcagaagatccagtgaccatgatggattccattttgaatgataacatcaatcttttgggaaaggttgagctgttggattatcttgacagtattgactgcagtttagaggacttccaggccatgctatcaggaagacaatttagcatagacccagatctcctggttgatcttttcactagttctgtgcagatgaatcccacagattacatcaataatacaaaatctgagaataaaggattagaaactaccaagaacaatgtagttcagccagtttcggaagagggaagaaaatctaaatccaaaccagataagcagcttatccagtataccgcctttccacttcttgcattcctcgatgggaaccctgcttcttctgttgaacaggcgagtacaacagcatcatcagaagttttgtcctctgtagataaacccatagaagttgatgagcttctggatagcagcctagacccagaaccaacccaaagtaagcttgttcgcctggagccattgactgaagctgaagctagtgaagctacactgttttatttatgtgaacttgctcctgcacctctggatagtgatatgccacttttagatagctaaatccccaggaagtggactttacatgtatatattcatcaaaatgatgaactatttattttaaagtatcatttggtactttttttgtaaattgctttgttttgtttaatcagatactgtggaataaaagcaccttttgcttttctcactaaccacacactcttgcagagctttcaggtgttactcagctgcatagttacgcagatgtaatgcacattattggcgtatctttaagttggattcaaatggccatttttctccaattttggtaaattggatatcttttttttacaaatacgaccattaacctcagttaaatttttgtttgttttcctgtttgatgctgtctatttgcattgagtgtaagtcatttgaactaatggtataactcctaaagcttctctgctccagttatttttattaaatatttttcacttggcttatttttaaaactgggaacataaagtgcctgtatcttgtaaaacttcatttgtttcttttggttcagagaagttcatttatgttcaaagacgtttattcatgttcaacaggaaagacaaagtgtacgtgaatgctcgctgtctgatagggttccagctccatatatatagaaagatcgggggtgggatgggatggagtgagccccatccagttagttggactagttttaaataaaggttttccggtttgtgtttttttgaaccatactgtttag

SEQ ID NO: 18 - protein, 536 aa, Homo sapiens
MKQSSNVPAFLSKLWTLVEETHTNEFITWSQNGQSFLVLDEQRFAKEILPKYFKHNNMASFVRQLNMYGFRKVVHIDSGIVKQERDGPVEFQHPYFKQGQDDLLENIKRKVSSSKPEENKIRQEDLTKIISSAQKVQIKQETIESRLSELKSENESLWKEVSELRAKHAQQQQVIRKIVQFIVTLVQNNQLVSLKRKRPLLLNTNGAQKKNLFQHIVKEPTDNHHHKVPHSRTEGLKPRERISDDIIIYDVTDDNADEENIPVIPETNEDVISDPSNCSQYPDIVIVEDDNEDEYAPVIQSGEQNEPARESLSSGSDGSSPLMSSAVQLNGSSSLTSEDPVTMMDSILNDNINLLGKVELLDYLDSIDCSLEDFQAMLSGRQFSIDPDLLVDLFTSSVQMNPTDYINNTKSENKGLETTKNNVVQPVSEEGRKSKSKPDKQLIQYTAFPLLAFLDGNPASSVEQASTTASSEVLSSVDKPIEVDELLDSSLDPEPTQSKLVRLEPLTEAEASEATLFYLCELAPAPLDSDMPLLDS

SEQ ID NO: 19 - DNA, 1555 bp, Homo sapiens
  CDS (5)..(1396)
ccggatggtgcaggaagcgccagctgcgctgcccacggagccaggccccagccccgtgcctgccttcctcggcaagctatgggcgctggtgggggacccaggcacagaccacctgatccgctggagcccgagcgggaccagtttcctcgtaagcgaccagagccgtttcgccaaggaagtgctgccccagtatttcaagcatagcaacatggcgagcttcgtgcgccaactcaacatgtacggttttcggaaggtggtgagcatcgagcagggcggcctgcttaggccggagcgcgaccacgtcgagttccagcacccgagcttcgtgcgcggccgcgagcagctactggagcgcgtgcggcgcaaggtgcccgcgctgcgcggcgacgacggccgctggcgcccggaggacctgggtcgactactgggcgaggtgcaggctttgcggggagtgcaggagagcaccgaggcgcggctgcgggagctcaggcagcagaacgagatcttgtggcgggaggtggtgacacttcggcagagccacggtcagcagcaccgggtcattggcaagctgatccagtgtctctttgggccacttcaggcggggccgagcaatgcaggaggcaagagaaagctgtccctgatgctggatgaggggagctcatgcccaacacctgccaagttcaacacctgccctctacctggtgcccttctgcaggacccctacttcatccagtcgccttctacttacagcctctcccagagacaaatttgggccttagccctcacagggccaggggccccatcatctctgacatcccagaagactctccatcccctgaggggaccaggctttctccctccagtgatggcaggagcccccccgccactgcctgtggctgtggtgcaggccatcctggaagggaaagggagcttcagccccgaggggcccaggaatgcccaacagcctgaaccaggggatcccagggagatacctgacagggggcctctgggcctggaaagcggggacaggagcccagagagtctgctgcctccgatgctgcttcagccccctcaagaaagtgtggaacctgcagggcctctagatgtgctgggccccagtctccaagggcgagaatggaccctgatggacttggacatggagctgtccttgatgcagcccttggttccagagcggggtgagcctgagctggcggtcaaggggttaaattctccaagcccagggaaggaccccacgctcggggccccactcctgctggatgtccaggcggccttgggaggcccagccctgggcctgcctggggctttaaccatttatagcactcctgagagccggactgcctcctacttgggcccggaagccagtccctccccctaagaccccgcgcctctgaaggggcttggaaccagtccgccgctgcacatccttcttggcttcctggccgcctacgggggtgagcgaagcccccactactaaatggcctctctccactaccccgactatccctgcacataaactccgtttttttttttcacc

SEQ ID NO: 20 - protein, 463 aa, Homo sapiens
MVQEAPAALPTEPGPSPVPAFLGKLWALVGDPGTDHLIRWSPSGTSFLVSDQSRFAKEVLPQYFKHSNMASFVRQLNMYGFRKVVSIEQGGLLRPERDHVEFQHPSFVRGREQLLERVRRKVPALRGDDGRWRPEDLGRLLGEVQALRGVQESTEARLRELRQQNEILWREVVTLRQSHGQQHRVIGKLIQCLFGPLQAGPSNAGGKRKLSLMLDEGSSCPTPAKFNTCPLPGALLQDPYFIQSPSTYSLSQRQIWALALTGPGAPSSLTSQKTLHPLRGPGFLPPVMAGAPPPLPVAVVQAILEGKGSFSPEGPRNAQQPEPGDPREIPDRGPLGLESGDRSPESLLPPMLLQPPQESVEPAGPLDVLGPSLQGREWTLMDLDMELSLMQPLVPERGEPELAVKGLNSPSPGKDPTLGAPLLLDVQAALGGPALGLPGALTIYSTPESRTASYLGPEASPSP

SEQ ID NO: 21 - DNA, 1550 bp, Homo sapiens
  CDS (95)..(1048)
tgccgccgtcccgcccgccagcgccccagcgaggaagcagcgcgcagcccgcggcccagcgcacccgcagcagcgcccgcagctcgtccgcgccatgttccaggcggccgagcgcccccaggagtgggccatggagggcccccgcgacgggctgaagaaggagcggctactggacgaccgccacgacagcggcctggactccatgaaagacgaggagtacgagcagatggtcaaggagctgcaggagatccgcctcgagccgcaggaggtgccgcgcggctcggagccctggaagcagcagctcaccgaggacggggactcgttcctgcacttggccatcatccatgaagaaaaggcactgaccatggaagtgatccgccaggtgaagggagacctggctttcctcaacttccagaacaacctgcagcagactccactccacttggctgtgatcaccaaccagccagaaattgctgaggcacttctgggagctggctgtgatcctgagctccgagactttcgaggaaatacccccctacaccttgcctgtgagcagggctgcctggccagcgtgggagtcctgactcagtcctgcaccaccccgcacctccactccatcctgaaggctaccaactacaatggccacacgtgtctacacttagcctctatccatggctacctgggcatcgtggagcttttggtgtccttgggtgctgatgtcaatgctcaggagccctgtaatggccggactgcccttcacctcgcagtggacctgcaaaatcctgacctggtgtcactcctgttgaagtgtggggctgatgtcaacagagttacctaccagggctattctccctaccagctcacctggggccgcccaagcacccggatacagcagcagctgggccagctgacactagaaaaccttcagatgctgccagagagtgaggatgaggagagctatgacacagagtcagagttcacggagttcacagaggacgagctgccctatgatgactgtgtgtttggaggccagcgtctgacgttatgagtgcaaaggggctgaaagaacatggacttgtatatttgtacaaaaaaaaagttttatttttctaaaaaaagaaaaaagaagaaaaaatttaaagggtgtacttatatccacactgcacactgcctagcccaaaacgtcttattgtggtaggatcagccctcattttgttgcttttgtgaactttttgtaggggacgagaaagatcattgaaattctgagaaaacttcttttaaacctcacctttgtggggtttttggagaaggttatcaaaaatttcatggaaggaccacattttatatttattgtgcttcgagtgactgaccccagtggtatcctgtgacatgtaacagccaggagtgttaagcgttcagtgatgtggggtgaaaagttactacctgtcaaggtttgtgttaccctcctgtaaatggtgtacataatgtattgttggtaattattttggtacttttatgatgtatatttattaaagagatttttacaaatg

SEQ ID NO: 22 - protein, 317 aa, Homo sapiens
MFQAAERPQEWAMEGPRDGLKKERLLDDRHDSGLDSMKDEEYEQMVKELQEIRLEPQEVPRGSEPWKQQLTEDGDSFLHLAIIHEEKALTMEVIRQVKGDLAFLNFQNNLQQTPLHLAVITNQPEIAEALLGAGCDPELRDFRGNTPLHLACEQGCLASVGVLTQSCTTPHLHSILKATNYNGHTCLHLASIHGYLGIVELLVSLGADVNAQEPCNGRTALHLAVDLQNPDLVSLLLKCGADVNRVTYQGYSPYQLTWGRPSTRIQQQLGQLTLENLQMLPESEDEESYDTESEFTEFTEDELPYDDCVFGGQRLTL

SEQ ID NO: 23 - DNA, 2880 bp, Homo sapiens
  CDS (142)..(2850)
gcttctggagggaggcggcagcgacggaggagggggcttctcagagaaagggagggagggagccacccgggtgaagatacagcagcctcctgaactcccccctcccacccaggccgggacctgggggctcctgccggatccatgggggcggccagctgcgaggatgaggagctggaatttaagctggtgttcggggaggaaaaggaggcccccccgctgggcgcggggggattgggggaagaactggactcagaggatgccccgccatgctgccgtctggccttgggagagccccctccctatggcgctgcacctatcggtattccccgacctccaccccctcggcctggcatgcattcgccaccgccgcgaccagccccctcacctggcacctgggagagccagcccgccaggtcggtgaggctgggaggaccaggagggggtgctgggggtgctgggggtggccgtgttctcgagtgtcccagcatccgcatcacctccatctctcccacgccggagccgccagcagcgctggaggacaaccctgatgcctggggggacggctctcctagagattaccccccaccagaaggctttgggggctacagagaagcaggggcccagggtgggggggccttcttcagcccaagccctggcagcagcagcctgtcctcgtggagcttcttctccgatgcctctgacgaggcagccctgtatgcagcctgcgacgaggtggagtctgagctaaatgaggcggcctcccgctttggcctgggctccccgctgccctcgccccgggcctcccctcggccatggacccccgaagatccctggagcctgtatggtccaagccccggaggccgagggccagaggatagctggctactcctcagtgctcctgggcccaccccagcctccccgcggcctgcctctccatgtggcaagcggcgctattccagctcgggaaccccatcttcagcctccccagctctgtcccgccgtggcagcctgggggaagaggggtctgagccacctccaccacccccattgcctctggcccgggacccgggctcccctggtccctttgactatgtgggggccccaccagctgagagcatccctcagaagacacggcggacttccagcgagcaggcagtggctctgcctcggtctgaggagcctgcctcatgcaatgggaagctgcccttgggagcagaggagtctgtggctcctccaggaggttcccggaaggaggtggctggcatggactacctggcagtgccctccccactcgcttggtccaaggcccggattgggggacacagccctatcttcaggacctctgccctacccccactggactggcctctgcccagccaatatgagcagctggagctgaggatcgaggtacagcctagagcccaccaccgggcccactatgagacagaaggcagccgtggagctgtcaaagctgcccctggcggtcaccccgtagtcaagctcctaggctacagtgagaagccactgaccctacagatgttcatcggcactgcagatgaaaggaacctgcggcctcatgccttctatcaggtgcaccgtatcacaggcaagatggtggccacggccagctatgaagccgtagtcagtggcaccaaggtgttggagatgactctgctgcctgagaacaacatggcggccaacattgactgcgcgggaatcctgaagcttcggaattcagacattgagcttcggaagggtgagacggacatcgggcgcaaaaacacacgtgtacggctggtgttccgggtacacgtgccccagggcggcgggaaggtcgtctcagtacaggcagcatcggtgcccatcgagtgctcccagcgctcagcccaggagctgccccaggtggaggcctacagccccagtgcctgctctgtgagaggaggcgaggaactggtactgaccggctccaacttcctgccagactccaaggtggtgttcattgagaggggtcctgatgggaagctgcaatgggaggaggaggccacagtgaaccgactgcagagcaacgaggtgacgctgaccctgactgtccccgagtacagcaacaagagggtttcccggccagtccaggtctacttttatgtctccaatgggcggaggaaacgcagtcctacccagagtttcaggtttctgcctgtgatctgcaaagaggagcccctaccggactcatctctgcggggtttcccttcagcatcggcaaccccctttggcactgacatggacttctcaccacccaggcccccctacccctcctatccccatgaagaccctgcttgcgaaactccttacctatcagaaggcttcggctatggcatgccccctctgtacccccagacggggcccccaccatcctacagaccgggcctgcggatgttccctgagactaggggtaccacaggttgtgcccaaccacctgcagtttccttccttccccgccccttccctagtgacccgtatggagggcggggctcctctttccccctggggctgccattctctccgccagccccctttcggccgcctcctcttcctgcatccccaccgcttgaaggccccttcccttcccagagtgatgtgcatcccctacctgctgagggatacaataaggtagggccaggctatggccctggggagggggctccggagcaggagaaatccaggggtggctacagcagcggctttcgagacagtgtccctatccagggtatcacgctggaggaagtgagtgagatcattggccgagacctgagtggcttccctgcacctcctggagaagagcctcctgcctgaaccacgtgaactgtcatcacctggcaaccc

SEQ ID NO: 24 - protein, 902 aa, Homo sapiens [sequence omitted]

SEQ ID NO: 25 - DNA, 3113 bp, Homo sapiens
  CDS (251)..(2953)
cacggtgagtggctggattcagacccctgggtggccgggacaagagaaaagagggaggagggcctttagcggacagcgcctggggctggagagcagcagctgcacacagccggaaagggcgcgcaggcgacgacactcggatccacgtcgacaccgttgtacaaagatacgcggacccgcgggcgtctaaaattctgggaagcagaacctggccggagccactagacagagccgggcctagcccagagacatggagagttgctacaacccaggtctggatggtattattgaatatgatgatttcaaattgaactcctccattgtggaacccaaggagccagccccagaaacagctgatggcccctacctggtgatcgtggaacagcctaagcagagaggcttccgatttcgatatggctgtgaaggcccctcccatggaggactgcccggtgcctccagtgagaagggccgaaagacctatcccactgtcaagatctgtaactacgagggaccagccaagatcgaggtggacctggtaacacacagtgacccacctcgtgctcatgcccacagtctggtgggcaagcaatgctcggagctggggatctgcgccgtttctgtggggcccaaggacatgactgcccaatttaacaacctgggtgtcctgcatgtgactaaggagaacatgatggggactatgatacaaaaacttcagaggcagcggctccgctctaggccccagggccttacggaggccgagcagcgggagctggagcaagaggccaaagaactgaagaaggtgatggatctgagtatagtgcggctgcgcttctctgccttccttagagccagtgatggctccttctccctgcccctgaagccagtcatctcccagcccatccatgacagcaaatctccgggggcatcaaacctgaagatttctcgaatggacaagacagcaggctctgtgcggggtggagatgaagtttatctgctttgtgacaaggtgcagaaagatgacattgaggttcggttctatgaggatgatgagaatggatggcaggcctttggggacttctctcccacagatgtgcataaacagtatgccattgtgttccggacacccccctatcacaagatgaagattgagcggcctgtaacagtgtttctgcaactgaaacgcaagcgaggaggggacgtgtctgattccaaacagttcacctattaccctctggtggaagacaaggaagaggtgcagcggaagcggaggaaggccttgcccaccttctcccagcccttcgggggtggctcccacatgggtggaggctctgggggtgcagccgggggctacggaggagctggaggaggtggcagcctcggtttcttcccctcctccctggcctacagcccctaccagtccggcgcgggccccatgggctgctacccgggaggcgggggcggggcgcagatggccgccacggtgcccagcagggactccggggaggaagccgcggagccgagcgccccctccaggaccccccagtgcgacgcgcaggccccggagatgctgcagcgagctcgagagtacaacgcgcgcctgttcggcctggcgcagcgcagcgcccgagccctactcgactacggcgtcaccgcggaccggcgcgcgctgctggcgggacagcgccacctgctgacggcgcaggacgagaacggagacacaccactgcacctagccatcatccacgggcagaccagtgtcattgagcagatagtctatgtcatccaccacgcccaggacctcggcgttgtcaacctcaccaaccacctgcaccagacgcccctgcacctggcggtgatcacggggcagacgagtgtggtgagctttctgctgcgggtaggtgcagacccagctctgctggatcggcatggagactcagccatgcatctggcgctgcgggcaggcgctggtgctcctgagctgctgcgtgcactgcttcagagtggagctcctgctgtgccccagctgttgcatatgcctgactttgagggactgtatccagtacacctggcggtccgagcccgaagccctgagtgcctggatctgctggtggacagtggggctgaagtggaggccacagagcggcaggggggacgaacagccttgcatctagccacagagatggaggagctggggttggtcacccatctggtcaccaagctccgggccaacgtgaacgctcgcacctttgcgggaaacacacccctgcacctggcagctggactggggtacccgaccctcacccgcctccttctgaaggctggtgctgacatccatgctgaaaacgaggagcccctgtgcccactgccttcaccccctacctctgatagcgactcggactctgaagggcctgagaaggacacccgaagcagcttccggggccacacgcctcttgacctcacttgcagcaccaaggtgaagaccttgctgctaaatgctgctcagaacaccatggagccacccctgaccccgcccagcccagcagggccgggactgtcacttggtgatacagctctgcagaacctggagcagctgctagacgggccagaagcccagggcagctgggcagagctggcagagcgtctggggctgcgcagcctggtagacacgtaccgacagacaacctcacccagtggcagcctcctgcgcagctacgagctggctggcggggacctggcaggtctactggaggccctgtctgacatgggcctagaggagggagtgaggctgctgaggggtccagaaacccgagacaagctgcccagcacaacagaggtgaaggaagacagtgcgtacgggagccagtcagtggagcagaaggcagagaagctgggcccaccccctgagccaccaggagggctctgccacgggcacccccagcctcaggtgcactgacctgctgcctgcccccagcccccttcccggaccccctgtacagcgtccccacctatttcaaatcttatttaacaccccacacccacccctcagttgggacaaataaaggattctcatgggaaggggaggacccctccttcccaacttaaaaaaaaaaaaa

SEQ ID NO: 26 - protein, 900 aa, Homo sapiens [sequence omitted]

SEQ ID NO: 27 - DNA, 2907 bp, Homo sapiens
  CDS (103)..(1491)
gccatctgggcccaggccccatgccccgaggaggggtggtctgaagcccaccagagccccctgccagactgtctgcctcccttctgactgtggccgcttggcatggccagcaacagcagctcctgcccgacacctgggggcgggcacctcaatgggtacccggtgcctccctacgccttcttcttcccccctatgctgggtggactctccccgccaggcgctctgaccactctccagcaccagcttccagttagtggatatagcacaccatccccagccaccattgagacccagagcagcagttctgaagagatagtgcccagccctccctcgccaccccctctaccccgcatctacaagccttgctttgtctgtcaggacaagtcctcaggctaccactatggggtcagcgcctgtgagggctgcaagggcttcttccgccgcagcatccagaagaacatggtgtacacgtgtcaccgggacaagaactgcatcatcaacaaggtgacccggaaccgctgccagtactgccgactgcagaagtgctttgaagtgggcatgtccaaggagtctgtgagaaacgaccgaaacaagaagaagaaggaggtgcccaagcccgagtgctctgagagctacacgctgacgccggaggtgggggagctcattgagaaggtgcgcaaagcgcaccaggaaaccttccctgccctctgccagctgggcaaatacactacgaacaacagctcagaacaacgtgtctctctggacattgacctctgggacaagttcagtgaactctccaccaagtgcatcattaagactgtggagttcgccaagcagctgcccggcttcaccaccctcaccatcgccgaccagatcaccctcctcaaggctgcctgcctggacatcctgatcctgcggatctgcacgcggtacacgcccgagcaggacaccatgaccttctcggacgggctgaccctgaaccggacccagatgcacaacgctggcttcggccccctcaccgacctggtctttgccttcgccaaccagctgctgcccctggagatggatgatgcggagacggggctgctcagcgccatctgcctcatctgcggagaccgccaggacctggagcagccggaccgggtggacatgctgcaggagccgctgctggaggcgctaaaggtctacgtgcggaagcggaggcccagccgcccccacatgttccccaagatgctaatgaagattactgacctgcgaagcatcagcgccaagggggctgagcgggtgatcacgctgaagatggagatcccgggctccatgccgcctctcatccaggaaatgttggagaactcagagggcctggacactctgagcggacagccggggggtggggggcgggacgggggtggcctggcccccccgccaggcagctgtagccccagcctcagccccagctccaacagaagcagcccggccacccactccccgtgaccgcccacgccacatggacacagccctcgccctccgccccggcttttctctgcctttctaccgaccatgtgaccccgcaccagccctgcccccacctgccctcccgggcagtactggggaccttccctgggggacggggagggaggaggcagcgactccttggacagaggcctgggccctcagtggactgcctgctcccacagcctgggctgacgtcagaggccgaggccaggaactgagtgaggcccctggtcctgggtctcaggatgggtcctgggggcctcgtgttcatcaagacacccctctgcccagctcaccacatcttcatcaccagcaaacgccaggacttggctcccccatcctcagaactcacaagccattgctccccagctggggaacctcaacctcccccctgcctcggttggtgacagagggggtgggacaggggcggggggttccccctgtacataccctgccataccaaccccaggtattaattctcgctggttttgtttttattttaatttttttgttttgatttttttaataagaattttcattttaagcacatttatactgaaggaatttgtgctgtgtattggggggagctggatccagagctggagggggtgggtccgggggagggagtggctcggaaggggcccccactctcctttcatgtccctgtgccccccagttctcctcctcagccttttcctcctcagttttctctttaaaactgtgaagtactaactttccaaggcctgccttcccctccctcccactggagaagccgccagcccctttctccctctgcctgaccactgggtgtggacggtgtggggcagccctgaaaggacaggctcctggccttggcacttgcctgcacccaccatgaggcatggagcagggcagagcaagggccccgggacagagttttcccagacctggctcctcggcagagctgcctcccgtcagggcccacatcatctaggctccccagcccccactgtgaaggggctggccaggggcccgagctgcccccacccccggcctcagccaccagcacccccatagggcccccagacaccacacacatgcgcgtgcgcacacacacaaacacacacacactggacagtagatgggccgacacacacttggcccgagttcctccatttccctggcctgccccccacccccaacctgtcccacccccgtgccccctccttaccccgcaggacgggcctacaggggggtctcccctcacccctgcacccccagctgggggagctggctctgccccgacctccttcaccaggggttggggccccttcccctggagcccgtgggtgcacctgttactgttgggctttccactgagatctactggataaagaataaagttctatttattct

SEQ ID NO: 28 - protein, 462 aa, Homo sapiens
MASNSSSCPTPGGGHLNGYPVPPYAFFFPPMLGGLSPPGALTTLQHQLPVSGYSTPSPATIETQSSSSEEIVPSPPSPPPLPRIYKPCFVCQDKSSGYHYGVSACEGCKGFFRRSIQKNMVYTCHRDKNCIINKVTRNRCQYCRLQKCFEVGMSKESVRNDRNKKKKEVPKPECSESYTLTPEVGELIEKVRKAHQETFPALCQLGKYTTNNSSEQRVSLDIDLWDKFSELSTKCIIKTVEFAKQLPGFTTLTIADQITLLKAACLDILILRICTRYTPEQDTMTFSDGLTLNRTQMHNAGFGPLTDLVFAFANQLLPLEMDDAETGLLSAICLICGDRQDLEQPDRVDMLQEPLLEALKVYVRKRRPSRPHMFPKMLMKITDLRSISAKGAERVITLKMEIPGSMPPLIQEMLENSEGLDTLSGQPGGGGRDGGGLAPPPGSCSPSLSPSSNRSSPATHSP

SEQ ID NO: 29 - DNA, 3119 bp, Homo sapiens
  CDS (496)..(1815)
gtgacagaagtagtaggaagtgagctgttcagaggcaggagggtctattctttgccaaaggggggaccagaattccccatgcgagctgtttgaggactgggatgccgagaacgcgagcgatccgagcagggtttgtctgggcaccgtcggggtaggatccggaacgcattcggaaggctttttgcaagcatttacttggaaggagaacttgggatctttctgggaaccccccgccccggctggattggccgagcaagcctggaaaatggtaaatgatcatttggatcaattacaggcttttagctggcttgtctgtcataattcatgattcggggctgggaaaaagaccaacagcctacgtgccaaaaaaggggcagagtttgatggagttgggtggacttttctatgccatttgcctccacacctagaggataagcacttttgcagacattcagtgcaagggagatcatgtttgactgtatggatgttctgtcagtgagtcctgggcaaatcctggatttctacactgcgagtccgtcttcctgcatgctccaggagaaagctctcaaagcatgcttcagtggattgacccaaaccgaatggcagcatcggcacactgctcaatcaattgaaacacagagcaccagctctgaggaactcgtcccaagccccccatctccacttcctccccctcgagtgtacaaaccctgcttcgtctgccaggacaaatcatcagggtaccactatggggtcagcgcctgtgagggatgtaagggctttttccgcagaagtattcagaagaatatgatttacacttgtcaccgagataagaactgtgttattaataaagtcaccaggaatcgatgccaatactgtcgactccagaagtgctttgaagtgggaatgtccaaagaatctgtcaggaatgacaggaacaagaaaaagaaggagacttcgaagcaagaatgcacagagagctatgaaatgacagctgagttggacgatctcacagagaagatccgaaaagctcaccaggaaactttcccttcactctgccagctgggtaaatacaccacgaattccagtgctgaccatcgagtccgactggacctgggcctctgggacaaattcagtgaactggccaccaagtgcattattaagatcgtggagtttgctaaacgtctgcctggtttcactggcttgaccatcgcagaccaaattaccctgctgaaggccgcctgcctggacatcctgattcttagaatttgcaccaggtataccccagaacaagacaccatgactttctcagacggccttaccctaaatcgaactcagatgcacaatgctggatttggtcctctgactgaccttgtgttcacctttgccaaccagctcctgcctttggaaatggatgacacagaaacaggccttctcagtgccatctgcttaatctgtggagaccgccaggaccttgaggaaccgacaaaagtagataagctacaagaaccattgctggaagcactaaaaatttatatcagaaaaagacgacccagcaagcctcacatgtttccaaagatcttaatgaaaatcacagatctccgtagcatcagtgctaaaggtgcagagcgtgtaattaccttgaaaatggaaattcctggatcaatgccacctctcattcaagaaatgctggagaattctgaaggacatgaacccttgaccccaagttcaagtgggaacacagcagagcacagtcctagcatctcacccagctcagtggaaaacagtggggtcagtcagtcaccactcgtgcaataagacattttctagctacttcaaacattccccagtaccttcagttccaggatttaaaatgcaagaaaaaacatttttactgctgcttagtttttggactgaaaagatattaaaactcaagaaggaccaagaagttttcatatgtatcaatatatatactcctcactgtgtaacttacctagaaatacaaacttttccaattttaaaaaatcagccatttcatgcaaccagaaactagttaaaagcttctattttcctctttgaacactcaagatgcatggcaaagacccagtcaaaatgatttacccctggttaagtttctgaagactttgtacatacagaagtatggctctgttctttctatactgtatgtttggtgctttccttttgtcttgcatactcaaaataaccatgacaccaaggttatgaaatagactactgtacacgtctacctaggttcaaaaagataactgtcttgctttcatggaatagtcaagacatcaaggtaaggaaacaggactattgacaggactattgtacagtatgacaagataaggctgaagatattctactttagttagtatggaagcttgtctttgctctttctgatgctctcaaactgcatcttttatttcatgttgcccagtaaaagtatacaaattccctgcactagcagaagagaattctgtatcagtgtaactgccagttcagttaatcaaatgtcatttgttcaattgttaatgtcactttaaattaaaagtggtttattacttgtttaatgacataactacacagttagttaaaaaaaatttttttacagtaatgatagcctccaaggcagaaacacttttcagtgttaagtttttgtttacttgttcacaagccattagggaaatttcatgggataattagcaggctggtctaccactggaccatgtaactctagtgtccttcctgattcatgcctgatattgggatttttttccagcccttcttgatgccaagggctaattatattacatcccaaagaaacaggcatagaatctgcctcctttgaccttgttcaatcactatgaagcagagtgaaagctgtggtagagtggttaacagatacaagtgtcagtttcttagttctcatttaagcactactggaatttttttttttgatatattagcaagtctgtgatgtactttcactggctctgtttgtacattgagattgtttgtttaacaatgctttctatgttcatatactgtttacctttttccatggactctcctggcaaagaataaaatatatttatttt

SEQ ID NO: 30 - protein, 439 aa, Homo sapiens
VSPGQILDFYTASPSSCMLQEKALKACFSGLTQTEWQHRHTAQSIETQSTSSEELVPSPPSPLPPPRVYKPCFVCQDKSSGYHYGVSACEGCKGFFRRSIQKNMIYTCHRDKNCVINKVTRNRCQYCRLQKCFEVGMSKESVRNDRNKKKKETSKQECTESYEMTAELDDLTEKIRKAHQETFPSLCQLGKYTTNSSADHRVRLDLGLWDKFSELATKCIIKIVEFAKRLPGFTGLTIADQITLLKAACLDILILRICTRYTPEQDTMTFSDGLTLNRTQMHNAGFGPLTDLVFTFANQLLPLEMDDTETGLLSAICLICGDRQDLEEPTKVDKLQEPLLEALKIYIRKRRPSKPHMFPKILMKITDLRSISAKGAERVITLKMEIPGSMPPLIQEMLENSEGHEPLTPSSSGNTAEHSPSISPSSVENSGVSQSPLVQ

SEQ ID NO: 31 - DNA, 2762 bp, Homo sapiens
  CDS (448)..(1458)
gtgacagaagtagtaggaagtgagctgttcagaggcaggagggtctattctttgccaaaggggggaccagaattccccatgcgagctgtttgaggactgggatgccgagaacgcgagcgatccgagcagggtttgtctgggcaccgtcggggtaggatccggaacgcattcggaaggctttttgcaagcatttacttggaaggagaacttgggatctttctgggaaccccccgccccggctggattggccgagcaagcctggaaaatgcaattgaaacacagagcaccagctctgaggaactcgtcccaagccccccatctccacttcctccccctcgagtgtacaaaccctgcttcgtctgccaggacaaatcatcagggtaccactatggggtcagcgcctgtgagggatgtaagggctttttccgcagaagtattcagaagaatatgatttacacttgtcaccgagataagaactgtgttattaataaagtcaccaggaatcgatgccaatactgtcgactccagaagtgctttgaagtgggaatgtccaaagaatctgtcaggaatgacaggaacaagaaaaagaaggagacttcgaagcaagaatgcacagagagctatgaaatgacagctgagttggacgatctcacagagaagatccgaaaagctcaccaggaaactttcccttcactctgccagctgggtaaatacaccacgaattccagtgctgaccatcgagtccgactggacctgggcctctgggacaaattcagtgaactggccaccaagtgcattattaagatcgtggagtttgctaaacgtctgcctggtttcactggcttgaccatcgcagaccaaattaccctgctgaaggccgcctgcctggacatcctgattcttagaatttgcaccaggtataccccagaacaagacaccatgactttctcagacggccttaccctaaatcgaactcagatgcacaatgctggatttggtcctctgactgaccttgtgttcacctttgccaaccagctcctgcctttggaaatggatgacacagaaacaggccttctcagtgccatctgcttaatctgtggagaccgccaggaccttgaggaaccgacaaaagtagataagctacaagaaccattgctggaagcactaaaaatttatatcagaaaaagacgacccagcaagcctcacatgtttccaaagatcttaatgaaaatcacagatctccgtagcatcagtgctaaaggtgcagagcgtgtaattaccttgaaaatggaaattcctggatcaatgccacctctcattcaagaaatgctggagaattctgaaggacatgaacccttgaccccaagttcaagtgggaacacagcagagcacagtcctagcatctcacccagctcagtggaaaacagtggggtcagtcagtcaccactcgtgcaataagacattttctagctacttcaaacattccccagtaccttcagttccaggatttaaaatgcaagaaaaaacatttttactgctgcttagtttttggactgaaaagatattaaaactcaagaaggaccaagaagttttcatatgtatcaatatatatactcctcactgtgtaacttacctagaaatacaaacttttccaattttaaaaaatcagccatttcatgcaaccagaaactagttaaaagcttctattttcctctttgaacactcaagatgcatggcaaagacccagtcaaaatgatttacccctggttaagtttctgaagactttgtacatacagaagtatggctctgttctttctatactgtatgtttggtgctttccttttgtcttgcatactcaaaataaccatgacaccaaggttatgaaatagactactgtacacgtctacctaggttcaaaaagataactgtcttgctttcatggaatagtcaagacatcaaggtaaggaaacaggactattgacaggactattgtacagtatgacaagataaggctgaagatattctactttagttagtatggaagcttgtctttgctctttctgatgctctcaaactgcatcttttatttcatgttgcccagtaaaagtatacaaattccctgcactagcagaagagaattctgtatcagtgtaactgccagttcagttaatcaaatgtcatttgttcaattgttaatgtcactttaaattaaaagtggtttattacttgtttaatgacataactacacagttagttaaaaaaaatttttttacagtaatgatagcctccaaggcagaaacacttttcagtgttaagtttttgtttacttgttcacaagccattagggaaatttcatgggataattagcaggctggtctaccactggaccatgtaactctagtgtccttcctgattcatgcctgatattgggatttttttccagcccttcttgatgccaagggctaattatattacatcccaaagaaacaggcatagaatctgcctcctttgaccttgttcaatcactatgaagcagagtgaaagctgtggtagagtggttaacagatacaagtgtcagtttcttagttctcatttaagcactactggaatttttttttttgatatattagcaagtctgtgatgtactttcactggctctgtttgtacattgagattgtttgtttaacaatgctttctatgttcatatactgtttacctttttccatggactctcctggcaaagaataaaatatatttatttt

SEQ ID NO: 32 - protein, 336 aa, Homo sapiens
MIYTCHRDKNCVINKVTRNRCQYCRLQKCFEVGMSKESVRNDRNKKKKETSKQECTESYEMTAELDDLTEKIRKAHQETFPSLCQLGKYTTNSSADHRVRLDLGLWDKFSELATKCIIKIVEFAKRLPGFTGLTIADQITLLKAACLDILILRICTRYTPEQDTMTFSDGLTLNRTQMHNAGFGPLTDLVFTFANQLLPLEMDDTETGLLSAICLICGDRQDLEEPTKVDKLQEPLLEALKIYIRKRRPSKPHMFPKILMKITDLRSISAKGAERVITLKMEIPGSMPPLIQEMLENSEGHEPLTPSSSGNTAEHSPSISPSSVENSGVSQSPLVQ

SEQ ID NO: 33 - DNA, 1576 bp, Homo sapiens
  CDS (200)..(1564)
gaattcggctcaacctgacccagtatgtagaagccagtctctgcaggcggccagcgggacttttggaggcccagtgggcaggccaggcagggcgggtacggagcctcccaggctggggcagtgggcatgggcaggggctgtggctgaagacctcgcccgcccactgcagaccccaggggactctcacaccgcagctgccatggccaccaataaggagcgactctttgcggctggtgccctggggcctggatctggctacccaggggcaggtttccccttcgccttcccaggggcactcagggggtctccgcctttcgagatgctgagccctagcttccggggcctgggccagcctgacctccccaaggagatggcctctctgtcggtggagacacagagcaccagctcagaggagatggtgcccagctcgccctcgccccctccgcctcctcgggtctacaagccatgcttcgtgtgcaatgacaagtcctctggctaccactatggggtcagctcttgtgaaggctgcaagggcttctttcgccgaagcatccagaagaacatggtgtacacgtgtcaccgcgacaaaaactgtatcatcaacaaggtgaccaggaatcgctgccagtactgccggctacagaagtgcttcgaagtgggcatgtccaaggaagctgtgcgaaatgaccggaacaagaagaagaaagaggtgaaggaagaagggtcacctgacagctatgagctgagccctcagttagaagagctcatcaccaaggtcagcaaagcccatcaggagactttcccctcgctctgccagctgggcaagtataccacgaactccagtgcagaccaccgcgtgcagctggatctggggctgtgggacaagttcagtgagctggctaccaagtgcatcatcaagatcgtggagtttgccaagcggttgcctggctttacagggctcagcattgctgaccagatcactctgctcaaagctgcctgcctagatatcctgatgctgcgtatctgcacaaggtacaccccagagcaggacaccatgaccttctccgacgggctgaccctgaaccggacccagatgcacaatgccggcttcgggcccctcacagaccttgtctttgcctttgctgggcagctcctgcccctggagatggatgacaccgagacagggctgctcagcgccatctgcctcatctgcggagaccgcatggacctggaggagcccgaaaaagtggacaagctgcaggagccactgctggaagccctgaggctgtacgcccggcgccggcggcccagccagccctacatgttcccaaggatgctaatgaaaatcaccgacctccggggcatcagcactaagggagctgaaagggccattactctgaagatggagattccaggcccgatgcctcccttaatccgagagatgctggagaaccctgaaatgtttgaggatgactcctcgcagcctggtccccaccccaatgcctctagcgaggatgaggttcctgggggccagggcaaagggggcctgaagtccccagcctgaccaggccgaatt

SEQ ID NO: 34 - protein, 454 aa, Homo sapiens
MATNKERLFAAGALGPGSGYPGAGFPFAFPGALRGSPPFEMLSPSFRGLGQPDLPKEMASLSVETQSTSSEEMVPSSPSPPPPPRVYKPCFVCNDKSSGYHYGVSSCEGCKGFFRRSIQKNMVYTCHRDKNCIINKVTRNRCQYCRLQKCFEVGMSKEAVRNDRNKKKKEVKEEGSPDSYELSPQLEELITKVSKAHQETFPSLCQLGKYTTNSSADHRVQLDLGLWDKFSELATKCIIKIVEFAKRLPGFTGLSIADQITLLKAACLDILMLRICTRYTPEQDTMTFSDGLTLNRTQMHNAGFGPLTDLVFAFAGQLLPLEMDDTETGLLSAICLICGDRMDLEEPEKVDKLQEPLLEALRLYARRRRPSQPYMFPRMLMKITDLRGISTKGAERAITLKMEIPGPMPPLIREMLENPEMFEDDSSQPGPHPNASSEDEVPGGQGKGGLKSPA

SEQ ID NO: 35 - DNA, 4740 bp, Homo sapiens
  CDS (139)..(2925)
ttccggtttttctcaggggacgttgaaattatttttgtaacgggagtcgggagaggacggggcgtgccccgcgtgcgcgcgcgtcgtcctccccggcgctcctccacagctcgctggctcccgccgcggaaaggcgtcatgccgcccaaaaccccccgaaaaacggccgccaccgccgccgctgccgccgcggaacccccggcaccgccgccgccgccccctcctgaggaggacccagagcaggacagcggcccggaggacctgcctctcgtcaggcttgagtttgaagaaacagaagaacctgattttactgcattatgtcagaaattaaagataccagatcatgtcagagagagagcttggttaacttgggagaaagtttcatctgtggatggagtattgggaggttatattcaaaagaaaaaggaactgtggggaatctgtatctttattgcacgagttgacctagatgagatgtcgttcactttactgagctacagaaaaacatacgaaatcagtgtccataaattctttaacttactaaaagaaattgataccagtaccaaagttgataatgctatgtcaagactgttgaagaagtatgatgtattgtttgcactcttcagcaaattggaaaggacatgtgaacttatatatttgacacaacccagcagttcgatatctactgaaataaattctgcattggtgctaaaagtttcttggatcacatttttattagctaaaggggaagtattacaaatggaagatgatctggtgatttcatttcagttaatgctatgtgtccttgactattttattaaactctcacctcccatgttgctcaaagaaccatataaaacagctgttatacccattaatggttcacctcgaacacccaggcgaggtcagaacaggagtgcacggatagcaaaacaactagaaaatgatacaagaattattgaagttctctgtaaagaacatgaatgtaatatagatgaggtgaaaaatgtttatttcaaaaattttataccttttatgaattctcttggacttgtaacatctaatggacttccagaggttgaaaatctttctaaacgatacgaagaaatttatcttaaaaataaagatctagatcgaagattatttttggatcatgataaaactcttcagactgattctatagacagttttgaaacacagagaacaccacgaaaaagtaaccttgatgaagaggtgaatataattcctccacacactccagttaggactgttatgaacactatccaacaattaatgatgattttaaattctgcaagtgatcaaccttcagaaaatctgatttcctattttaacaactgcacagtgaatccaaaagaaagtatactgaaaagagtgaaggatataggatacatctttaaagagaaatttgctaaagctgtgggacagggttgtgtcgaaattggatcacagcgatacaaacttggagttcgcttgtattaccgagtaatggaatccatgcttaaatcagaagaagaacgattatccattcaaaattttagcaaacttctgaatgacaacatttttcatatgtctttattggcgtgcgctcttgaggttgtaatggccacatatagcagaagtacatctcagaatcttgattctggaacagatttgtctttcccatggattctgaatgtgcttaatttaaaagcctttgatttttacaaagtgatcgaaagttttatcaaagcagaaggcaacttgacaagagaaatgataaaacatttagaacgatgtgaacatcgaatcatggaatcccttgcatggctctcagattcacctttatttgatcttattaaacaatcaaaggaccgagaaggaccaactgatcaccttgaatctgcttgtcctcttaatcttcctctccagaataatcacactgcagcagatatgtatctttctcctgtaagatctccaaagaaaaaaggttcaactacgcgtgtaaattctactgcaaatgcagagacacaagcaacctcagccttccagacccagaagccattgaaatctacctctctttcactgttttataaaaaagtgtatcggctagcctatctccggctaaatacactttgtgaacgccttctgtctgagcacccagaattagaacatatcatctggacccttttccagcacaccctgcagaatgagtatgaactcatgagagacaggcatttggaccaaattatgatgtgttccatgtatggcatatgcaaagtgaagaatatagaccttaaattcaaaatcattgtaacagcatacaaggatcttcctcatgctgttcaggagacattcaaacgtgttttgatcaaagaagaggagtatgattctattatagtattctataactcggtcttcatgcagagactgaaaacaaatattttgcagtatgcttccaccaggccccctaccttgtcaccaatacctcacattcctcgaagcccttacaagtttcctagttcacccttacggattcctggagggaacatctatatttcacccctgaagagtccatataaaatttcagaaggtctgccaacaccaacaaaaatgactccaagatcaagaatcttagtatcaattggtgaatcattcgggacttctgagaagttccagaaaataaatcagatggtatgtaacagcgaccgtgtgctcaaaagaagtgctgaaggaagcaaccctcctaaaccactgaaaaaactacgctttgatattgaaggatcagatgaagcagatggaagtaaacatctcccaggagagtccaaatttcagcagaaactggcagaaatgacttctactcgaacacgaatgcaaaagcagaaaatgaatgatagcatggatacctcaaacaaggaagagaaatgaggatctcaggaccttggtggacactgtgtacacctctggattcattgtctctcacagatgtgactgtataactttcccaggttctgtttatggccacatttaatatcttcagctctttttgtggatataaaatgtgcagatgcaattgtttgggtgagtcctaagccacttgaaatgttagtcattgttatttatacaagattgaaaatcttgtgtaaatcctgccatttaaaaagttgtagcagattgtttcctcttccaaagtaaaattgctgtgctttatggatagtaagaatggccctagagtgggagtcctgataacccaggcctgtctgactactttgccttcttttgtagcatataggtgatgtttgctcttgtttttattaatttatatgtatatttttttaatttaacatgaacacccttagaaaatgtgtcctatctatcttccaaatgcaatttgattgactgcccattcaccaaaattatcctgaactcttctgcaaaaatggatattattagaaattagaaaaaaattactaattttacacattagattttattttactattggaatctgatatactgtgtgcttgttttataaaattttgcttttaattaaataaaagctggaagcaaagtataaccatatgatactatcatactactgaaacagatttcatacctcagaatgtaaaagaacttactgattattttcttcatccaacttatgtttttaaatgaggattattgatagtactcttggtttttataccattcagatcactgaatttataaagtacccatctagtacttgaaaaagtaaagtgttctgccagatcttaggtatagaggaccctaacacagtatatcccaagtgcactttctaatgtttctgggtcctgaagaattaagatacaaattaattttactccataaacagactgttaattataggagccttaatttttttttcatagagatttgtctaattgcatctcaaaattattctgccctccttaatttgggaaggtttgtgttttctctggaatggtacatgtcttccatgtatcttttgaactggcaattgtctatttatcttttatttttttaagtcagtatggtctaacactggcatgttcaaagccacattatttctagtccaaaattacaagtaatcaagggtcattatgggttaggcattaatgtttctatctgattttgtgcaaaagcttcaaattaaaacagctgcattagaaaaagaggcgcttctcccctcccctacacctaaaggtgtatttaaactatcttgtgtgattaacttatttagagatgctgtaacttaaaataggggatatttaaggtagcttcagctagcttttaggaaaatcactttgtctaactcagaattatttttaaaaagaaatctggtcttgttagaaaacaaaattttattttgtgctcatttaagtttcaaacttactattttgacagttattttgataacaatgacactagaaaacttgactccatttcatcattgtttctgcatgaatatcatacaaatcagttagtttttaggtcaagggcttactatttctgggtcttttgctactaagttcacattagaattagtgccagaattttaggaacttcagagatcgtgtattgagatttcttaaataatgcttcagatattattgctttattgcttttttgtattggttaaaactgtacatttaaaattgctatgttactattttctacaattaatagtttgtctattttaaaataaattagttgttaagagtc

SEQ ID NO: 36 - protein, 928 aa, Homo sapiens
MPPKTPRKTAATAAAAAAEPPAPPPPPPPEEDPEQDSGPEDLPLVRLEFEETEEPDFTALCQKLKIPDHVRERAWLTWEKVSSVDGVLGGYIQKKKELWGICIFIARVDLDEMSFTLLSYRKTYEISVHKFFNLLKEIDTSTKVDNAMSRLLKKYDVLFALFSKLERTCELIYLTQPSSSISTEINSALVLKVSWITFLLAKGEVLQMEDDLVISFQLMLCVLDYFIKLSPPMLLKEPYKTAVIPINGSPRTPRRGQNRSARIAKQLENDTRIIEVLCKEHECNIDEVKNVYFKNFIPFMNSLGLVTSNGLPEVENLSKRYEEIYLKNKDLDRRLFLDHDKTLQTDSIDSFETQRTPRKSNLDEEVNIIPPHTPVRTVMNTIQQLMMILNSASDQPSENLISYFNNCTVNPKESILKRVKDIGYIFKEKFAKAVGQGCVEIGSQRYKLGVRLYYRVMESMLKSEEERLSIQNFSKLLNDNIFHMSLLACALEVVMATYSRSTSQNLDSGTDLSFPWILNVLNLKAFDFYKVIESFIKAEGNLTREMIKHLERCEHRIMESLAWLSDSPLFDLIKQSKDREGPTDHLESACPLNLPLQNNHTAADMYLSPVRSPKKKGSTTRVNSTANAETQATSAFQTQKPLKSTSLSLFYKKVYRLAYLRLNTLCERLLSEHPELEHIIWTLFQHTLQNEYELMRDRHLDQIMMCSMYGICKVKNIDLKFKIIVTAYKDLPHAVQETFKRVLIKEEEYDSIIVFYNSVFMQRLKTNILQYASTRPPTLSPIPHIPRSPYKFPSSPLRIPGGNIYISPLKSPYKISEGLPTPTKMTPRSRILVSIGESFGTSEKFQKINQMVCNSDRVLKRSAEGSNPPKPLKKLRFDIEGSDEADGSKHLPGESKFQQKLAEMTSTRTRMQKQKMNDSMDTSNKEEK

SEQ ID NO: 37 - DNA, 4201 bp, Homo sapiens
  CDS (359)..(1885)
ggtcgggggatccctccgccgccagcgcgtggtcccggccccctccacccgccgtctcggccgcggccagcagcccctgccccccgggggacgctgacggccgcccggcgcgccgccctagcagacggacagggggcgctgcgcgcggcctggggcaacccgggccacaggggcaggaaagtgagggcccaggtcggcccgggcgtgcaggggccccgggttcgcagcggcggccgcggcagcgatagcggcactagcagcagcgggagtgccgggttgagccgggaagccgatggcggcggctgcggcggctccgattcctcgctgactgcccgtccgccctcctgcatcgagcgccatgttaccgacccaagctggggccgcggcggctctgggccggggctcggccctggggggcagcctgaaccggaccccgacggggcggccgggcggcggcggcgggacacgcggggctaacgggggccgggtccccgggaatggcgcggggctcgggcccggccgcctggagcgggaggctgcggcagcggcggcaaccaccccggcgcccaccgcgggggccctctacagcggcagcgagggcgactcggagtcgggcgaggaggaggagctgggcgccgagcggcgcggcctgaagcggagcctgagcgagatggagatcggtatggtggtcggtgggcccgaggcgtcggcagcggccaccgggggctacgggccggtgagcggcgcggtgagcggggccaagccgggtaagaagacccggggccgcgtgaagatcaagatggagttcatcgacaacaagctgcggcgctacacgaccttcagcaagaggaagacgggcatcatgaagaaggcctatgagctgtccacgctgacagggacacaggtgctgttgctggtggccagtgagacaggccatgtgtatacctttgccacccgaaaactgcagcccatgatcaccagtgagaccggcaaggcactgattcagacctgcctcaactcgccagactctccaccccgttcagaccccacaacagaccagagaatgagtgccactggctttgaagagacagatctcacctaccaggtgtcggagtctgacagcagtggggagaccaaggacacactgaagccggcgttcacagtcaccaacctgccgggtacaacctccaccatccaaacagcacctagcacctctaccaccatgcaagtcagcagcggcccctcctttcccatcaccaactacctggcaccagtgtctgctagtgtcagccccagtgctgtcagcagtgccaatgggactgtgctgaagagtacaggcagcggccctgtctcctctgggggccttatgcagctgcctaccagcttcaccctcatgcctggtggggcagtggcccagcaggtcccagtgcaggccattcaagtgcaccaggccccacagcaagcgtctccctcccgtgacagcagcacagacctcacgcagacctcctccagcgggacagtgacgctgcccgccaccatcatgacgtcatccgtgcccacaactgtgggtggccacatgatgtaccctagcccgcatgcggtgatgtatgcccccacctcgggcctgggtgatggcagcctcaccgtgctgaatgccttctcccaggcaccatccaccatgcaggtgtcacacagccaggtccaggagccaggtggcgtcccccaggtgttcctgacagcatcatctgggacagtgcagatccctgtttcagcagttcagctccaccagatggctgtgatagggcagcaggccgggagcagcagcaacctcaccgagctacaggtggtgaacctggacaccgcccacagcaccaagagtgaatgatccgcccgccgccctggacagatggcccaagggatggcaccacttatttattgttgccttttcacgttttctttacacacacgttgacgggccgcaggagggaggcggggaggaggaacgggcagccacaggactgagccctctcactccagccaaagaaatgggcctgcctgcctccacccgtcctccctcagcctccccttcttcccgccccacctcccatttctgttgctggaggggctgtcctccttcctgggaccccctcgccagcttggctcgatgtttgccatgagtattagcttacccaatgggaccgtgccccacctccccacacacaggccttctgtggggctgggcaccgtgtcctcctctgaggaagcagttggggccctcttgccagcctccttgctgaccccaggtcagccctgtgtctgtcacaggctgggtcaaaagagccctggctctgcccctcagggggccagctggggagatgggggcttcttcctcacactgctgtcctctcccccttcagctcctgagtagctgggcctgtgcactgggcaggttcctggggccgcctgccctgccttgccgctccccttggacctccaggggctcctgggttggagggaaccaccagcgttcccttctcccccttgtcttcccccctctcctcccagctgctttacttaaagttgattttgaactttttatttgaggagacgaagtgaaaacaaatctataaatatatatttttaaaatatttaacttttttttatggcgtttttctcgtccccctccctgcccaaactccccttccctggggagccctcaggctccccagaactggctgggcccctggggacagagccaccccatgagctcggggtccaccagtgtgtgggggagattctgggtttgcccagtcctggattgtttccaggagaaagccgggggaggggccctcaggccattccccaacggggtggggagggtgacccacagctctgggcctctttttgccctttagggctgttgctagggagagggaagagggagaccaaatgtcggggttggggtgggagggcgtcaggcagaggcaactgacttcatttgtgccacacgcatgggcattgcagccttgcgctgtcccaggcatgcagctgcctggggcccaagttgcagtgagcagggtggggtctgggagggggtgagaggcaggaatgggggtcagaagaagtgggagcagcttcttgggctgagtgcagccaaaggggagccagaaatgggcagttctcccagggagtgagcagctactgtaacttttttaaattaagacaaaaagccttgaagaaaatgactttatttttctaagtgtaacctcagtatttatgtaatttgtacaggggccatgccccacccccctcctccccctttggggtagaccttgagggtgggccagcataggggggagggtcttttaccctgtgtcagagcctaccttcaccacctatatccagaaggggagctttttcagaaacagggcagcagtggggtgaaattttcttaacccctaagactgccttcagtaggaacaagctggcttctgtgattaggtgaagggatgggggaagattttatgcacagcctagttatcaaggggatgatttgccgacatgtttgagaaccccctaacctctaaccctcattgctgtcttgccccagtttggggtgccaagatggaagtcacctttctgggctttctcctggagactagctggggcttatgggtggctttcaaggctggggcatggcaaatcaggggccagagagcaggggagcttgggactcaggtctgtaactgcccagccccttttctctgctcttgtttcactccaccatcactcactcactccccactcccccacccatggggaggagacctttgatgaattcttcctctccttcccacaaaagacagacccagtgagtgaatcaggcaaagtgcttataatgtgtgttgtgtgagcgtggccttgggaggacatgcgtgtgtcagggatgagttgaggtgatatttttatgtgcagcgacccttggtgtttcccttcctcggtggctctggggtatgtgtgtgtgggtgtgtgcgcctgagtgagtgtgtgtgcttgaatgtgagtgtgtatgtcagtggtttctacttcccctgggatgctgacccaggaatagtggacatggtcacagtcctatgtacagagctttcttttgtattaaaaaaaaatactctttcaataaatgtatcatttttgtgcacag

SEQ ID NO: 38 - protein, 508 aa, Homo sapiens
MLPTQAGAAAALGRGSALGGSLNRTPTGRPGGGGGTRGANGGRVPGNGAGLGPGRLEREAAAAAATTPAPTAGALYSGSEGDSESGEEEELGAERRGLKRSLSEMEIGMVVGGPEASAAATGGYGPVSGAVSGAKPGKKTRGRVKIKMEFIDNKLRRYTTFSKRKTGIMKKAYELSTLTGTQVLLLVASETGHVYTFATRKLQPMITSETGKALIQTCLNSPDSPPRSDPTTDQRMSATGFEETDLTYQVSESDSSGETKDTLKPAFTVTNLPGTTSTIQTAPSTSTTMQVSSGPSFPITNYLAPVSASVSPSAVSSANGTVLKSTGSGPVSSGGLMQLPTSFTLMPGGAVAQQVPVQAIQVHQAPQQASPSRDSSTDLTQTSSSGTVTLPATIMTSSVPTTVGGHMMYPSPHAVMYAPTSGLGDGSLTVLNAFSQAPSTMQVSHSQVQEPGGVPQVFLTASSGTVQIPVSAVQLHQMAVIGQQAGSSSNLTELQVVNLDTAHSTKSE

SEQ ID NO: 39 - DNA, 4003 bp, Homo sapiens
  CDS (197)..(2449)
attaaacctctcgccgagcccctccgcagactctgcgccggaaagtttcatttgctgtatgccatcctcgagagctgtctaggttaacgttcgcactctgtgtatataacctcgacagtcttggcacctaacgtgctgtgcgtagctgctcctttggttgaatccccaggcccttgttggggcacaaggtggcaggatgtctcagtggtacgaacttcagcagcttgactcaaaattcctggagcaggttcaccagctttatgatgacagttttcccatggaaatcagacagtacctggcacagtggttagaaaagcaagactgggagcacgctgccaatgatgtttcatttgccaccatccgttttcatgacctcctgtcacagctggatgatcaatatagtcgcttttctttggagaataacttcttgctacagcataacataaggaaaagcaagcgtaatcttcaggataattttcaggaagacccaatccagatgtctatgatcatttacagctgtctgaaggaagaaaggaaaattctggaaaacgcccagagatttaatcaggctcagtcggggaatattcagagcacagtgatgttagacaaacagaaagagcttgacagtaaagtcagaaatgtgaaggacaaggttatgtgtatagagcatgaaatcaagagcctggaagatttacaagatgaatatgacttcaaatgcaaaaccttgcagaacagagaacacgagaccaatggtgtggcaaagagtgatcagaaacaagaacagctgttactcaagaagatgtatttaatgcttgacaataagagaaaggaagtagttcacaaaataatagagttgctgaatgtcactgaacttacccagaatgccctgattaatgatgaactagtggagtggaagcggagacagcagagcgcctgtattggggggccgcccaatgcttgcttggatcagctgcagaactggttcactatagttgcggagagtctgcagcaagttcggcagcagcttaaaaagttggaggaattggaacagaaatacacctacgaacatgaccctatcacaaaaaacaaacaagtgttatgggaccgcaccttcagtcttttccagcagctcattcagagctcgtttgtggtggaaagacagccctgcatgccaacgcaccctcagaggccgctggtcttgaagacaggggtccagttcactgtgaagttgagactgttggtgaaattgcaagagctgaattataatttgaaagtcaaagtcttatttgataaagatgtgaatgagagaaatacagtaaaaggatttaggaagttcaacattttgggcacgcacacaaaagtgatgaacatggaggagtccaccaatggcagtctggcggctgaatttcggcacctgcaattgaaagaacagaaaaatgctggcaccagaacgaatgagggtcctctcatcgttactgaagagcttcactcccttagttttgaaacccaattgtgccagcctggtttggtaattgacctcgagacgacctctctgcccgttgtggtgatctccaacgtcagccagctcccgagcggttgggcctccatcctttggtacaacatgctggtggcggaacccaggaatctgtccttcttcctgactccaccatgtgcacgatgggctcagctttcagaagtgctgagttggcagttttcttctgtcaccaaaagaggtctcaatgtggaccagctgaacatgttgggagagaagcttcttggtcctaacgccagccccgatggtctcattccgtggacgaggttttgtaaggaaaatataaatgataaaaattttcccttctggctttggattgaaagcatcctagaactcattaaaaaacacctgctccctctctggaatgatgggtgcatcatgggcttcatcagcaaggagcgagagcgtgccctgttgaaggaccagcagccggggaccttcctgctgcggttcagtgagagctcccgggaaggggccatcacattcacatgggtggagcggtcccagaacggaggcgaacctgacttccatgcggttgaaccctacacgaagaaagaactttctgctgttactttccctgacatcattcgcaattacaaagtcatggctgctgagaatattcctgagaatcccctgaagtatctgtatccaaatattgacaaagaccatgcctttggaaagtattactccaggccaaaggaagcaccagagccaatggaacttgatggccctaaaggaactggatatatcaagactgagttgatttctgtgtctgaagttcacccttctagacttcagaccacagacaacctgctccccatgtctcctgaggagtttgacgaggtgtctcggatagtgggctctgtagaattcgacagtatgatgaacacagtatagagcatgaatttttttcatcttctctggcgacagttttccttctcatctgtgattccctcctgctactctgttccttcacatcctgtgtttctagggaaatgaaagaaaggccagcaaattcgctgcaacctgttgatagcaagtgaatttttctctaactcagaaacatcagttactctgaagggcatcatgcatcttactgaaggtaaaattgaaaggcattctctgaagagtgggtttcacaagtgaaaaacatccagatacacccaaagtatcaggacgagaatgagggtcctttgggaaaggagaagttaagcaacatctagcaaatgttatgcataaagtcagtgcccaactgttataggttgttggataaatcagtggttatttagggaactgcttgacgtaggaacggtaaatttctgtgggagaattcttacatgttttctttgctttaagtgtaactggcagttttccattggtttacctgtgaaatagttcaaagccaagtttatatacaattatatcagtcctctttcaaaggtagccatcatggatctggtagggggaaaatgtgtattttattacatctttcacattggctatttaaagacaaagacaaattctgtttcttgagaagagaatattagctttactgtttgttatggcttaatgacactagctaatatcaatagaaggatgtacatttccaaattcacaagttgtgtttgatatccaaagctgaatacattctgctttcatcttggtcacatacaattatttttacagttctcccaagggagttaggctattcacaaccactcattcaaaagttgaaattaaccatagatgtagataaactcagaaatttaattcatgtttcttaaatgggctactttgtcctttttgttattagggtggtatttagtctattagccacaaaattgggaaaggagtagaaaaagcagtaactgacaacttgaataatacaccagagataatatgagaatcagatcatttcaaaactcatttcctatgtaactgcattgagaactgcatatgtttcgctgatatatgtgtttttcacatttgcgaatggttccattctctctcctgtactttttccagacacttttttgagtggatgatgtttcgtgaagtatactgtatttttacctttttccttccttatcactgacacaaaaagtagattaagagatgggtttgacaaggttcttcccttttacatactgctgtctatgtggctgtatcttgtttttccactactgctaccacaactatattatcatgcaaatgctgtattcttctttggtggagataaagatttcttgagttttgttttaaaattaaagctaaagtatctgtattgcattaaatataatatcgacacagtgctttccgtggcactgcatacaatctgaggcctcctctctcagtttttatatagatggcgagaacctaagtttcagttgattttacaattgaaatgactaaaaaacaaagaagacaacattaaaaacaatattgtttcta

SEQ ID NO: 40 - protein, 750 aa, Homo sapiens
MSQWYELQQLDSKFLEQVHQLYDDSFPMEIRQYLAQWLEKQDWEHAANDVSFATIRFHDLLSQLDDQYSRFSLENNFLLQHNIRKSKRNLQDNFQEDPIQMSMIIYSCLKEERKILENAQRFNQAQSGNIQSTVMLDKQKELDSKVRNVKDKVMCIEHEIKSLEDLQDEYDFKCKTLQNREHETNGVAKSDQKQEQLLLKKMYLMLDNKRKEVVHKIIELLNVTELTQNALINDELVEWKRRQQSACIGGPPNACLDQLQNWFTIVAESLQQVRQQLKKLEELEQKYTYEHDPITKNKQVLWDRTFSLFQQLIQSSFVVERQPCMPTHPQRPLVLKTGVQFTVKLRLLVKLQELNYNLKVKVLFDKDVNERNTVKGFRKFNILGTHTKVMNMEESTNGSLAAEFRHLQLKEQKNAGTRTNEGPLIVTEELHSLSFETQLCQPGLVIDLETTSLPVVVISNVSQLPSGWASILWYNMLVAEPRNLSFFLTPPCARWAQLSEVLSWQFSSVTKRGLNVDQLNMLGEKLLGPNASPDGLIPWTRFCKENINDKNFPFWLWIESILELIKKHLLPLWNDGCIMGFISKERERALLKDQQPGTFLLRFSESSREGAITFTWVERSQNGGEPDFHAVEPYTKKELSAVTFPDIIRNYKVMAAENIPENPLKYLYPNIDKDHAFGKYYSRPKEAPEPMELDGPKGTGYIKTELISVSEVHPSRLQTTDNLLPMSPEEFDEVSRIVGSVEFDSMMNTV

SEQ ID NO: 41 - DNA, 2607 bp, Homo sapiens
  CDS (197)..(2332)
attaaacctctcgccgagcccctccgcagactctgcgccggaaagtttcatttgctgtatgccatcctcgagagctgtctaggttaacgttcgcactctgtgtatataacctcgacagtcttggcacctaacgtgctgtgcgtagctgctcctttggttgaatccccaggcccttgttggggcacaaggtggcaggatgtctcagtggtacgaacttcagcagcttgactcaaaattcctggagcaggttcaccagctttatgatgacagttttcccatggaaatcagacagtacctggcacagtggttagaaaagcaagactgggagcacgctgccaatgatgtttcatttgccaccatccgttttcatgacctcctgtcacagctggatgatcaatatagtcgcttttctttggagaataacttcttgctacagcataacataaggaaaagcaagcgtaatcttcaggataattttcaggaagacccaatccagatgtctatgatcatttacagctgtctgaaggaagaaaggaaaattctggaaaacgcccagagatttaatcaggctcagtcggggaatattcagagcacagtgatgttagacaaacagaaagagcttgacagtaaagtcagaaatgtgaaggacaaggttatgtgtatagagcatgaaatcaagagcctggaagatttacaagatgaatatgacttcaaatgcaaaaccttgcagaacagagaacacgagaccaatggtgtggcaaagagtgatcagaaacaagaacagctgttactcaagaagatgtatttaatgcttgacaataagagaaaggaagtagttcacaaaataatagagttgctgaatgtcactgaacttacccagaatgccctgattaatgatgaactagtggagtggaagcggagacagcagagcgcctgtattggggggccgcccaatgcttgcttggatcagctgcagaactggttcactatagttgcggagagtctgcagcaagttcggcagcagcttaaaaagttggaggaattggaacagaaatacacctacgaacatgaccctatcacaaaaaacaaacaagtgttatgggaccgcaccttcagtcttttccagcagctcattcagagctcgtttgtggtggaaagacagccctgcatgccaacgcaccctcagaggccgctggtcttgaagacaggggtccagttcactgtgaagttgagactgttggtgaaattgcaagagctgaattataatttgaaagtcaaagtcttatttgataaagatgtgaatgagagaaatacagtaaaaggatttaggaagttcaacattttgggcacgcacacaaaagtgatgaacatggaggagtccaccaatggcagtctggcggctgaatttcggcacctgcaattgaaagaacagaaaaatgctggcaccagaacgaatgagggtcctctcatcgttactgaagagcttcactcccttagttttgaaacccaattgtgccagcctggtttggtaattgacctcgagacgacctctctgcccgttgtggtgatctccaacgtcagccagctcccgagcggttgggcctccatcctttggtacaacatgctggtggcggaacccaggaatctgtccttcttcctgactccaccatgtgcacgatgggctcagctttcagaagtgctgagttggcagttttcttctgtcaccaaaagaggtctcaatgtggaccagctgaacatgttgggagagaagcttcttggtcctaacgccagccccgatggtctcattccgtggacgaggttttgtaaggaaaatataaatgataaaaattttcccttctggctttggattgaaagcatcctagaactcattaaaaaacacctgctccctctctggaatgatgggtgcatcatgggcttcatcagcaaggagcgagagcgtgccctgttgaaggaccagcagccggggaccttcctgctgcggttcagtgagagctcccgggaaggggccatcacattcacatgggtggagcggtcccagaacggaggcgaacctgacttccatgcggttgaaccctacacgaagaaagaactttctgctgttactttccctgacatcattcgcaattacaaagtcatggctgctgagaatattcctgagaatcccctgaagtatctgtatccaaatattgacaaagaccatgcctttggaaagtattactccaggccaaaggaagcaccagagccaatggaacttgatggccctaaaggaactggatatatcaagactgagttgatttctgtgtctgaagtgtaagtgaacacagaagagtgacatgtttacaaacctcaagccagccttgctcctggctggggcctgttgaagatgcttgtattttacttttccattgtaattgctatcgccatcacagctgaacttgttgagatccccgtgttactgcctatcagcattttactactttaaaaaaaaaaaaaaaagccaaaaaccaaatttgtatttaaggtatataaattttcccaaaactgataccctttgaaaaagtataaataaaatgagcaaaagttgaa

SEQ ID NO: 42 - protein, 712 aa, Homo sapiens
MSQWYELQQLDSKFLEQVHQLYDDSFPMEIRQYLAQWLEKQDWEHAANDVSFATIRFHDLLSQLDDQYSRFSLENNFLLQHNIRKSKRNLQDNFQEDPIQMSMIIYSCLKEERKILENAQRFNQAQSGNIQSTVMLDKQKELDSKVRNVKDKVMCIEHEIKSLEDLQDEYDFKCKTLQNREHETNGVAKSDQKQEQLLLKKMYLMLDNKRKEVVHKIIELLNVTELTQNALINDELVEWKRRQQSACIGGPPNACLDQLQNWFTIVAESLQQVRQQLKKLEELEQKYTYEHDPITKNKQVLWDRTFSLFQQLIQSSFVVERQPCMPTHPQRPLVLKTGVQFTVKLRLLVKLQELNYNLKVKVLFDKDVNERNTVKGFRKFNILGTHTKVMNMEESTNGSLAAEFRHLQLKEQKNAGTRTNEGPLIVTEELHSLSFETQLCQPGLVIDLETTSLPVVVISNVSQLPSGWASILWYNMLVAEPRNLSFFLTPPCARWAQLSEVLSWQFSSVTKRGLNVDQLNMLGEKLLGPNASPDGLIPWTRFCKENINDKNFPFWLWIESILELIKKHLLPLWNDGCIMGFISKERERALLKDQQPGTFLLRFSESSREGAITFTWVERSQNGGEPDFHAVEPYTKKELSAVTFPDIIRNYKVMAAENIPENPLKYLYPNIDKDHAFGKYYSRPKEAPEPMELDGPKGTGYIKTELISVSEV

SEQ ID NO: 43 - DNA, 3281 bp, Homo sapiens
  CDS (38)..(2590)
attaaacttcctcactgcaaccctaatcagagcccaaatggcgcagtgggaaatgctgcagaatcttgacagcccctttcaggatcagctgcaccagctttactcgcacagcctcctgcctgtggacattcgacagtacttggctgtctggattgaagaccagaactggcaggaagctgcacttgggagtgatgattccaaggctaccatgctattcttccacttcttggatcagctgaactatgagtgtggccgttgcagccaggacccagagtccttgttgctgcagcacaatttgcggaaattctgccgggacattcagcccttttcccaggatcctacccagttggctgagatgatctttaacctccttctggaagaaaaaagaattttgatccaggctcagagggcccaattggaacaaggagagccagttctcgaaacacctgtggagagccagcaacatgagattgaatcccggatcctggatttaagggctatgatggagaagctggtaaaatccatcagccaactgaaagaccagcaggatgtcttctgcttccgatataagatccaggccaaagggaagacaccctctctggacccccatcagaccaaagagcagaagattctgcaggaaactctcaatgaactggacaaaaggagaaaggaggtgctggatgcctccaaagcactgctaggccgattaactaccctaatcgagctactgctgccaaagttggaggagtggaaggcccagcagcaaaaagcctgcatcagagctcccattgaccacgggttggaacagctggagacatggttcacagctggagcaaagctgttgtttcacctgaggcagctgctgaaggagctgaagggactgagttgcctggttagctatcaggatgaccctctgaccaaaggggtggacctacgcaacgcccaggtcacagagttgctacagcgtctgctccacagagcctttgtggtagaaacccagccctgcatgccccaaactccccatcgacccctcatcctcaagactggcagcaagttcaccgtccgaacaaggctgctggtgagactccaggaaggcaatgagtcactgactgtggaagtctccattgacaggaatcctcctcaattacaaggcttccggaagttcaacattctgacttcaaaccagaaaactttgacccccgagaaggggcagagtcagggtttgatttgggactttggttacctgactctggtggagcaacgttcaggtggttcaggaaagggcagcaataaggggccactaggtgtgacagaggaactgcacatcatcagcttcacggtcaaatatacctaccagggtctgaagcaggagctgaaaacggacaccctccctgtggtgattatttccaacatgaaccagctctcaattgcctgggcttcagttctctggttcaatttgctcagcccaaaccttcagaaccagcagttcttctccaacccccccaaggccccctggagcttgctgggccctgctctcagttggcagttctcctcctatgttggccgaggcctcaactcagaccagctgagcatgctgagaaacaagctgttcgggcagaactgtaggactgaggatccattattgtcctgggctgacttcactaagcgagagagccctcctggcaagttaccattctggacatggctggacaaaattctggagttggtacatgaccacctgaaggatctctggaatgatggacgcatcatgggctttgtgagtcggagccaggagcgccggctgctgaagaagaccatgtctggcacctttctactgcgcttcagtgaatcgtcagaagggggcattacctgctcctgggtggagcaccaggatgatgacaaggtgctcatctactctgtgcaaccgtacacgaaggaggtgctgcagtcactcccgctgactgaaatcatccgccattaccagttgctcactgaggagaatatacctgaaaacccactgcgcttcctctatccccgaatcccccgggatgaagcttttgggtgctactaccaggagaaagttaatctccaggaacggaggaaatacctgaaacacaggctcattgtggtctctaatagacaggtggatgaactgcaacaaccgctggagcttaagccagagccagagctggagtcattagagctggaactagggctggtgccagagccagagctcagcctggacttagagccactgctgaaggcagggctggatctggggccagagctagagtctgtgctggagtccactctggagcctgtgatagagcccacactatgcatggtatcacaaacagtgccagagccagaccaaggacctgtatcacagccagtgccagagccagatttgccctgtgatctgagacatttgaacactgagccaatggaaatcttcagaaactgtgtaaagattgaagaaatcatgccgaatggtgacccactgttggctggccagaacaccgtggatgaggtttacgtctcccgccccagccacttctacactgatggacccttgatgccttctgacttctaggaaccacatttcctctgttcttttcatatctctttgcccttcctactcctcatagcatgatattgttctccaaggatgggaatcaggcatgtgtcccttccaagctgtgttaactgttcaaactcaggcctgtgtgactccattggggtgagaggtgaaagcataacatgggtacagaggggacaacaatgaatcagaacagatgctgagccataggtctaaataggatcctggaggctgcctgctgtgctgggaggtataggggtcctgggggcaggccagggcagttgacaggtacttggagggctcagggcagtggcttctttccagtatggaaggatttcaacattttaatagttggttaggctaaactggtgcatactggcattggccttggtggggagcacagacacaggataggactccatttctttcttccattccttcatgtctaggataacttgctttcttctttcctttactcctggctcaagccctgaatttcttcttttcctgcaggggttgagagctttctgccttagcctaccatgtgaaactctaccctgaagaaagggatggataggaagtagacctctttttcttaccagtctcctcccctactctgccccctaagctggctgtacctgttcctcccccataaaatgatcctgccaatctaaaaaaaaaa

SEQ ID NO: 44 - protein, 851 aa, Homo sapiens
MAQWEMLQNLDSPFQDQLHQLYSHSLLPVDIRQYLAVWIEDQNWQEAALGSDDSKATMLFFHFLDQLNYECGRCSQDPESLLLQHNLRKFCRDIQPFSQDPTQLAEMIFNLLLEEKRILIQAQRAQLEQGEPVLETPVESQQHEIESRILDLRAMMEKLVKSISQLKDQQDVFCFRYKIQAKGKTPSLDPHQTKEQKILQETLNELDKRRKEVLDASKALLGRLTTLIELLLPKLEEWKAQQQKACIRAPIDHGLEQLETWFTAGAKLLFHLRQLLKELKGLSCLVSYQDDPLTKGVDLRNAQVTELLQRLLHRAFVVETQPCMPQTPHRPLILKTGSKFTVRTRLLVRLQEGNESLTVEVSIDRNPPQLQGFRKFNILTSNQKTLTPEKGQSQGLIWDFGYLTLVEQRSGGSGKGSNKGPLGVTEELHIISFTVKYTYQGLKQELKTDTLPVVIISNMNQLSIAWASVLWFNLLSPNLQNQQFFSNPPKAPWSLLGPALSWQFSSYVGRGLNSDQLSMLRNKLFGQNCRTEDPLLSWADFTKRESPPGKLPFWTWLDKILELVHDHLKDLWNDGRIMGFVSRSQERRLLKKTMSGTFLLRFSESSEGGITCSWVEHQDDDKVLIYSVQPYTKEVLQSLPLTEIIRHYQLLTEENIPENPLRFLYPRIPRDEAFGCYYQEKVNLQERRKYLKHRLIVVSNRQVDELQQPLELKPEPELESLELELGLVPEPELSLDLEPLLKAGLDLGPELESVLESTLEPVIEPTLCMVSQTVPEPDQGPVSQPVPEPDLPCDLRHLNTEPMEIFRNCVKIEEIMPNGDPLLAGQNTVDEVYVSRPSHFYTDGPLMPSDF

SEQ ID NO: 45 - DNA, 2787 bp, Homo sapiens
  CDS (221)..(2533)
cagctggaattcggggcggcggcgcagactgggagggggagccgggggttccgacgtcgcagccgagggaacaagccccaaccggatcctggacaggcaccccggcttggcgctgtctctccccctcggctcggagaggcccttcggcctgagggagcctcgccgcccgtccccggcacacgcgcagccccggcctctcggcctctgccggagaaacaggatggcccaatggaatcagctacagcagcttgacacacggtacctggagcagctccatcagctctacagtgacagcttcccaatggagctgcggcagtttctggccccttggattgagagtcaagattgggcatatgcggccagcaaagaatcacatgccactttggtgtttcataatctcctgggagagattgaccagcagtatagccgcttcctgcaagagtcgaatgttctctatcagcacaatctacgaagaatcaagcagtttcttcagagcaggtatcttgagaagccaatggagattgcccggattgtggcccggtgcctgtgggaagaatcacgccttctacagactgcagccactgcggcccagcaagggggccaggccaaccaccccacagcagccgtggtgacggagaagcagcagatgctggagcagcaccttcaggatgtccggaagagagtgcaggatctagaacagaaaatgaaagtggtagagaatctccaggatgactttgatttcaactataaaaccctcaagagtcaaggagacatgcaagatctgaatggaaacaaccagtcagtgaccaggcagaagatgcagcagctggaacagatgctcactgcgctggaccagatgcggagaagcatcgtgagtgagctggcggggcttttgtcagcgatggagtacgtgcagaaaactctcacggacgaggagctggctgactggaagaggcggcaacagattgcctgcattggaggcccgcccaacatctgcctagatcggctagaaaactggataacgtcattagcagaatctcaacttcagacccgtcaacaaattaagaaactggaggagttgcaccaaaaagtttcctacaaaggggaccccattgtacagcaccggccgatgctggaggagaggatcgtggagctgttcagaaacttaatgaaaagtgcctttgtggtggagcggcagccctgcatgcccatgcatcctgaccggcccctcgtcatcaagaccggcgtccagttcactactaaagtcaggttgctggtcaagttccctgagttgaattatcagcttaaaattaaagtgtgcattgacaaagactctggggacgttgcagctctcagaggatcccggaaatttaacattctgggcacaaacacaaaagtgatgaacatggaagaatccaacaacggcagcctctctgcagaattcaaacacttgaccctgagggagcagagatgtgggaatgggggccgagccaattgtgatgcttccctgattgtgactgaggagctgcacctgatcacctttgagaccgaggtgtatcaccaaggtctcaagattgacctagagacccactccttgtcagttgtggtgatctccaacatctgtcagatgccaaatgcctgggcgtccatcctgtggtacaacatgctgaccaacaatcccaagaatgtgaacttcttcactaagccgccaattggaacctgggaccaagtggccgaggtgctcagctggcagttctcgtccaccaccaagcgggggctgagcatcgagcagctgacaacgctggctgagaagctcctagggcctggtgtgaactactcagggtgtcagatcacatgggctaacttctgcaaagaaaacatggctggcaagggcttctcctactgggtctggctagacaatatcatcgaccttgtgaaaaagtatatcttggccctttggaatgaagggtacatcatgggtttcatcagcaaggagcgggagcgggccatcttgagcactaagcccccaggcaccttcctgctgcgcttcagtgaaagcagcaaagaaggaggcgtcactttcacttgggtggagaaggacatcagcggtaagacccagatccagtccgtggaaccatacacaaagcagcagctgaacaacatgtcatttgctgaaatcatcatgggctataagatcatggatgctaccaatatcctgttgtctccacttgtctatctctatcctgacattcccaaggaggaggcattcgggaagtattgtcggccagagagccaggagcatcctgaagctgacccaggtagcgctgccccatacctgaagaccaagtttatctgtgtgacaccaacgacctgcagcaataccattgacctgccgatgtccccccgcgctttagattcattgatgcagtttggaaataatggtgaaggtgctgaaccctcagcaggagggcagtttgagtccctcacctttgacatggagttgacctcggagtgcgctacctcccccatgtgaggagctgagaacggaagctgcagaaagatacgactgaggcgcctacctgcattctgccacccctcacacagccaaaccccagatcatctgaaactactaactttgtggttccagattttttttaatctcctacttctgctatctttgagcaatctgggcacttttaaaaatagagaaatgagtgaatgtgggtgatctgcttttatctaaatgcaaataaggatgtgttctctgagacccatgatcaggggatg

SEQ ID NO: 46 - protein, 770 aa, Homo sapiens
MAQWNQLQQLDTRYLEQLHQLYSDSFPMELRQFLAPWIESQDWAYAASKESHATLVFHNLLGEIDQQYSRFLQESNVLYQHNLRRIKQFLQSRYLEKPMEIARIVARCLWEESRLLQTAATAAQQGGQANHPTAAVVTEKQQMLEQHLQDVRKRVQDLEQKMKVVENLQDDFDFNYKTLKSQGDMQDLNGNNQSVTRQKMQQLEQMLTALDQMRRSIVSELAGLLSAMEYVQKTLTDEELADWKRRQQIACIGGPPNICLDRLENWITSLAESQLQTRQQIKKLEELHQKVSYKGDPIVQHRPMLEERIVELFRNLMKSAFVVERQPCMPMHPDRPLVIKTGVQFTTKVRLLVKFPELNYQLKIKVCIDKDSGDVAALRGSRKFNILGTNTKVMNMEESNNGSLSAEFKHLTLREQRCGNGGRANCDASLIVTEELHLITFETEVYHQGLKIDLETHSLSVVVISNICQMPNAWASILWYNMLTNNPKNVNFFTKPPIGTWDQVAEVLSWQFSSTTKRGLSIEQLTTLAEKLLGPGVNYSGCQITWANFCKENMAGKGFSYWVWLDNIIDLVKKYILALWNEGYIMGFISKERERAILSTKPPGTFLLRFSESSKEGGVTFTWVEKDISGKTQIQSVEPYTKQQLNNMSFAEIIMGYKIMDATNILLSPLVYLYPDIPKEEAFGKYCRPESQEHPEADPGSAAPYLKTKFICVTPTTCSNTIDLPMSPRALDSLMQFGNNGEGAEPSAGGQFESLTFDMELTSECATSPM

SEQ ID NO: 47 - DNA, 2112 bp, Homo sapiens
  CDS (334)..(1806)
cgcgtcgctgcccagcccggtccggcgcgccacgcagtggatctctggacaggacaagactccgaagctactcccccagcacacagcccgggacccacaaacccagcttgcccccagccctcccacctgccactccctggcccctcccaccggccgccccccttggcgcgggcgcatggtgtgaaaggccaagtgctgaggcgggtatcatgggtgctgtgccctaggcctgggtggcagggggtgggtggcctgtgggtgtgccgggggggccagtgtgcccaccccagtctcttggcgtgctggagggcatcctggatggaattgaagtgaatggaacagaagccaagcaaggtggagtgtgggtcagacccagaggagaacagtgccaggtcaccagatggaaagcgaaaaagaaagaacggccaatgttccctgaaaagcagcatgtcagggtatatccctagttacctggacaaagacgagcagtgtgtcgtgtgtggggacaaggcaactggttatcactaccgctgtatcacttgtgagggctgcaagggcttctttcgccgcacaatccagaagaacctccatcccacctattcctgcaaatatgacagctgctgtgtcattgacaagatcacccgcaatcagtgccagctgtgccgcttcaagaagtgcatcgccgtggccatggccatggacttggttctagatgactcgaagcgggtggccaagcgtaagctgattgagcagaaccgggagcggcggcggaaggaggagatgatccgatcactgcagcagcgaccagagcccactcctgaagagtgggatctgatccacattgccacagaggcccatcgcagcaccaatgcccagggcagccattggaaacagaggcggaaattcctgcccgatgacattggccagtcacccattgtctccatgccggacggagacaaggtggacctggaagccttcagcgagtttaccaagatcatcaccccggccatcacccgtgtggtggactttgccaaaaaactgcccatgttctccgagctgccttgcgaagaccagatcatcctcctgaaggggtgctgcatggagatcatgtccctgcgggcggctgtccgctacgaccctgagagcgacaccctgacgctgagtggggagatggctgtcaagcgggagcagctcaagaatggcggcctgggcgtagtctccgacgccatcttcgaactgggcaagtcactctctgcctttaacctggatgacacggaagtggctctgctgcaggctgtgctgctaatgtcaacagaccgctcgggcctgctgtgtgtggacaagatcgagaagagtcaggaggcgtacctgctggcgttcgagcactacgtcaaccaccgcaaacacaacattccgcacttctggcccaagctgctgatgaaggagagagaagtgcagagttcgattctgtacaagggggcagcggcagaaggccggccgggcgggtcactgggcgtccacccggaaggacagcagcttctcggaatgcatgttgttcagggtccgcaggtccggcagcttgagcagcagcttggtgaagcgggaagtctccaagggccggttcttcagcaccagagcccgaagagcccgcagcagcgtctcctggagctgctccaccgaagcggaattctccatgcccgagcggtctgtggggaagacgacagcagtgaggcggactccccgagctcctctgaggaggaaccggaggtctgcgaggacctggcaggcaatgcagcctctccctgaagccccccagaaggccgatggggaaggagaaggagtgccataccttctcccaggcctctgccccaagagcaggaggtgcctgaaagctgggagcgtgggctcagcagggctggtcacctcccatcccgtaagaccaccttcccttcctcagcagccaaacatggccagactcccttgctttttgctgtgtagttccctctgcctgggatgcccttccccctttctctgcctggcaacatcttacttgtcctttgaggccccaactcaagtgtcacctccttccccagctcccccaggcagaaatag

SEQ ID NO: 48 - protein, 490 aa, Homo sapiens
MEQKPSKVECGSDPEENSARSPDGKRKRKNGQCSLKSSMSGYIPSYLDKDEQCVVCGDKATGYHYRCITCEGCKGFFRRTIQKNLHPTYSCKYDSCCVIDKITRNQCQLCRFKKCIAVAMAMDLVLDDSKRVAKRKLIEQNRERRRKEEMIRSLQQRPEPTPEEWDLIHIATEAHRSTNAQGSHWKQRRKFLPDDIGQSPIVSMPDGDKVDLEAFSEFTKIITPAITRVVDFAKKLPMFSELPCEDQIILLKGCCMEIMSLRAAVRYDPESDTLTLSGEMAVKREQLKNGGLGVVSDAIFELGKSLSAFNLDDTEVALLQAVLLMSTDRSGLLCVDKIEKSQEAYLLAFEHYVNHRKHNIPHFWPKLLMKEREVQSSILYKGAAAEGRPGGSLGVHPEGQQLLGMHVVQGPQVRQLEQQLGEAGSLQGPVLQHQSPKSPQQRLLELLHRSGILHARAVCGEDDSSEADSPSSSEEEPEVCEDLAGNAASP

SEQ ID NO: 49 - DNA, 2521 bp, Homo sapiens
  CDS (136)..(1317)
ggcacgagccaccgtccagggagcaggtagctgctgggctccggggacactttgcgttcgggctgggagcgtgctttccacgacggtgacacgcttccctggattggcagccagactgccttccgggtcactgccatggaggagccgcagtcagatcctagcgtcgagccccctctgagtcaggaaacattttcagacctatggaaactacttcctgaaaacaacgttctgtcccccttgccgtcccaagcaatggatgatttgatgctgtccccggacgatattgaacaatggttcactgaagacccaggtccagatgaagctcccagaatgccagaggctgctccccgcgtggcccctgcaccagcagctcctacaccggcggcccctgcaccagccccctcctggcccctgtcatcttctgtcccttcccagaaaacctaccagggcagctacggtttccgtctgggcttcttgcattctgggacagccaagtctgtgacttgcacgtactcccctgccctcaacaagatgttttgccaactggccaagacctgccctgtgcagctgtgggttgattccacacccccgcccggcacccgcgtccgcgccatggccatctacaagcagtcacagcacatgacggaggttgtgaggcgctgcccccaccatgagcgctgctcagatagcgatggtctggcccctcctcagcatcttatccgagtggaaggaaatttgcgtgtggagtatttggatgacagaaacacttttcgacatagtgtggtggtgccctatgagccgcctgaggttggctctgactgtaccaccatccactacaactacatgtgtaacagttcctgcatgggcggcatgaaccggaggcccatcctcaccatcatcacactggaagactccagtggtaatctactgggacggaacagctttgaggtgcgtgtttgtgcctgtcctgggagagaccggcgcacagaggaagagaatctccgcaagaaaggggagcctcaccacgagctgcccccagggagcactaagcgagcactgcccaacaacaccagctcctctccccagccaaagaagaaaccactggatggagaatatttcacccttcagatccgtgggcgtgagcgcttcgagatgttccgagagctgaatgaggccttggaactcaaggatgcccaggctgggaaggagccaggggggagcagggctcactccagccacctgaagtccaaaaagggtcagtctacctcccgccataaaaaactcatgttcaagacagaagggcctgactcagactgacattctccacttcttgttccccactgacagcctcccacccccatctctccctcccctgccattttgggttttgggtctttgaacccttgcttgcaataggtgtgcgtcagaagcacccaggacttccatttgctttgtcccggggctccactgaacaagttggcctgcactggtgttttgttgtggggaggaggatggggagtaggacataccagcttagattttaaggtttttactgtgagggatgtttgggagatgtaagaaatgttcttgcagttaagggttagtttacaatcagccacattctaggtaggggcccacttcaccgtactaaccagggaagctgtccctcactgttgaattttctctaacttcaaggcccatatctgtgaaatgctggcatttgcacctacctcacagagtgcattgtgagggttaatgaaataatgtacatctggccttgaaaccaccttttattacatggggtctagaacttgacccccttgagggtgcttgttccctctccctgttggtcggtgggttggtagtttctacagttgggcagctggttaggtagagggagttgtcaagtctctgctggcccagccaaaccctgtctgaccacctcttggtgaaccttagtacctaaaaggaaatctcaccccatcccacaccctggaggatttcatctcttgtatatgatgatctggatccaccaagacttgttttatgctcagggtcaatttcttttttctttttttttttttttttctttttctttgagactgggtctcgctttgttgcccaggctggagtggagtggcgtgatcttggcttactgcagcctttgcctccccggctcgagcagtcctgcctcagcctccggagtagctgggaccacaggttcatgccaccatggccagccaacttttgcatgttttgtagagatggggtctcacagtgttgcccaggctggtctcaaactcctgggctcaggcgatccacctgtctcagcctcccagagtgctgggattacaattgtgagccaccacgtccagctggaagggtcaacatcttttacattctgcaagcacatctgcattttcaccccacccttcccctccttctccctttttatatcccatttttatatcgatctcttattttacaataaaactttgctgccaaaaaaaaaaaaaaaaaa

SEQ ID NO: 50 - protein, 393 aa, Homo sapiens [sequence omitted]

SEQ ID NO: 51 - DNA, 1929 bp, Homo sapiens
  CDS (1)..(1929)
atgcttaggggtccggggcccgggctgctgctgctggccgtccagtgcctggggacagcggtgccctccacgggagcctcgaagagcaagaggcaggctcagcaaatggttcagccccagtccccggtggctgtcagtcaaagcaagcccggttgttatgacaatggaaaacactatcagataaatcaacagtgggagcggacctacctaggcaatgcgttggtttgtacttgttatggaggaagccgaggttttaactgcgagagtaaacctgaagctgaagagacttgctttgacaagtacactgggaacacttaccgagtgggtgacacttatgagcgtcctaaagactccatgatctgggactgtacctgcatcggggctgggcgagggagaataagctgtaccatcgcaaaccgctgccatgaagggggtcagtcctacaagattggtgacacctggaggagaccacatgagactggtggttacatgttagagtgtgtgtgtcttggtaatggaaaaggagaatggacctgcaagcccatagctgagaagtgttttgatcatgctgctgggacttcctatgtggtcggagaaacgtgggagaagccctaccaaggctggatgatggtagattgtacttgcctgggagaaggcagcggacgcatcacttgcacttctagaaatagatgcaacgatcaggacacaaggacatcctatagaattggagacacctggagcaagaaggataatcgaggaaacctgctccagtgcatctgcacaggcaacggccgaggagagtggaagtgtgagaggcacacctctgtgcagaccacatcgagcggatctggccccttcaccgatgttcgtgcagctgtttaccaaccgcagcctcacccccagcctcctccctatggccactgtgtcacagacagtggtgtggtctactctgtggggatgcagtggctgaagacacaaggaaataagcaaatgctttgcacgtgcctgggcaacggagtcagctgccaagagacagctgtaacccagacttacggtggcaactcaaatggagagccatgtgtcttaccattcacctacaatggcaggacggacagcacaacttcgaattatgagcaggaccagaaatactctttctgcacagaccacactgttttggttcagactcgaggaggaaattccaatggtgccttgtgccacttccccttcctatacaacaaccacaattacactgattgcacttctgagggcagaagagacaacatgaagtggtgtgggaccacacagaactatgatgccgaccagaagtttgggttctgccccatggctgcccacgaggaaatctgcacaaccaatgaaggggtcatgtaccgcattggagatcagtgggataagcagcatgacatgggtcacatgatgaggtgcacgtgtgttgggaatggtcgtggggaatggacatgcattgcctactcgcagcttcgagatcagtgcattgttgatgacatcacttacaatgtgaacgacacattccacaagcgtcatgaagaggggcacatgctgaactgtacatgcttcggtcagggtcggggcaggtggaagtgtgatcccgtcgaccaatgccaggattcagagactgggacgttttatcaaattggagattcatgggagaagtatgtgcatggtgtcagataccagtgctactgctatggccgtggcattggggagtggcattgccaacctttacagacctatccaagctcaagtggtcctgtcgaagtatttatcactgagactccgagtcagcccaactcccaccccatccagtggaatgcaccacagccatctcacatttccaagtacattctcaggtggagacctgtgagtatcccacccagaaaccttggatactga

SEQ ID NO: 52 - protein, 642 aa, Homo sapiens
MLRGPGPGLLLLAVQCLGTAVPSTGASKSKRQAQQMVQPQSPVAVSQSKPGCYDNGKHYQINQQWERTYLGNALVCTCYGGSRGFNCESKPEAEETCFDKYTGNTYRVGDTYERPKDSMIWDCTCIGAGRGRISCTIANRCHEGGQSYKIGDTWRRPHETGGYMLECVCLGNGKGEWTCKPIAEKCFDHAAGTSYVVGETWEKPYQGWMMVDCTCLGEGSGRITCTSRNRCNDQDTRTSYRIGDTWSKKDNRGNLLQCICTGNGRGEWKCERHTSVQTTSSGSGPFTDVRAAVYQPQPHPQPPPYGHCVTDSGVVYSVGMQWLKTQGNKQMLCTCLGNGVSCQETAVTQTYGGNSNGEPCVLPFTYNGRTDSTTSNYEQDQKYSFCTDHTVLVQTRGGNSNGALCHFPFLYNNHNYTDCTSEGRRDNMKWCGTTQNYDADQKFGFCPMAAHEEICTTNEGVMYRIGDQWDKQHDMGHMMRCTCVGNGRGEWTCIAYSQLRDQCIVDDITYNVNDTFHKRHEEGHMLNCTCFGQGRGRWKCDPVDQCQDSETGTFYQIGDSWEKYVHGVRYQCYCYGRGIGEWHCQPLQTYPSSSGPVEVFITETPSQPNSHPIQWNAPQPSHISKYILRWRPVSIPPRNLGY

SEQ ID NO: 53 - DNA, 19 bp, Artificial
  nucleotide sequence of c-Fos siRNA
gcggagacagaccaacuag

SEQ ID NO: 54 - DNA, 19 bp, Artificial
  nucleotide sequence of c-Jun siRNA
gguggcacagcuuaaacag

SEQ ID NO: 55 - DNA, 19 bp, Artificial
  nucleotide sequence of CREB siRNA
caggagucaguggauagug

SEQ ID NO: 56 - DNA, 19 bp, Artificial
  nucleotide sequence of E2F siRNA
cugaccaucaguaccuggc

SEQ ID NO: 57 - DNA, 19 bp, Artificial
  nucleotide sequence of ER siRNA
ccuucuagaaugugccugg

SEQ ID NO: 58 - DNA, 19 bp, Artificial
  nucleotide sequence of GR siRNA
cucgaaugaggacugcaag

SEQ ID NO: 59 - DNA, 19 bp, Artificial
  nucleotide sequence of HSF-1 siRNA
ggagugcauggacuccaag

SEQ ID NO: 60 - DNA, 19 bp, Artificial
  nucleotide sequence of HSF-2 siRNA
guuccacacaguaggacug

SEQ ID NO: 61 - DNA, 19 bp, Artificial
  nucleotide sequence of HSF-4 siRNA
gucgccuucuacuuacagc

SEQ ID NO: 62 - DNA, 19 bp, Artificial
  nucleotide sequence of IkBa siRNA
gcagacuccacuccacuug

SEQ ID NO: 63 - DNA, 19 bp, Artificial
  nucleotide sequence of NFAT3 siRNA
gccacugacccuacagaug

SEQ ID NO: 64 - DNA, 19 bp, Artificial
  nucleotide sequence of NFkB siRNA
gccuaagcagagaggcuuc

SEQ ID NO: 65 - DNA, 19 bp, Artificial
  nucleotide sequence of RARA siRNA
guacugccgacugcagaag

SEQ ID NO: 66 - DNA, 19 bp, Artificial
  nucleotide sequence of RARB1 siRNA
gugaacuggccaccaagug

SEQ ID NO: 67 - DNA, 19 bp, Artificial
  nucleotide sequence of RARB2 siRNA
gacggccuuacccuaaauc

SEQ ID NO: 68 - DNA, 19 bp, Artificial
  nucleotide sequence of RARG siRNA
gcccuacauguucccaagg

SEQ ID NO: 69 - DNA, 19 bp, Artificial
  nucleotide sequence of Rb siRNA
cucucaccucccauguugc

SEQ ID NO: 70 - DNA, 19 bp, Artificial
  nucleotide sequence of SRF siRNA
cagcaccuagcaccucuac

SEQ ID NO: 71 - DNA, 19 bp, Artificial
  nucleotide sequence of STATa siRNA
ggaagacccaauccagaug

SEQ ID NO: 72 - DNA, 19 bp, Artificial
  nucleotide sequence of STATb siRNA
ggaagacccaauccagaug

SEQ ID NO: 73 - DNA, 19 bp, Artificial
  nucleotide sequence of STAT2 siRNA
ggugcucaucuacucugug

SEQ ID NO: 74 - DNA, 19 bp, Artificial
  nucleotide sequence of STAT3 siRNA
gaaacuggaggaguugcac

SEQ ID NO: 75 - DNA, 19 bp, Artificial
  nucleotide sequence of TR siRNA
ccuccaucccaccuauucc

SEQ ID NO: 76 - DNA, 19 bp, Artificial
  nucleotide sequence of p53 siRNA
gacuccagugguaaucuac

SEQ ID NO: 77 - DNA, 19 bp, Artificial
  nucleotide sequence of scramble II Duplex
aguuccaauagaaccaguc

SEQ ID NO: 78 - DNA, 5616 bp, Homo sapiens
  CDS (247)..(3879)
ccccggcgcagcgcggccgcagcagcctccgccccccgcacggtgtgagcgcccgacgcggccgaggcggccggagtcccgagctagccccggcggccgccgccgcccagaccggacgacaggccacctcgtcggcgtccgcccgagtccccgcctcgccgccaacgccacaaccaccgcgcacggccccctgactccgtccagtattgatcgggagagccggagcgagctcttcggggagcagcgatgcgaccctccgggacggccggggcagcgctcctggcgctgctggctgcgctctgcccggcgagtcgggctctggaggaaaagaaagtttgccaaggcacgagtaacaagctcacgcagttgggcacttttgaagatcattttctcagcctccagaggatgttcaataactgtgaggtggtccttgggaatttggaaattacctatgtgcagaggaattatgatctttccttcttaaagaccatccaggaggtggctggttatgtcctcattgccctcaacacagtggagcgaattcctttggaaaacctgcagatcatcagaggaaatatgtactacgaaaattcctatgccttagcagtcttatctaactatgatgcaaataaaaccggactgaaggagctgcccatgagaaatttacaggaaatcctgcatggcgccgtgcggttcagcaacaaccctgccctgtgcaacgtggagagcatccagtggcgggacatagtcagcagtgactttctcagcaacatgtcgatggacttccagaaccacctgggcagctgccaaaagtgtgatccaagctgtcccaatgggagctgctggggtgcaggagaggagaactgccagaaactgaccaaaatcatctgtgcccagcagtgctccgggcgctgccgtggcaagtcccccagtgactgctgccacaaccagtgtgctgcaggctgcacaggcccccgggagagcgactgcctggtctgccgcaaattccgagacgaagccacgtgcaaggacacctgccccccactcatgctctacaaccccaccacgtaccagatggatgtgaaccccgagggcaaatacagctttggtgccacctgcgtgaagaagtgtccccgtaattatgtggtgacagatcacggctcgtgcgtccgagcctgtggggccgacagctatgagatggaggaagacggcgtccgcaagtgtaagaagtgcgaagggccttgccgcaaagtgtgtaacggaataggtattggtgaatttaaagactcactctccataaatgctacgaatattaaacacttcaaaaactgcacctccatcagtggcgatctccacatcctgccggtggcatttaggggtgactccttcacacatactcctcctctggatccacaggaactggatattctgaaaaccgtaaaggaaatcacagggtttttgctgattcaggcttggcctgaaaacaggacggacctccatgcctttgagaacctagaaatcatacgcggcaggaccaagcaacatggtcagttttctcttgcagtcgtcagcctgaacataacatccttgggattacgctccctcaaggagataagtgatggagatgtgataatttcaggaaacaaaaatttgtgctatgcaaatacaataaactggaaaaaactgtttgggacctccggtcagaaaaccaaaattataagcaacagaggtgaaaacagctgcaaggccacaggccaggtctgccatgccttgtgctcccccgagggctgctggggcccggagcccagggactgcgtctcttgccggaatgtcagccgaggcagggaatgcgtggacaagtgcaaccttctggagggtgagccaagggagtttgtggagaactctgagtgcatacagtgccacccagagtgcctgcctcaggccatgaacatcacctgcacaggacggggaccagacaactgtatccagtgtgcccactacattgacggcccccactgcgtcaagacctgcccggcaggagtcatgggagaaaacaacaccctggtctggaagtacgcagacgccggccatgtgtgccacctgtgccatccaaactgcacctacggatgcactgggccaggtcttgaaggctgtccaacgaatgggcctaagatcccgtccatcgccactgggatggtgggggccctcctcttgctgctggtggtggccctggggatcggcctcttcatgcgaaggcgccacatcgttcggaagcgcacgctgcggaggctgctgcaggagagggagcttgtggagcctcttacacccagtggagaagctcccaaccaagctctcttgaggatcttgaaggaaactgaattcaaaaagatcaaagtgctgggctccggtgcgttcggcacggtgtataagggactctggatcccagaaggtgagaaagttaaaattcccgtcgctatcaaggaattaagagaagcaacatctccgaaagccaacaaggaaatcctcgatgaagcctacgtgatggccagcgtggacaacccccacgtgtgccgcctgctgggcatctgcctcacctccaccgtgcagctcatcacgcagctcatgcccttcggctgcctcctggactatgtccgggaacacaaagacaatattggctcccagtacctgctcaactggtgtgtgcagatcgcaaagggcatgaactacttggaggaccgtcgcttggtgcaccgcgacctggcagccaggaacgtactggtgaaaacaccgcagcatgtcaagatcacagattttgggctggccaaactgctgggtgcggaagagaaagaataccatgcagaaggaggcaaagtgcctatcaagtggatggcattggaatcaattttacacagaatctatacccaccagagtgatgtctggagctacggggtgaccgtttgggagttgatgacctttggatccaagccatatgacggaatccctgccagcgagatctcctccatcctggagaaaggagaacgcctccctcagccacccatatgtaccatcgatgtctacatgatcatggtcaagtgctggatgatagacgcagatagtcgcccaaagttccgtgagttgatcatcgaattctccaaaatggcccgagacccccagcgctaccttgtcattcagggggatgaaagaatgcatttgccaagtcctacagactccaacttctaccgtgccctgatggatgaagaagacatggacgacgtggtggatgccgacgagtacctcatcccacagcagggcttcttcagcagcccctccacgtcacggactcccctcctgagctctctgagtgcaaccagcaacaattccaccgtggcttgcattgatagaaatgggctgcaaagctgtcccatcaaggaagacagcttcttgcagcgatacagctcagaccccacaggcgccttgactgaggacagcatagacgacaccttcctcccagtgcctgaatacataaaccagtccgttcccaaaaggcccgctggctctgtgcagaatcctgtctatcacaatcagcctctgaaccccgcgcccagcagagacccacactaccaggacccccacagcactgcagtgggcaaccccgagtatctcaacactgtccagcccacctgtgtcaacagcacattcgacagccctgcccactgggcccagaaaggcagccaccaaattagcctggacaaccctgactaccagcaggacttctttcccaaggaagccaagccaaatggcatctttaagggctccacagctgaaaatgcagaatacctaagggtcgcgccacaaagcagtgaatttattggagcatgaccacggaggatagtatgagccctaaaaatccagactctttcgatacccaggaccaagccacagcaggtcctccatcccaacagccatgcccgcattagctcttagacccacagactggttttgcaacgtttacaccgactagccaggaagtacttccacctcgggcacattttgggaagttgcattcctttgtcttcaaactgtgaagcatttacagaaacgcatccagcaagaatattgtccctttgagcagaaatttatctttcaaagaggtatatttgaaaaaaaaaaaaagtatatgtgaggatttttattgattggggatcttggagtttttcattgtcgctattgatttttacttcaatgggctcttccaacaaggaagaagcttgctggtagcacttgctaccctgagttcatccaggcccaactgtgagcaaggagcacaagccacaagtcttccagaggatgcttgattccagtggttctgcttcaaggcttccactgcaaaacactaaagatccaagaaggccttcatggccccagcaggccggatcggtactgtatcaagtcatggcaggtacagtaggataagccactctgtcccttcctgggcaaagaagaaacggaggggatggaattcttccttagacttacttttgtaaaaatgtccccacggtacttactccccactgatggaccagtggtttccagtcatgagcgttagactgacttgtttgtcttccattccattgttttgaaactcagtatgctgcccctgtcttgctgtcatgaaatcagcaagagaggatgacacatcaaataataactcggattccagcccacattggattcatcagcatttggaccaatagcccacagctgagaatgtggaatacctaaggatagcaccgcttttgttctcgcaaaaacgtatctcctaatttgaggctcagatgaaatgcatcaggtcctttggggcatagatcagaagactacaaaaatgaagctgctctgaaatctcctttagccatcaccccaaccccccaaaattagtttgtgttacttatggaagatagttttctccttttacttcacttcaaaagctttttactcaaagagtatatgttccctccaggtcagctgcccccaaaccccctccttacgctttgtcacacaaaaagtgtctctgccttgagtcatctattcaagcacttacagctctggccacaacagggcattttacaggtgcgaatgacagtagcattatgagtagtgtggaattcaggtagtaaatatgaaactagggtttgaaattgataatgctttcacaacatttgcagatgttttagaaggaaaaaagttccttcctaaaataatttctctacaattggaagattggaagattcagctagttaggagcccaccttttttcctaatctgtgtgtgccctgtaacctgactggttaacagcagtcctttgtaaacagtgttttaaactctcctagtcaatatccaccccatccaatttatcaaggaagaaatggttcagaaaatattttcagcctacagttatgttcagtcacacacacatacaaaatgttccttttgcttttaaagtaatttttgactcccagatcagtcagagcccctacagcattgttaagaaagtatttgatttttgtctcaatgaaaataaaactatattcatttccactctaaaaaaaaaaaaaaaaa

SEQ ID NO: 79 - protein, 1210 aa, Homo sapiens [sequence omitted]

SEQ ID NO: 80 - DNA, 3963 bp, Homo sapiens
  CDS (138)..(3068)
attaaggactcggggcaggaggggcagaagttgcgcgcaggccggcgggcgggagcggacaccgaggccggcgtgcaggcgtgcgggtgtgcgggagccgggctcggggggatcggaccgagagcgagaagcgcggcatggagctccaggcagcccgcgcctgcttcgccctgctgtggggctgtgcgctggccgcggccgcggcggcgcagggcaaggaagtggtactgctggactttgctgcagctggaggggagctcggctggctcacacacccgtatggcaaagggtgggacctgatgcagaacatcatgaatgacatgccgatctacatgtactccgtgtgcaacgtgatgtctggcgaccaggacaactggctccgcaccaactgggtgtaccgaggagaggctgagcgtatcttcattgagctcaagtttactgtacgtgactgcaacagcttccctggtggcgccagctcctgcaaggagactttcaacctctactatgccgagtcggacctggactacggcaccaacttccagaagcgcctgttcaccaagattgacaccattgcgcccgatgagatcaccgtcagcagcgacttcgaggcacgccacgtgaagctgaacgtggaggagcgctccgtggggccgctcacccgcaaaggcttctacctggccttccaggatatcggtgcctgtgtggcgctgctctccgtccgtgtctactacaagaagtgccccgagctgctgcagggcctggcccacttccctgagaccatcgccggctctgatgcaccttccctggccactgtggccggcacctgtgtggaccatgccgtggtgccaccggggggtgaagagccccgtatgcactgtgcagtggatggcgagtggctggtgcccattgggcagtgcctgtgccaggcaggctacgagaaggtggaggatgcctgccaggcctgctcgcctggattttttaagtttgaggcatctgagagcccctgcttggagtgccctgagcacacgctgccatcccctgagggtgccacctcctgcgagtgtgaggaaggcttcttccgggcacctcaggacccagcgtcgatgccttgcacacgacccccctccgccccacactacctcacagccgtgggcatgggtgccaaggtggagctgcgctggacgccccctcaggacagcgggggccgcgaggacattgtctacagcgtcacctgcgaacagtgctggcccgagtctggggaatgcgggccgtgtgaggccagtgtgcgctactcggagcctcctcacggactgacccgcaccagtgtgacagtgagcgacctggagccccacatgaactacaccttcaccgtggaggcccgcaatggcgtctcaggcctggtaaccagccgcagcttccgtactgccagtgtcagcatcaaccagacagagccccccaaggtgaggctggagggccgcagcaccacctcgcttagcgtctcctggagcatccccccgccgcagcagagccgagtgtggaagtacgaggtcacttaccgcaagaagggagactccaacagctacaatgtgcgccgcaccgagggtttctccgtgaccctggacgacctggccccagacaccacctacctggtccaggtgcaggcactgacgcaggagggccagggggccggcagcaaggtgcacgaattccagacgctgtccccggagggatctggcaacttggcggtgattggcggcgtggctgtcggtgtggtcctgcttctggtgctggcaggagttggcttctttatccaccgcaggaggaagaaccagcgtgcccgccagtccccggaggacgtttacttctccaagtcagaacaactgaagcccctgaagacatacgtggacccccacacatatgaggaccccaaccaggctgtgttgaagttcactaccgagatccatccatcctgtgtcactcggcagaaggtgatcggagcaggagagtttggggaggtgtacaagggcatgctgaagacatcctcggggaagaaggaggtgccggtggccatcaagacgctgaaagccggctacacagagaagcagcgagtggacttcctcggcgaggccggcatcatgggccagttcagccaccacaacatcatccgcctagagggcgtcatctccaaatacaagcccatgatgatcatcactgagtacatggagaatggggccctggacaagttccttcgggagaaggatggcgagttcagcgtgctgcagctggtgggcatgctgcggggcatcgcagctggcatgaagtacctggccaacatgaactatgtgcaccgtgacctggctgcccgcaacatcctcgtcaacagcaacctggtctgcaaggtgtctgactttggcctgtcccgcgtgctggaggacgaccccgaggccacctacaccaccagtggcggcaagatccccatccgctggaccgccccggaggccatttcctaccggaagttcacctctgccagcgacgtgtggagctttggcattgtcatgtgggaggtgatgacctatggcgagcggccctactgggagttgtccaaccacgaggtgatgaaagccatcaatgatggcttccggctccccacacccatggactgcccctccgccatctaccagctcatgatgcagtgctggcagcaggagcgtgcccgccgccccaagttcgctgacatcgtcagcatcctggacaagctcattcgtgcccctgactccctcaagaccctggctgactttgacccccgcgtgtctatccggctccccagcacgagcggctcggagggggtgcccttccgcacggtgtccgagtggctggagtccatcaagatgcagcagtatacggagcacttcatggcggccggctacactgccatcgagaaggtggtgcagatgaccaacgacgacatcaagaggattggggtgcggctgcccggccaccagaagcgcatcgcctacagcctgctgggactcaaggaccaggtgaacactgtggggatccccatctgagcctcgacagggcctggagccccatcggccaagaatacttgaagaaacagagtggcctccctgctgtgccatgctgggccactggggactttatttatttctagttctttcctccccctgcaacttccgctgaggggtctcggatgacaccctggcctgaactgaggagatgaccagggatgctgggctgggccctctttccctgcgagacgcacacagctgagcacttagcaggcaccgccacgtcccagcatccctggagcaggagccccgccacagccttcggacagacatataggatattcccaagccgaccttccctccgccttctcccacatgaggccatctcaggagatggagggcttggcccagcgccaagtaaacagggtacctcaagccccatttcctcacactaagagggcagactgtgaacttgactgggtgagacccaaagcggtccctgtccctctagtgccttctttagaccctcgggccccatcctcatccctgactggccaaacccttgctttcctgggcctttgcaagatgcttggttgtgttgaggtttttaaatatatattttgtactttgtggagagaatgtgtgtgtgtggcagggggccccgccagggctggggacagagggtgtcaaacattcgtgagctggggactcagggaccggtgctgcaggagtgtcctgcccatgccccagtcggccccatctctcatccttttggataagtttctattctgtcagtgttaaagattttgttttgttggacatttttttcgaatcttaatttattattttttttatatttattgttagaaaatgacttatttctgctctggaataaagttgcagatgattcaaaccgaaaaaaaaaaaaaaaaaa

SEQ ID NO: 81 - protein, 976 aa, Homo sapiens
MELQAARACFALLWGCALAAAAAAQGKEVVLLDFAAAGGELGWLTHPYGKGWDLMQNIMNDMPIYMYSVCNVMSGDQDNWLRTNWVYRGEAERIFIELKFTVRDCNSFPGGASSCKETFNLYYAESDLDYGTNFQKRLFTKIDTIAPDEITVSSDFEARHVKLNVEERSVGPLTRKGFYLAFQDIGACVALLSVRVYYKKCPELLQGLAHFPETIAGSDAPSLATVAGTCVDHAVVPPGGEEPRMHCAVDGEWLVPIGQCLCQAGYEKVEDACQACSPGFFKFEASESPCLECPEHTLPSPEGATSCECEEGFFRAPQDPASMPCTRPPSAPHYLTAVGMGAKVELRWTPPQDSGGREDIVYSVTCEQCWPESGECGPCEASVRYSEPPHGLTRTSVTVSDLEPHMNYTFTVEARNGVSGLVTSRSFRTASVSINQTEPPKVRLEGRSTTSLSVSWSIPPPQQSRVWKYEVTYRKKGDSNSYNVRRTEGFSVTLDDLAPDTTYLVQVQALTQEGQGAGSKVHEFQTLSPEGSGNLAVIGGVAVGVVLLLVLAGVGFFIHRRRKNQRARQSPEDVYFSKSEQLKPLKTYVDPHTYEDPNQAVLKFTTEIHPSCVTRQKVIGAGEFGEVYKGMLKTSSGKKEVPVAIKTLKAGYTEKQRVDFLGEAGIMGQFSHHNIIRLEGVISKYKPMMIITEYMENGALDKFLREKDGEFSVLQLVGMLRGIAAGMKYLANMNYVHRDLAARNILVNSNLVCKVSDFGLSRVLEDDPEATYTTSGGKIPIRWTAPEAISYRKFTSASDVWSFGIVMWEVMTYGERPYWELSNHEVMKAINDGFRLPTPMDCPSAIYQLMMQCWQQERARRPKFADIVSILDKLIRAPDSLKTLADFDPRVSIRLPSTSGSEGVPFRTVSEWLESIKMQQYTEHFMAAGYTAIEKVVQMTNDDIKRIGVRLPGHQKRIAYSLLGLKDQVNTVGIPI

SEQ ID NO: 82 - DNA, 5826 bp, Homo sapiens
  CDS (226)..(3177)
cccgctctgcttcagcgcacgctgaagacggcactaggacccagggaagtccccgagcggggttcgcggaaaggcagccagactcctccttatctccagtgtcaaacttgacatcagcctgcgagcggagcatggtaacttctccagcaatcagagcgctccccctcacatcagtggcatgcttcatggagatatgctcctctcactgccctctgcaccagcaacatggattgtcagctctccatcctcctccttctcagctgctctgttctcgacagcttcggggaactgattccgcagccttccaatgaagtcaatctactggattcaaaaacaattcaaggggagctgggctggatctcttatccatcacatgggtgggaagagatcagtggtgtggatgaacattacacacccatcaggacttaccaggtgtgcaatgtcatggaccacagtcaaaacaattggctgagaacaaactgggtccccaggaactcagctcagaagatttatgtggagctcaagttcactctacgagactgcaatagcattccattggttttaggaacttgcaaggagacattcaacctgtactacatggagtctgatgatgatcatggggtgaaatttcgagagcatcagtttacaaagattgacaccattgcagctgatgaaagtttcactcaaatggatcttggggaccgtattctgaagctcaacactgagattagagaagtaggtcctgtcaacaagaagggattttatttggcatttcaagatgttggtgcttgtgttgccttggtgtctgtgagagtatacttcaaaaagtgcccatttacagtgaagaatctggctatgtttccagacacggtacccatggactcccagtccctggtggaggttagagggtcttgtgtcaacaattctaaggaggaagatcctccaaggatgtactgcagtacagaaggcgaatggcttgtacccattggcaagtgttcctgcaatgctggctatgaagaaagaggttttatgtgccaagcttgtcgaccaggtttctacaaggcattggatggtaatatgaagtgtgctaagtgcccgcctcacagttctactcaggaagatggttcaatgaactgcaggtgtgagaataattacttccgggcagacaaagaccctccatccatggcttgtacccgacctccatcttcaccaagaaatgttatctctaatataaacgagacctcagttatcctggactggagttggcccctggacacaggaggccggaaagatgttaccttcaacatcatatgtaaaaaatgtgggtggaatataaaacagtgtgagccatgcagcccaaatgtccgcttcctccctcgacagtttggactcaccaacaccacggtgacagtgacagaccttctggcacatactaactacacctttgagattgatgccgttaatggggtgtcagagctgagctccccaccaagacagtttgctgcggtcagcatcacaactaatcaggctgctccatcacctgtcctgacgattaagaaagatcggacctccagaaatagcatctctttgtcctggcaagaacctgaacatcctaatgggatcatattggactacgaggtcaaatactatgaaaagcaggaacaagaaacaagttataccattctgagggcaagaggcacaaatgttaccatcagtagcctcaagcctgacactatatacgtattccaaatccgagcccgaacagccgctggatatgggacgaacagccgcaagtttgagtttgaaactagtccagactctttctccatctctggtgaaagtagccaagtggtcatgatcgccatttcagcggcagtagcaattattctcctcactgttgtcatctatgttttgattgggaggttctgtggctataagtcaaaacatggggcagatgaaaaaagacttcattttggcaatgggcatttaaaacttccaggtctcaggacttatgttgacccacatacatatgaagaccctacccaagctgttcatgagtttgccaaggaattggatgccaccaacatatccattgataaagttgttggagcaggtgaatttggagaggtgtgcagtggtcgcttaaaacttccttcaaaaaaagagatttcagtggccattaagaccctgaaagttggctacacagaaaagcagaggagagacttcctgggagaagcaagcattatgggacagtttgaccaccccaatatcattcgactggaaggagttgttaccaaaagtaagccagttatgattgtcacagaatacatggagaatggttccttggatagtttcctacgtaaacacgatgcccagtttactgtcattcagctagtggggatgcttcgagggatagcatctggcatgaagtacctgtcagacatgggctatgttcaccgagacctcgctgctcggaacatcttgatcaacagtaacttggtgtgtaaggtttctgatttcggactttcgcgtgtcctggaggatgacccagaagctgcttatacaacaagaggagggaagatcccaatcaggtggacatcaccagaagctatagcctaccgcaagttcacgtcagccagcgatgtatggagttatgggattgttctctgggaggtgatgtcttatggagagagaccatactgggagatgtccaatcaggatgtaattaaagctgtagatgagggctatcgactgccaccccccatggactgcccagctgccttgtatcagctgatgctggactgctggcagaaagacaggaacaacagacccaagtttgagcagattgttagtattctggacaagcttatccggaatcccggcagcctgaagatcatcaccagtgcagccgcaaggccatcaaaccttcttctggaccaaagcaatgtggatatcactaccttccgcacaacaggtgactggcttaatggtgtctggacagcacactgcaaggaaatcttcacgggtgtggagtacagttcttgtgacacaatagccaagatttccacagatgacatgaaaaaggttggtgtcaccgtggttgggccacagaagaagatcatcagtagcattaaagctctagaaacgcaatcaaagaatggcccagttcccgtgtaaagcacgggacggaagtgcttctggacggaagtggtggctgtggaaggcgtagcatcatcctgcagacagacaataattctggagatactggtggaagttccaagtccaataagacactcaaatatgagtacaaatgccttaaaatggaattgaaaaactctttattttcccctatcatttattggatgggtgggtggggtatttttttgtaattgcttttttaaatattagttaatggattaaatttaattcttcagcgtaaaatggtgaagaactagcatatagccattgatcataaactgactatcataaaatcaaaacaagtgaaataacaaaatggacatggtggctttgtttaggtagagccacaaaagaaaagacttgtaatatttttatatacagaggaaatctgtaacaggtattttgtttcttttaaagcaagcaacacagaggaatttatacctcaaactatctggccatatttactaccttatcactgcattattctcttttatctgtttaaagcatatagagatgaagtttgtagttgttttaagtactacacatttttaaattgttagcttccttaagtatatcatgtaaagaaatgtcttaatttttgaaaaaagtacatatttattttcttttgaattgtttttattgttttctatttatgccttgatgatttaatatggatttgttacagccaagtgccaaatgctctctcaaattgtcagcaatttaactagacacagataataatgggtttctttcagattttttgaaccatccacttacatatatttttaaaaaatgaaatccttttcctgttcatacactaaccaaatctctcaaatctgttatcccaatcattgttgcctctccgtttattataaactgtatgctcacaacttagtgtaatataccagcttgtatgcaatggattttcaaccagataacatacctttcctgctctggtgcttagagactatcaactccctcctttagtgaaggagccgtgttagagcttccgagaatagctccactggagagaagtggaatcctatatagaatgctgcactaattgacaacacagcctataggccaatgcatgagtaaaaaaaaaaacaattactggctcactggctttgaaaagtcacttactattgttgctgaaacttgctgagctgtttatagagaatgatgataacagaacttttcctctgtatcactggtgtttaggtgaattaattaaacattgtgatcattagtaccaggtattattatctttaagagtcttccacttcaatgcacatggtgcagttttggtgtgtaacttagaaggattgaacttctttgaatttactggacataacattttcagaatagttggtcatctagcaaccgcctcaaaatgtgtaagcaggagagaaatttctcatcacagggatttagacttactattacataaaggctaactatgagcttgctcattaattttgaaaagatgtacctggtggatatctagctagtaatatattctgaagcaacattttagctctattgatactctttctaatgctgatatgatcttgagtataagaaatgcatatgtcactagaatggataaaataatgctgcaaacttaatgttcttatgcaaaatggaacgctaatgaaacacagcttacaatcgcaaatcaaaactcacaagtgctcatctgttgtagatttagtgtaataagacttagattgtgctccttcggatatgattgtttctcaaatcttggcaatattccttagtcaaatcaggctactagaattctgtattggatatataagagcatgaaatttttaaaaatacacttgtgattataaaattaatcacaaatttcacttatacctgctatcagcagctagaaaacattttttttttaaatcaagtattttgtgtttggaatgttagaatgagatctgaatgtggtttcaatctaattttttcccagactactattttcttttttaggtactattctgagcatactcaacaaaacccatgcatttcataaactaatagaagttgaggattgttgaatctatttcacttattttggctgtggtttccatctgaaagtagaggttgtatacaccatatactgttcttcattttattaatatttttctccttgacctctcataaatttactttacacaattcttaccctgtacatatgtaaacataagtgtacgattcttaaccatggagtagaggtactagaatgcttacggccatctctttgtacaggaactgcattgactttcagtaaacataaagccacaactcctacatgatgttatgtaccatatgatctgttttgtatcttaaatttgatttacatatattatttatttctggtaactcactcagtttatgctgtgctaaatatcaatcaagccatgtataaatgtgatatgattggcaatatgtgtttactttaaacttgtcttttcaaaatattactcagtttatgttgtacaatgtagatggcctcttactaatgtaaaatgatttgtagtggaaacatttatatttttataataaacataatgaaaatattttttacagattggaaaaaaaaaaaaaaaaaaa

SEQ ID NO: 83 - protein, 983 aa, Homo sapiens
MDCQLSILLLLSCSVLDSFGELIPQPSNEVNLLDSKTIQGELGWISYPSHGWEEISGVDEHYTPIRTYQVCNVMDHSQNNWLRTNWVPRNSAQKIYVELKFTLRDCNSIPLVLGTCKETFNLYYMESDDDHGVKFREHQFTKIDTIAADESFTQMDLGDRILKLNTEIREVGPVNKKGFYLAFQDVGACVALVSVRVYFKKCPFTVKNLAMFPDTVPMDSQSLVEVRGSCVNNSKEEDPPRMYCSTEGEWLVPIGKCSCNAGYEERGFMCQACRPGFYKALDGNMKCAKCPPHSSTQEDGSMNCRCENNYFRADKDPPSMACTRPPSSPRNVISNINETSVILDWSWPLDTGGRKDVTFNIICKKCGWNIKQCEPCSPNVRFLPRQFGLTNTTVTVTDLLAHTNYTFEIDAVNGVSELSSPPRQFAAVSITTNQAAPSPVLTIKKDRTSRNSISLSWQEPEHPNGIILDYEVKYYEKQEQETSYTILRARGTNVTISSLKPDTIYVFQIRARTAAGYGTNSRKFEFETSPDSFSISGESSQVVMIAISAAVAIILLTVVIYVLIGRFCGYKSKHGADEKRLHFGNGHLKLPGLRTYVDPHTYEDPTQAVHEFAKELDATNISIDKVVGAGEFGEVCSGRLKLPSKKEISVAIKTLKVGYTEKQRRDFLGEASIMGQFDHPNIIRLEGVVTKSKPVMIVTEYMENGSLDSFLRKHDAQFTVIQLVGMLRGIASGMKYLSDMGYVHRDLAARNILINSNLVCKVSDFGLSRVLEDDPEAAYTTRGGKIPIRWTSPEAIAYRKFTSASDVWSYGIVLWEVMSYGERPYWEMSNQDVIKAVDEGYRLPPPMDCPAALYQLMLDCWQKDRNNRPKFEQIVSILDKLIRNPGSLKIITSAAARPSNLLLDQSNVDITTFRTTGDWLNGVWTAHCKEIFTGVEYSSCDTIAKISTDDMKKVGVTVVGPQKKIISSIKALETQSKNGPVPV

SEQ ID NO: 84 - DNA, 5602 bp, Homo sapiens
  CDS (294)..(4805)
gcggcgggagcgcggcttcccaggcccgccgctccgcagggctgctggcgttgctgctgttgagaggcggcggcggcggcgcaggcgggcgggaaggatggtgtttctgcgactggagcggcaggtgcggaccgggagccggaccgaggtttggcagaagcaacgtgtgctcgggagcaaccggcgcgggtgccactgaggcagcggagggaggcaggatcgactgacgggcgaacggacggacggacggaaggcgactcgagggccggccccggagccgcgccgtgggcgagatgccggggccgccggcgttgcggcggaggctgctgctgctgctgctggtcctcctgatcgccggcagtgctggggccgcgccacttccgcaaacaggtgcaggggaggcgccacctgctgcagaagtttcctcatcttttgtgatcctgtgtgtgtgcagtttaataatattaatagtgttaattgcaaactgtgtatcctgctgtaaggacccagaaatagactttaaggaatttgaagataattttgatgatgagatagatttcacaccaccagcagaagacactccctctgttcagtccccagcagaggtcttcacactttcagtaccaaatatttcactcccagctccctcgcaattccagccttctgtagagggattgaagtctcaagttgcccgccacagtctaaactacatacaggaaattggaaatggctggtttggaaaggttctcttgggagagatttacacgggcactagcgtagcaagagtcatcgtgaaggagttaaaagcaagtgccaacccaaaggaacaagatacttttttgaaaaatggagaaccttactacattcttcagcatccaaatattcttcagtgtgttggacagtgcgtagaagcgattccctacctcctggtgtttgagttctgtgacttgggtgacctgaaggcgtatctgcgcagcgagcaggagcacatgcggggggactcacagaccatgctgctgcagaggatggcgtgcgaggtcgccgcggggctggccgccatgcacaagctgcacttcctgcacagtgatttagccctgcggaattgttttctcacctccgacttaaatgtgaaagtgggagattacggaataggattcagcaggtacaaggaggattatattgaaacagatgataaaaaagttttccctctgcgatggactgctccagaattagtaaccagctttcaagacagactgctaactgcagatcagactaagtatagtaatatctggtctctgggtgtgacactttgggagctttttgacaatgccgcacagccgtattcaaacctttccaacttagatgtcctcaaccaagtcattagagagagagacacaaaactcccgaagccccagctggagcagccctactctgatagatggtatgaagtcttacagttctgttggctgtcaccagaaaagagacccgcggctgaagatgtgcacaggctgctgacttacctgcggctgcagagccagcgggactcagaggtcgactttgaacagcagtggaacgctctgaagccgaacacaaacagcagagactcctccaacaatgctgcattcccaattctcgaccactttgccagggaccggctgggtcgtgaaatggaggaagtcctcaccgtgaccgaaaccagccagggcctgagcttcgagtatgtctgggaggccgctaagcacgaccactttgacgagcgcagccggggccacctggacgaaggcttgtcctacacgagcatcttctatccggttgaagtttttgagagttcgctttcagatcctgggcccggaaagcaagatgacagcggccaggatgtccccctgagggtccctggagtggttcctgtttttgatgcccacaacctttctgttggaagcgactattatatccagttagaagaaaaaagtggtagtaacttggagcttgattacccaccagcgctgctcacaaccgacatggataatccagaaaggactggccctgaactgtcccagctcacggcgctcaggagcgttgaacttgaggagtccagtacagatgaggacttcttccaaagcagtacagaccccaaagactctagcttaccaggggacttacacgtgaccagtggccccgagagccctttcaacaatatatttaatgatgtggacaaatcggaagatttgcccagtcaccaaaaaatattcgacttaatggaattaaacggagttcaagccgactttaaacctgccactttaagttccagtttggataaccccaaagagtcagtcataacaggccactttgagaaagaaaagccccgtaagatttttgacagtgagcctctctgcctatcagataatcttatgcaccaagataattttgatccattgaatgttcaagaattgtcagaaaactttttatttcttcaagagaaaaacttactaaaaggctcattgtccagcaaagaacacataaatgatcttcagacagaacttaagaatgctggttttactgaagctatgttagaaacgtcatgtagaaactctttagatactgagcttcagtttgctgaaaataagccaggcttgtctttgttgcaggaaaacgtaagcacaaagggtgacgatacagatgtcatgctcacaggtgacactttgagcacctcattgcagtcttccccggaagtgcaggtacctcctacctccttcgaaacagaagaaacgccccgtcgggtacccccagactcactcccaacacagggagaaacccagcccacgtgtttagatgttattgtcccggaggactgtctccaccaggacatcagtccagacgctgtgactgtcccggttgaaattctctcaactgatgccagaacccacagcctggataacaggtcccaggactctcctggcgagagtgaggagaccctgcgactcaccgaaagtgactctgttcttgctgatgacatccttgccagcagggtgagtgtagggagtagtctcccggaactgggacaggaattgcacaataaaccattttcggaagaccatcacagtcatcgccggctagagaaaaacttagaggctgtggagactttaaatcagctcaattctaaagacgcagcaaaagaagcaggcttggtgtctgccctctcctcggactcaaccagtcaggacagcctcctggaggacagcttgtcagcacccttcccagcctctgagccgtccctggaaaccccggactctctggagtcagtggatgtccacgaagcgctactggactctttaggatctcacactccccagaaactagtgccccccgataagccggcagacagtggctacgaaacagagaacttggagtctcccgagtggaccttgcatcccgctcccgagggcaccgcagactcagaaccagccaccacgggcgatggcggccacagcggtctgcctcccaacccggtcattgtcatctcagatgccggcgatggtcacagaggcacagaagtgacccctgagacgttcacagctggctcccagggttcataccgagactctgcgtacttctcagacaatgactctgagcccgagaaaaggtctgaggaggtcccgggaacctccccatccgccttggtgttggtacaggagcagcccctacccgagccagtcctccccgagcaaagtcctgctgcccaggatagctgcctggaagccagaaagagccagccagatgaaagttgtctgtctgctttgcacaactccagtgacctggaattaagagccacgccggagccagcacagactggtgttccccagcaggtgcatcccacggaagacgaggccagcagtccctggagtgtgctgaatgcagaacttagcagcggcgatgacttcgagacacaggacgatcgcccctgcaccctcgcttccacggggaccaacacgaacgaactccttgcctacaccaattctgcgctggacaagtccctgtccagccactccgagggcccgaagttgaaggagccggacatcgaagggaagtacctggggaaactcggggtgtcagggatgctcgacctctcagaggacgggatggatgcagacgaggaggacgaaaacagcgacgactcggacgaggacctgcgggccttcaacctgcatagcctcagctccgagtcggaggacgagaccgagcaccccgtgcccatcatcctcagcaacgaggacggaaggcacctgcggagtctgttgaagcccacagcggccaatgcccccgacccactgcccgaggactggaagaaggaaaagaaggcagtcacgtttttcgatgatgtcacagtctacctgtttgaccaggagaccccaaccaaagagctggggccctgtggaggagaggcgtgcggcccggacctgagcggcccagccccagcctcaggctctccctacctgagcaggtgcatcaactccgaaagctccaccgacgaagaaggtggtggctttgagtgggatgatgacttctccccagatccttttatgtcaaagacaacaagtaacctgctcagctccaagccttctctccaaacatccaagtacttttctccgccgccaccggcccggagcacggagcagagctggccgcactcggcgccttactcccggttctccatctctcccgccaacattgccagcttttccctcacacacctgaccgactcggacatcgagcagggcggaagcagcgaagacggagaaaaggactaggtggctgccaacgcgcacgctcgggtccgaggctgctcccctggagcggcgcccctgcgccctcagcccgagcagcgacatccactcgccatttgctgacatgagattgggaggaagaatccagaggtgaagagggagacggctcttagctgcgttcaaggcggggccctcgggagcccaggtgcagagcgaggccgtgtccaggagccggcgtccctcagtgccccgtgcacccgcggccgcggcctcccaggcagtgctcatgcgctggccgtcgggggaggcaggggcacagcctccatgtgcgcgcgcgtgtggagctgtgtgcaccgcatgtgtgctttccacaggggcgtctctgcgtccacgcctgcacatcccggcgcacgtgtgggcaccacagaggacacgtgaggggaatggtcaccagtgagccatatttattatttctagagaaatcacgaactgctttctgtaattgcactgtggataaatgttccgagagtctccattgttgtacaggatcttcagttattcgaggggaatgaggcaggtcaagccgatgctagccactagtttgattttttttctgttttatagtttgcgctgcatggtacttgtgaagcttaaatattttgagtgttctactgtgtctaggattgttgggattgtacatatggtactctttcataaatgataaatgattctgaatgttagtgttttatgttcatataggaaatattttcattgagtccaaaataccactgttttgttgatggacttgaatgcatttttgt

SEQ ID NO: 85 - protein, 1503 aa, Homo sapiens
MPGPPALRRRLLLLLLVLLIAGSAGAAPLPQTGAGEAPPAAEVSSSFVILCVCSLIILIVLIANCVSCCKDPEIDFKEFEDNFDDEIDFTPPAEDTPSVQSPAEVFTLSVPNISLPAPSQFQPSVEGLKSQVARHSLNYIQEIGNGWFGKVLLGEIYTGTSVARVIVKELKASANPKEQDTFLKNGEPYYILQHPNILQCVGQCVEAIPYLLVFEFCDLGDLKAYLRSEQEHMRGDSQTMLLQRMACEVAAGLAAMHKLHFLHSDLALRNCFLTSDLNVKVGDYGIGFSRYKEDYIETDDKKVFPLRWTAPELVTSFQDRLLTADQTKYSNIWSLGVTLWELFDNAAQPYSNLSNLDVLNQVIRERDTKLPKPQLEQPYSDRWYEVLQFCWLSPEKRPAAEDVHRLLTYLRLQSQRDSEVDFEQQWNALKPNTNSRDSSNNAAFPILDHFARDRLGREMEEVLTVTETSQGLSFEYVWEAAKHDHFDERSRGHLDEGLSYTSIFYPVEVFESSLSDPGPGKQDDSGQDVPLRVPGVVPVFDAHNLSVGSDYYIQLEEKSGSNLELDYPPALLTTDMDNPERTGPELSQLTALRSVELEESSTDEDFFQSSTDPKDSSLPGDLHVTSGPESPFNNIFNDVDKSEDLPSHQKIFDLMELNGVQADFKPATLSSSLDNPKESVITGHFEKEKPRKIFDSEPLCLSDNLMHQDNFDPLNVQELSENFLFLQEKNLLKGSLSSKEHINDLQTELKNAGFTEAMLETSCRNSLDTELQFAENKPGLSLLQENVSTKGDDTDVMLTGDTLSTSLQSSPEVQVPPTSFETEETPRRVPPDSLPTQGETQPTCLDVIVPEDCLHQDISPDAVTVPVEILSTDARTHSLDNRSQDSPGESEETLRLTESDSVLADDILASRVSVGSSLPELGQELHNKPFSEDHHSHRRLEKNLEAVETLNQLNSKDAAKEAGLVSALSSDSTSQDSLLEDSLSAPFPASEPSLETPDSLESVDVHEALLDSLGSHTPQKLVPPDKPADSGYETENLESPEWTLHPAPEGTADSEPATTGDGGHSGLPPNPVIVISDAGDGHRGTEVTPETFTAGSQGSYRDSAYFSDNDSEPEKRSEEVPGTSPSALVLVQEQPLPEPVLPEQSPAAQDSCLEARKSQPDESCLSALHNSSDLELRATPEPAQTGVPQQVHPTEDEASSPWSVLNAELSSGDDFETQDDRPCTLASTGTNTNELLAYTNSALDKSLSSHSEGPKLKEPDIEGKYLGKLGVSGMLDLSEDGMDADEEDENSDDSDEDLRAFNLHSLSSESEDETEHPVPIILSNEDGRHLRSLLKPTAANAPDPLPEDWKKEKKAVTFFDDVTVYLFDQETPTKELGPCGGEACGPDLSGPAPASGSPYLSRCINSESSTDEEGGGFEWDDDFSPDPFMSKTTSNLLSSKPSLQTSKYFSPPPPARSTEQSWPHSAPYSRFSISPANIASFSLTHLTDSDIEQGGSSEDGEKD

SEQ ID NO: 86 - DNA, 5084 bp, Homo sapiens
  CDS (22)..(2952)
gatcccatcgcagctaccgcgatgagaggcgctcgcggcgcctgggattttctctgcgttctgctcctactgcttcgcgtccagacaggctcttctcaaccatctgtgagtccaggggaaccgtctccaccatccatccatccaggaaaatcagacttaatagtccgcgtgggcgacgagattaggctgttatgcactgatccgggctttgtcaaatggacttttgagatcctggatgaaacgaatgagaataagcagaatgaatggatcacggaaaaggcagaagccaccaacaccggcaaatacacgtgcaccaacaaacacggcttaagcaattccatttatgtgtttgttagagatcctgccaagcttttccttgttgaccgctccttgtatgggaaagaagacaacgacacgctggtccgctgtcctctcacagacccagaagtgaccaattattccctcaaggggtgccaggggaagcctcttcccaaggacttgaggtttattcctgaccccaaggcgggcatcatgatcaaaagtgtgaaacgcgcctaccatcggctctgtctgcattgttctgtggaccaggagggcaagtcagtgctgtcggaaaaattcatcctgaaagtgaggccagccttcaaagctgtgcctgttgtgtctgtgtccaaagcaagctatcttcttagggaaggggaagaattcacagtgacgtgcacaataaaagatgtgtctagttctgtgtactcaacgtggaaaagagaaaacagtcagactaaactacaggagaaatataatagctggcatcacggtgacttcaattatgaacgtcaggcaacgttgactatcagttcagcgagagttaatgattctggagtgttcatgtgttatgccaataatacttttggatcagcaaatgtcacaacaaccttggaagtagtagataaaggattcattaatatcttccccatgataaacactacagtatttgtaaacgatggagaaaatgtagatttgattgttgaatatgaagcattccccaaacctgaacaccagcagtggatctatatgaacagaaccttcactgataaatgggaagattatcccaagtctgagaatgaaagtaatatcagatacgtaagtgaacttcatctaacgagattaaaaggcaccgaaggaggcacttacacattcctagtgtccaattctgacgtcaatgctgccatagcatttaatgtttatgtgaatacaaaaccagaaatcctgacttacgacaggctcgtgaatggcatgctccaatgtgtggcagcaggattcccagagcccacaatagattggtatttttgtccaggaactgagcagagatgctctgcttctgtactgccagtggatgtgcagacactaaactcatctgggccaccgtttggaaagctagtggttcagagttctatagattctagtgcattcaagcacaatggcacggttgaatgtaaggcttacaacgatgtgggcaagacttctgcctattttaactttgcatttaaaggtaacaacaaagagcaaatccatccccacaccctgttcactcctttgctgattggtttcgtaatcgtagctggcatgatgtgcattattgtgatgattctgacctacaaatatttacagaaacccatgtatgaagtacagtggaaggttgttgaggagataaatggaaacaattatgtttacatagacccaacacaacttccttatgatcacaaatgggagtttcccagaaacaggctgagttttgggaaaaccctgggtgctggagctttcgggaaggttgttgaggcaactgcttatggcttaattaagtcagatgcggccatgactgtcgctgtaaagatgctcaagccgagtgcccatttgacagaacgggaagccctcatgtctgaactcaaagtcctgagttaccttggtaatcacatgaatattgtgaatctacttggagcctgcaccattggagggcccaccctggtcattacagaatattgttgctatggtgatcttttgaattttttgagaagaaaacgtgattcatttatttgttcaaagcaggaagatcatgcagaagctgcactttataagaatcttctgcattcaaaggagtcttcctgcagcgatagtactaatgagtacatggacatgaaacctggagtttcttatgttgtcccaaccaaggccgacaaaaggagatctgtgagaataggctcatacatagaaagagatgtgactcccgccatcatggaggatgacgagttggccctagacttagaagacttgctgagcttttcttaccaggtggcaaagggcatggctttcctcgcctccaagaattgtattcacagagacttggcagccagaaatatcctccttactcatggtcggatcacaaagatttgtgattttggtctagccagagacatcaagaatgattctaattatgtggttaaaggaaacgctcgactacctgtgaagtggatggcacctgaaagcattttcaactgtgtatacacgtttgaaagtgacgtctggtcctatgggatttttctttgggagctgttctctttaggaagcagcccctatcctggaatgccggtcgattctaagttctacaagatgatcaaggaaggcttccggatgctcagccctgaacacgcacctgctgaaatgtatgacataatgaagacttgctgggatgcagatcccctaaaaagaccaacattcaagcaaattgttcagctaattgagaagcagatttcagagagcaccaatcatatttactccaacttagcaaactgcagccccaaccgacagaagcccgtggtagaccattctgtgcggatcaattctgtcggcagcaccgcttcctcctcccagcctctgcttgtgcacgacgatgtctgagcagaatcagtgtttgggtcacccctccaggaatgatctcttcttttggcttccatgatggttattttcttttctttcaacttgcatccaactccaggatagtgggcaccccactgcaatcctgtctttctgagcacactttagtggccgatgatttttgtcatcagccaccatcctattgcaaaggttccaactgtatatattcccaatagcaacgtagcttctaccatgaacagaaaacattctgatttggaaaaagagagggaggtatggactgggggccagagtcctttccaaggcttctccaattctgcccaaaaatatggttgatagtttacctgaataaatggtagtaatcacagttggccttcagaaccatccatagtagtatgatgatacaagattagaagctgaaaacctaagtcctttatgtggaaaacagaacatcattagaacaaaggacagagtatgaacacctgggcttaagaaatctagtatttcatgctgggaatgagacataggccatgaaaaaaatgatccccaagtgtgaacaaaagatgctcttctgtggaccactgcatgagcttttatactaccgacctggtttttaaatagagtttgctattagagcattgaattggagagaaggcctccctagccagcacttgtatatacgcatctataaattgtccgtgttcatacatttgaggggaaaacaccataaggtttcgtttctgtatacaaccctggcattatgtccactgtgtatagaagtagattaagagccatataagtttgaaggaaacagttaataccattttttaaggaaacaatataaccacaaagcacagtttgaacaaaatctcctcttttagctgatgaacttattctgtagattctgtggaacaagcctatcagcttcagaatggcattgtactcaatggatttgatgctgtttgacaaagttactgattcactgcatggctcccacaggagtgggaaaacactgccatcttagtttggattcttatgtagcaggaaataaagtataggtttagcctccttcgcaggcatgtcctggacaccgggccagtatctatatatgtgtatgtacgtttgtatgtgtgtagacaaatatttggaggggtatttttgccctgagtccaagagggtcctttagtacctgaaaagtaacttggctttcattattagtactgctcttgtttcttttcacatagctgtctagagtagcttaccagaagcttccatagtggtgcagaggaagtggaaggcatcagtccctatgtatttgcagttcacctgcacttaaggcactctgttatttagactcatcttactgtacctgttccttagaccttccataatgctactgtctcactgaaacatttaaattttaccctttagactgtagcctggatattattcttgtagtttacctctttaaaaacaaaacaaaacaaaacaaaaaactccccttcctcactgcccaatataaaaggcaaatgtgtacatggcagagtttgtgtgttgtcttgaaagattcaggtatgttgcctttatggtttcccccttctacatttcttagactacatttagagaactgtggccgttatctggaagtaaccatttgcactggagttctatgctctcgcacctttccaaagttaacagattttggggttgtgttgtcacccaagagattgttgtttgccatactttgtctgaaaaattcctttgtgtttctattgacttcaatgatagtaagaaaagtggttgttagttatagatgtctaggtacttcaggggcacttcattgagagttttgtcttgccatactttgtctgaaaaattcctttgtgtttctattgacttcaatgatagtaagaaaagtggttgttagttatagatgtctaggtacttcaggggcacttcattgagagttttgtcaatgtcttttgaatattcccaagcccatgagtccttgaaaatattttttatatatacagtaactttatgtgtaaatacataagcggcgtaagtttaaaggatgttggtgttccacgtgttttattcctgtatgttgtccaattgttgacagttctgaagaattc

SEQ ID NO: 87 - protein, 976 aa, Homo sapiens [sequence omitted]

SEQ ID NO: 88 - DNA, 3135 bp, Homo sapiens
  CDS (171)..(2765)
aggtgggcgtggccagaccagctttaggtccggggagtgtctcgccagcggcagcacacccctgtaagtggtggccagggctgccgtggcaaaatgagctgtcaactttaggttgacaggggtgtggccgcgaccgcaagggcttttgttgccgggtggacccaacagggatgggctgctggggacagctgctggtgtggttcggagccgcgggcgccattctctgctctagcccggggtcccaggagacttttctgcggtcctcgcccctgccgctggcaagtcccagcccccgggacccgaaagtcagcgccccgcctagtatcttggagccagcctccccgctgaattctccgggcaccgaggggtcttggctgttttctacctgcggggccagcggccggcatgggcccacacagacacaatgtgacggggcgtacgcggggaccagcgtggtggtgaccgtgggggccgccgggcagctgagaggcgtgcagctgtggcgcgtgccgggccctggccagtatctgatctcagcctacggagccgcgggcggcaaaggcgccaagaaccacctgtcgcgggcgcatggcgtcttcgtctcagcaatcttctccctcggtctcggggagtcgctgtacatcctggtggggcagcagggagaggacgcctgtcccggaggtagcccggagagccagctcgtctgcctcggggagtctcgagccgttgaagagcacgcggcgatggatgggagcgaaggggtcccggggtcgcggcgctgggcgggaggtggcgggggtggcgggggcgccacctacgttttccgggtgcgcgctggcgagctggaaccgttgctggtggcggccggaggcggcggtcgggcctacctgaggccgcgggaccgaggccggactcaggcctcccccgagaaactggagaaccgctcggaggcgcccgggagcggcgggagaggcggggcggcaggtggtgggggcggctggacgtcgcgggctccctctccgcaggccggccgctcactgcaggagggggcggagggcggccagggctgctccgaggcttgggcgacccttggctgggccgcggccggcggcttcgggggcggcggcggggcctgcactgcgggcggaggcggcggcggctacagggggggcgacgcttcagagactgacaacctctgggctgatggggaagatggagtatccttcatacaccccagcagcgagctcttcctgcagcctctggcagtcaccgagaaccacggagaggtagagatccgaaggcacctcaactgcagtcactgccctttgagagactgccaatggcaggcagagctccagctggctgaatgcctgtgcccagaaggcatggagctagctgtggataacgtcacctgcatggacctgcacaagcccccaggccctctggttctgatggtggctgtggtggcaacctcaacactgagcctccttatggtgtgtggggtcctgattctggtgaagcagaagaagtggcagggcctgcaggagatgaggctgccgagccctgagcttgagctgagcaagcttcgaacctctgccatcaggacagcccccaatccctattattgccaggtggggcttggcccggcccagtcctggcctctgccaccaggtgtcaccgaggtttccccagccaatgttactctgctcagagccctgggccatggtgcctttggggaggtgtatgagggactggtaattggccttcctggggactccagtcccctgcaggtagctatcaagaccctgccagaactctgctcgcctcaggatgagctggatttcctcatggaggccctcatcatcagcaagtttcgccatcagaacattgtgcggtgtgtggggctcagcctcagggccacccctcgcctcattctgctggaactgatgtctggaggggacatgaagagtttcctgaggcacagtcggccacacctgggccagccatcacctctggtcatgcgggacctgctgcaactggcccaggacatagcccagggctgccactacctggaggaaaatcacttcatccacagggatattgccgcccggaactgcctgctgagctgcgctggacccagccgagtggccaagattggggactttgggatggcacgagatatctaccgggccagttattaccgcaggggggaccgggccttgctcccagtcaagtggatgcccccagaggccttcctggagggcatcttcacatccaagacagattcctggtcttttggggtgctgctctgggagatcttctcactgggctacatgccctatcctgggcgcaccaaccaggaggtgctggacttcgtcgttggaggaggccggatggaccctcctaggggctgcccagggcctgtgtaccgcatcatgacccagtgttggcagcacgagcctgagctccgccctagctttgccagcatcttggagcgtctgcagtactgcactcaggacccggatgtgctgaattcactcctgccaatggagctggggcccaccccagaggaggaagggacttctgggctggggaacagatctttggagtgcctaagacccccacagccccaggaactgagtccagagaagttgaaaagctggggaggtagccctcttggcccctggctgtcctctggcctcaagcccctcaaatccaggggcctccaacctcagaacctttggaatcccacttatcgctcctgagccccaaggggccctgagggtaaggactgaggcactgagggtccctccctatactcctcaggctcctgggtggcctgttatgccagcggcctctgttccctgcagtctgtgctgtgtgtctgggcctgtctcggggctggcctggcagcgctgcacttgccatgctggaaaccagcccaggcctcccagggaagggcccagccacttccagcttttgatcttggggccagaggccgccttacacacaccccaggtgtccatggggagcactggattgctctcccattatgagcgtccttcatctgggcagaccccccaccctgcagatgcttctaataaaaagctcttctcatcaaaaaaaaaaaaaaaa

SEQ ID NO: 89 - protein, 864 aa, Homo sapiens
MGCWGQLLVWFGAAGAILCSSPGSQETFLRSSPLPLASPSPRDPKVSAPPSILEPASPLNSPGTEGSWLFSTCGASGRHGPTQTQCDGAYAGTSVVVTVGAAGQLRGVQLWRVPGPGQYLISAYGAAGGKGAKNHLSRAHGVFVSAIFSLGLGESLYILVGQQGEDACPGGSPESQLVCLGESRAVEEHAAMDGSEGVPGSRRWAGGGGGGGGATYVFRVRAGELEPLLVAAGGGGRAYLRPRDRGRTQASPEKLENRSEAPGSGGRGGAAGGGGGWTSRAPSPQAGRSLQEGAEGGQGCSEAWATLGWAAAGGFGGGGGACTAGGGGGGYRGGDASETDNLWADGEDGVSFIHPSSELFLQPLAVTENHGEVEIRRHLNCSHCPLRDCQWQAELQLAECLCPEGMELAVDNVTCMDLHKPPGPLVLMVAVVATSTLSLLMVCGVLILVKQKKWQGLQEMRLPSPELELSKLRTSAIRTAPNPYYCQVGLGPAQSWPLPPGVTEVSPANVTLLRALGHGAFGEVYEGLVIGLPGDSSPLQVAIKTLPELCSPQDELDFLMEALIISKFRHQNIVRCVGLSLRATPRLILLELMSGGDMKSFLRHSRPHLGQPSPLVMRDLLQLAQDIAQGCHYLEENHFIHRDIAARNCLLSCAGPSRVAKIGDFGMARDIYRASYYRRGDRALLPVKWMPPEAFLEGIFTSKTDSWSFGVLLWEIFSLGYMPYPGRTNQEVLDFVVGGGRMDPPRGCPGPVYRIMTQCWQHEPELRPSFASILERLQYCTQDPDVLNSLLPMELGPTPEEEGTSGLGNRSLECLRPPQPQELSPEKLKSWGGSPLGPWLSSGLKPLKSRGLQPQNLWNPTYRS

SEQ ID NO: 90 - DNA, 4384 bp, Homo sapiens
  CDS (196)..(3540)
gcttcagtcccgcgaccgaagcagggcgcgcagcagcgctgagtgccccggaacgtgcgtcgcgcccccagtgtccgtcgcgtccgccgcgccccgggcggggatggggcggccagactgagcgccgcacccgccatccagacccgccggccctagccgcagtccctccagccgtggccccagcgcgcacgggcgatggcgaaggcgacgtccggtgccgcggggctgcgtctgctgttgctgctgctgctgccgctgctaggcaaagtggcattgggcctctacttctcgagggatgcttactgggagaagctgtatgtggaccaggcagccggcacgcccttgctgtacgtccatgccctgcgggacgcccctgaggaggtgcccagcttccgcctgggccagcatctctacggcacgtaccgcacacggctgcatgagaacaactggatctgcatccaggaggacaccggcctcctctaccttaaccggagcctggaccatagctcctgggagaagctcagtgtccgcaaccgcggctttcccctgctcaccgtctacctcaaggtcttcctgtcacccacatcccttcgtgagggcgagtgccagtggccaggctgtgcccgcgtatacttctccttcttcaacacctcctttccagcctgcagctccctcaagccccgggagctctgcttcccagagacaaggccctccttccgcattcgggagaaccgacccccaggcaccttccaccagttccgcctgctgcctgtgcagttcttgtgccccaacatcagcgtggcctacaggctcctggagggtgagggtctgcccttccgctgcgccccggacagcctggaggtgagcacgcgctgggccctggaccgcgagcagcgggagaagtacgagctggtggccgtgtgcaccgtgcacgccggcgcgcgcgaggaggtggtgatggtgcccttcccggtgaccgtgtacgacgaggacgactcggcgcccaccttccccgcgggcgtcgacaccgccagcgccgtggtggagttcaagcggaaggaggacaccgtggtggccacgctgcgtgtcttcgatgcagacgtggtacctgcatcaggggagctggtgaggcggtacacaagcacgctgctccccggggacacctgggcccagcagaccttccgggtggaacactggcccaacgagacctcggtccaggccaacggcagcttcgtgcgggcgaccgtacatgactataggctggttctcaaccggaacctctccatctcggagaaccgcaccatgcagctggcggtgctggtcaatgactcagacttccagggcccaggagcgggcgtcctcttgctccacttcaacgtgtcggtgctgccggtcagcctgcacctgcccagtacctactccctctccgtgagcaggagggctcgccgatttgcccagatcgggaaagtctgtgtggaaaactgccaggcattcagtggcatcaacgtccagtacaagctgcattcctctggtgccaactgcagcacgctaggggtggtcacctcagccgaggacacctcggggatcctgtttgtgaatgacaccaaggccctgcggcggcccaagtgtgccgaacttcactacatggtggtggccaccgaccagcagacctctaggcaggcccaggcccagctgcttgtaacagtggaggggtcatatgtggccgaggaggcgggctgccccctgtcctgtgcagtcagcaagagacggctggagtgtgaggagtgtggcggcctgggctccccaacaggcaggtgtgagtggaggcaaggagatggcaaagggatcaccaggaacttctccacctgctctcccagcaccaagacctgccccgacggccactgcgatgttgtggagacccaagacatcaacatttgccctcaggactgcctccggggcagcattgttgggggacacgagcctggggagccccgggggattaaagctggctatggcacctgcaactgcttccctgaggaggagaagtgcttctgcgagcccgaagacatccaggatccactgtgcgacgagctgtgccgcacggtgatcgcagccgctgtcctcttctccttcatcgtctcggtgctgctgtctgccttctgcatccactgctaccacaagtttgcccacaagccacccatctcctcagctgagatgaccttccggaggcccgcccaggccttcccggtcagctactcctcttccggtgcccgccggccctcgctggactccatggagaaccaggtctccgtggatgccttcaagatcctggaggatccaaagtgggaattccctcggaagaacttggttcttggaaaaactctaggagaaggcgaatttggaaaagtggtcaaggcaacggccttccatctgaaaggcagagcagggtacaccacggtggccgtgaagatgctgaaagagaacgcctccccgagtgagctgcgagacctgctgtcagagttcaacgtcctgaagcaggtcaaccacccacatgtcatcaaattgtatggggcctgcagccaggatggcccgctcctcctcatcgtggagtacgccaaatacggctccctgcggggcttcctccgcgagagccgcaaagtggggcctggctacctgggcagtggaggcagccgcaactccagctccctggaccacccggatgagcgggccctcaccatgggcgacctcatctcatttgcctggcagatctcacaggggatgcagtatctggccgagatgaagctcgttcatcgggacttggcagccagaaacatcctggtagctgaggggcggaagatgaagatttcggatttcggcttgtcccgagatgtttatgaagaggattcctacgtgaagaggagccagggtcggattccagttaaatggatggcaattgaatccctttttgatcatatctacaccacgcaaagtgatgtatggtcttttggtgtcctgctgtgggagatcgtgaccctagggggaaacccctatcctgggattcctcctgagcggctcttcaaccttctgaagaccggccaccggatggagaggccagacaactgcagcgaggagatgtaccgcctgatgctgcaatgctggaagcaggagccggacaaaaggccggtgtttgcggacatcagcaaagacctggagaagatgatggttaagaggagagactacttggaccttgcggcgtccactccatctgactccctgatttatgacgacggcctctcagaggaggagacaccgctggtggactgtaataatgcccccctccctcgagccctcccttccacatggattgaaaacaaactctatggcatgtcagacccgaactggcctggagagagtcctgtaccactcacgagagctgatggcactaacactgggtttccaagatatccaaatgatagtgtatatgctaactggatgctttcaccctcagcggcaaaattaatggacacgtttgatagttaacatttctttgtgaaagatgcacaacactcctccagtcttgtgggggcagcttttgggaagtctcagcagctcttctggctgtgttgtcagcactgtaacttcgcagaaaagagtcggattaccaaaacactgcctgctcttcagacttaaagcactgataggacttaaaatagtctcattcaaatactgtattttatataggcatttcacaaaaacagcaaaattgtggcattttgtgaggccaaggcttggatgcgtgtgtaatagagccttgtggtgtgtgcgcacacacccagagggagagtttgaaaaatgcttattggacacgtaacctggctctaatttgggctgtttttcagatacactgtgataagttcttttacaaatatctatagacatggtaaacttttggttttcagatatgcttaatgatagtcttactaaatgcagaaataagaataaactttctcaaattattaaaaatgcctacacagtaagtgtgaattgctgcaacaggtttgttctcaggagggtaagaactccaggtctaaacagctgacccagtgatggggaatttatccttgaccaatttatccttgaccaataacctaattgtctattcctgagttataaaagtccccatccttattagctctactggaattttcatacacgtaaatgcagaagttactaagtattaagtattactgagtattaagtagtaatctgtcagttattaaaatttgtaaaatctatttatgaaaggtcattaaaccagatcatgttcctttttttgtaatcaaggtgactaagaaaatcagttgtgtaaataaaatcatgtatc

SEQ ID NO: 91 - protein, 1114 aa, Homo sapiens
MAKATSGAAGLRLLLLLLLPLLGKVALGLYFSRDAYWEKLYVDQAAGTPLLYVHALRDAPEEVPSFRLGQHLYGTYRTRLHENNWICIQEDTGLLYLNRSLDHSSWEKLSVRNRGFPLLTVYLKVFLSPTSLREGECQWPGCARVYFSFFNTSFPACSSLKPRELCFPETRPSFRIRENRPPGTFHQFRLLPVQFLCPNISVAYRLLEGEGLPFRCAPDSLEVSTRWALDREQREKYELVAVCTVHAGAREEVVMVPFPVTVYDEDDSAPTFPAGVDTASAVVEFKRKEDTVVATLRVFDADVVPASGELVRRYTSTLLPGDTWAQQTFRVEHWPNETSVQANGSFVRATVHDYRLVLNRNLSISENRTMQLAVLVNDSDFQGPGAGVLLLHFNVSVLPVSLHLPSTYSLSVSRRARRFAQIGKVCVENCQAFSGINVQYKLHSSGANCSTLGVVTSAEDTSGILFVNDTKALRRPKCAELHYMVVATDQQTSRQAQAQLLVTVEGSYVAEEAGCPLSCAVSKRRLECEECGGLGSPTGRCEWRQGDGKGITRNFSTCSPSTKTCPDGHCDVVETQDINICPQDCLRGSIVGGHEPGEPRGIKAGYGTCNCFPEEEKCFCEPEDIQDPLCDELCRTVIAAAVLFSFIVSVLLSAFCIHCYHKFAHKPPISSAEMTFRRPAQAFPVSYSSSGARRPSLDSMENQVSVDAFKILEDPKWEFPRKNLVLGKTLGEGEFGKVVKATAFHLKGRAGYTTVAVKMLKENASPSELRDLLSEFNVLKQVNHPHVIKLYGACSQDGPLLLIVEYAKYGSLRGFLRESRKVGPGYLGSGGSRNSSSLDHPDERALTMGDLISFAWQISQGMQYLAEMKLVHRDLAARNILVAEGRKMKISDFGLSRDVYEEDSYVKRSQGRIPVKWMAIESLFDHIYTTQSDVWSFGVLLWEIVTLGGNPYPGIPPERLFNLLKTGHRMERPDNCSEEMYRLMLQCWKQEPDKRPVFADISKDLEKMMVKRRDYLDLAASTPSDSLIYDDGLSEEETPLVDCNNAPLPRALPSTWIENKLYGMSDPNWPGESPVPLTRADGTNTGFPRYPNDSVYANWMLSPSAAKLMDTFDS

SEQ ID NO: 92 - DNA, 3358 bp, Homo sapiens
  CDS (376)..(3189)
gagctggagcagccgccaccgccgccgccgagggagccccgggacggcagcccctgggcgcagggtgcgctgttctcggagtccgacccagggcgactcacgcccactggtgcgacccggacagcctgggactgacccgccggcccaggcgaggctgcagccagagggctgggaagggatcgcgctcgcggcatccagaggcggccaggcggaggcgagggagcaggttagagggacaaagagctttgcagacgtccccggcgtcctgcgagcgccagcggccgggacgaggcggccgggagcccgggaagagcccgtggatgttctgcgcgcggcctgggagccgccgccgccgccgcctcagcgagaggaggaatgcaccggccgcgccgccgcgggacgcgcccgccgctcctggcgctgctggccgcgctgctgctggccgcacgcggggctgctgcccaagaaacagagctgtcagtcagtgctgaattagtgcctacctcatcatggaacatctcaagtgaactcaacaaagattcttacctgacccttgatgaaccaatgaataacatcaccacgtctctgggccagacagcagaactgcactgcaaagtctctgggaatccacctcccaccatccgctggttcaaaaatgatgctcctgtggtccaggagccccggaggctctcctttcggtccaccatctatggctctcggctgcggattagaaacctcgacaccacagacacaggctacttccagtgcgtggcaacaaacggcaaggaggtggtttcttccactggagtcttgtttgtcaagtttggcccccctcccactgcaagtccaggatactcagatgagtatgaagaagatggattctgtcagccatacagagggattgcatgtgcaagatttattggcaaccgcaccgtctatatggagtctttgcacatgcaaggggaaatagaaaatcagatcacagctgccttcactatgattggcacttccagtcacttatctgataagtgttctcagttcgccattccttccctgtgccactatgccttcccgtactgcgatgaaacttcatccgtcccaaagccccgtgacttgtgtcgcgatgaatgtgaaatcctggagaatgtcctgtgtcaaacagagtacatttttgcaagatcaaatcccatgattctgatgaggctgaaactgccaaactgtgaagatctcccccagccagagagcccagaagctgcgaactgtatccggattggaattcccatggcagatcctataaataaaaatcacaagtgttataacagcacaggtgtggactaccgggggaccgtcagtgtgaccaaatcagggcgccagtgccagccatggaattcccagtatccccacacacacactttcaccgcccttcgtttcccagagctgaatggaggccattcctactgccgcaacccagggaatcaaaaggaagctccctggtgcttcaccttggatgaaaactttaagtctgatctgtgtgacatcccagcttgcgattcaaaggattccaaggagaagaataaaatggaaatcctgtacatactagtgccaagtgtggccattcccctggccattgctttactcttcttcttcatttgcgtctgtcggaataaccagaagtcatcgtcggcaccagtccagaggcaaccaaaacacgtcagaggtcaaaatgtggagatgtcaatgctgaatgcatataaacccaagagcaaggctaaagagctacctctttctgctgtacgctttatggaagaattgggtgagtgtgcctttggaaaaatctataaaggccatctctatctcccaggcatggaccatgctcagctggttgctatcaagaccttgaaagactataacaacccccagcaatggatggaatttcaacaagaagcctccctaatggcagaactgcaccaccccaatattgtctgccttctaggtgccgtcactcaggaacaacctgtgtgcatgctttttgagtatattaatcagggggatctccatgagttcctcatcatgagatccccacactctgatgttggctgcagcagtgatgaagatgggactgtgaaatccagcctggaccacggagattttctgcacattgcaattcagattgcagctggcatggaatacctgtctagtcacttctttgtccacaaggaccttgcagctcgcaatattttaatcggagagcaacttcatgtaaagatttcagacttggggctttccagagaaatttactccgctgattactacagggtccagagtaagtccttgctgcccattcgctggatgccccctgaagccatcatgtatggcaaattctcttctgattcagatatctggtcctttggggttgtcttgtgggagattttcagttttggactccagccatattatggattcagtaaccaggaagtgattgagatggtgagaaaacggcagctcttaccatgctctgaagactgcccacccagaatgtacagcctcatgacagagtgctggaatgagattccttctaggagaccaagatttaaagatattcacgtccggcttcggtcctgggagggactctcaagtcacacaagctctactactccttcagggggaaatgccaccacacagacaacctccctcagtgccagcccagtgagtaatctcagtaaccccagatatcctaattacatgttcccgagccagggtattacaccacagggccagattgctggtttcattggcccgccaatacctcagaaccagcgattcattcccatcaatggatacccaatacctcctggatatgcagcgtttccagctgcccactaccagccaacaggtcctcccagagtgattcagcactgcccacctcccaagagtcggtccccaagcagtgccagtgggtcgactagcactggccatgtgactagcttgccctcatcaggatccaatcaggaagcaaatattcctttactaccacacatgtcaattccaaatcatcctggtggaatgggtatcaccgtttttggcaacaaatctcaaaaaccctacaaaattgactcaaagcaagcatctttactaggagacgccaatattcatggacacaccgaatctatgatttctgcagaactgtaaaatgcacaacttttgtaaatgtggtatacaggacaaactagacggccgtagaaaagatttatattcaaatgtttttattaaagtaaggttctcatttagcagacatcgcaacaagtaccttctgtgaagtttcactgtgtcttaccaagcaggacagacactcggccag

SEQ ID NO: 93 - protein, 937 aa, Homo sapiens
MHRPRRRGTRPPLLALLAALLLAARGAAAQETELSVSAELVPTSSWNISSELNKDSYLTLDEPMNNITTSLGQTAELHCKVSGNPPPTIRWFKNDAPVVQEPRRLSFRSTIYGSRLRIRNLDTTDTGYFQCVATNGKEVVSSTGVLFVKFGPPPTASPGYSDEYEEDGFCQPYRGIACARFIGNRTVYMESLHMQGEIENQITAAFTMIGTSSHLSDKCSQFAIPSLCHYAFPYCDETSSVPKPRDLCRDECEILENVLCQTEYIFARSNPMILMRLKLPNCEDLPQPESPEAANCIRIGIPMADPINKNHKCYNSTGVDYRGTVSVTKSGRQCQPWNSQYPHTHTFTALRFPELNGGHSYCRNPGNQKEAPWCFTLDENFKSDLCDIPACDSKDSKEKNKMEILYILVPSVAIPLAIALLFFFICVCRNNQKSSSAPVQRQPKHVRGQNVEMSMLNAYKPKSKAKELPLSAVRFMEELGECAFGKIYKGHLYLPGMDHAQLVAIKTLKDYNNPQQWMEFQQEASLMAELHHPNIVCLLGAVTQEQPVCMLFEYINQGDLHEFLIMRSPHSDVGCSSDEDGTVKSSLDHGDFLHIAIQIAAGMEYLSSHFFVHKDLAARNILIGEQLHVKISDLGLSREIYSADYYRVQSKSLLPIRWMPPEAIMYGKFSSDSDIWSFGVVLWEIFSFGLQPYYGFSNQEVIEMVRKRQLLPCSEDCPPRMYSLMTECWNEIPSRRPRFKDIHVRLRSWEGLSSHTSSTTPSGGNATTQTTSLSASPVSNLSNPRYPNYMFPSQGITPQGQIAGFIGPPIPQNQRFIPINGYPIPPGYAAFPAAHYQPTGPPRVIQHCPPPKSRSPSSASGSTSTGHVTSLPSSGSNQEANIPLLPHMSIPNHPGGMGITVFGNKSQKPYKIDSKQASLLGDANIHGHTESMISAEL